(19) United States
(12) Patent Application Publication
(10) Pub. No.: US 2007/0038384 A1
(43) Pub. Date: Feb. 15, 2007

(54) Devices and assays for monitoring/measuring cellular dynamics to create subject profiles from primary cells

(76) Inventors: Gregory L. Kirk, Pleasanton, CA (US); Emanuele Ostuni, Flourtown, PA (US); Enoch Kim, Boston, MA (US); Olivier Schueller, Arlington, MA (US); Paul Sweetnam, Marblehead, MA (US)

Correspondence Address: KENYON & KENYON LLP, 1500 K STREET N.W., SUITE 700, WASHINGTON, DC, 20005, US

(21) Appl. No.: 11/325,505

(22) Filed: Jan. 5, 2006

Related U.S. Application Data
(63) Continuation of application No. 11/044,205, filed on Jan. 28, 2005, now abandoned.
Application No. 11/044,205 is a continuation of application No. 10/823,720, filed on Apr. 14, 2004, now abandoned.
(60) Provisional application No. 60/462,315, filed on Apr. 14, 2003.

(51) Int. Cl. G06F 19/00

(52) U.S. Cl. 702/19

(57) ABSTRACT

The present invention further relates to utilizing the above devices and methods for assaying cellular dynamics and phenotypes to create subject primary cell profiles for patients. Additionally, the present invention relates to methods of correlating primary cell profiles with a therapeutic regimen. Finally, the invention relates to methods for screening test compounds for biological activities by measuring their effect on primary cell profiles.

This application claims the benefit of U.S. Provisional Patent Application Ser. No. 60/462,315, filed Apr. 14, 2003, the disclosure of which is hereby incorporated in its entirety.

### FIELD OF THE INVENTION

The invention generally relates to devices and methods for patterning cells in a predetermined array for subsequent observation and measurement of cell motility.

The present invention relates to devices and methods for monitoring the interaction of a cell or group of cells with a substratum. In particular, the present invention relates to devices and methods for monitoring leukocyte migration. The present invention relates generally to biological assays performed in gradients formed in microfluidic systems.

The present invention relates generally to device for monitoring cell motility and chemotaxis.

The present invention relates generally to biological assays performed in gradients formed in microfluidic systems.

The present invention further relates to utilizing the above devices and methods for assaying cellular dynamics and phenotypes to create subject primary cell profiles for patients. Additionally, the present invention relates to methods of correlating primary cell profiles with a therapeutic regimen. Finally, the invention relates to methods for screening test compounds for biological activities by measuring their effect on primary cell profiles.

### BACKGROUND

The study of cellular behavior and the effects of external stimuli on the cell are prevalent throughout contemporary biological research. Generally, this research involves exposing a cell to external stimuli and studying the cell's reaction. By placing a living cell into various environments and exposing it to different external stimuli, both the internal workings of the cell and the effects of the external stimuli on the cell can be measured, recorded, and better understood.

When a cell is exposed to chemical stimuli, its behavior is an important consideration, particularly when developing and evaluating therapeutic candidates and their effectiveness. By documenting the reaction of a cell or a group of cells to a chemical stimulus, such as a therapeutic agent, the effectiveness of the chemical stimulus can be better understood. In particular, in the fields of oncology and cell biology, cell migration and metastasis are regularly considered. Typically, studies in these fields involve analyzing the migration and behavior of living cells with regard to various biological factors and potential anti-cancer drugs. Moreover, the resultant migration, differentiation, and behavior of a cell are often insightful towards further understanding the chemotactic processes involved in tumor cell metastasis. In addition, these studies can also provide insight into the processes of tissue regeneration, wound healing, inflammation, autoimmune diseases, and many other degenerative diseases and conditions.

Cell migration assays are often used in conducting these types of research. Commercially available devices for creating such assays are often based on or employ a Boyden chamber (a vessel partitioned by a thin porous membrane to form two distinct, super-imposed chambers). Also known as transwells, the Boyden chamber is used by placing a migratory stimulus on one side of a thin porous membrane and cells to be studied on the other. After a sufficient incubation period the cells may be fixed, stained, and counted to study the effects of the stimulus on cell migration across the membrane.

The use of transwells has several shortcomings. For instance, assays employing transwells require a labor-intensive protocol that is not readily adaptable to high-throughput screening and processing. The counting of cells, which is often done manually using a microscope, is a time-consuming, tedious, and expensive process. Furthermore, cell counting is also subjective and involves statistical approximations. Specifically, due to the time and expense associated with examining an entire filter, only representative areas, selected at random, may be counted, and, even when these areas are counted, if a cell has only partially migrated through the filter, a technician must, nevertheless, exercise his or her judgement when accounting for such a cell.

Notwithstanding the above, perhaps the most significant disadvantage to the use of transwells is that when the cells are fixed to a slide, as required for observation, they are killed. Consequently, once a cell is observed it can no longer be reintroduced into the assay or studied at subsequent periods of exposure to the stimulus. Therefore, in order to study the progress of a cell reaction to a stimulus, it is necessary to run concurrent samples that may be slated for observation at various time periods before and after the introduction of the stimulus. In light of the multiple samples required for each test, in addition to the positive and negative controls required to obtain reliable data, a single chemotaxis assay can require dozens of filters, each of which needs to be individually examined and counted an enormous and onerous task.

Cell migration and differentiation is also important to the understanding of numerous biological functions, both normal and abnormal. For example, the study of tissue regeneration and wound healing, and the study of inflammation, autoimmune diseases and other degenerative diseases, all involve the analysis of cell movement, either spontaneous or in response to chemotactic factors, or other cellular signals. Further, in studying the treatment of various abnormal cellular functions or diseases, scientists must analyze the effects of potential therapies on cell movement in cell culture before proceeding to clinical studies.

Thus, a cell migration assay is a useful tool for cell biologists for determining the ability of cells to grow, proliferate, and migrate. Although useful, assays based on cell migration have been limited in use because of the unavailability of convenient tools for performing the assay. Currently, commercially available devices for studying cell migration or chemotaxis are based on the Boyden Chamber. S. Boyden, J. Exp. Med. 115: pp. 453-466, (1962). The time and expense associated with a time-dependent study is usually prohibitive of conducting such a study using the Boyden procedure. As the migratory behavior of cells has potential implications in the development of certain therapeutics, a better in vitro system is needed for screening and quantifying the effects of drug targets on cell motility and migration.

Alternatives to the Boyden assay have been proposed to overcome some of the above disadvantages. See generally, P. Wilkinson, Methods in Enzymology, Vol. 162, (Academic Press, Inc. 1988), pp. 38-50; see also, Goodwin, U.S. Pat. No. 5,302,515; Guiruis et al., U.S. Pat. No. 4,912,057; Goodwin, U.S. Pat. No. 5,284,753; and Goodwin, U.S. Pat. No. 5,210,021. Although the chemotaxis devices and procedures described in these references have some advantages over the original Boyden procedure and apparatus, they are not without their shortcomings. For example, all of these procedures, like the Boyden Chamber, require that the filter be removed and the non-migrated cells be wiped or brushed from the filter before the migrated cells can be counted. In addition, most of these procedures require fixing and staining the cells, and none of them permit the kinetic or time-dependent study of the chemotactic response of the same cell sample. Further, these methods involve the counting of cells, a lengthy procedure not compatible with high-throughput applications.

Cell migration is important for tissue morphogenesis. Much progress has been made in terms of understanding the molecular basis of cell movement. However, because of the inherent complexity of multicellular systems, little is known about how cell migration mediates cellular pattern formation. Bragwynne et al. (Proceedings of the 22nd Annual International Conference, July 23-28, 2000) report spontaneous pattern generation in a model mammalian tissue in vitro by spatially constraining cell adhesion. They observed coupled, coordinated migration of bovine capillary endothelial cells within a field defined by spatial limits of an adhesive surface. Bragwynne et al. have speculated that pattern-generating behavior that emerges from collective interactions among different interacting cellular components may contribute to tissue development. Bragwynne et al. surmise that the resulting cell patterns demonstrate that a geometric constraint on a group of migratory cells can induce spontaneous pattern formation. Thus, in order to more fully understand spontaneous pattern formation it is necessary to have a device that would allow one to pattern cells in a predetermined location in a predefined pattern and observe their migration and spontaneous pattern formation.

The role of cell-cell interactions in the control of cellular growth, migration, differentiation, and function is becoming increasingly apparent. Cell-cell contact is believed to be involved in developmental processes such as mesoderm interaction and mesenchymal-epithelial transformation. Sargent, T. D., et al., Dev. Biol. 114:238-246 (1986); Lehtonen, E., et al., J. Embryol. Exp. Morphol. 33:187-203 (1975). In the nervous system, the pattern of neural cell migration axonal cone growth and glial cell differentiation are thought to depend on heterolytic cell-cell interactions. Rakic, P., The cell in contact, New York: Wiley Intersciences, 67-91 (1985); Bently, D., et al., Nature 304:62-65 (1983); Lillien, L., et al., Neuron 4:525-534 (1990). In the immune system, the development and activation of lymphocytes are dependent on contact with a number of different cell types throughout the life of a lymphocyte. Kierny, P. C., et al., Blood 70:1418-1424 (1987). In addition, the differentiation and function of epithelial cells, e.g. intestinal epithelia, are regulated in part by contacts with the underlying mesenchymal cells. Kedinger, M., et al., Cell Differ. 20:171-182 (1987). As the role of heterocellular contact becomes more apparent, in vitro systems designed to investigate intercellular communication are needed.

A number of experimental approaches utilizing co-cultures of two different tissue or cell types have been used to examine the role of intercellular communication in various cellular processes. For example, the contribution of cell-cell interactions to embryonic inductive processes was elucidated by experiments in which pieces of embryonic tissue were attached to opposite sides of a porous membrane. Grobstein, C., Exp. Cell Res. 10:424-440 (1956). Investigations of the effects of heterotypic interactions on cellular functions have co-cultured two different cell types in the same culture dish. Davies, P. F., et al., J. Cell Biol. 101:871-879 (1985); Guguen-Guillouzo, C., et al., Exp. Cell Res. 143:47-54 (1983); Mehta, R. P., et al., Cell 44:187-196 (1986); Orlidge, A., et al., J. Cell Biol. 105:1455-1462 (1987); Shimaoka, S., et al., Exp. Cell Res. 172:228-242 (1987). These co-cultures have limited use, however, because they represent a mixed population of cells. The effects of intercellular contact on cell morphology or on a function or protein unique to one of the cell types can be examined; however, investigation of biochemical or molecular processes common to both cells in not possible. Porous filters have been used in co-cultures of tissue culture cells to circumvent this limitation. In these studies, one cell type is usually grown in a tissue culture dish and second cell type cultured on a porous membrane in a chamber that fits into the culture dish. Hisanaga, K., et al., Dev. Brain Res. 54:151-160 (1990); Kruegar, G. G., et al., Dermatologic 179:91S-100S (1989); Ueda, H., et al., J. Cell Sci. 89:175-188 (1988).

It has been determined that many factors operate synergistically to produce an effect on cellular migration. For example, Woodward et al., Journal of Cell Science 111, 469-478 (1998) have used a migration chamber to demonstrate that ∀₅₅₀∃₃ integrin and PDGF receptor work synergistically to increase cell migration. Thus, an assay device or method that would allow further study of cell migration in response to various factors, including synergistic effects, would aid in the understanding of cellular motility and migration.

To study cell motility, either in response to a cell affecting agent, or random motility, it is desirable to be able to monitor cellular movement from a predefined “starting” position. To do this, cells must be placed, attached or immobilized upon a surface in such a manner that their viability is maintained and that their position is defineable so that multiple interrogations or probing of cellular response (i.e. motility or lack thereof) may be performed. In previous methods concerning cell immobilization, cells often undergo a nonreversible immobilization. For example, cells have been immobilized by patterning cells on a self-assembled monolayer that has a protein tether that will “capture” the cell. Alternatively, cells have been immobilized via immunological reaction with antibodies, which themselves have been immobilized on the immobilization surface. Other methods of immobilization involve simply allowing cells to attach themselves to a suitable surface, such as glass or plastic, and then allowing them to migrate into adjacent areas.

Ostuni et al. have used elastomeric membranes to pattern the attachment of cells to surfaces that are commonly used in cell culture. Patterning of cells is an experimental protocol that is broadly useful in studying and controlling the behavior of anchorage-dependent cells. Chen, C. S., et al., Science, 276, 1425-1428 (1997); Ingber, D. E., et al., J. Cell Biol. 109, 317-330 (1989); Ingber, D. E. Proc. Natl. Acad. Sci. U.S.A., 87, 3379-3583 (1990); Singhvi, R.; et al., Science 264, 696-698 (1994). It is also relevant to applied cell biology, bio-sensors, high-throughput screening and tissue engineering. Chen, et al., Science 276, 1425-1428 (1997); Bhatia, S. N. et al., Biotechnol. J. 14, 378-387 (1998); Borkholder, D. A., et al., J. Neurosci. Methods, 77, 61-66 (1997); Dodd, S. J., et al., Biophys. J., 76, 103-109 (1999); Fromherz, P., Phys. Rev. Lett. 78, 4131-4134; Hickman, J. J., et al., J. Vac. Sci. Technol., A-Vac. Surf. Films 12, 607-616 (1994); Humes, H. D., et al., Nat. Biotechnol. 17, 451-455 (1999); Huynh, T., et al., Nat. Biotechnol. 17, 1088-1086 (1999); Kapur, R., et al., J. Biomech. Eng.-Trans. ASME 121, 65-72 (1999); Pancrazio, J. J., et al., Sens. Actuators, B-Chem. 53, 179-185 (1998); St. John, P. M., et al., Anal. Chem. 70, 1108-1111 (1998); You, A. J., et al., Chem., Biol. 4, 969-975 (1997).

Soft lithography has been developed to provide a set of methods for patterning surfaces and fabricating structures with dimensions in the 1-100 μm range in ways that are useful in cell biology and biochemistry. Qin, D., et al., Adv. Mater. 8, 917-919 (1996); Qin, D., et al., J. Vac. Sci., Technol., B 16, 98-103 (1998); Xia, Y., et al., Agnew. Chem., Int. Ed. Engl. 37, 550-575 (1998); Zhao, X.-M., et al., Adv. Mater. 8, 837-840 (1996); Zhao, X.-M., et al., Adv. Mater. 9, 251-254 (1997). Microcontact printing is particularly useful as a method for generating patterns of proteins and cells, by patterning self-assembled monolayers of alkanethiolates on the surface of gold. Chen, C. S., et al., Science 276, 1425-1428 (1997); Singhvi, R., et al., Science 264, 696-698 (1994); López, G. P., et al., J. Am. Chem. Soc. 115, 5877-5878 (1993); Kumar, A., et al., Appl. Phys. Lett. 63, 2002-2004 (1993); Mrksich, M., et al., Trends Biotech. 13, 228-235 (1995).

Mrksich et al. have partitioned a gold support into regions patterned with a hydrophobic alkanethiolate and another alkanethiolate that presents small percentages of an electrochemically active terminal group. (Yousaf, M. N.; Houseman, B. T.; Mrksich, M. Submitted.). After cells attached and spread themselves on the hydrophobic pattern, application of a short voltage pulse changed the oxidation state and polarity of the terminal redox center. This oxidation state and polarity change allowed groups presenting peptide sequences to react with the surface to generate a subsequent surface that the patterned cells could spread on. This method requires the synthesis of electroactive alkanethiols, and also requires electrochemical instrumentation.

It is further known in the art to use under agarose migration studies to assay cell differentiation and cell migration. These methods are slow and laborious and as such are not suitable to the demands of high throughput assays.

Thus, there remains a need for a device and method of tracking live cells in real time. Current existing techniques require laborious protocols and work as end-point assays. The present invention fulfills this need.

The inflammatory response is an attempt by the body to restore and maintain homeostasis after infection or injury, and is an integral part of body defense. Most of the body defense elements are located in the blood and inflammation is the means by which these elements leave the blood and enter the tissue around the injured or infected site. The primary objective of inflammation is to localize and eradicate the source of injury or infection and repair tissue surrounding the site of injury or infection.

As a consequence of the initial innate immune response to infection, phagocytes such as mast cells in the damaged tissue release a variety of cytokines and inflammatory mediators, such as histamines, leukotrienes, bradykinins, and prostaglandins. These inflammatory mediators reversibly open the junctional zones between the thin delicate cells of the inner surface of the blood vessels, known as the endothelium, that surround the damaged tissue. The inflammatory mediators also cause increased blood vessel permeability and decreased blood flow velocity. Another result of these changes in the blood vessels is that leukocytes, which normally travel in the center of the blood vessel, move out to the periphery of the inner surface of the blood vessel to interact with the endothelium. The cytokines and inflammatory mediators released by the phagocytes also induce the expression of adhesion molecules on the surface of the endothelium, resulting in an “activated” endothelium.

The first contact of leukocytes with the activated endothelium is known as “capture” and is thought to involve the adhesion molecules P-selectin and L-selectin, which are upregulated on endothelium after exposure to inflammatory mediators. P-selectin and L-selectin belong to a family of adhesion molecules called selectins. Selectins are a group of monomeric, integral membrane glycoproteins expressed on the surface of activated endothelium and leukocytes. Selectins contain an N-terminal extracellular domain with structural homology to calcium-dependent lectins, followed by a domain homologous to epidermal growth factor, and nine consensus repeats (CR) similar to sequences found in complement regulatory proteins. There are three primary selectins thought to be involved in the inflammatory response: P-selectin; E-selectin; and L-selectin. P-selectin, also known as CD62P, GMP-140, and PADGEM, the largest selectin, is expressed on activated endothelium; E-selectin, also known as ELAM-1, is expressed on endothelium with chemically or cytokine-induced inflammation; L-selectin, also known as LECAM-1, LAM-1, Mel-14 antigen, gp90mel, and Leu8/TQ-1 antigen, is the smallest selectin and is found on most leukocytes. All three selectins are thought to bind to selectin binding ligands, at least in part through a carbohydrate component.

During capture, P-selectin is thought to bind to its main leukocyte ligand P-selectin glycoprotein ligand-1 (PSGL-1). Other ligands of P-selectin include CD24 and yet uncharacterized ligands. The structure of functional PSGL-1 includes a sialyl-Lewisx component. In addition, during capture L-selectin is thought to bind to its ligand on endothelial cells. L-selectin interacts with three known counter receptors or ligands, MAdCAM-1, GlyCAM-1, and CD34, although the precise ligand or counter receptor involved in capture is unknown.

Once leukocytes are captured, they may transiently adhere to the endothelium and begin to “roll” along the endothelium. The term “rolling” refers to the literal rolling of leukocytes along the activated endothelium in the presence of fluid drag forces arising from the relative movement between the endothelium and the leukocytes. Rolling is thought to involve P-selectin, L-selectin, and E-selectin. Bonds between P-selectin and PSGL-1 are thought to primarily mediate the “rolling” of leukocytes across the endothelium.

Proinflammatory cytokines such as interleukin-1 (IL-1), and tumor necrosis factor-a (TNF-∀) produced by cells at the injured or infected site stimulate the endothelium to produce chemokines such as interleukin-8 (IL-8) and integrin binding ligands such as intercellular adhesion molecules (ICAMs) and vascular cell adhesion molecules (VCAMs) on the surface of the endothelial cells opposite the basal lamina. The chemokines are held on the surface of the endothelial cells opposite the basal lamina where the chemokines interact with chemokine receptors on the surface of the rolling leukocytes. This interaction, in turn, triggers the activation of molecules called integrins on the surface of the leukocytes. Integrins are a family of heterodimeric transmembrane glycoproteins that attach cells to extracellular matrix proteins of the basement membrane or to ligands on other cells. Integrins are composed of large a and small b subunits. Mammalian integrins form several subfamilies sharing common b subunits that associate with difference a subunits. $2 integrins (the “CD-18 family”) include four different heterodimers: CD11a/CD18 (Lymphocyte Function-Associated Antigen-1 (LFA-1)); CD11b/CD18 (Mac-1); CD11c/CD18 (p150,95), and CD11d/CD18. The most important member of the $1 integrin subfamily on leukocytes is Very Late Antigen 4 (VLA-4, CD49d/CD29, “4$1). Activation of these integrins by chemokines enables the slowly rolling leukocytes to “arrest” and strongly bind to the endothelium's ICAMs, VCAMs, and other integrin binding ligands of the endothelial cells, such as collagen, fibronectin, and fibrinogen. Once bound to the endothelial cells, the leukocytes then flatten and squeeze between the endothelial cells to leave the blood vessels and enter the damaged tissue through a process termed “transmigration.” Transmigration is thought to be mediated by platelets, endothelial cell adhesion molecule-1 (PECAM-1), junctional adhesion molecule (JAM), and possibly CD99, a transmembrane protein.

Despite their importance in fighting infection and injury, leukocytes themselves can promote tissue damage. During an abnormal inflammatory response, leukocytes can cause significant tissue damage by releasing toxic substances at the vascular wall or in uninjured tissue. Alternatively, leukocytes may stick to the capillary wall or clump in venules to such a degree that the endothelium becomes lined with these cells. Such a phenomenon, referred to as “pavementing,” may be related to the development of arteriosclerosis and associated diseases. Such abnormal inflammatory responses have been implicated in the pathogenesis of a variety of other clinical disorders including adult respiratory distress syndrome (ARDS); ischemia-reperfusion injury following myocardial infarction, shock, stroke, or organ transplantation; acute and chronic allograft rejection; vasculitis; sepsis; rheumotoid arthritis; and inflammatory skin diseases.

Several methods and devices exist in the art to study the processes of leukocyte migration implicated in these various inflammatory diseases. For example, one method involves plating a monolayer of isolated endothelial cells on the surface of microtiter plates, activating the cells with a chemoattractant and then placing labeled leukocytes in the plate. A test agent, such as an adhesion inhibitor, may be optionally added to the plate. The number of leukocytes that remain adherent to the endothelial cell monolayer is then determined. A significant disadvantage of this method is that the leukocytes are not exposed to the endothelial cells in the presence of shear flow and thus this method does not simulate physiological conditions in vivo.

Another method involves contacting a suspension of isolated leukocytes in a suitable medium with a human vascular tissue sample mounted on a microscope slide and then incubating the tissue with a cell suspension on a rotating table. The adhered cells are fixed and counted. Because cells are fixed, such a method precludes the observation of leukocyte migration in real time. In addition, such a method requires human vascular tissue, which can be difficult and costly to obtain.

Another method known in the art to study leukocyte migration, involves a device consisting of two glass tubes called microslides, one microslide capable of being inserted into the other. The smaller microslide is inserted into the larger one to create a flow channel with a flat surface on which selected adhesion molecules are present. A suspension of leukocytes is then perfused through the flow channel over the adhesion molecule immobilized surface using a syringe pump. The rolling and adhesion of the leukocytes is then observed. Because of the size and configuration of this device, it requires considerable handling and manipulation.

Another device to study leukocyte migration during the inflammatory response is described in U.S. Pat. No. 5,460,945 to Springer et al. entitled “Device and Method for Analysis of Blood Components and Identifying Inhibitors and Promoters of the Inflammatory Response.” This device consists of several different components that are bulky in size. As such, it requires extra handling and positioning, creating the risk of contaminating or damaging the endothelial monolayer. This device also requires the use of a large number of cells and consequently a large amount of reagents.

Therefore, there exists a need for an improved device to study the leukocyte migration along the endothelium that simulates the physiological conditions of a blood vessel. There also exists a need for a device that would allow for high throughput screening of test agents that potentially affect the interaction of leukocytes with the endothelium without requiring the number of leukocytes per assay as required by the devices currently known in the art. The present invention meets these needs.

Test devices, such as those used in chemotaxis, haptotaxis and chemoinvasion are well known. Such devices are disclosed for example in U.S. Pat. Nos. 6,329,164, 6,238,874, and 5,302,515.

Three processes involved in cell migration are chemotaxis, haptotaxis, and chemoinvasion. Chemotaxis is defined as the movement of cells induced by a concentration gradient of a soluble chemotactic stimulus. Haptotaxis is defined as the movement of cells in response to a concentration gradient of a substrate-bound stimulus. Chemoinvasion is defined as the movement of cells into and/or through a barrier or gel matrix. The study of chemotaxis/haptotaxis and chemoinvasion and the effects of external stimuli on such behavior are prevalent throughout contemporary biological research. Generally, this research involves exposing a cell to external stimuli and studying the cell's reaction. By placing a living cell into various environments and exposing it to different external stimuli, both the internal workings of the cell and the effects of the external stimuli on the cell can be measured, recorded, and better understood.

A cell's migration in response to a chemical stimulus is a particularly important consideration for understanding various disease processes and accordingly developing and evaluating therapeutic candidates for these diseases. By documenting the cell migration of a cell or a group of cells in response to a chemical stimulus, such as a therapeutic agent, the effectiveness of the chemical stimulus can be better understood. Typically, studies of disease processes in various medical fields, such as oncology, immunology, angiogenesis, wound healing, and neurobiology involve analyzing the chemotactic and invasive properties of living cells. For example, in the field of oncology, cell migration is an important consideration in understanding the process of metastasis. During metastasis, cancer cells of a typical solid tumor must loosen their adhesion to neighboring cells, escape from the tissue of origin, invade other tissues by degrading the tissues' extracellular matrix until reaching a blood or lymphatic vessel, cross the basal lamina and endothelial lining of the vessel to enter circulation, exit from circulation elsewhere in the body, and survive and proliferate in the new environment in which they ultimately reside. Therefore, studying the cancer cells' migration may aid in understanding the process of metastasis and developing therapeutic agents that potentially inhibit this process. In the inflammatory disease field, cell migration is also an important consideration in understanding the inflammatory response. During the inflammation response, leukocytes migrate to the damaged tissue area and assist in fighting the infection or healing the wound. The leukocytes migrate through the capillary adhering to the endothelial cells lining the capillary. The leukocytes then squeeze between the endothelial cells and use digestive enzymes to crawl across the basal lamina. Therefore, studying the leukocytes migrating across the endothelial cells and invading the basal lamina may aid in understanding the inflammation process and developing therapeutic agents that inhibit this process in inflammatory diseases such as adult respiratory distress sydrome (ARDS), rheumotoid arthritis, and inflammatory skin diseases.

Cell migration is also an important consideration in the field of angiogenesis. When a capillary sprouts from an existing small vessel, an endothelial cell initially extends from the wall of the existing small vessel generating a new capillary branch and pseudopodia guide the growth of the capillary sprout into the surrounding connective tissue. New growth of these capillaries enables cancerous growths to enlarge and spread and contributes, for example, to the blindness that can accompany diabetes. Conversely, lack of capillary production can contribute to tissue death in cardiac muscle after, for example, a heart attack. Therefore studying the migration of endothelial cells as new capillaries form from existing capillaries may aid in understanding angiogenesis and optimizing drugs that block vessel growth or improve vessel function. In addition, studying cell migration can also provide insight into the processes of tissue regeneration, organ transplantation, autoimmune diseases, and many other degenerative diseases and conditions.

Cell migration assays are often used in conducting these types of research. Commercially available devices for creating such assays are sometimes based on or employ a transwell system (a vessel partitioned by a thin porous membrane to form an upper compartment and a lower compartment). To study cell chemotaxis, cells are placed in the upper compartment and a migratory stimulus is placed in the lower compartment. After a sufficient incubation period, the cells are fixed, stained, and counted to study the effects of the stimulus on cell chemotaxis across the membrane.

To study chemoinvasion, a uniform layer of a MATRIGEL™ matrix is placed over the membrane to occlude the pores of the membrane. Cells are seeded onto the MATRIGEL™ matrix in the upper compartment and a chemoattractant is placed in the lower compartment. Invasive cells attach to and invade the matrix passing through the porous membrane. Non-invasive cells do not migrate through the occluded pores. After a sufficient incubation period, the cells may be fixed, stained, and counted to study the effects of the stimulus on cell invasion across the membrane.

The use of transwells has several shortcomings. Assays employing transwells require a labor-intensive protocol that is not readily adaptable to high-throughput screening and processing. Because of the configuration of a transwell system, it is difficult to integrate with existing robotic liquid handling systems and automatic image acquisition systems. As described above, the transwell system requires manual cell counting which is time consuming, expensive, and subjective.

Transwell-based assays have intrinsic limitations imposed by the thin membranes utilized in transwell systems. The membrane is only 50-30 microns (μm) thick, and a chemical concentration gradient that forms across the membrane is transient and lasts for a short period. If a cell chemotaxis assay requires the chemotactic gradient to be generated over a long distance (>100-200 μm) and to be stable over at least two hours, currently available transwell assays cannot be satisfactorily performed.

The most significant disadvantage of transwells is the lack of real-time observation of chemotaxis and chemoinvasion. In particular, the changes in cell morphology during chemotaxis cannot be observed in real-time with the use of transwells. Because the transwell system requires killing the cells for observation as described above, a single chemotaxis assay can require dozens of filters, each of which needs to be individually examined and counted.

More recently, devices for measuring chemotaxis and chemoinvasion have become available which employ a configuration in which two wells are horizontally offset with respect to one another. This configuration of a device was introduced by Sally Zigmond in 1977 and, hereafter referred to as the “Zigmond device,” consists of a 25 millimeters (mm)×75 mm glass slide with two grooves 4 mm wide and 1 mm deep, separated by a 1 mm bridge. One of the grooves is filled with an attractant and the other groove is filled with a control solution, thus forming a concentration gradient across the bridge. Cells are then added to the other groove. Two holes are provided at each end of the slide to accept pin clamps. The clamps hold a cover glass in place during incubation and observation of the cells. Because of the size and configuration of the Zigmond chamber, it does not allow integration with existing robotic liquid handling systems and automatic image acquisition systems. Further, as with transwell-based systems, the changes in cell morphology during chemotaxis cannot be observed in real-time with the use of the Zigmond chamber as the cells are fixed to a slide for observation. In addition, the pin clamps must be assembled with an allen wrench and thus the device requires extra handling, positioning, and alignment before performing the assay. Such handling and positioning of the cover glass on the glass slide, as well as the rigidity of the cover glass, can potentially damage or interfere any surface treatment on the bridge.

A chemotaxis device attempting to solve the problem of lack of real-time observation is the “Dunn chamber.” The Dunn chamber consists of a specially constructed microslide with a central circular sink and a concentric annular moat. In an assay using a Dunn chamber, cells migrate on a coverslip, which is placed inverted on the Dunn chamber, towards a chemotactic stimulus. The cells are monitored over-night using a phase-contrast microscope fitted with a video camera connected to a computer with an image-grabber board.

In addition to the problems of rigidity of the coverslip and the lack of integration into existing robotic liquid handling systems, a major problem with the Dunn chamber assay is that only a very small number of cells are monitored (typically ten). The average behavior of this very small sample may not be typical of the population as a whole. A second major problem is that replication is very restricted. Each control chamber and each treatment chamber must be viewed in separate microscopes, each one similarly equipped with camera and computer.

Another chemotaxis device known in the art is disclosed in U.S. Pat. No. 6,238,874 to Jarnigan et. al. (the '874 patent). The '874 patent discloses various embodiments of test devices that may be used to monitor chemotaxis. However, disadvantageously, the devices in Jarnagin et al. can not be easily sealed or assembled or peeled and disassembled. Thus, it is difficult to maintain surfaces that are prepared chemically or biologically during assembly. The test devices of the '874 patent are therefore more suited for one-time use. Also, disassembly and collection of cells is difficult to do without damage to the cells or without disturbing the cell positions.

The prior art has failed to provide a test device, such as a device for monitoring chemotaxis, haptotaxis, and/or chemoinvasion, which device is easily assembled and dissembled. In addition, the prior art has failed to provide a test device for monitoring chemotaxis and/or chemoinvasion, which is not limited to measuring the effects on cell migration of chemoattractants, chemorepellants and chemostimulants.

### SUMMARY OF THE INVENTION

The present invention provides a device comprising a support; a first layer configured to be placed in fluid-tight contact with the support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; and a second layer configured to be placed in fluid-tight contact with the upper surface of the first layer, the second layer defining a pattern of macro-orifices, each macro-orifice of the pattern of macro-orifices having walls and defining a macro-region when the first layer is placed in fluid-tight contact with the support and the second layer is placed in fluid-tight contact with the first layer such that the walls of the macro-orifice and the macro-region together define a macro-well.

The first layer is preferably configured to be placed in conformal contact with the support when the first layer is placed against the support. The second layer is preferably configured to be placed in conformal contact with the first layer when the second layer is placed against the first layer. The support is made of a material selected from the group consisting of glass, silicon, fused silica, metal films, polystyrene, poly(methylacrylate) and polycarbonate. The first layer and the second layer are made of a material selected from the group consisting of glass, elastomers, rigid plastics, metals, silicon and silicon dioxide. Preferably the first layer and second layer are made of an elastomer. Most preferably the first layer and the second layer is PDMS. Preferably each macro-region encompasses at least one micro-region and more preferably each macro-region encompasses a plurality of micro-regions.

In one embodiment the walls of each macro-well define a curve in a cross-sectional plane perpendicular to the upper surface of the first layer.

In the device at least one of the pattern of micro-orifices and the pattern of macro-orifices spatially and dimensionally corresponds to a standard microtiter plate. Preferably the at least one of the pattern of micro-orifices and the pattern of macro-orifices spatially and dimensionally corresponds to a standard microtiter plate selected from a group consisting of a 6-well microtiter plate, a 12-well microtiter plate, a 24-well microtiter plate, a 96-well microtiter plate, a 384-well microtiter plate, a 1,536-well microtiter plate, and a 9,600-well microtiter plate.

In another embodiment, the device further comprises at least one cap for enclosing at least one of the macro-wells. Preferably the devices comprises a plurality of caps for enclosing each of the macro-wells.

The device may also comprise a means for aligning the micro-orifices with the macro-orifices. The means for aligning includes a guide mechanism on at least one of the support, the first layer and the second layer. The guide mechanism includes protrusions extending from the support, and guide orifices defined in the first layer and in the second layer for receiving the protrusions therein thereby aligning respective ones of the first layer and the second layer on the support. The means for aligning includes markings on at least one of the support, the first layer and the second layer.

In another embodiment, the device comprises a support; a first layer configured to be placed in fluid-tight contact with the support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; and a second layer configured to be placed in fluid-tight contact with the support upon the removal of the first layer from the support, the second layer defining a pattern of macro-orifices, each macro-orifice of the pattern of macro-orifices having walls and defining a macro-region when the first layer is placed in fluid-tight contact with the support and the second layer is placed in fluid-tight contact with the first layer such that the walls of the macro-orifice and the macro-region together define a macro-well.

The present invention further provides a device comprising a support; a first layer configured to be placed in fluid-tight contact with the support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; and a second layer configured to be placed in fluid-tight contact with the support, the second layer comprising a plurality of rings, the rings defining a pattern of respective macro-orifices, each ring having walls and defining a macro-region when the second layer is placed in fluid-tight contact with the support such that the walls of the ring and the macro-region together define a macro-well.

The invention further comprises a device comprising a support; a layer configured to be placed in fluid-tight contact with the support, the layer defining a pattern of macro-orifices, each macro-orifice of the pattern of macro-orifices having walls and defining a macro-region when the layer is placed in fluid-tight contact with the support such that the walls of the macro-orifice and the macro-region together define a macro-well; and a set of plugs, each of the plugs being configured for being received in a respective macro-well, each of the plugs comprising a lower membrane adapted to be placed in fluid-tight contact with the support when the layer is placed in fluid-tight contact with the support and the plug is received in a corresponding macro-well defined by the layer and the support, the lower membrane further defining a pattern of micro-orifices, wherein each micro-orifice has walls and defines a micro-region on the support when the plug is in fluid-tight contact with the support such that the walls of the micro-orifice and the micro-region together define a micro-well.

The present invention also provides a device for arraying biomolecules, including cells, comprising a support; a first layer configured to be placed in fluid-tight contact with the support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; a second layer configured to be placed in fluid-tight contact with the upper surface of the first layer, the second layer defining a pattern of macro-orifices, each macro-orifice of the pattern of macro-orifices having walls and defining a macro-region when the first layer is placed in fluid-tight contact with the support and the second layer is placed in fluid-tight contact with the first layer such that the walls of the macro-orifice and the macro-region together define a macro-well; wherein the first layer and the second layer are configured for an arraying of biomolecules and/or cells on the support through the pattern of micro-orifices and the pattern of macro-orifices.

Preferably the first layer is configured to be placed in conformal contact with the support when the first layer is placed against the support and the second layer is configured to be placed in conformal contact with the support when the second layer is placed against the support. The support is made of a material selected from the group consisting of glass, silicon, fused silica, metal films, polystyrene, poly(methylacrylate) and polycarbonate. The first layer and the second layer are made of a material selected from the group consisting of glass, elastomers, rigid plastics, metals, silicon and silicon dioxide. The first layer and second layer is preferably made of an elastomer, and more preferably PDMS.

In the device preferably each macro-region encompasses at least one micro-region and more preferably each macro-region encompasses a plurality of micro-regions.

In the device, the walls of each macro-well may define a curve in a cross-sectional plane perpendicular to the upper surface of the first layer.

Preferably, the device has at least one of the pattern of micro-orifices and the pattern of macro-orifices spatially and dimensionally corresponds to a standard microtiter plate. Further, the at least one of the pattern of micro-orifices and the pattern of macro-orifices spatially and dimensionally corresponds to a standard microtiter plate selected from a group consisting of a 6-well microtiter plate, a 12-well microtiter plate, a 24-well microtiter plate, a 96-well microtiter plate, a 384-well microtiter plate, a 1,536-well microtiter plate, and a 9,600-well microtiter plate.

In one embodiment, the device further comprises at least one cap for enclosing at least one of the macro-wells. Preferably the devices comprises a plurality of caps for enclosing each of the macro-wells.

The device may also comprise a means for aligning the micro-orifices with the macro-orifices. The means for aligning includes a guide mechanism on at least one of the support, the first layer and the second layer. The guide mechanism includes protrusions extending from the support, and guide orifices defined in the first layer and in the second layer for receiving the protrusions therein thereby aligning respective ones of the first layer and the second layer on the support. The means for aligning includes markings on at least one of the support, the first layer and the second layer.

The support has an upper surface that may have a coating thereon. The coating comprises a material selected from the group consisting of proteins, protein fragments, peptides, small molecules, lipid bilayers, metals and self-assembled monolayers.

The present invention further provides a device for arraying biomolecules and/or cells comprising a support; a first layer configured to be placed in fluid-tight contact with the support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; a second layer configured to be placed in fluid-tight contact with the support, the second layer defining a pattern of macro-orifices, each macro-orifice of the pattern of macro-orifices having walls and defining a macro-region when the second layer is placed in fluid-tight contact with the support such that the walls of the macro-orifice and the macro-region together define a macro-well; wherein the first layer and the second layer are configured for an arraying of biomolecules and/or cells on the support through the pattern of micro-orifices and the pattern of macro-orifices.

The present invention also provides a device for arraying biomolecules and/or cells comprising a support; a first layer configured to be placed in fluid-tight contact with the support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; a second layer configured to be placed in fluid-tight contact with the support, the second layer comprising a plurality of rings, the rings defining a pattern of respective macro-orifices, each ring having walls and defining a macro-region when the second layer is placed in fluid-tight contact with the support such that the walls of the ring and the macro-region together define a macro-well; wherein the first layer and the second layer are configured for an arraying of biomolecules and/or cells on the support through the pattern of micro-orifices and the pattern of macro-orifices.

In another embodiment, a device for arraying biomolecules and/or cells comprises a support; a layer configured to be placed in fluid-tight contact with the support, the layer defining a pattern of macro-orifices, each macro-orifice of the pattern of macro-orifices having walls and defining a macro-region when the layer is placed in fluid-tight contact with the support such that the walls of the macro-orifice and the macro-region together define a macro-well; a set of plugs, each of the plugs being configured for being received in a respective macro-well, each of the plugs comprising a lower membrane adapted to be placed in fluid-tight contact with the support when the layer is placed in fluid-tight contact with the support and the plug is received in a corresponding macro-well defined by the layer and the support, the lower membrane further defining a pattern of micro-orifices, wherein each micro-orifice has walls and defines a micro-region on the support when the plug is in fluid-tight contact with the support such that the walls of the micro-orifice and the micro-region together define a micro-well; wherein the first layer and the second layer are configured for an arraying of biomolecules and/or cells on the support through the pattern of micro-orifices and the pattern of macro-orifices.

The present invention further provides a method for arraying biomolecules and/or cells comprising the steps of positioning a first layer to be in fluid-tight contact with a support, the first layer having an upper surface and defining a pattern of micro-orifices, each micro-orifice of the pattern of micro-orifices having walls and defining a macro-region on the support when the first layer is placed in fluid-tight contact with the support such that the walls of said each micro-orifice and the micro-region on the support together define a micro-well; positioning a second layer to be in fluid-tight contact with an upper surface of the first layer, the second layer defining a pattern of macro-orifices, each macro-orifice of the pattern of macro-orifices having walls and defining a macro-region when the first layer is placed in fluid-tight contact with the support and the second layer is placed in fluid-tight contact with the first layer such that the walls of the macro-orifice and the macro-region together define a macro-well; and immobilizing at least one biomolecule and/or cell of a plurality of biomolecules and/or cells in each respective micro-region on the support so as to situate the at least one biomolecule and/or cell within a corresponding micro-well, the biomolecules and/or cells thereby being arrayed on the support in a pattern that corresponds to the pattern of the micro-orifices.

In another embodiment, a coating is applied to an upper surface of the support. The coating may be cells, proteins, protein fragments, peptides, small molecules, lipid bilayers, metals and self-assembled monolayers.

The present invention further provides a method for arraying biomolecules and/or cells comprising: positioning a first layer to be in fluid-tight contact with a support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; immobilizing at least one biomolecule and/or cell of a plurality of biomolecules and/or cells in each respective micro-region on the support so as to situate the at least one biomolecule and/or cell within a corresponding micro-well, the biomolecules and/or cells thereby being arrayed on the support in a pattern that corresponds to the pattern of the micro-orifices; removing the first layer from the support after the step of immobilizing; and positioning a second layer to be in fluid-tight contact with the support, the second layer defining a pattern of macro-orifices, each macro-orifice of the pattern of macro-orifices having walls and defining a macro-region when the second layer is placed in fluid-tight contact with the support such that the walls of the macro-orifice and the macro-region together define a macro-well.

In an alternate embodiment, the method comprises positioning a first layer to be in fluid-tight contact with a support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; positioning a second layer to be in fluid-tight contact with the support, the second layer comprising a plurality of rings, the rings defining a pattern of respective macro-orifices, each ring having walls and defining a macro-region when the second layer is placed in fluid-tight contact with the support such that the walls of the ring and the macro-region together define a macro-well; and immobilizing at least one biomolecule and/or cell of a plurality of biomolecules and/or cells in each respective micro-region on the support so as to situate the at least one biomolecule and/or cell within a corresponding micro-well, the biomolecules and/or cells thereby being arrayed on the support in a pattern that corresponds to the pattern of the micro-orifices.

In yet another embodiment, a method of arraying biomolecules and/or cells comprises positioning a layer to be in fluid-tight contact with the support, the layer defining a pattern of macro-orifices, each macro-orifice of the pattern of macro-orifices having walls and defining a macro-region when the layer is placed in fluid-tight contact with the support such that the walls of the macro-orifice and the macro-region together define a macro-well; inserting each plug of a set of plugs in a respective macro-well, each of the plugs comprising a lower membrane placed in fluid-tight contact with the support when the layer is placed in fluid-tight contact with the support and the plug is received in a corresponding macro-well defined by the layer and the support, the lower membrane further defining a pattern of micro-orifices, wherein each micro-orifice has walls and defines a micro-region on the support when the plug is in fluid-tight contact with the support such that the walls of the micro-orifice and the micro-region together define a micro-well; and immobilizing a biomolecule and/or cell in at least one micro-region on the support so as to be situated within the micro-well, such that the biomolecule and/or cell is arrayed on the support in a pattern that corresponds to the first pattern of micro-orifices.

The present invention further provides a method of fabricating a device comprising: providing a support; providing a first layer configured to be placed in fluid-tight contact with the support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; and providing a second layer configured to be placed in fluid-tight contact with the upper surface of the first layer, the second layer defining a pattern of macro-orifices, each macro-orifice of the pattern of macro-orifices having walls and defining a macro-region when the first layer is placed in fluid-tight contact with the support and the second layer is placed in fluid-tight contact with the first layer such that the walls of the macro-orifice and the macro-region together define a macro-well.

In one embodiment, the method comprises: providing a mold; applying an elastomeric material in liquid form to a mold having a pattern of micro-posts corresponding to the pattern of micro-orifices; curing the elastomeric material; and removing the cured elastomeric material from the mold. The application includes spin-coating the elastomeric material. In an alternate embodiment, an adhesive adapted to be applied between the first layer and the second layer when the second layer is placed against the first layer is provided.

In yet another embodiment, a method of fabricating a device comprises: providing a first precursor layer (preferably an elastomer and more preferably PDMS); curing the first precursor layer to form a first layer, the first layer having an upper surface and defining a pattern of micro-orifices, each micro-orifice of the pattern of micro-orifices having walls and defining a micro-region in a plane defined by a lower surface of the first layer; placing a mold having a pattern of macro-posts on an upper surface of the first layer; providing a second precursor layer on the upper surface of the first layer; curing the second precursor layer to form a second layer, the second layer defining a pattern of macro-orifices, each macro-orifice of the pattern of macro-orifices having walls and defining a macro-region in a plane defined by a lower surface of the second layer.

Another embodiment further comprises placing the first layer against a support for establishing a fluid-tight contact of the first layer with the support, each micro-orifice of the pattern of micro-orifices having walls and defining the micro-region on the support when the first layer is placed in fluid-tight contact with the support such that the walls of said each micro-orifice and the micro-region on the support together define a micro-well, and each macro-orifice of the pattern of macro-orifices having walls and defining the macro-region such that the walls of said each macro-orifice and the macro-region together define a macro-well.

In yet another embodiment wherein providing a second precursor layer comprises providing the second precursor layer on the mold having the pattern of macro-posts such that a macro-orifice created by each macro-post encompasses at least one or more preferably a plurality of micro-regions.

In another embodiment, there is provided a method of fabricating a device, comprising: providing a first mold having a pattern of micro-posts; providing a second mold having a pattern of macro-posts; placing the second mold on the first mold; applying an elastomeric precursor in liquid form to the first mold and to the second mold after the step of placing so as to fill spaces around the micro-posts and the macro-posts with the elastomeric precursor; curing the elastomeric precursor after the step of applying for providing an elastomeric element; separating the elastomeric element from the first mold and from the second mold, wherein the pattern of micro-posts and the pattern of macro-posts are configured such that the micro-posts form a pattern of micro-orifices in the elastomeric element, and the macro-posts define a pattern of macro-orifices in the elastomeric element.

The present invention also provides for assays measuring cell movement. One embodiment, comprises: positioning a first layer to be in fluid-tight contact with a support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; positioning a second layer to be in fluid-tight contact with an upper surface of the first layer, the second layer defining a pattern of macro-orifices, each macro-orifice of the pattern of macro-orifices having walls and defining a macro-region when the first layer is placed in fluid-tight contact with the support and the second layer is placed in fluid-tight contact with the first layer such that the walls of the macro-orifice and the macro-region together define a macro-well; each macro-region encompassing at least one micro-region; immobilizing at least one cell of a plurality of cells in each respective micro-region on the support so as to situate the at least one cell within a corresponding micro-well, the cells thereby being arrayed on the support in a pattern that corresponds to the pattern of the micro-orifices; allowing the cells to grow to confluency within the micro-regions; providing at least one of a plurality of test agents to at least one macro-well and allowing said test agent to contact confluent cells; removing said first and second layer; monitoring cells for movement or lack of movement away from said micro-regions; and correlating cellular movement or lack of movement away from said micro-regions with effect of said test agent on cellular movement.

Preferably each macro-region encompasses a plurality of micro-regions. A plurality of test agents can be provided into each macro-well.

The present invention also contemplates applying coating to an upper surface of the support before positioning said first layer. The coating is made of a material selected from the group consisting of proteins, protein fragments, peptides, small molecules, lipid bilayers, metals, self-assembled monolayers, cells, extracellular matrix proteins, hydrogels, and matrigel.

In yet another embodiment, an assay comprises positioning a first layer to be in fluid-tight contact with a support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; immobilizing at least one cell of a plurality of cells in each respective micro-region on the support so as to situate the at least one cell within a corresponding micro-well, the cells thereby being arrayed on the support in a pattern that corresponds to the pattern of the micro-orifices; allowing the cells to grow to confluency within the micro-regions; removing the first layer from the support after the step of immobilizing; positioning a second layer to be in fluid-tight contact with the support, the second layer defining a pattern of macro-orifices, each macro-orifice of the pattern of macro-orifices having walls and defining a macro-region when the second layer is placed in fluid-tight contact with the support such that the walls of the macro-orifice and the macro-region together define a macro-well; each macro-region encompassing at least one micro-region; providing at least one of a plurality of test agents to at least one macro-well and allowing said test agent to contact confluent cells; removing said second layer; monitoring cells for movement or lack of movement away from said micro-regions; correlating cellular movement or lack of movement away from said micro-regions with effect of said test agent on cellular movement.

Another embodiment comprises the steps of: positioning a first layer to be in fluid-tight contact with a support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; positioning a second layer to be in fluid-tight contact with the support, the second layer comprising a plurality of rings, the rings defining a pattern of respective macro-orifices, each ring having walls and defining a macro-region when the second layer is placed in fluid-tight contact with the support such that the walls of the ring and the macro-region together define a macro-well; each macro-region encompassing at least one micro-region; immobilizing at least one cell of a plurality of cells in each respective micro-region on the support so as to situate the at least one cell within a corresponding micro-well, the cells thereby being arrayed on the support in a pattern that corresponds to the pattern of the micro-orifices, allowing the cells to grow to confluency within the micro-regions; providing at least one of a plurality of test agents to at least one macro-well and allowing said test agent to contact confluent cells; removing said first and second layer; monitoring cells for movement or lack of movement away from said micro-regions; and correlating cellular movement or lack of movement away from said micro-regions with effect of said test agent on cellular movement.

In an alternate embodiment, an assay for monitoring cell movement comprises the steps of: positioning a layer to be in fluid-tight contact with the support, the layer defining a pattern of macro-orifices, each macro-orifice of the pattern of macro-orifices having walls and defining a macro-region when the layer is placed in fluid-tight contact with the support such that the walls of the macro-orifice and the macro-region together define a macro-well; inserting each plug of a set of plugs in a respective macro-well, each of the plugs comprising a lower membrane placed in fluid-tight contact with the support when the layer is placed in fluid-tight contact with the support and the plug is received in a corresponding macro-well defined by the layer and the support, the lower membrane further defining a pattern of micro-orifices, wherein each micro-orifice has walls and defines a micro-region on the support when the plug is in fluid-tight contact with the support such that the walls of the micro-orifice and the micro-region together define a micro-well; immobilizing a cell in at least one micro-region on the support so as to be situated within the micro-well, such that the cell is arrayed on the support in a pattern that corresponds to the first pattern of micro-orifices; allowing the cells to grow to confluency within the micro-regions; providing at least one of a plurality of test agents to at least one macro-well and allowing said test agent to contact confluent cells; removing said layer containing said plugs; monitoring cells for movement or lack of movement away from said micro-regions; and correlating cellular movement or lack of movement away from said micro-regions with effect of said test agent on cellular movement.

The present invention also provides for a system for monitoring cell movement comprising: a) a device for arraying cells comprising a support; a first layer configured to be placed in fluid-tight contact with the support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well; a second layer configured to be placed in fluid-tight contact with the upper surface of the first layer, the second layer defining a pattern of macro-orifices, each macro-orifice of the pattern of macro-orifices having walls and defining a macro-region when the first layer is placed in fluid-tight contact with the support and the second layer is placed in fluid-tight contact with the first layer such that the walls of the macro-orifice and the macro-region together define a macro-well; wherein the first layer and the second layer are configured for an arraying of cells on the support through the pattern of micro-orifices and the pattern of macro-orifices; allowing the cells to grow to confluency within the micro-regions; providing at least one of a plurality of test agents to at least one macro-well and allowing said test agent to contact confluent cells; removing said first and second layer; monitoring cells for movement or lack of movement away from said micro-regions; and correlating cellular movement or lack of movement away from said micro-regions with effect of said test agent on cellular movement; b) an observation system configured to observe movement or lack of movement of arrayed cells; and c) a controller configured to coordinate cellular movement of the device for arraying cells into said observation system.

The observation system preferably comprises a phase contrast microscope or a fluorescent image microscope. The controller further comprises a computer interface configured to coordinate the movement of the device into the observation system. The observation system further comprises a recording device configured to record images of the cells arrayed on the device for arraying cells. The recording device preferably comprises a digital camera configured to record images of the cells arrayed on the device for arraying cells, and wherein the recorded images are in a digital output. The computer interface is preferably configured to receive said digital output.

The present invention also provides for methods for monitoring and imaging cell growth. These methods involve positioning a first layer to be in fluid-tight contact with a support, the first layer having an upper surface and defining a pattern of micro-orifices, each micro-orifice of the pattern of micro-orifices having walls and defining a micro-region on the support when the first layer is placed in fluid-tight contact with the support such that the walls of said each micro-orifice and the micro-region on the support together define a micro-well. Further, a second layer is positioned to be in fluid-tight contact with an upper surface of the first layer, the second layer defining a pattern of macro-orifices, each macro-orifice of the pattern of macro-orifices having walls and defining a macro-region when the first layer is placed in fluid-tight contact with the support and the second layer is placed in fluid-tight contact with the first layer such that the walls of the macro-orifice and the macro-region together define a macro-well; each macro-region encompassing at least one micro-region.

At least one cell of a plurality of cells is immobilized in each respective micro-region on the support so as to situate the at least one cell within a corresponding micro-well, the cells thereby being arrayed on the support in a pattern that corresponds to the pattern of the micro-orifices.

The cells are allowed to grow to confluency within the micro-regions. At least one of a plurality of test agents is provided to at least one macro-well. The test agent is allowed to contact confluent cells. Thereafter the first and second layer is removed. The cells are then monitored for movement away from the micro-regions. The monitoring involves imaging the cells for at least two different time points to generate an image for each of the at least two different time points to generate at least two images, and calculating cellular movement from a comparison of the at least two images.

In yet other embodiments, cell growth and cell multiplication or proliferation is monitored and determined by a comparison of the at least two images.

Another embodiment of the present invention provides an image processing method comprising, from captured image data: a) creating a first histogram of image data signal strength along a first axis of the image data; b) identifying first coarse island locations from the first histogram; c) marking interstitial boundaries on the first axis between the first coarse island locations; d) creating a second histogram of image data signal strength along a second axis of the image data; e) identifying second coarse island locations from the second histogram; and f) marking second interstitial boundaries on the second axis between the second coarse island locations.

In another embodiment, the first and second coarse island locations are determined from maxima of the first and second histograms respectively. Alternatively, the first and second coarse island locations are determined from portions of the first and second histograms respectively that exceed a predetermined threshold value.

In another embodiment, the first and second interstitial boundaries are marked at midpoints between the first and second coarse island locations respectively. Another embodiment involves defining a plurality of island bounding boxes based on the first and second interstitial boundaries.

Another embodiment of an imaging processing method of the present invention comprises, from source image data representing imaged cellular material: for each pixel in a portion of the source image data; determining whether the source image data indicates the presence of cellular material in a region of a scanning circle; and if so, setting image data for a co-located, similarly dimensioned scanning circle in second image data; and thereafter, identifying objects based on the second image data. Further, a bounding box for each object identified in the image data may be defined.

The present invention also provides a device for monitoring leukocyte migration including a housing defining a plurality of chambers therein. Each of the plurality of chambers includes a first well region including at least one first well; a second well region including at least one second well; and a channel region including at least one channel connecting the first well region and the second well region with one another. The at least one channel includes at least one leukocyte migration mediator disposed therein. At least one of the plurality of chambers on the one hand, and the first well regions and the second well regions of respective ones of the plurality of chambers on the other hand, are disposed relative to one another to match a pitch of a standard microtiter plate.

The present invention also provides a device for monitoring leukocyte migration including a housing defining a plurality of chambers therein. Each of the plurality of chambers includes: a first well region including at least one first well; a second well region including at least one second well; and a channel region including at least one channel connecting the first well region and the second well region with one another. The at least one channel includes endothelial cells disposed therein. At least one of the plurality of chambers on the one hand, and the first well regions and the second well regions of respective ones of the plurality of chambers on the other hand, are disposed relative to one another to match a pitch of a standard microtiter plate.

The present invention furthermore provides a device for monitoring leukocyte migration including a housing comprising: a support member; and a top member, the top member mounted to the support member by being placed in conformal contact with the support member, wherein the support member and the top member are configured such that they together define at least one chamber. The at least one chamber includes a first well region including at least one first well; a second well region including at least one second well; and a channel region including at least one channel connecting the first well region and the second well region with one another. The at least one channel includes at least one leukocyte migration mediator disposed therein or endothelial cells disposed therein.

The present invention further provides a kit for monitoring leukocyte migration. The kit comprises a device including a housing defining a plurality of chambers therein. Each of the plurality of chambers includes a first well region including at least one first well; a second well region including at least one second well; and a channel region including at least one channel connecting the first well region and the second well region with one another. At least one of the plurality of chambers on the one hand, and the first well regions and the second well regions of the respective ones of the plurality of chambers on the other hand, are disposed relative to one another to match a pitch of a standard microtiter plate. The kit also comprises a first leukocyte migration mediator.

The present invention additionally provides a device for monitoring leukocyte migration comprising a housing and means associated with the housing defining a plurality of chambers in the housing. Each of the plurality of chambers includes an inlet means for receiving a sample comprising leukocytes; an outlet means in flow communication with the inlet means for receiving the sample comprising leukocytes from the inlet means; and connection means connecting the inlet means and the outlet means to one another. The connection means includes at least one leukocyte migration mediator disposed therein or endothelial cells disposed therein. At least one of the plurality of chambers on the one hand, and the inlet means and the outlet means on the other hand, are disposed relative to one another to match a pitch of a standard microtiter plate.

The invention further provides a method of monitoring leukocyte migration. The method comprises providing a device including a housing defining a plurality of chambers therein, each of the plurality of chambers including: a first well region including at least one first well; a second well region including at least one second well; and a channel region including at least one channel connecting the first well region and the second well region with one another. At least one of the plurality of chambers on the one hand, and the first well regions and the second well regions of the respective ones of the plurality of chambers on the other hand, are disposed relative to one another to match a pitch of a standard microtiter plate. The method further comprises placing at least one leukocyte migration mediator in the at least one channel or placing endothelial cells in the at least one channel and providing a sample comprising leukocytes in the at least one channel. In one embodiment, the method additionally includes placing at least one test agent in the at least one channel. The method further includes observing the interaction between the leukocytes and the at least one leukocyte migration mediator or the endothelial cells. In the embodiment wherein a test agent is placed in the at least one channel, the method includes observing the interaction between the leukocytes and the at least one leukocyte migration mediator or the endothelial cells in the presence of the test agent.

The present invention furthermore provides a method of screening a plurality of test agents comprising: providing a device comprising a housing defining a plurality of chambers therein, each of the chambers including: a first well region including at least one first well; a second well region including at least one second well; and a channel region including at least one channel connecting the first well region and the second well region with one another. Preferably, each of the plurality of test agents are different from one another. The at least one channel includes at least one leukocyte migration mediator disposed therein or endothelial cells disposed therein. At least one of the plurality of chambers on the one hand, and the first well regions and the second well regions of respective ones of the plurality of chambers on the other hand, are disposed relative to one another to match a pitch of a standard microtiter plate. The method further includes providing leukocytes in each of the channels of the respective ones of the plurality of chambers; placing at least one of the plurality of test agents in each of the channels of respective ones of the plurality of chambers; and observing the interaction between the leukocytes and the at least one leukocyte migration mediator or endothelial cells in the presence of the test agent.

The present invention additionally provides a method of simulating physiological conditions of a blood vessel in vivo. The method comprises providing a device comprising a chamber, the chamber including: a first well region including at least one first well; a second well region including at least one second well; and a channel region including at least one channel connecting the first well region and the second well region with one another. The method further comprises placing a first leukocyte migration mediator capable of mediating rolling of a leukocyte in the at least one channel; placing a second leukocyte migration mediator capable of mediating arrest of a leukocyte in the at least one channel; providing a suspension comprising leukocytes in about 10 microliters to about 100 microliters of fluid in the at least one channel; and allowing the suspension comprising leukocytes to flow along the at least one channel.

The present invention also provides biological assays performed using microfluidic devices to establish dynamic gradients that may be used in conjunction with static gradients of immobilized biomolecules.

The present invention further provides a device for monitoring chemotaxis or chemoinvasion including a housing comprising a support member and a top member, the top member mounted to the support member by being placed in substantially fluid-tight conformal contact with the support member, wherein the support member and the top member are configured such that they together define a discrete chamber. The discrete chamber including a first well region including at least one first well, the first well region configured to receive a test agent therein; a second well region including at least one second well, the second well region further being horizontally offset with respect to the first well region in a test orientation of the device, the second well region configured to receive a cell sample therein; and a channel region including at least one channel connecting the first well region and the second well region with one another.

The present invention further provides a device for monitoring chemotaxis or chemoinvasion including a housing comprising: a support member and a top member. The top member is mounted to the support member by being placed in substantially fluid-tight, conformal contact with the support member, wherein the support member and the top member are configured such that they together define a discrete chamber adapted to allow a monitoring of chemotaxis or chemoinvasion therein. The discrete chamber has an opening facing vertically upward in a test orientation of the device. The discrete chamber includes: a first well region including at least one first well, the at least one first well configured to receive a test agent therein; a second well region including at least one second well, the second well region further being horizontally offset with respect to the first well region in a test orientation of the device, the at least one second well configured to receive a sample comprising cells therein; and a channel region including at least one channel connecting the first well region and the second well region with one another.

The present invention furthermore provides a device for monitoring chemotaxis or chemoinvasion comprising: a support means and means mounted to the support means for defining a discrete chamber with the support means by being placed in substantially fluid-tight, conformal contact with the support means. The discrete chamber is adapted to allow a monitoring of chemotaxis or chemoinvasion therein. The discrete chamber includes a first well region including at least one first well, the at least one first well configured to receive a test agent therein; a second well region including at least one second well, the second well region further being horizontally offset with respect to the first well region in a test orientation of the device, the at least one second well configured to receive a sample comprising cells therein; and a channel region including at least one channel connecting the first well region and the second well region with one another.

The present invention also provides a device for monitoring chemotaxis or chemoinvasion comprising: a support member and a top member. The top member is mounted to the support member by forming a substantially instantaneous seal with the support member, wherein the support member and the top member are configured such that they together define a discrete chamber. The discrete chamber is adapted to allow for a monitoring of chemotaxis or chemoinvasion therein. The discrete chamber includes a first well region including at least one first well, the at least one first well configured to receive a test agent therein; a second well region including at least one second well, the second well region further being horizontally offset with respect to the first well region in a test orientation of the device, the at least one second well configured to receive a sample comprising cells therein; and a channel region including at least one channel connecting the first well region and the second well region with one another.

The present invention moreover provides a device for monitoring chemotaxis or chemoinvasion including a housing defining a chamber adapted to allow for a monitoring of chemotaxis or chemoinvasion therein. The chamber comprises: a first well region including at least one first well, the at least one first well configured to receive a test agent therein; a second well region including at least one second well, the second well region further being horizontally offset with respect to the first well region in a test orientation of the device, the at least one second well configured to receive a sample comprising cells therein; and a channel region including a plurality of channels connecting the first well region and the second well region with one another.

The present invention provides for the optional inclusion of a gel matrix in the channel(s) of the above-mentioned embodiments.

The present invention provides a test device including a housing comprising: a support member; a top member mounted to the support member by being placed in substantially fluid-tight, conformal contact with the support member, wherein the support member and the top member are configured such that they together define a discrete chamber. The discrete chamber includes a first well region including at least one first well; a second well region including at least one second well, the second well region further being horizontally offset with respect to the first well region in a test orientation of the device; and a channel region including at least one channel connecting the first well region and the second well region with one another.

The present invention further provides a kit for forming the housing of a test device. The kit comprises: a support member; a top member adapted to be mounted to the support member by being placed in substantially fluid-tight, conformal contact with the support member, wherein the support member and the top member are configured such that they together define a discrete chamber when the top member is mounted to the support member. The discrete chamber includes: a first well region including at least one first well; a second well region including at least one second well, the second well region further being horizontally offset with respect to the first well region in a test orientation of the device; and a channel region including at least one channel connecting the first well region and the second well region with one another.

The present invention additionally provides a top member adapted to be mounted to a support member for forming the housing of a test device by being placed in substantially fluid-tight, conformal contact with the support member, wherein the top member is configured such that it defines a discrete chamber with the support member when the top member is mounted to the support member. The discrete chamber includes a first well region including at least one first well; a second well region including at least one second well, the second well region further being horizontally offset with respect to the first well region in a test orientation of the device; and a channel region including at least one channel connecting the first well region and the second well region with one another.

The present invention also provides a test device including a housing comprising: a support member; and a top member mounted to the support member by being placed in substantially fluid tight, conformal contact with the support member, wherein the support member and the top member are configured such that they together define a discrete chamber, the discrete chamber having an opening facing upwardly in a test orientation of the device.

The present invention additionally provides a test device comprising: a support member and top member wherein the top member is mounted to the support member by forming a substantially instantaneous seal with the support member. The support member and the top member are configured such that they together define a discrete chamber. The discrete chamber includes a first well region including at least one first well; a second well region including at least one second well, the second well region further being horizontally offset with respect to the first well region in a test orientation of the device; and a channel region including at least one channel connecting the first well region and the second well region with one another.

The present invention furthermore provides a test device including a housing defining a chamber. The chamber comprises a first well region including at least one first well; a second well region including at least one second well, the second well region further being horizontally offset with respect to the first well region in a test orientation of the device; and a channel region including at a plurality of channels connecting the first well region and the second well region with one another.

The present invention furthermore provides a test device comprising: support means; means mounted to the support means for defining a discrete chamber with the support means by being placed in substantially fluid-tight, conformal contact with the support means. The discrete chamber includes a first well region including at least one first well; a second well region including at least one second well, the second well region further being horizontally offset with respect to the first well region in a test orientation of the device; and a channel region including at least one channel connecting the first well region and the second well region with one another.

The present invention additionally provides a method of providing a test device comprising: providing a support member; providing a top member; mounting the top member to the support member, wherein providing a top member comprises selecting a predetermined material for the top member such that the top member is mounted to the support member by being placed against the support member for forming a substantially fluid-tight, conformal contact with the support member; and configuring the top member and the support member such that they together define a discrete chamber when the top member is mounted to the support member. The discrete chamber includes: a first well region including at least one first well; a second well region including at least one second well, the second well region further being horizontally offset with respect to the first well region in a test orientation of the device; and a channel region including at least one channel connecting the first well region and the second well region with one another.

The present invention further provides a method of making a top member of a test device comprising the steps of: selecting a predetermined material for the top member such that the top member is adapted to be mounted to a support member by being placed against the support member for forming a substantially fluid-tight, conformal contact with the support member; and configuring the top member such that it defines a discrete chamber with the support member when it is mounted to the support member. The discrete chamber includes: a first well region including at least one first well; a second well region including at least one second well, the second well region further being horizontally offset with respect to the first well region in a test orientation of the device; and a channel region including at least one channel connecting the first well region and the second well region with one another.

The present invention moreover provides a method of making a test device comprising: providing a support member; providing a top member; mounting the top member to the support member by placing the top member in substantially fluid tight, conformal contact with the support member, wherein the support member and the top member are configured such that they together define a discrete chamber, the discrete chamber having an opening facing vertically upward in a test orientation of the device.

The present invention provides an image processing method for use in analyzing image data of a cellular migration assay. The method includes defining a major axis within the image data that is perpendicular to an orientation of channels in the image data, determining an aggregate light intensity within the image data along the major axis, and identifying locations of channels within the image data from the projection.

The present invention provide a method of monitoring haptotaxis. The method includes providing a device for monitoring haptotaxis having a housing defining a chamber. The chamber includes a first well region including at least one first well, the first well region configured to receive a test agent therein and further including biomolecules immobilized therein; a second well region including at least one second well, the second well region configured to receive a sample comprising cells therein and further being horizontally offset with respect to the first well region in a test orientation of the device; and a channel region with biomolecules immobilized therein and including at least one channel connecting the first well region and the second well region with one another.

The method further includes forming a surface concentration gradient along a longitudinal axis of the chamber by decreasing the concentration of biomolecules from the at least one first well to the at least one second well. The method additionally includes placing a first sample comprising cells in the at least one second well. The method also includes monitoring haptotaxis of the cells.

The present invention provides a method of monitoring chemotaxis and chemoinvasion comprising: providing a device for monitoring chemotaxis, the device having a support member; a top member mounted to the support member by being placed in substantially fluid-tight, conformal contact with the support member, wherein the support member and the top member are configured such that they together define a discrete assay chamber. The discrete chamber includes: a first well region including at least one first well, each of the at least one first well being adapted to receive a soluble test substance therein; a second well region including at least one second well horizontally offset with respect to the first well region in a test orientation of the device, the at least one second well being adapted to receive a sample comprising cells therein; and a channel region including a plurality of channels connecting the first well region and the second well region with one another. The method further comprises: placing the soluble test substance in the at least one first well; forming a solution concentration gradient along a longitudinal axis of the chamber; placing a sample comprising cells in the at least one second well; and monitoring chemotaxis of the cells.

The present invention provides a device for monitoring haptotaxis including a housing comprising: a support member and a top member, the top member mounted to the support member wherein the support member and the top member are configured such that they together define a discrete chamber. The discrete chamber includes a first well region including at least one first well, the first well configured to receive a test agent therein and further including biomolecules immobilized therein; a second well region including at least one second well, the second well region configured to receive a sample comprising cells therein and further being horizontally offset with respect to the first well region in a test orientation of the device; and a channel region including at least one channel connecting the first well region and the second well region with one another, the channel region further including biomolecules immobilized therein.

The present invention moreover provides a device for monitoring haptotaxis including a housing defining a discrete chamber. The chamber has an opening facing vertically upward in a test orientation of the device. The chamber further comprises: a first well region including at least one first well, the at least one first well configured to receive a test agent therein and further including biomolecules immobilized therein; a second well region including at least one second well, the second well region further being horizontally offset with respect to the first well region in a test orientation of the device, the at least one second well configured to receive a sample comprising cells therein; and a channel region including at least one channel connecting the first well region and the second well region with one another, the at least one channel further including biomolecules immobilized therein.

The present invention additionally provides a device for monitoring haptotaxis. The device comprises support means; means mounted to the support means for defining a discrete chamber with the support means. The discrete chamber includes a first well region including at least one first well, the at least one first well configured to receive a test agent therein and further including biomolecules immobilized therein; a second well region including at least one second well, the second well region further being horizontally offset with respect to the first well region in a test orientation of the device, the at least one second well configured to receive a sample comprising cells; and a channel region including at least one channel connecting the first well region and the second well region with one another, the at least one channel further including biomolecules immobilized therein.

The present invention also provides a device for monitoring haptotaxis comprising a support member and a top member mounted to the support member by forming a substantially instantaneous seal with the support member. The support member and the top member are configured such that they together define a discrete chamber. The discrete chamber includes: a first well region including at least one first well, the at least one first well configured to receive a test agent therein and further including biomolecules immobilized therein; a second well region including at least one second well, the second well region configured to receive a sample comprising cells therein and further being horizontally offset with respect to the first well region in a test orientation of the device; and a channel region including at least one channel connecting the first well region and the second well region with one another, the channel region further including biomolecules immobilized therein.

The present invention furthermore provides a device for monitoring haptotaxis including a housing defining a chamber. The chamber comprises: a first well region including at least one first well, the first well configured to receive a test agent therein and further including biomolecules immobilized therein; a second well region including at least one second well, the second well region configured to receive a sample comprising cells therein and further being horizontally offset with respect to the first well region in a test orientation of the device; and a channel region including at a least one channel connecting the first well region and the second well region with one another, the channel region further including biomolecules immobilized therein.

The present invention also provides a kit for monitoring haptotaxis comprising: a device including a housing defining a chamber. The chamber comprises: a first well region including at least one first well, the first well configured to receive a test agent therein; a second well region including at least one second well, the second well region configured to receive a sample comprising cells therein and further being horizontally offset with respect to the first well region in a test orientation of the device; and a channel region including at a least one channel connecting the first well region and the second well region with one another. The kit further comprises a sample comprising biomolecules.

One aspect of the present invention relates to methods for correlating a pharmacological therapy with a primary cell profile of a subject patient. One embodiment of this aspect of the invention relating to the assaying of cellular phenotypes and dynamics comprising monitoring a patient's primary cells' morphology, molecular marker expression pattern, state of selective activation, their rolling and adhesive properties, ability to transmigrate and their chemotactic properties (alone or in combination). In one embodiment, a primary cellular profile is created from at least one “normal” or “healthy” patient for a certain phenotype. Then—a suspected “diseased” patient primary cellular profile may be compared against the “healthy” profile.

The cellular phenotypes and dynamics may be studied for any type of cell. In one embodiment, the primary cells are utilized. In another embodiment primary leukocytes are used. In yet another embodiment, the method utilizes monocytes.

The devices of the present invention, allow the use of smaller number of cells than allowed by prior art devices. Thus, in one embodiment, for example, the method uses between about 25,000 and about 50,000 monocytes per assaying unit.

Another aspect of the invention relates to testing the biological activity of test compounds by assaying their ability to perturb a primary cell profile. In one embodiment of this aspect of the invention the primary cell profile comprises information with respect to primary cells' morphology, molecular marker expression pattern, state of selective activation, their rolling and adhesive properties, ability to transmigrate and their chemotactic properties. In another embodiment of this aspect of the invention, the cells are leukocytes. In another embodiment, the candidate drugs are anti-inflammatory drugs.

One embodiment of this aspect of the invention relates to methods for creating cellular microenvironments for complex primary cell cultures. In one embodiment, neuronal cells are grown in a predetermined array on a substrate based on patterned surface chemistry. In a further embodiment, endothelial cells are cultured such that they form a lumen.

### BRIEF DESCRIPTION OF THE DRAWINGS

The present invention is illustrated, by way of example and not limitation, in the figures in the accompanying drawings, in which like references indicate similar elements.

FIG. 1(a) is a perspective view of a qualitative cell migration system, in accordance with an example embodiment of the present invention.

FIG. 1(b) is a cross-sectional view of the qualitative cell migration assay plate shown in FIG. 1(a), taken along the lines II-II.

FIG. 2(a) is a perspective view of a qualitative cell migration system, in accordance with an example embodiment of the present invention.

FIG. 2(b) is a cross-sectional view of the qualitative cell migration assay plate shown in FIG. 2(a), taken along the lines IV-IV.

FIG. 3(a) is a top view of a support for a qualitative cell migration system, in accordance with one embodiment of the present invention.

FIG. 3(b) is a side view of the support shown in FIG. 3(a).

FIG. 4(a) is a top view of a first layer for a qualitative cell migration system, in accordance with one embodiment of the present invention.

FIG. 4(b) is a side view of the first layer shown in FIG. 4(a).

FIG. 5(a) is a top view of a second layer for a qualitative cell migration system, in accordance with one embodiment of the present invention.

FIG. 5(b) is a side view of the second layer shown in FIG. 5(a).

FIG. 6(a) is a top view of a first layer for a qualitative cell migration system, in accordance with one embodiment of the present invention.

FIG. 6(b) is a top view of a second layer for a qualitative cell migration system, in accordance with one embodiment of the present invention.

FIG. 6(c) is a top view of the second layer shown in FIG. 6(b) positioned on the first layer shown in FIG. 6(a).

FIG. 7(a) is a top view of a first layer for a qualitative cell migration system, in accordance with another embodiment of the present invention.

FIG. 7(b) is a top view of a second layer for a qualitative cell migration system, in accordance with another embodiment of the present invention.

FIG. 7(c) is a top view of the second layer shown in FIG. 7(b) positioned on the first layer shown in FIG. 7(a).

FIG. 8(a) is a top view of a qualitative cell migration assay plate, in accordance with another embodiment of the present invention.

FIG. 8(b) is a cross-sectional view of the qualitative cell migration assay plate shown in FIG. 8(a), taken along the lines IX-IX.

FIG. 8(c) is a top view of a qualitative cell migration assay plate, in accordance with another embodiment of the present invention.

FIG. 8(d) is a cross-sectional view of a plug insertable into the qualitative cell migration assay plate shown in FIG. 8(c).

FIG. 9(a) is a perspective view of a PDMS casting having a plurality of macroposts disposed thereon, in accordance with one embodiment of the present invention.

FIG. 9(b) is a perspective view of a 96-well microtiter plate that may be employed for casting the macrocosms shown in FIG. 9(a).

FIGS. 10(a) through 10(c) illustrates steps that may be performed in order to fabricate first and second elastomeric layers, in accordance with one embodiment of the present invention.

FIGS. 11(a) through 11(c) illustrates steps that may be performed in order to fabricate first and second elastomeric layers, in accordance with another embodiment of the present invention.

FIG. 12(a) illustrates a first cell type patterned into micro-orifices, in accordance with one embodiment of the present invention.

FIG. 12(b) illustrates a second type of cells arrayed around the first cell type shown in FIG. 12(a).

FIG. 12(c) illustrates an overlayed arrangement of the first and second cell types shown in FIGS. 12(a) and 12(b).

FIG. 13(a) illustrates a second layer positioned on a first layer, in accordance with another embodiment of the present invention.

FIG. 13(b) illustrates the first and second layers shown in FIG. 13(a) having cells patterned there through onto a support.

FIG. 13(c) illustrates the first layer shown in FIG. 13(b) being removed such that the cells arrayed on the support shown in FIG. 13(b) are permitted to migrate.

FIG. 13(d) illustrates cells that have been patterned through the first and second layers shown in FIG. 13(b) onto a support and that have grown to confluence.

FIG. 13(e) shows the cells having migrated upon the removal of the first and second layers, as shown in FIG. 13(c).

FIG. 14(a) illustrates a self-assembled monolayer having a “switchable head,” in accordance with one embodiment of the present invention.

FIG. 15(a) illustrates the effect of a test agent on cell motility for a control group and a particular cell type, in accordance with one embodiment of the present invention.

FIG. 15(b) is a graphical representation of the effects of the test agent on cell motility as shown in FIG. 15(a).

FIGS. 16 and 17 illustrate the effect of a various agents on cell motility for a group of cell, in accordance with various embodiments of the present invention.

FIG. 18 is a graphical representation of the amount of cell motility relative to an amount of cell proliferation, in accordance with one embodiment of the present invention.

FIG. 19 is a schematic diagram of a system for measuring the migration or motility of cells, in accordance with one embodiment of the present invention.

FIG. 20 contains the pictorial results of an assay using a qualitative cell motility assay plate showing farnesyl transferase inhibition in MS1 and SVR cells, in accordance with one embodiment of the present invention.

FIG. 21 shows the data analysis of cell motility of MS1 and SVR affected by farnesyl transferase inhibition, in accordance with one embodiment of the present invention.

FIG. 22 shows graphs of the results of an assay determining the inhibition of 769-P motility using MMP inhibitor GM6001, and a chart comparing the results of the assay performed in a transwell system and the assay performed in employing the qualitative cell motility assay plate, in accordance with one embodiment of the present invention.

FIG. 23 presents the results of an assay where the effects of several inhibitors in the RAS pathway were measured, in accordance with one embodiment of the present invention.

FIG. 24 depicts a cell motility assay wherein cells are patterned in a predetermined area using a physical constraint. The physical constraint is removed and cell motility is monitored. Well defined patterns of cells can be created once the membrane is lifted.

FIG. 25 depicts a particular cell motility assay using endothelial cells and agonists and antagonists of such cells. The results depicted show that cell motility is affected when an inhibitor to VEGF is added. Normally VEGF stimulates cells to migrate as depicted in FIG. 25A. In FIG. 25B, the concentration of VEGF is fixed. An antibody to VEGF is added in various concentrations. The motility of cells is affected in a dose-dependent fashion by the antibody. When an inhibitor to the VEGF receptor is added, the cells migrate at a such slower rate as depicted in FIG. 25C. FIG. 25D shows that cell motility can be affected with kinase inhibitors. Normally enzyme inhibition screens involve proteins and their substrates and not cells. FIG. 25D depicts enzyme inhibition screens in a cell based context.

FIG. 26 shows that cell migration may be affected by the support upon which the cells are placed. It also depicts the use of fibronectin on the support as a cytophilic substance to encourage adherence of cells to the support.

FIG. 27 depicts control of cell cycle by patterning.

FIG. 28 depicts the effects of cell patterning geometry on cell differentiation.

FIG. 29 depicts cell differentiation brought about by patterning of the cells into certain constraints.

FIG. 30 depicts single cell patterning and the subsequent evaluation of cytoskeletal stability and rearrangement.

FIG. 31 illustrates a flow chart of a assay according to an embodiment of the present invention.

FIG. 32 illustrates exemplary test apparatus according to an embodiment of the present invention.

FIG. 33 illustrates exemplary test apparatus according to another embodiment of the present invention.

FIG. 34 illustrates a method of performing island acquisition according to an embodiment of the present invention.

FIG. 35 illustrates idealized, exemplary image data for use in an embodiment of the present invention.

FIG. 36 illustrates idealized, exemplary image data for use in an embodiment of the present invention.

FIG. 37 illustrates idealized, exemplary image data for use in an embodiment of the present invention.

FIG. 38 illustrates a method of identifying islands according to an embodiment of the present invention.

FIG. 39 is a screen shot of exemplary source image data.

FIG. 40 is a screen shot of exemplary dilated image data.

FIG. 41 depicts various images of data and digital images retrieved from an assay according to an embodiment of the present invention. Algorithms are used to convert digital images into computer readable data that is then converted into usable graphic interfaces.

FIG. 42 is a perspective view of an embodiment of a device adapted to be used in a method for monitoring leukocyte migration according to the present invention.

FIG. 43 is a cross-sectional view of the device of FIG. 1 along lines II-II.

FIG. 44 is a top plan view of the device of FIG. 1.

FIG. 45 is a top plan view of an alternative embodiment of a chamber defined in a housing of a device adapted to be used in a method for monitoring leukocyte migration according to the present invention.

FIG. 46 is a top plan view of a plurality of chambers such as the chamber of FIG. 4 disposed in a predetermined relationship with respect to one another.

FIG. 47 is a top, perspective view of an alternative embodiment of a device adapted to be used in a method for monitoring leukocyte migration according to the present invention, where the device displays the dimensions and pitch of a standard 96-well microtiter plate.

FIG. 47A is a top enlarged view of an individual well of an alternative embodiment of the device according to the present invention.

FIG. 48 is a bar graph comparing the velocity of shear flow under different cell suspension volumes.

FIG. 49 is a graph comparing the number of cells rolling under different dilutions of P-selectin antibody.

FIG. 50 is a graph and time-lapsed still photographs of cells rolling and adhering under different dilutions of P-selectin antibody.

FIG. 51 is a graph and time-lapsed still photographs of cells rolling and adhering under different dilutions of E-selectin antibody.

FIG. 52 is a graph and time-lapsed still photographs of cells adhering to endothelium in the presence of antibodies to E-selectin, P-selectin, and VCAM-1.

FIG. 53 depicts the results of an experiment involving the creation of a concentration gradient of TNF-∀ via laminar flow. The TNF-∀ was delivered to a confluent “lawn” of endothelial cells. The endothelial cells that were contacted by the TNF-∀ were activated and thus are able to bind the leukocytes. Leukocytes were then delivered to the endothelial cells. As is demonstrated in the figure, the leukocytes bound to the area of the endothelial cells that received high concentrations of TNF-∀ whereas those areas not exposed to TNF-∀ or exposed to very little TNF-∀ did not bind leukocytes.

FIG. 54 depicts an exemplary microfluidic device for creating a laminar flow gradient.

FIG. 55A is a top, perspective view, in partial cross section, of a portion of an embodiment of test device according to the present invention.

FIG. 55B is a top, perspective view of an embodiment of a test device of the present invention.

FIG. 55C is a side-elevational view of a longitudinal cross section of one of the chambers of the test device of FIG. 55B.

FIG. 56A is a schematic outline depicting a top plan view of an alternative embodiment of a chamber defined in a test device of the present invention, where the channel region defines a single channel.

FIG. 56B is a schematic outline depicting a top plan view of the embodiment of the chambers defined in the embodiment of the test device according to FIG. 55B, where the channel region defines a single channel.

FIG. 56C is a figure similar to FIG. 56A, showing an alternative embodiment of a chamber defined in a test device of the present invention, where the channel region defines a single channel.

FIG. 57A is a figure similar to FIGS. 56A, showing an alternative embodiment of a chamber defined in a test device of the present invention, where the channel region defines a plurality of channels having identical lengths.

FIG. 57B is a figure similar to FIG. 57A, showing a channel region defining a plurality of channels having lengths that increase from one side of the chamber to another side of the chamber.

FIG. 57C is a figure similar to FIG. 57A, showing a channel region defining a plurality of channels having widths that increase from one side of the chamber to another side of the chamber.

FIG. 58A is a figure similar to FIG. 55B showing an alternative embodiment of a test device according to the present invention.

FIG. 58B is an enlarged, schematic, top plan view of a channel of FIG. 58A showing cells on the sides of the channel.

FIGS. 59 and 60 are views similar to FIG. 56A, showing an alternative embodiment of a chamber defined in a test device of the present invention, where the wells are trapezoidal in a top plan view thereof.

FIG. 61 is a view similar to FIG. 56A, showing an alternative embodiment of a chamber defined in a test device of the present invention, where the chamber is in the form of a FIG. 8 in a top plan view thereof.

FIG. 62 is a view similar to FIG. 56A, showing an alternative embodiment of a chamber defined in a test device of the present invention, where one well is rectangular and the other well circular in a top plan view of the device.

FIG. 63 is a view similar to FIG. 56A, showing an alternative embodiment of a chamber defined in a test device of the present invention, where the first well region and the second well region each define a plurality of wells, and where the channel region defines a plurality of channels joining respective wells of each well region.

FIG. 64 is a view similar to FIG. 56A, showing an alternative embodiment of a chamber defined in a test device of the present invention, where the channel region defines a plurality of channels joining respective wells of each well region.

FIG. 65 is a view similar to FIG. 56A, showing an alternative embodiment of a chamber defined in a test device of the present invention, where the first well region has a plurality of wells and a respective capillary for each well, the channel region has a single channel, and the second well region has a single well.

FIG. 66 is a side, cross-sectional view of an embodiment of a portion of the support member according to the present invention, the portion of the support member being shown along a longitudinal axis of a chamber according to the present invention.

FIG. 67 is an isometric view of a collective system according to one embodiment of the present invention.

FIG. 68 is a view similar to FIG. 56A, showing an alternative embodiment of a chamber defined in a test device of the present invention, where the first well region includes a plurality of wells interconnected by a network of capillaries, where the channel region includes a single channel, and where the second well includes a single well.

FIG. 69 is a block diagram of an automated analysis system according to an embodiment of the present invention.

FIG. 70 is a flow diagram of a method according to an embodiment of the present invention.

FIG. 71 illustrates exemplary image data on which the method of FIG. 70 may operate.

FIG. 72 illustrates a histogram that may be obtained from the image data of FIG. 71.

FIG. 73 illustrates exemplary image data.

FIG. 74 illustrates exemplary dilated image data.

FIG. 75 depicts various cell types that have been patterned using soft lithographic techniques.

FIG. 76 depicts various biological reactions involving patterned biomolecules.

FIG. 77 depicts a device according to one embodiment of our invention versus a transwell system. In a transwell system, the concentration of chemoattractant is transient and the chemotactic gradient is not stable or quantifiable. In a device according to the present invention, the chemotactic gradient is internally calibrated. According to one embodiment of the present invention where the device comprises multiple chambers, one chamber may be used to calibrate the cell migration assay, and the other chambers may be used to monitor cell migration. At any particular point in time, cell migration may be monitored in different chambers at a particular concentration of the chemoattractant.

FIG. 78 depicts formation of a MCP-1 gradient and migration of THP-1 cells in a channel in the direction of a gradient.

FIG. 79 depicts the characterization of a cytokine gradient using rhodamine dextran.

FIG. 80 depicts THP-1 cells migrating in channels in the direction of a MCP-1 gradient. Hydrogels are filled in the channels of the device. According to one method of placing the gel in channels, the gel stops at a definite point in the channel and does not spill over into the wells.

FIG. 81. In this assay, a known CCR2 binding inhibitor is used to test whether the inhibitor has an effect on THP-1 cells migrating towards MCP-1. Results show that the inhibitor does indeed inhibit cell migration. Using the devices of the present invention allows for the correlation of pharmacologically relevant data to cell based systems.

FIG. 82 depicts the flexibility of the device according to one embodiment of the present invention. The channel width, length, and architecture may be varied. Using the device of the present invention, allows for monitoring of the maximum distances the cells traveled, weighted average of distance the cells traveled and measurement of cell pixels (all the cells that traveled any distance), average distance traveled, and number of cells that traveled. Transmigration mimics cells moving through endothelium. In one embodiment, the width of the channels is 2-10 microns. In one embodiment of the present invention, the device may use a configuration of channels that mimic human vasculature. For example, the height of the channels may be 80 microns tall.

FIG. 83 depicts small molecule inhibition of cell migration.

FIG. 84 show that algorithms of the present invention convert digital images into data that is then converted to usable graphic interfaces.

FIG. 85 depicts the results of an experiment involving the creation of a concentration gradient of TNF-∀ via laminar flow. The TNF-∀ was delivered to a confluent “lawn” of endothelial cells. The endothelial cells that were contacted by the TNF-∀ were activated and thus are able to bind the leukocytes. Leukocytes were then delivered to the endothelial cells. As is demonstrated in the figure, the leukocytes bound to the area of the endothelial cells that received high concentrations of TNF-∀ whereas those areas not exposed to TNF-∀ or exposed to very little TNF-∀ did not bind leukocytes.

FIG. 86 depicts an exemplary microfluidic device for creating a laminar flow gradient.

FIG. 87. (Top) Traditionally, the human element is introduced at the clinical stage of the drug discovery/development process. (Bottom) The inventors disclose methods to humanize the preclinical stages of drug discovery in that in vivo-like conditions are employed into the target validation, lead optimization, and ADMETox stages. This is accomplished by the disclosed methods for controlling and manipulation of cells and the use of primary cell lines.

FIG. 88. Subject profiles from the general population can be created and compared against a diseased subject. Cellular dynamics are sued to create subject profiles. Exemplary cellular dynamic include pathologic study, FACS measurement, and biochemical analysis. For example, in the exemplified subject there is an increase in leukocytes, change in activation markers, and upregulation/stronger signals in biochemical arrays.

FIG. 89 shows a correlation between the individual subject profile and the pharmacological response. Here an exemplary donor specific primary leukocyte profile is obtained for a healthy person (SLs-374) and an unhealthy person (Sls-373) by determining the molecular expression patterns of molecular markers CD14, CD11b, CD62L, Target 1, Target 2, Target 3, and Target 4, as well as by quantifying the cellular dynamics exhibited by their respective leukocytes cellular assays measuring activation, rolling/adhesion, transmigration and chemotaxis. Additionally, the experiments are repeated in the presence of test compounds SLs-001, SLs-002, SLs-003, SLs-004 and SLs-005 determine their biological efficacy and effect the various components of the primary cell profile. Such an assay allows for the rapid determination of IC50 of the compounds in the individual over the suite of assays for a particular target.

FIG. 90. Increased sensitivity allows the scientist to profile individual target expression levels within a subclass of individuals for a particular disease state. For example, a patient diagnoses with generalized inflammation might be thought to have a disease etiology relating to several putative molecular targets. With a more specific diagnosis, into for example, Psoriatic arthritis, Rheumatoid arthritis and Osteoarthritis, particular molecular targets or combinations thereof are implicated. By analyzing the primary cell profiles of individuals with these diseases, putative drug targets can quickly be validated.

FIG. 91. Screening compounds against two targets (target 1 and 2) with primary cells from three individuals (SLs-384, SLs-270, SLs-373) over a suite of assays measuring primary cell dynamics.

FIG. 92. As opposed to traditional microtiter plate- and transwell-based assays that require between 500,000 to 1 million cells, the assays described herein use about 25,000 to about 50,000 cells. Aside from its economy, these assays achieve more data points resulting in a higher signal to noise ratio.

FIG. 93. This figure illustrates the disclosed methods' ability to tightly control primary cells and to modify surfaces upon which they are grown. On the left, different surface types yield different levels of monocyte activation and/or adhesion. On the right, different types of extracellular matrix gels work better with different cells types. An “x” indicates a gel/cell combination that is “bad” where as a check indicates a gel/cell combination that is “good.”

FIG. 94. This figure shows the inventors' ability to control the differentiation of various types of endothelial cells based on various culture conditions and surface treatments.

FIG. 95. This figure shows the ability to control the cell environment and patterning is such a way as to create capillary-like structures of endothelial cells that more closely mimic conditions in the body. Capillary-like formation does not occur with traditional cell culture methods.

FIG. 96. This figure shows the invention's ability to reproduce flow and shear force on cultured endothelial cells to mimic conditions in the body. Cells exhibit different morphology in the absence of flow (static) and do not accurately exhibit in vivo-like behavior in its absence. Additionally, the complex gradients (on the right) show that as the concentration of TNF-alpha increases, so does the activation of thus cultured endothelial cells.

FIG. 97. This figure depicts the current molecular and cellular model of inflammation. Accordingly, the invention envisages and discloses various assays to measure the molecular and cellular dynamics of primary leukocytes. These assays include: target biochemical characterization, endothelial cell activation, adhesion and rolling leukocytes, transmigration of leukocytes, chemotaxis of leukocytes, immobilized chemokine activation of leukocyte, and cell motility assays.

FIG. 98. This figure shows that activated monocytes exhibit a quantifiable wider, flatter morphology than non-activated monocytes and thereby exhibit an increase in surface area of cytoplasm. The activation of monocytes here is measured by lamellipodia extension time lapse video.

FIG. 99. This figure shows a primary leukocyte rolling and adhesion assay on cultured endothelium. To show the efficacy of the system, the leukocytes are activated using the cytokine MCP-1. The primary leukocytes in the assay were provided by donors SLs-373 and SLs-374.

FIG. 100. This figure depicts an assay for measuring the chemotaxis of primary monocytes provided by donors SLs-373 and SLs-374 over a MCP-1 gradient.

FIG. 101. This figure illustrates a transmigration (diapedesis) assay of primary monocytes provided by donors SLs-373 and SLs-374 over various MCP-1 concentrations.

FIG. 102. This figure depicts other controlled cellular microenvironments upon which to test or culture primary cell cultures.

FIG. 103. This shows an overview of the technology disclosed

### DETAILED DESCRIPTION

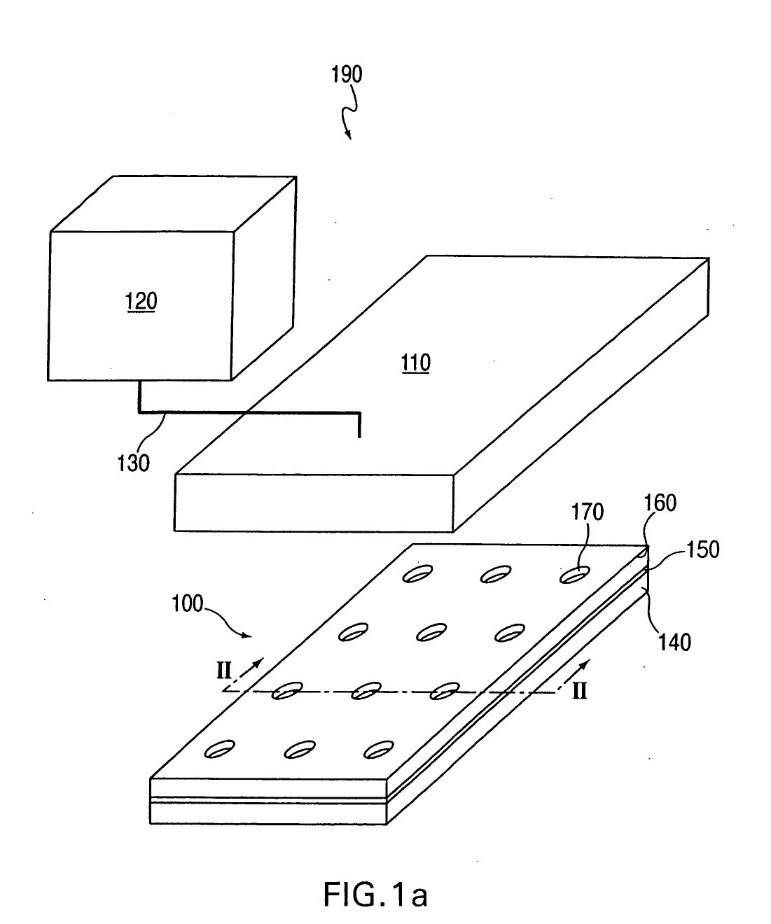

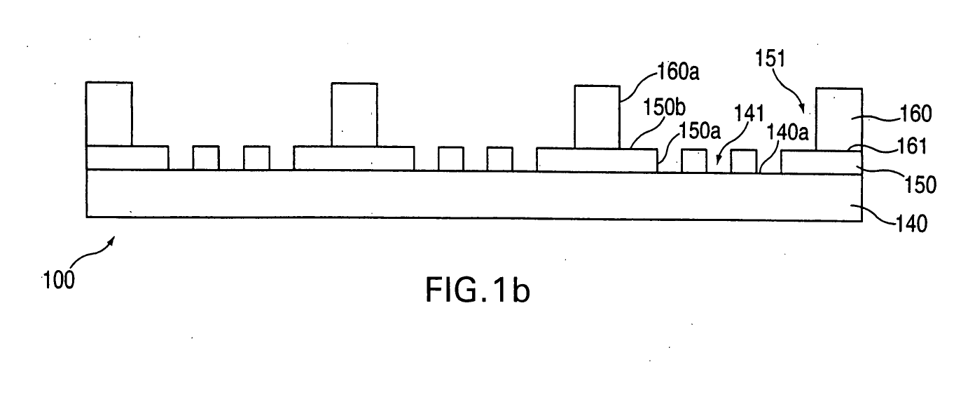

FIG. 1(a) is a schematic, perspective view of a qualitative cell migration system 190 in accordance with an embodiment of the present invention. The qualitative cell migration system 190 includes a qualitative cell migration assay plate 100, an observation system 110, and a controller 120. The controller 120 in this embodiment is in signal communication with the observation system 110 via line 130. The controller 120 and the observation system 110 may be positioned and programmed to observe, record, and analyze the migration, movement, and behavior of cells that are placed in or on the qualitative cell migration assay plate 100, as readily recognizable by a person skilled in the art.

The present invention provides a cell migration assay plate 100 for the quantification of the qualitative cell patterning and migration. Embodiments of the assay plate, according to the present invention, allow a patterning of cells in a discrete, predetermined array. The present invention also provides cell migration/motility assays, also referred to as “CMAs,” which preferably uses a qualitative cell migration assay plate according to the present invention to pattern cells into discrete arrays and uses a cell migration system according to the present invention to monitor and record the results of the assays. Embodiments of the cell migration assay plate, the cell migration system, and the cell migration/motility assays of the present invention are compatible with the demands of high-throughput screening, and represent a significant advance in both throughput and ease of use. Generally, with embodiments of the qualitative cell migration assay plate of the invention, cells are patterned into a specific geometry, treated with various cell affecting agents, and allowed to migrate or otherwise react in response to a cell affecting agent.

FIG. 1(b) is a cross-sectional view of cell migration assay plate 100 of FIG. 1(a), taken along lines II-II. Embodiments of the cell migration assay plate according to the present invention, as shown by way of example in the embodiments of FIGS. 1(a) and 1(b), include: a support 140 onto which cells may be arrayed, a first layer 150 that provides a pattern through which cells may be arrayed on the support 140; and a second layer 160. The support 140 provides a base upon which cells can be patterned, attached, or reversibly or irreversibly immobilized. The support 140 has an upper surface 140a. The first layer 150 defines a plurality of orifices 300 there through, referred to hereinafter as “micro-orifices 300.” The micro-orifices 300 are arranged in a pattern or array that defines positions in which cells may be deposited, attached, or reversibly or irreversibly immobilized to the upper surface 140a of the support 140. The micro-orifices 300 have walls 150a that define the micro-orifices 300. The second layer 160 defines a plurality of orifices 170 there through, referred to hereinafter as “macro-orifices 170.” The macro-orifices 170 are arranged in a pattern or array through which test agents or solutions are deposited to contact cells that were previously deposited, attached, or reversibly or irreversibly immobilized to the upper surface 140a of the support 140. The macro-orifices 170 have walls 160a that define the macro-orifices 170.

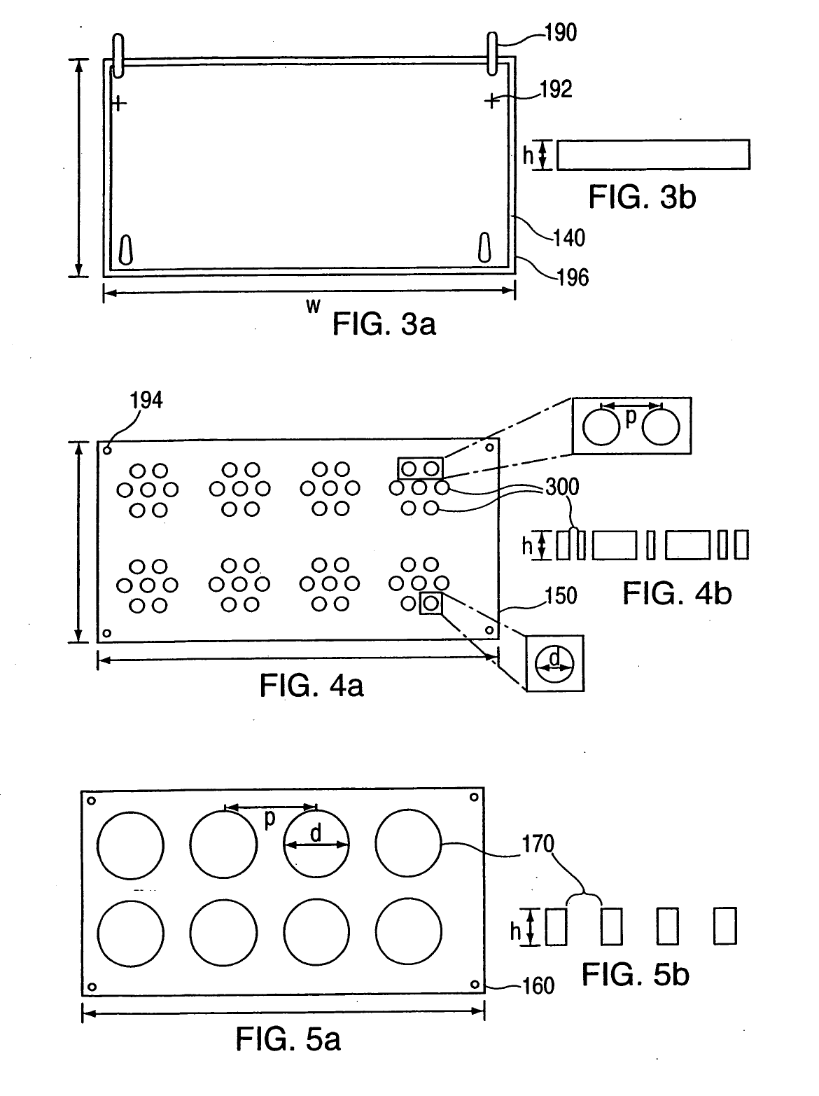

The size of the support 140 preferably matches the dimensions of an industry standard micro-titer plate. For example, FIGS. 3(a) and 3(b) illustrate the support 140, according to one embodiment of the present invention. More specifically, FIG. 3(a) is a plan view that illustrates the support 140 having a length dimension L and a width dimension W. According to one embodiment, the length dimension L of the support 140 is approximately 3 inches (75 mm), while the width dimension W is approximately 5 inches (125 mm). Preferably, all of the layers of the cell migration assay plate 100 would have corresponding outer dimensions and would be amenable to use in standard laboratory platforms such as microtiter plate readers, automatic handlers, and fluid delivery systems.

Referring to the embodiment illustrated in FIG. 1(b), the micro-orifices 300 extend through the entire thickness of the first layer 150. In a preferred embodiment of the present invention, the first layer 150 defines an array of micro-orifices 300, which are disposed in an array of discrete first positions. In addition, the first layer 150 is preferably capable of making conformal contact, that is, a form-fitting fluid-tight contact, with support 140, when brought into contact with the support 140. Furthermore, the first layer 150 is preferably capable of self-sealing to the support 140, e.g., creating a seal with the support 140 without the use of a sealing agent. When the first layer 150 is brought into contact with the support 140 to create a fluid-tight seal, a plurality of wells, referred to hereinafter as “micro-wells,” are formed. The walls of each micro-well 141 are defined by the walls 150a of the micro-orifices 300 in the first layer 150, while the bottom of each micro-well 141 is defined by an exposed region on the upper surface 140a of the support 140. Advantageously, each micro-well 141 is individually fluidically addressable, e.g., may have a different fluid introduced therein.

The first layer 150 may be comprised of materials commonly used in biological sciences, such as glass, elastomers (e.g., PDMS), rigid plastics (e.g., polyethylene, polypropylene, polystyrene, polycarbonate, PMMA), metals, silicon, silicon dioxide and other rigid supports.

According to one embodiment of the present invention, the first layer 150 may be treated, conditioned or coated with a substance that resists cell attachment so that when the first layer 150 is lifted from the support, the risk of damaging cells is reduced. Coatings resistant to proteins are known in the art and include, but are not limited to: bovine serum albumin (BSA), gelatin, lysozyme, octoxynol, polysorbate 20 (polyoxyethylenesorbitan monolaurate), and polyethylene oxide-containing block copolymer surfactants. Conversely, according to other embodiments of the present invention, the first layer 150 is not so coated, such that when the first layer 150 is removed, the cells that have adhered to the first layer 150 will likely be damaged as the first layer 150 is peeled away from the support. By damaging cells, phenomena, such as wound healing, may be observed.

FIG. 4(a) illustrates the first layer 150 defining a plurality of micro-orifices 300 disposed there through. In the embodiment shown, the micro-orifices 300 are grouped into discrete areas. These discrete areas may have a variety of shapes and sizes. In the embodiment shown, each area has a cluster of micro-orifices 300 arranged in a circular arrangement. It is understood that the micro-orifices 300 of the first layer 150 may have any other arrangement that would be within the knowledge of a person skilled in the art, such as, for example, a rectangular, hexagonal, circular or any another arrangement.

The diameter of the micro-orifices 300 (and also the diameter of the micro-wells 141 that are defined by the walls 150a of the micro-orifices), shown as dimension “d” in FIG. 4(a), may be varied according to cell types and the desired number of cells to be placed into each micro-well 141. For example, if the diameter of the micro-well 141 and the cell to be placed in the micro-well 141 are both 10 mm, only one cell will be depositable through each micro-orifice 300 and into each micro-well 141. Thus, in this example, if the diameter of the micro-orifice 300 is 100 mm, up to approximately 100 cells may be deposited in a micro-well 141 defined by that micro-orifice 300.

According to embodiments of the present invention, the diameter d of micro-wells 141 varies from about 1 mm to about 500 mm, and is preferably from about 40 mm to about 200 mm. In most cases, the diameter d is greater than the diameter of cells used in experiments, but in specialized assays, the diameter d may be smaller than that of the cells. For example, if it is desired to pattern a single cell through each micro-orifice 300 of the first layer 150 and into micro-well 141, the diameter d may range from about 1 microns to about 20 microns. In a typical chemotaxis assay, the diameter d is preferably approximately 0.3-0.8 times the diameter of cells. Furthermore, the distance between adjacent micro-orifices 300 (and thus the distance between adjacent micro-wells 141 defined by the micro-orifices 300) may be varied. This distance is identified as dimension “p” in FIG. 4(a). Although any distance p may be employed, this distance p may vary, according to various example embodiments of the present invention, from about the same distance as the diameter dimension d to about 10 times the diameter d.

The second layer 160 is comprised of materials commonly used in biological sciences, such as glass, elastomers (e.g., PDMS), rigid plastics (e.g., polyethylene, polypropylene, polystyrene, polycarbonate, PMMA), metals, silicon, silicon dioxide and other rigid supports. A preferred material is PDMS, and a more preferred material is a combination of PDMS and a rigid plastic such as polycarbonate.

Referring to the embodiment illustrated in FIG. 1(b), the macro-orifices 170 extend through the entire thickness of the second layer 160. In a preferred embodiment of the present invention, the second layer 160 has an array of macro-orifices 170. In addition, the second layer 160 is preferably capable of making conformal contact, that is, a form-fitting, fluid tight contact when brought into contact with either an upper surface 150b of the first layer 150, or the upper surface 140a of the support 140. Furthermore, the second layer 160 is preferably capable of self-sealing to either of upper surface 150b or upper surface 140a, e.g., creating a conformal, fluid-tight seal therewith without the use of a sealing agent. In the embodiment of the present invention shown in FIG. 1(b), when the second layer 160 is brought into contact with the upper surface 150b of the first layer 150 to create a fluid-tight seal, a plurality of wells 151, referred to hereinafter as “macro-wells 151,” are formed. The walls of each macro-well 151 are defined by the walls 160a of the macro-orifices 170 in the second layer 160. The bottom of each macro-well 151 is the exposed region defined by the size and shape of the macro-orifice 151 at the lower surface 161 of the second layer 160. For instance, in the embodiment illustrated in FIG. 1(b), the bottom of the macro-well 151 is the exposed region defined by a portion of the upper surface 140a of the support 140, the walls 150a of the micro-orifices 300 that are encompassed by the macro-well 151, and by the exposed regions of the upper surface 150b of the first layer 150 within the encompassed micro-wells 300. Thus, as should be evident, the elements that make up the bottom of the macro-wells 151 depend on the size and orientation of the macro-wells 151 relative to the micro-wells 141. Advantageously, each micro-well 141 is individually fluidically addressable, e.g., may have a different fluid introduced therein. It is also noted that, in accordance with an alternate embodiment of the present invention, the first layer 150 is removed from the support 140 after arraying the cells through the micro-orifices 300, and the second layer 160 is brought into contact with the upper surface 140a of the support 140. In this case, the bottom of the macro-well 151 is an exposed region of the upper surface 140a of the support 140, and may encompass cells or groups of cells that were previously arrayed onto the upper surface 140a of the support 140.

The macro-wells 151 defined by the macro-orifices 170 may encompass discrete regions of the first layer 150 such that fluids added to one macro-orifice 170 will flow to the encompassed micro-wells 141, but may not flow to adjacent or other micro-wells 141 not encompassed by the macro-well 151. In this embodiment, the macro-wells 151 allow for easy addition and removal of solutions, while the first layer 150 of micro-orifices 300 provides the spatial patterning of the cells.

As previously mentioned, the micro-orifices 300 may be sized to accommodate the passage of several cells at a time, the passage of a single cell at a time, or the passage of a portion of a cell. The size of the micro-orifices 300 may be selected to accommodate the particular cell and stimulus being studied. Depending on the size and orientation of the micro-orifices 300, cells can be placed in specific regions, groups or patterns on the support layer 140. In so doing, the starting point of each cell or cell group can be readily identified and its distance of travel readily measured and timed for various time periods. Preferably, more than one cell will settle through each orifice.

FIG. 5 illustrates the second layer 160 having a plurality of macro-orifices 170 defined there through. In the embodiment shown, the macro-orifices 170 are circular in a top plan view thereof, although it is understood that the macro-orifices 170 may have a variety of shapes and sizes. The number of macro-wells 151, the diameter of the macro-orifices 170 (and also the diameter of the macro-wells 151 that are defined by the walls 160a of the micro-orifices 170), shown as dimension “d” in FIG. 5, and the distance between adjacent macro-wells 151, shown as dimension “p” in FIG. 5, may each be varied according to cell types and the number of micro-wells 141 desired to be encompassed in each macro-well 151, or the process desired to be performed. Preferably the arrangement of the macro-orifices 300, and thus the arrangement of the macro-wells 151 defined thereby, corresponds to the footprint of standard 24-, 96-, 384-, and 1536-well micro-titer plates. For example, the typical dimensions of various standard micro-titer plates (“ID” refers to the inner diameter of a well of the micro-titer plate, while “p” refers to the distance between adjacent wells) are as follows:

| Device | ID (mm) | p (mm) |
|---|---|---|
| 24 well | 9-15 | 18 |
| 96 well | 6 | 9 |
| 384 well | 3 | 4.5 |
| 1536 well | 1.5 | 2.25 |

In one embodiment of the present invention, the second layer 160 is comprised of an elastomer, such as PDMS. In this embodiment, the macro-orifices 170 are formed in the second layer 160 in a manner that is similar to the manner in which the micro-orifices 300 are formed in the first layer 150, e.g., precursor PDMS is spin cast on to a master having posts corresponding in size (diameter and length) and pitch as the desired macro-orifices. In another embodiment, the second layer 160 is comprised of a rigid material including, but not limited to, glass, rigid plastics or metals. The macro-orifices 170 are formed in these materials by methods known in the art, such as molding, etching, and punching.

In various other embodiments of the present invention, macro-orifices 170 of the second layer 160 may comprise individual rings or interconnected rings. For instance, in one embodiment, the second layer 160 comprises rings made of a rigid plastic such as polypropylene, and having a diameter equal to the desired diameter of the macro-orifices 170. The rigid rings may be molded together with an elastomer such as PDMS to form the second layer 160.

The thickness or height of the first layer 150, which is shown in FIG. 4(b) and which is designated as “2 h,” may be predetermined so as to accommodate a desired number of cells, e.g., a single cell or multiple cells. In other words, the thickness of the first layer 150 dictates the maximum depth of the micro-wells 141 formed by the micro-orifices 300. To alter the thickness of the first layer 150, one may stack identical first layer 150s on top of each other to achieve the desired thickness. In alternate embodiments, the first layer 150 may be fabricated so as to have a desired thickness. Because elastomers such as PDMS create a conformal contact that is reversible, stacking of the layers allows one to achieve a micro-orifice of a desired depth. By “reversible,” what is meant in the context of the present invention, is a conformal contact that can be undone without compromising a structural integrity of the component making the conformal contact.

The thickness or height of the support 140, shown in FIG. 3(b) and designated as “h,” may be chosen as desired. Similarly, the thickness or height of the second layer 160, as shown in FIG. 5(b) and designated as “h,” may be chosen to accommodate a desired amount of solution to be added into the macro-wells 151 formed by the macro-orifices 170. A preferred height “h” of the second layer 160 ranges from about 2 mm to about 12 mm.

The support 140 on which the cells may be placed or patterned comprises a material that is compatible with the cells. Suitable materials may include standard materials used in cell biology, such as glass, ceramics, metals, polystyrene, polycarbonate, polypropylene, as well as other plastics including polymeric thin films, and polymethyl methacrylate (PMMA). Preferably, the material provides sufficient rigidity to allow the device to be handled either manually or by automatic laboratory handlers. A preferred material is optical grade polycarbonate with a thickness of about 0.2 to 2 mm, as this may allow the viewing of the patterned cells with optical microscopy techniques.

Additionally, the support 140 may be comprised of any material that provides a conformal contact with additional layers of the cell migration assay plate 100. Materials which allow conformal contact are known in the art and include elastomers with a preferred elastomer being polydimethylsiloxane (“PDMS”). In an alternate embodiment, the support 140 and/or the first layer 150 are comprised of an elastomer. Elastomers such as PDMS are preferred in that the conformal contact prevents fluids from infiltrating other orifices in the first layer 150 or the second layer 160. In other embodiments, sealing agents or mechanical sealing devices such as clamps and gaskets may also be used to create or enhance the seal between the support 140 and the first layer 150 or between the first layer 150 and the second layer 160. Sealing agents capable of creating fluid-tight seals between two materials are known in the art and include glues, inert gels, and swellable resins.

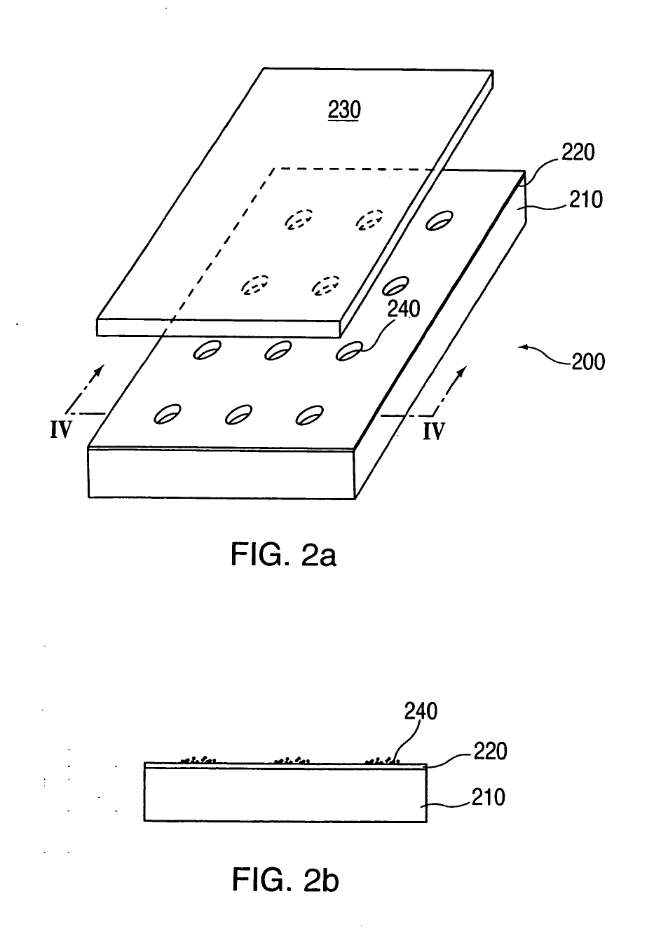

FIG. 2(a) illustrates one embodiment wherein support 210 is treated with a coating 220. A cross-sectional view of the embodiment shown in FIG. 2(a), taken along the lines II-II, is shown in FIG. 2(b). Alternatively, support 210 may be overlayed with a membrane having a desired treatment or coating 220 thereon.

Coating 220 may be made of any substance that achieves a desired effect on the cells to be arrayed or may be made of any substance to assist in the arraying of the cells or it may comprise a bio-inert coating. Coating 220 may also comprise proteins, proteins fragments, peptides, small molecules, lipid bilayers, metals, or self-assembled monolayers. Self-assembled monolayers are the most widely studied and best developed examples of nonbiological, self-assembling systems. They form spontaneously by chemisorption and self-organization of functionalized, long-chain organic molecules onto the surfaces of appropriate substrates. Self-assembled monolayers are usually prepared by immersing a substrate in the solution containing a ligand that is reactive toward the surface, or by exposing the substrate to the vapor of the reactive species. There are many systems known in the art to produce self-assembled monolayers.

The best characterized systems of self-assembled monolayers are alkanethiolates CH₃(CH₂)ₙS— on gold. Alkanethiols chemisorb spontaneously on a gold surface from solution and form adsorbed alkanethiolates. Sulfur atoms bonded to the gold surface bring the alkyl chains in close contact—these contacts freeze out configurational entropy and lead to an ordered structure. For carbon chains of up to approximately 20 atoms, the degree of interaction in a self-assembled monolayer increases with the density of molecules on the surface and the length of the alkyl backbones. Only alkanethiolates with n>11 form the closely packed and essentially two-dimensional organic quasi-crystals supported on gold that characterize the self-assembled monolayers most useful in soft lithography. The formation of ordered self-assembled monolayers on gold from alkanethiols is a relatively fast process. Highly ordered self-assembled monolayers of hexanedecanethiolate on gold can be prepared by immersing a gold substrate in a solution of hexadecanethiold in ethanol (ca. 2 mM) for several minutes, and formation of self-assembled monolayers during microcontact printing may occur in seconds.

It may be desirable to pattern the self-assembled monolayer to have an arrayed surface. For example, it may be desirable to pattern the self-assembled monolayer such that it has an array matching the array of micro-orifices or macro-orifices or any other array. Patterning self-assembled monolayers in the plane of the surface has been achieved by a wide variety of techniques, including micro-contact printing, photo-oxidation, photo-cross-linking, photo-activation, photolithography/plating, electron beam writing, focused ion beam writing, neutral metastable atom writing, SPM lithography, micro-machining, micro-pen writing. A preferred method is micro-contact printing. Micro-contact printing is described, by way of example, in U.S. Pat. No. 5,776,748, which is herein incorporated by reference in its entirety.

In another embodiment, coating 220 comprising self-assembled monolayers is “patterned” by micro-contact printing. The self-assembled monolayer patterns are applied to the support using a stamp in a “printing” process in which the “ink” consists of a solution including a compound capable of chemisorbing to form a self-assembled monolayer. The ink is applied to the surface of a plate using the stamp and deposits a self-assembled monolayer on the support in a pattern determined by the pattern on the stamp. The support may be stamped repeatedly with the same or different stamps in various orientations and with the same or different self-assembled monolayer-forming solutions. In addition, after stamping, the portions of the support which remain bare or uncovered by a self-assembled monolayer may be derivatized. Such derivatization may conveniently include exposure to another solution including a self-assembled monolayer-forming compound. The self-assembled monolayer-forming or derivatizing solutions are chosen such that the regions of the finished support defined by the patterns differ from each other in their ability to bind biological materials. Thus, for example, a grid pattern may be created in which the square regions of the grid are cytophilic and bind cells but the linear regions of the grid are cytophobic and no cells bind to these regions.

A simple illustration of the general process of microcontact printing is provided by way of example below. A polymeric material is cast onto a mold with raised features defining a pattern to form a stamp. The stamp with the stamping surface after curing is separated from the mold. The stamp is inked with a desired “ink,” which includes a self-assembled monolayer-forming compound. The “inked” stamp is brought into contact with a plate comprising a substrate and optionally, coated with a thin coating of surface material. The self-assembled monolayer forming compound of the ink chemisorbs to the material surface to form a self-assembled monolayer with surface regions in a pattern corresponding to the stamping surface of the stamp. The plate can then be exposed to a second or filling solution including a self-assembled monolayer-forming compound. The second solution has filled the bare regions of the surface material with a second or filling self-assembled monolayer. The plate having the patterned self-assembled monolayer can then have a material selectively bound to the surface regions of the first self-assembled monolayer but not bound the surface regions of the second self-assembled monolayer and vice-versa.

The stamp is inked with a solution capable of forming a self-assembled monolayer by chemisorption to a surface. The inking may, for example, be accomplished by: (1) contacting the stamp with a piece of lint-free paper moistened with the ink; (2) pouring the ink directly onto the stamp or; (3) applying the ink to the stamp with a cotton swab. The ink is then allowed to dry on the stamp or is blown dry so that no ink in liquid form, which may cause blurring, remains on the stamp. The self-assembled monolayer-forming compound may be very rapidly transferred to the stamping surface. For example, contacting the stamping surface with the compound for a period of time of approximately two seconds is generally adequate to effect sufficient transfer, or contact may be maintained for substantially longer periods of time. The self-assembled monolayer-forming compound may be dissolved in a solvent for such transfer, and this is often advantageous in the present invention. Any organic solvent within which the compound dissolves may be employed but, preferably, one is chosen which aids in the absorption of the self-assembled monolayer-forming compound by the stamping surface. Thus, for example, ethanol, THF, acetone, diethyl ether, toluene, isooctane and the like may be employed. For use with a PDMS stamp, ethanol is particularly preferred, and toluene and isooctane and not preferred as they are not well absorbed. The concentration of the self-assembled monolayer-forming compound in the ink solution may be as low as 1 φM. A concentration of 1-10 mM is preferred and concentrations above 100 mM are not recommended.

The support is then contacted with the stamp such that the inked stamping surface bearing the pattern contacts the surface material of the plate. This may be accomplished by hand with the application of slight finger pressure or by a mechanical device. The stamp and plate need not be held in contact for an extended period; contact times between 1 second and 1 hour result in apparently identical patterns for hexadecanethiol (1-10 mM in ethanol) ink applied to a plate with a gold surface. During contact, the self-assembled monolayer-forming compound of the ink reacts with the surface of the plate such that, when the stamp is gently removed, a self-assembled monolayer is chemisorbed to the plate in a pattern corresponding to the stamp.

A variety of compounds may be used in solution as the ink and a variety of materials may provide the surface material onto which the ink is stamped and the self-assembled monolayer is formed. In general, the choice of ink will depend on the surface material to be stamped. In general, the surface material and self-assembled monolayer-forming compound are selected such that the self-assembled monolayer-forming compound terminates at a first end in a functional group that binds or chemisorbs to the surface of the surface material. As used herein, the terminology “end” of a compound is meant to include both the physical terminus of a molecule as well as any portion of a molecule available for forming a bond with the surface in a way that the compound can form a self-assembled monolayer. The compound may comprise a molecule having first and second terminal ends, separated by a spacer portion, the first terminal end comprising a first functional group selected to bond to the surface material of the plate, and the second terminal end optionally including a second functional group selected to provide a self-assembled monolayer on the material surface having a desirable exposed functionality. The spacer portion of the molecule may be selected to provide a particular thickness of the resultant self-assembled monolayer, as well as to facilitate self-assembled monolayer formation. Although self-assembled monolayers of the present invention may vary in thickness, as described below, self-assembled monolayers having a thickness of less than about 50 Angstroms are generally preferred, more preferably those having a thickness of less than about 30 Angstroms and more preferably those having a thickness of less than about 15 Angstroms. These dimensions are generally a function of the selection of the compound and in particular the spacer portion thereof.

A wide variety of surface materials and self-assembled monolayer-forming compounds are suitable for use in the present invention. A non-limiting exemplary list of combinations of surface materials and functional groups which will bind to those surface materials follows. Although the following list categorizes certain preferred materials with certain preferred functional groups which firmly bind thereto, many of the following functional groups would be suitable for use with exemplary materials with which they are not categorized, and any and all such combinations are within the scope of the present invention. Preferred materials for use as the surface material include metals such as gold, silver, copper, cadmium, zinc, palladium, platinum, mercury, lead, iron, chromium, manganese, tungsten, and any alloys of the above when employed with sulfur-containing functional groups such as thiols, sulfides, disulfides, and the like; doped or undoped silicon employed with silanes and chlorosilanes; metal oxides such as silica, alumina, quartz, glass, and the like employed with carboxylic acids; platinum and palladium employed with nitrites and isonitriles; and copper employed with hydroxamic acids. Additional suitable functional groups include acid chlorides, anhydrides, sulfonyl groups, phosphoryl groups, hydroxyl groups and amino acid groups. Additional surface materials include germanium, gallium, arsenic, and gallium arsenide. Additionally, epoxy compounds, polysulfone compounds, plastics and other polymers may find use as the surface material in the present invention. Polymers used to form bioerodable articles, including but not limited to polyanhydrides, and polylactic and polyglycolic acids, are also suitable. Additional materials and functional groups suitable for use in the present invention can be found in U.S. Pat. No. 5,079,600, issued Jan. 7, 1992, which is incorporated herein in its entirety by reference.

According to a particularly preferred embodiment of the present invention, a combination of gold as the surface material and a self-assembled monolayer-forming compound having at least one sulfur-containing functional group such as a thiol, sulfide, or disulfide is selected.

The self-assembled monolayer-forming compound may terminate in a second end or “head group,” opposite to the end bearing the functional group selected to bind to the surface material, with any of a variety of functionalities. That is, the compound may include a functionality that, when the compound forms a self-assembled monolayer on the surface material, is exposed. Such a functionality may be selected to create a self-assembled monolayer that is hydrophobic, hydrophilic, that selectively binds various biological or other chemical species, or the like. For example, ionic, nonionic, polar, nonpolar, halogenated, alkyl, aryl or other functionalities may exist at the exposed portion of the compound. A non-limiting, exemplary list of such functional groups includes those described above with respect to the functional group for attachment to the surface material in addition to: —OH, —CONH—, —CONHCO—, —NH₂, —NH—, —COOH, —COOR, —CSNH—, —NO₂⁻, —SO₂⁻, —RCOR—, —RCSR—, —RSR, —ROR—, —PO₄⁻³, —OSO₃⁻², —SO₃⁻, —NHₓR₄x⁺, —COO⁻, —SOO⁻, —RSOR—, —CONR₂, —(OCH₂CH₂), OH (where n=1-20, preferably 1-8), —CH₃, —PO₃H⁻, -2-imidazole, —N(CH₃₎₂, —NR₂, —PO₃H₂, —CN, —(CF₂)ₙ CF₃ (where n=1-20, preferably 1-8), olefins, and the like. In the above list, R is hydrogen or an organic group such as a hydrocarbon or fluorinated hydrocarbon. As used herein, the term “hydrocarbon” includes alkyl, alkenyl, alkynyl, cycloalkyl, aryl, alkaryl, aralkyl, and the like. The hydrocarbon group may, for example, comprise methyl, propenyl, ethynyl, cyclohexyl, phenyl, tolyl, and benzyl groups. The term “fluorinated hydrocarbon” is meant to refer to fluorinated derivatives of the above-described hydrocarbon groups.

In addition, the functional group may be chosen from a wide variety of compounds or fragments thereof which will render the self-assembled monolayer generally or specifically “biophilic” as those terms are defined below. Generally biophilic functional groups are those that would generally promote the binding, adherence, or adsorption of biological materials such as, for example, intact cells, fractionated cells, cellular organelles, proteins, lipids, polysaccharides, simple carbohydrates, complex carbohydrates, and/or nucleic acids. Generally biophilic functional groups include hydrophobic groups or alkyl groups with charged moieties such as —COO⁻, —PO₃H⁻ or 2-imidazolo groups, and compounds or fragments of compounds such as extracellular matrix proteins, fibronectin, collagen, laminin, serum albumin, polygalactose, sialic acid, and various lectin binding sugars. Specifically biophilic functional groups are those that selectively or preferentially bind, adhere or adsorb a specific type or types of biological material so as, for example, to identify or isolate the specific material from a mixture of materials. Specific biophilic materials include antibodies or fragments of antibodies and their antigens, cell surface receptors and their ligands, nucleic acid sequences and many others that are known to those of ordinary skill in the art. The choice of an appropriate biophilic functional group depends on considerations of the biological material sought to be bound, the affinity of the binding required, availability, facility of ease, effect on the ability of the Self-assembled monolayer-forming compound to effectively form a Self-assembled monolayer, and cost. Such a choice is within the knowledge, ability and discretion of one of ordinary skill in the art.

Alternatively, the functional group may be chosen from a wide variety of compounds or fragments thereof which will render the self-assembled monolayer “biophobic” as that term is defined below. Biophobic self-assembled monolayers are those with a generally low affinity for binding, adhering, or adsorbing biological materials such as, for example, intact cells, fractionated cells, cellular organelles, proteins, lipids, polysaccharides, simple carbohydrates, complex carbohydrates, and/or nucleic acids. Biophobic functional groups include polar but uncharged groups including unsaturated hydrocarbons. A particularly preferred biophobic functional group is polyethylene glycol (PEG).

The central portion of the molecules comprising the self-assembled monolayer-forming compound generally includes a spacer functionality connecting the functional group selected to bind the to surface material and the exposed functionality. Alternately, the spacer may essentially comprise the exposed functionality, if no particular functional group is selected other than the spacer. Any spacer that does not disrupt self-assembled monolayer packing and that allows the self-assembled monolayer layer to be somewhat impermeable to various reagents such as etching reagents, as described below, in addition to organic or aqueous environments, is suitable. The spacer may be polar; non-polar; halogenated or, in particular, fluorinated; positively charged; negatively charged; or uncharged. For example, a saturated or unsaturated, linear or branched alkyl, aryl, or other hydrocarbon spacer may be used.

A variety of lengths of the self-assembled monolayer-forming compound may be employed in the present invention. If two or more different self-assembled monolayer-forming compounds are used in one stamping step, for example if two or more different self-assembled monolayer-forming compounds are used in the ink, it is often advantageous that these species have similar lengths. However, when a two or more step process is used in which a first self-assembled monolayer is provided on a surface and at least a second self-assembled monolayer is provided on the surface, the various self-assembled monolayers being continuous or noncontinuous, it may be advantageous in some circumstances to select molecular species for formation of the various self-assembled monolayers that have different lengths. For example, if the self-assembled monolayer formed by stamping has a first molecular length and the self-assembled monolayer subsequently derivatized to the surface has a second molecular length greater than that of the stamped self-assembled monolayer, a continuous self-assembled monolayer having a plurality of “wells” results. These wells are the result of the stamped self-assembled monolayer being surrounded by the second self-assembled monolayer having a longer chain length. Such wells may be advantageously fabricated according to certain embodiments, for example, when it is desirable to add greater lateral stability to particular biological materials, such as cells, which have been captured in the wells. Such wells may also form the basis for reaction vessels.

Additionally, self-assembled monolayers formed on the surface material may be modified after such formation for a variety of purposes. For example, a self-assembled monolayer-forming compound may be deposited on the surface material in a self-assembled monolayer, the compound having an exposed functionality including a protecting group which may be removed to effect further modification of the self-assembled monolayer. For example, a photoremovable protecting group may be used, the group being advantageously selected such that it may be removed without disturbance of the self-assembled monolayer of which it is a part. For example, a protective group may be selected from a wide variety of positive light-reactive groups preferably including nitroaromatic compounds such as o-nitrobenzyl derivatives or benzylsulfonyl. Photo-removable protective groups are described in, for example, U.S. Pat. No. 5,143,854, and incorporated herein in its entirety by reference, as well as an article by Patchornik, JACS, 92, 6333 (1970) and Amit et al., JOC, 39, 192, (1974), both of which are incorporated herein by reference in their entireties. Alternately, a reactive group may be provided on an exposed portion of a self-assembled monolayer that may be activated or deactivated by electron beam lithography, x-ray lithography, or any other radiation. Such protections and deprotections may aid in chemical or physical modification of an existing surface-bound self-assembled monolayer, for example in lengthening existing molecular species forming the self-assembled monolayer. Such modification is described in U.S. Pat. No. 5,143,857 referenced above.

Another preferred method of patterning the self-assembled monolayer to have an array matching the first layer 150, for example, is through soft lithography methods known in the art. Soft lithography has been exploited by George M. Whitesides and is described, by way of example, in U.S. Pat. No. 5,976,826 and in PCT WO 01/70389, both of which are herein incorporated by reference in their entireties. For example, the first layer 150 having micro-orifices 300 is placed over the self-assembled monolayer. The first layer makes conformal contact with support 140 by sealing against the self-assembled monolayer. A modifying solution is then placed on the first layer and allowed to contact the self-assembled monolayer surface exposed by the micro-orifices 300. A “modifying” solution is one that modifies the head group of the self-assembled monolayer to achieve a desired characteristic or that adds or removes a desired biomolecule to the head group. For example, a tether may be added to the exposed self-assembled monolayers head groups, which in turn captures a protein, which in turns provides an affinity for the cell to be patterned subsequently through the first layer 150 or the second layer 160.

Preferred surface portions of the patterned self-assembled monolayer are cytophilic, that is, adapted to promote cell attachment. Molecular entities creating cytophilic surfaces are well known to those of ordinary skill in the art and include antigens, antibodies, cell adhesion molecules, extracellular matrix molecules such as laminin, fibronectin, synthetic peptides, carbohydrates and the like.

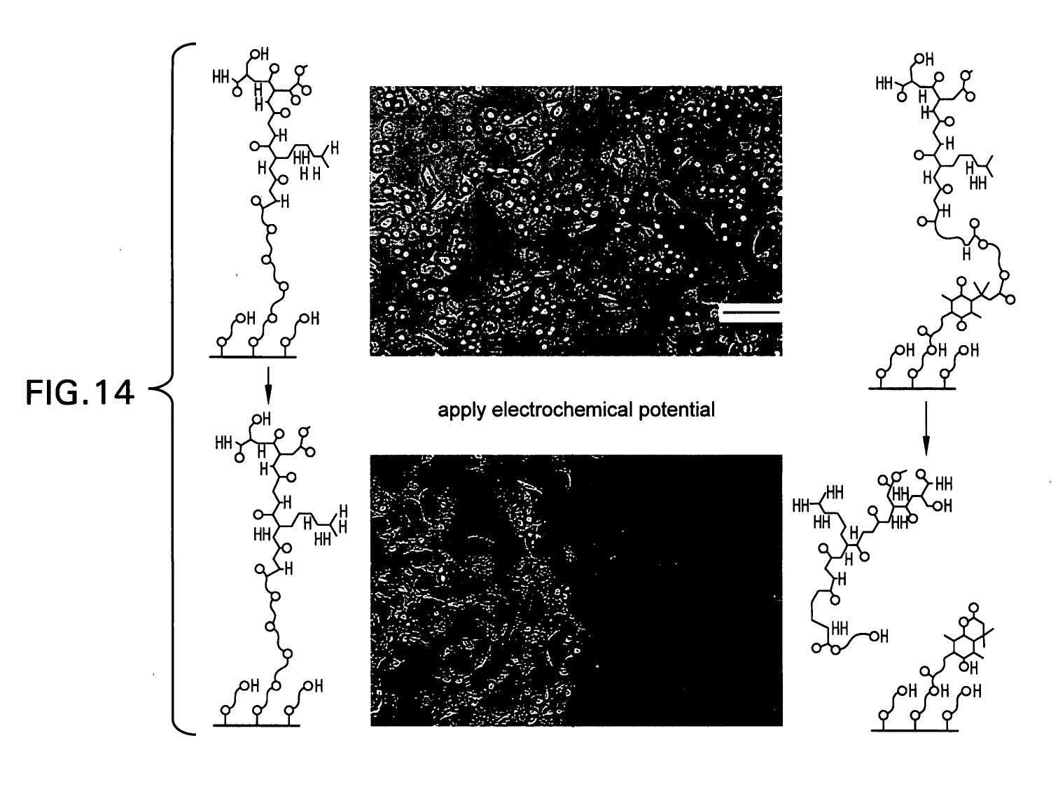

In a preferred embodiment of the present invention, the self-assembled monolayers are modified to have “switchable surfaces.” For example, self-assembled monolayers can be designed with a “head group” that will capture a desired molecule. The head group is then subsequently modified at a desired point in time to release the captured molecule. In a preferred embodiment of the present invention, the head group is modified such that after release of the captured cell, the head group no longer will attract and attach subsequent cells. This release is important to allow the patterned cells to migrate. If a self-assembled monolayer did not have a “switchable” head group, the migration of the cell may be hindered. An example of a “switchable” control is depicted in FIG. 14. This figure depicts a particular peptide-presenting compound that allows cells to attach to itself. Upon application of an electrical potential, the peptide presenting compound is cleaved causing the release of cells from the support. Importantly, the portion of the peptide presenting compound that remains after application of the electrical potential is unable to bind cells, and thus eliminates the potential for non-specific cell binding.

It is also often desirable to utilize a bioinert support material to resist non-specific adsorption of cells, proteins, or any other biological material. The most successful method to confer this resistance to the adsorption of protein has been to coat the surface with poly(ethylene glycol) PEG. A variety of methods, including adsorption, covalent immobilization, and radiation cross-linking, have been used to modify surfaces with PEG. Polymers that comprise carbohydrate units also passivate surface, but these material are less stable and less effective than PEG. A widely used strategy is to preadsorb a protein—usually bovine serum albumin—that resists adsorption of other proteins. In addition, self-assembled monolayers that are prepared from alkanethiols terminated in short oligomers of the ethylene glycol group [HS(CH₂₎₁₁(OCH₂CH₂), OH:n=2-7] resist the adsorption of several model proteins. Even self-assembled monolayers that contain as much as 50% methyl-terminated alkanethiolates, if mixed with oligo(ethylene glycol)-terminated alkanethiolates, resist the adsorption of protein. Further, self-assembled monolayers that are terminated in oligo(ethylene glycol) groups may have broad usefulness as inert supports, because a variety of reactive groups can be incorporated in self-assembled monolayers in controlled environments.

In contrast to using a bioinert treatment or support material, by choosing an appropriate support or treatment, the surface can be modified to have any desired functionality. For example, the support can be treated to have immobilized biomolecules such as other cells, DNA/RNA, chemicals, or other biological or chemical entity. For example, the attachment and spreading of anchorage dependent cells to surfaces are mediated by proteins of the extracellular matrix, e.g. fibronectin, laminin, vitronectin, and collagen. A common strategy for controlling the attachment of cells to a surface therefore relies on controlling the adsorption of matrix proteins to the surface. Therefore, a preferred coating 220 includes extracellular matrix proteins, or hydrogels, including matrigel, or other coatings that mimic the extracellular matrix.

In another example, the coating comprises an immobilized entity that may or may not affect the behavior of the cell migration or motility, such as drugs, toxins, metabolites, test agents, etc. After placing the cells into the orifices of the first layer 150, the cells settle onto the surface of the support and are thus affected by the immobilized entity.

In yet another preferred embodiment, coating 220 may comprise coatings that provide a more in vivo-like environment for the arrayed cells. Since cells in vivo are usually in contact with other cell types, and since it has been observed that cell to cell contact effects the behavior of cells, a preferred coating 220 also comprises a secondary cell type to that of the primary cells to be arrayed. For example, cancer cells are surrounded by stromal cells. Thus, to more accurately correlate the migration or movement of cancer cells in vitro with what occurs in vivo, it is desirable to provide a coating 220 of stromal cells before patterning the cancer cells onto the coating. The growing of two different cell types together has been coined “co-culture” by those skilled in the art. Some commonly known co-cultures include hepatocytes/fibroblasts; astrocytes/dendrocytes; endothelial cells/leukocytes; and neural cells/glial cells. The present invention contemplate employing co-culture systems by providing a coating of one cell type and then arraying the second type onto the cellular coated support.

In yet another embodiment of the present invention, the support 140 may have a surface treatment in the form of “physical” modifications, such as striations, grooves, channels and indentations to effect cell motility and migration.

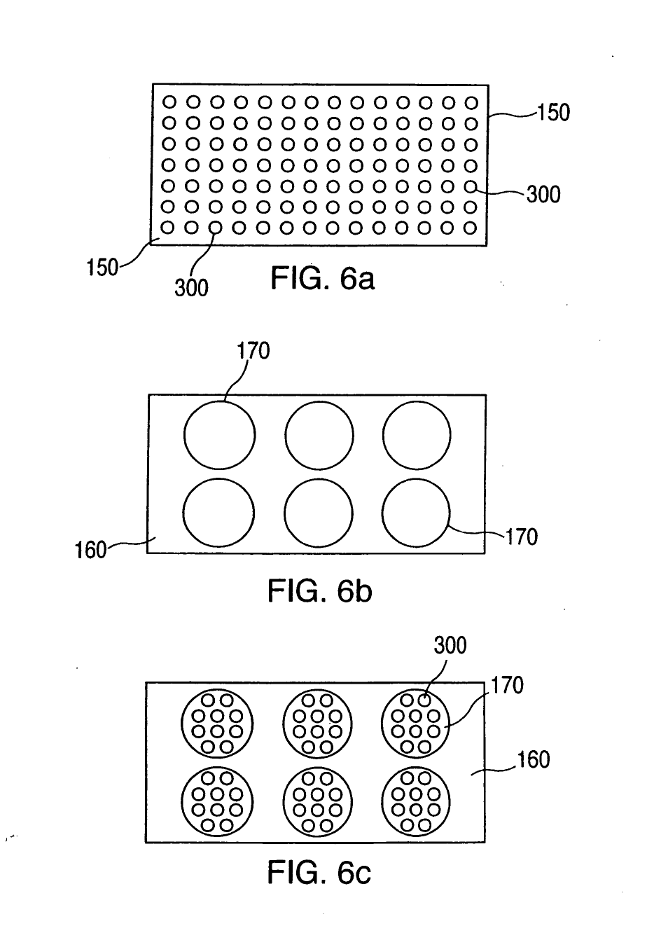

The cell migration assay plate of the present invention allows for a broad range of patterns to be applied. For example, the entire support may define a pattern that is uniformly distributed across the support. FIG. 6(a) depicts one embodiment of the present invention wherein the first layer 150 has a plurality of micro-orifices uniformly distributed across the first layer 150. When the second layer 160 of FIG. 6(b) is placed onto the first layer 150 shown in FIG. 6(a), the arrangement of micro-wells 300 with macro-wells 170 as shown in FIG. 6(c) is created.

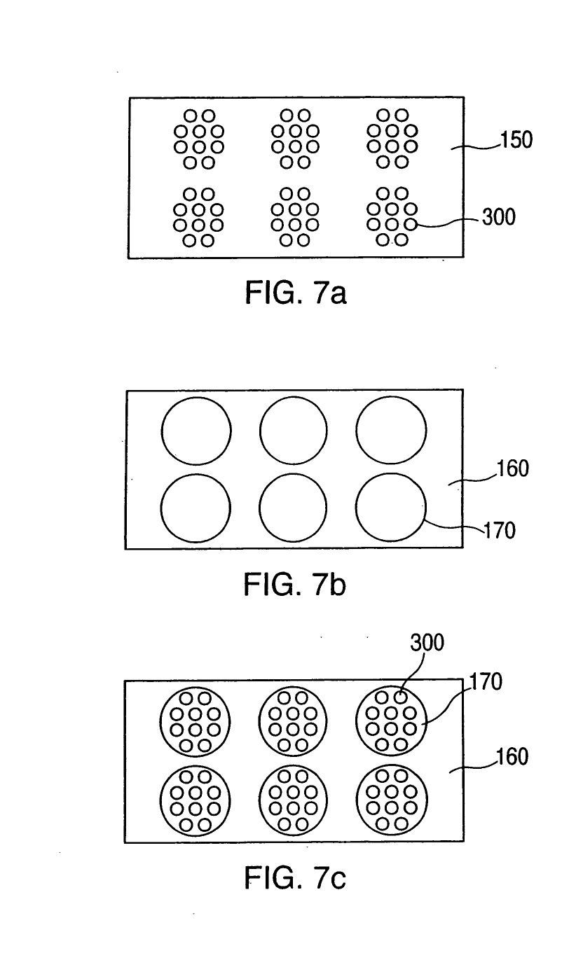

FIG. 7(a) depicts another embodiment of the present invention, in which the support 140 is configured by arraying the micro-orifices 300 of the first layer 150 into discrete geometric patterns. When the second layer 160 of FIG. 7(b) is then placed onto the first layer 150 shown in FIG. 7(a), the arrangement of micro-wells 300 with macro-wells 170 as shown in FIG. 7(c) is created. These discrete areas preferably have the same size and pitch of standard micro-titer plates. The discrete areas may contain any desired number of individual patterned cells. For illustration purposes, FIG. 7(a) depicts the first layer 150 having 6 discrete geometric patterns, each pattern occupying a corresponding area of the first layer 150. Within each of these 6 discrete areas are 10 micro-orifices. After applying cells to the support 140 through the micro-orifices 300, the resulting patterned support 140 will define six macro-regions, each of these macro-regions defining ten micro-regions of patterned cells. Each micro-region may contain one cell or a plurality of cells.

The description of the embodiment of the present invention set forth above with respect to FIGS. 7(a)-7(c) demonstrates the flexibility of the cell migration assay plate of the present invention. By varying the number, size, and pitch of the micro-orifices 300 of the first layer 150 and/or macro-orifices 170 of the second layer 160 of assay plate 100, any desired configuration or pattern of cells can be achieved. According to the present invention, any number of macro-wells 151 could be defined by an assay plate, and in addition, each macro-well could circumscribe any number of micro-wells 141 to create a desired geometric pattern. As previously mentioned, preferred embodiments of the present invention have discrete areas that match the number, size and pitch of the footprint of standard micro-titer plates used in the industry. For example, one preferred embodiment comprises a second layer 160 having 96 discrete macro-orifices 170 that match the footprint of a 96-well micro-titer plate. Arranged on the first layer 150 so as to be situated within each one of the 96 discrete macro-orifices 170 are, for instance, 100 micro-orifices 300 configured to receive solutions of cells. The resulting arrayed support 140 has 96 areas, each having 100 separate micro-regions of cell(s).

In another embodiment of the cell migration assay plate of the present invention, there are means for aligning the layers of the device. For instance, in order to align the micro-orifices 300 of the first layer 150 with the macro-orifices 170 of the second layer 160, the first layer 150 may need to be aligned precisely on the second layer 160. FIG. 3(a) depicts physical aligning means 190 and visual aligning means 192, one or both of which may be employed in the present invention. Physical aligning means 190 may comprise protrusions, pins, prongs, or the like that extend from the support. In one embodiment of the present invention, physical aligning means 190 are prongs that protrude from the support 140 and extend through guidance orifices 194 in layers placed thereon. An example of guidance orifices 194 is shown in FIG. 4(a). In another embodiment, the support 140 has a raised outer frame or ridge comprising a wall made of rigid material on the perimeter edge of the support 140, such as wall 196 illustrated in FIG. 3(a). The spatial constraints of the frame or wall 196 guide layers placed thereon into the correct position. The visual means 192 may include markings on the support 140 and/or on other layers to guide the placement of each additional layer on top of the next layer. Visual aligning means 192 include, but are not limited to, markings such as dots or cross hatches.

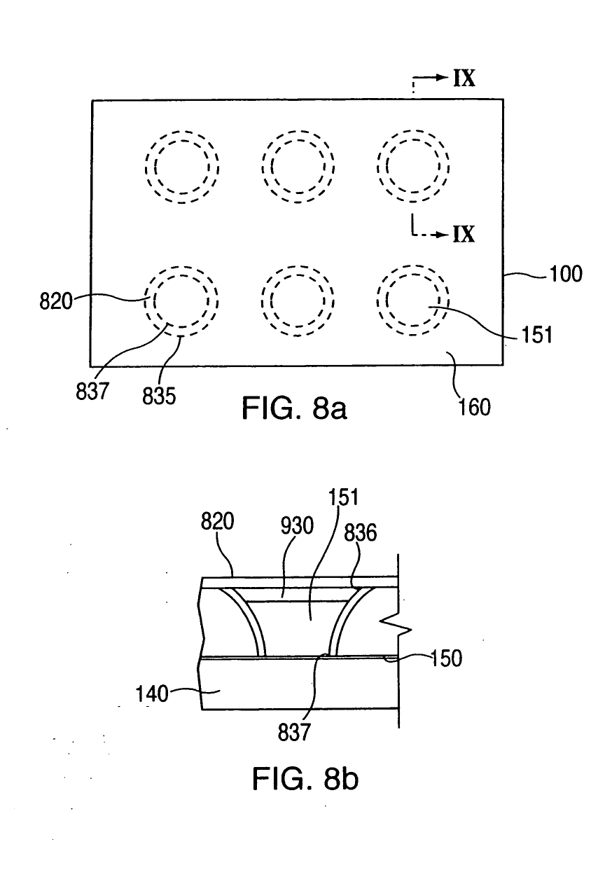

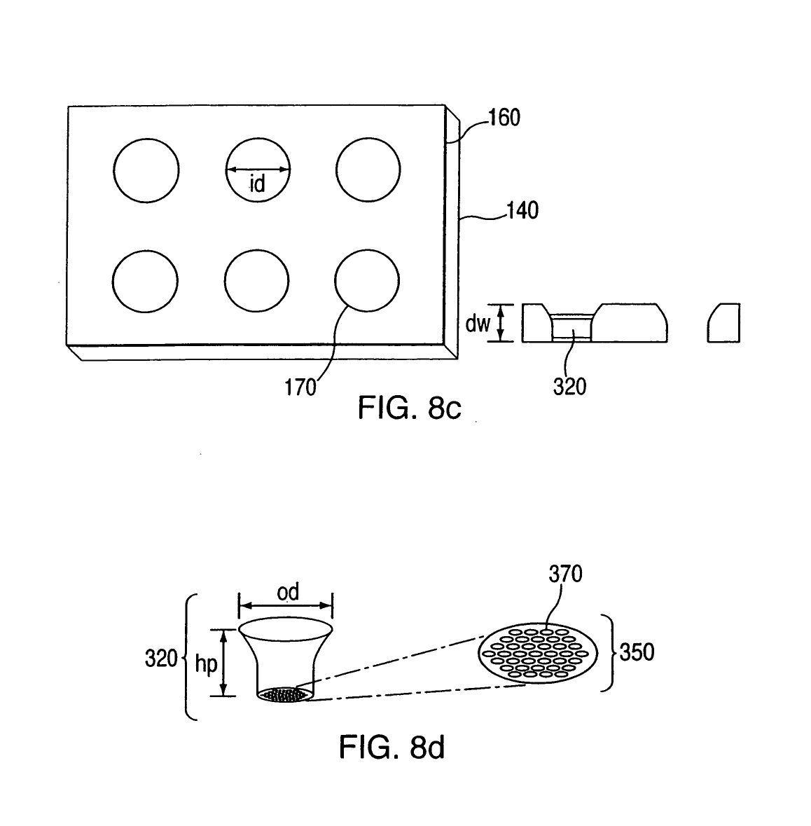

FIG. 8(a) is a top plan view of a cell migration assay plate 100 in accordance with still another alternative embodiment of the present invention. In this embodiment, rather than being cylindrically shaped, the macro-wells 151 are funnel-shaped. Moreover, rather than being open and exposed to the atmosphere, the macro-wells 151 in this embodiment are shown as being capped with a cap 820. The cap 820 may comprise one or more materials configured to conform to at least in part an upper surface of the second layer 160 and sealably engage itself with the openings of the macro-wells 151. In the embodiment of the present invention shown in FIG. 8(b), cap 820 includes a seal 930 made of a first material that acts as a plug with respect to the macro-well 151, and a continuous covering layer 835 made of a second material and extending across an upper surface of the second layer 160. The cap 820 may be useful for preventing evaporation of assay solutions that may be placed into the macro-wells 151 and/or during the storage and transport of the cell migration assay plate.

FIG. 8(a) and 8(b) also depict a lining 835 that may be used to form and line each macro-well 151 of the cell migration assay plate 100. This lining, which has a top edge 836 and bottom edge 837, may be made from a material different from the material of the cell migration assay plate 100 in order to provide the macro-wells 151 with properties other than those attributable to the cell migration assay plate 100 material. Moreover, the lining 835 may also be used to form the cell migration assay plate 100 during its manufacture by positioning the linings in space and then by pouring the material of the cell migration assay plate material around them.

The funnel shape of the linings 835 and of their corresponding macro-wells 151 is seen in FIG. 8(b). The first layer 150, support 140, cap 820, seal 930, top edge 836, and bottom edge 837 can also be seen in this figure. Moreover, as is also seen in FIG. 8(b), the linings 835 define and form the shape of the macro-wells 151 and sealably engage the first layer 150 located on top of the support 140.

FIGS. 8(c) and 8(d) depict another embodiment of a cell migration assay plate 100 comprising plugs 320. In the shown embodiment, a second layer 160 defining macro-orifices 170 is placed onto a support 140. According to one embodiment of the invention, plugs 320 having an outside diameter “OD” smaller than an inner diameter “ID” of a macro-well 151 is configured for insertion into each macro-orifice 170. In the embodiment shown, the height of the plug, designated as “HP,” is shorter than the depth of the second layer corresponding to a depth of the macro-well 151 and, designated as “DW,” so as to enable test substances to be added at a subsequent time into the openings of the macro-orifices 170. Each of these plugs 320 has a membrane 350 at a bottom surface thereof, membrane 350 defining micro-regions 370 of cells in a defined geometric pattern. Plugs 320 are preferably dimensioned so as to be insertable into respective macro-wells 151 of the assay plate 100.

In another embodiment of the cell migration assay plate according to the present invention, cap 185 (not shown) is placed on top of the second layer 160. Cap 185 may be composed of rigid or flexible materials, described previously. Cap 185 is useful for preventing evaporation of assay solutions that will be placed onto the device through the macro-orifices 170.

Fabrication of the Qualitative Cell Migration Assay Plate

The cell migration assay plate according to the present invention having a first layer 150 and a second layer 160 may be manufactured according to the present invention by two methods: a single-piece fabrication method on the one hand, and a two-piece fabrication on the other hand, as will be described further below. It is understood, however, that the present invention includes within its scope other methods for manufacturing the assay plate according to the present invention that would be within the knowledge of a person skilled in the art.

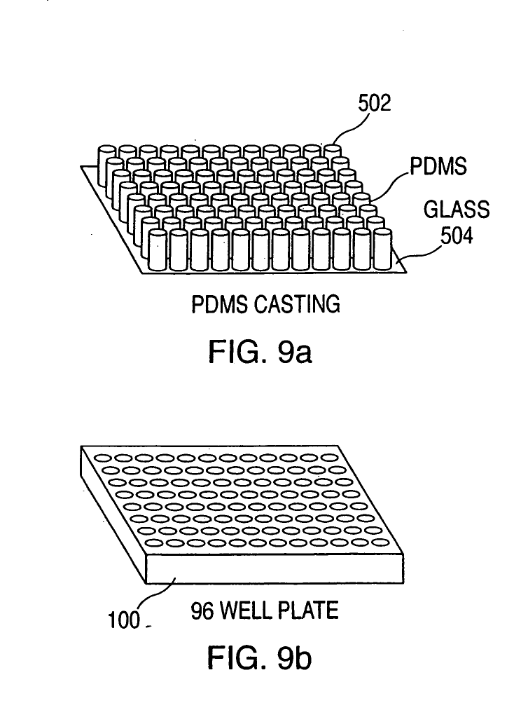

By forming the cell migration assay plate of the present invention in a single sequence of pouring, degassing, and curing, the manufacturing cycle time is reduced and a seal between the first layer and the second layer of the device is improved. The main advantage of this method is that it requires no manual handling of a preferred material (a thin PDMS membrane). According to various embodiments of the invention, a single-piece fabrication method may be employed wherein the device is formed on an original silicone/photoresist membrane master. FIG. 9(a) depicts a device comprising a silanized array of PDMS macrocosms 502 to form the macro-orifices in the second layer. These macrocosms 502 are formed by casting PDMS against a standard micro-titer plate 100 as shown in FIG. 9(b), such as a 96-well micro-titer plate, for example, and by sealing the resulting structure to a glass slide 504.

The use of PDMS macrocosms 502 provides a convenient method for fabricating the patterning layers. Silanization of PDMS using a perfluorosilane renders its surface resistant to lesion by the PDMS precursor and eliminates cross-linking of PDMS into the posts. The macrocosms are preferably prepared using PDMS, but many other materials may be used, such as Teflon, metal (e.g., aluminum), and other polymers. As previously mentioned, a 96-well plates may be used as a master, though lower and higher densities based on 12, 24, 384 and 1586 well configurations may also be used. The standard micro-titer plate footprints are preferred because many detection schemes have been developed for the same. After the PDMS macrocosms 502 are oxidized in air plasma (1 minute at 300 mTorr, 6 watts), they are silanized by immersion in a fluorosilane solution (1% by volume in methanol).

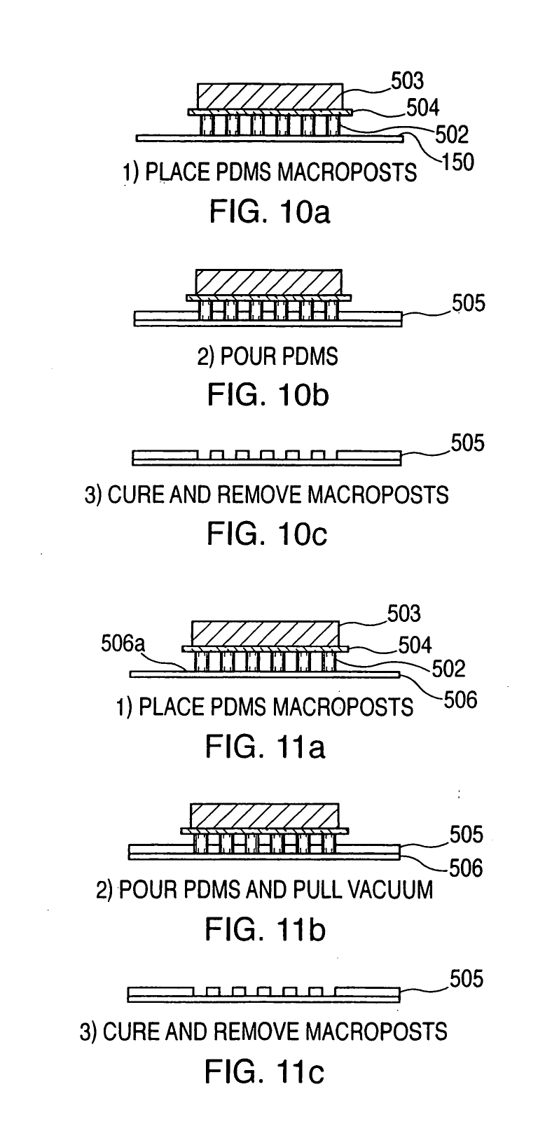

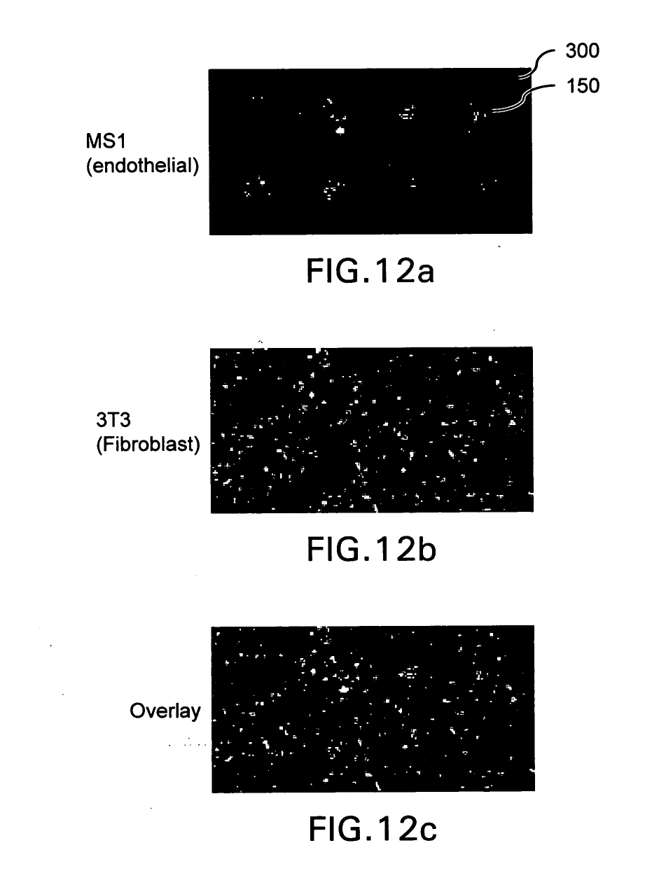

FIGS. 10(a) through 10(c) illustrate schematically respective stages corresponding to one embodiment of a method according to the present invention in which the first layer and the second layer of an embodiment of the assay plate of the present invention may be fabricated using the macrocosms 502 as previously described. Although the following description is with respect to the embodiments of the assay plate of FIGS. 1(a)-7(c), it is understood that the methods described with respect to FIGS. 10(a)-11(c) and with respect to cell patterning are equally applicable to other embodiments of the assay plate of the present invention. Prior to the performance of the step shown in FIG. 10(a), a PDMS precursor is spin-coated onto a pattern of photoresist posts arranged in an array of any desired shape, diameter and pitch in order to produce a first layer, such as first layer 150. A preferred array has 100 μm-diameter posts in a 3″×3″ array (200 μm center-to-center period). The first layer 150 is then cured on the master. Next, as is shown in FIG. 10(a), the silanized macrocosms 502 are placed on top of the membrane and a weight 503 (approximately 500-1000 g) is placed onto the glass backing 504. The macrocosms 502 seal against the first layer 150, i.e., the PDMS membrane. As shown in FIG. 10(b), PDMS prepolymer 505 is poured onto the first layer 150, and flows around the macrocosms 502 and forms a thick (˜5 mm) plate 505 on top of the first layer 150. As shown in FIG. 10(c), after curing the PDMS, the weight 503 and the macrocosms 502 are removed, and the resulting first layer 150 and second layer 160 together can be peeled off the master more easily and reproducibly than the first layer 150 alone.

FIGS. 11(a) through 11(c) illustrate schematically respective stages corresponding to another embodiment of a method of the present invention according to which the first layer and the second layer of an embodiment of the assay plate of the present invention may be fabricated using the macrocosms 502 as previously described. The shown method, contrary to that of FIGS. 10(a)-10(c), does not incorporate a spin-coating step. Instead, the first layer, such as first layer 150, and the second layer, such as second layer 160, are formed and cured simultaneously. Here, as shown in FIG. 11(a), the macrocosms 502 are placed directly onto a silicon wafer 506 patterned with photoresist posts 506a. Then, as shown in FIG. 11(b), a PDMS precursor is poured onto the silicon wafer 506. Then, as shown in FIG. 11(c), a vacuum is applied to the device so as to remove any air trapped under the macrocosms and to urge the PDMS to fill the spaces between the photoresist posts 506a and between the macro-posts 502.

An alternative fabrication method (not shown) involves the separate formation of the second layer, such as second layer 160, and the first layer, such as first layer 150, followed by the assembly, via adhesion, of the layers. This method is advantageous as it lends itself well to high throughput—the first layer and the second layer are relatively straightforward to make using conventional processes such as spin-coating and molding. After the first layer and the second layer are made, they are aligned and bonded together. Care must be taken when handling the thin membrane component.

The assembly of the two layers 150 and 160 may be accomplished using one of multiple methods, for instance plasma oxidation, using an adhesive layer, using double sided tape or using mechanical methods. When an adhesive layer is used, a PDMS precursor may be used to bond the two layers. This precursor may be crosslinked either thermally or photochemically. Additionally, any other “glue” that can adhere to the PDMS surface may be used. The present invention also contemplates that double-sided adhesive tapes that can adhere strongly to the surface of PDMS can be used. In various other embodiments, mechanical methods may also be employed. In some applications, mechanical pressure may be maintained on the layers throughout the course of an experiment. Because PDMS can deform under pressure and act as a “gasket,” mechanical sealing is a practical solution to assembling the components. One of the advantages to using mechanical methods over glues and tapes is that the assembled structure may be disassembled quickly without resulting in any damage to the device or the patterned material.

The present invention is also directed to methods of patterning cells using the cell migration assay plate of the present invention. In a preferred method of patterning cells according to the present invention, a first layer, such as first layer 150, is placed on a support 140, and the second layer, such as second layer 160, is placed on top of the first layer. The positioning of the macro-orifices 170 over the micro-orifices 300 may be assisted by the use of an alignment means as discussed above. In one embodiment, cells are patterned through the first layer 150 and allowed to settle and are applied to the support 140 to create an arrayed support 140 having micro-regions of adhered cells. Each micro-orifice 300 can receive the same cell containing solution or a different cell containing solution. The first layer 150 may then be removed. In this embodiment, it is preferred that the first layer 150 is coated with BSA or other cytophobic materials to resist cellular attachment. The second layer 160 is then aligned over the arrayed support 140. The macro-orifices 170 define macro-wells 151 encompassing a plurality of micro-regions of cells. Test agents can then be added through the macro-wells 151 to contact the micro-regions of arrayed cells. Each macro-well 151 can receive the same or a different test agent.

In an alternate embodiment, the first layer 150 is placed on the support 140, and the second layer 160 is placed on top of the first layer 150. The positioning of the macro-orifices over the micro-orifices 300 may be assisted by the use of an alignment means as discussed above. Cells of a first type are patterned through the first layer 150 and are applied to the support 140 in a pattern to create micro-regions of adhered cells. The first layer 150 is removed. The second layer 160 is then mated to the support. The second layer 160 has macro-wells 151 that encompass a plurality of micro-regions of the first cell type. A solution having cells of a second type is then placed into each of the macro-wells 151 to fill in around the micro-regions of the first cell type. The cells are allowed to attach to the support. Test agents then may be added into the macro-wells to contact the cells on the support 140. Each macro-well 151 can receive the same or a different test agent. FIG. 12(a) depicts a first cell type, e.g., MS1 (endothelial cancer cells), patterned into micro-orifices 300 of the first layer 150. After removal of the first layer 150, a second type of cells, e.g., 3T3 normal fibroblast cells, as shown in FIG. 12(b) is arrayed around the first cell type to create an overlayed arrangement as shown in FIG. 12(c). The method illustrated in FIGS. 12(a)-(c) is commonly referred to as resulting in a “co-culture.”

In another embodiment, both the first layer 150 and the second layer 160 are brought into contact with each other and are placed on top of the support 140. The cells are patterned through the macro-wells 151 of the second layer 160 and through the micro-orifices 300 of the first layer 150 to contact and attach to the underlying support 140. The resulting patterned support 140 has micro-regions of attached cells. Test agents are then added to the macro-wells 151 to contact the patterned cells. Each macro-well 151 can receive the same or a different test agent. In another embodiment, discussed previously above, the support 140 is first coated with a coating 220 before the first layer 150 is mated to the support and before the micro-orifices receive a solution of cells.

Because the cells are patterned in predetermined arrays by their placement through the micro-orifices 300 of the first layer 150, the exact positions of the cells are known and identifiable. The effects on movement or migration of the arrayed cells can be studied more precisely by measuring the movement or lack of movement of the cells away from their starting positions. In addition, since the arraying is brought about by the constraints of the micro-orifices 300 of the first layer 150, the precise pattern can be duplicated across the support in the areas encompassed by each of the plurality of macro-wells 151 by having the same geometric pattern of micro-orifices 300 in each macro-well 151. This reproducibility of cellular patterns on a support 140 provides for a quick and reliable comparison of cellular movement of the cells in each macro-well 151 against other macro-wells 151. Furthermore, within each macro-well 151, each micro-region of cell(s) is illustrative of the other micro-regions within that macro-well 151. For example, because each of the micro-orifices 300 can be fabricated to be of the same size and shape, and the same amount of cell(s) can added to each micro-orifice 300, one can observe a micro-region of cells patterned by a first micro-orifice 300 at a first time point and later observe a second micro-region of cells patterned by a second micro-orifice 300 at a second time point and compare the observations recorded at the two time points. Since the cell(s) in each of the micro-orifices 300 were exposed to the same conditions, and were patterned by identical micro-orifices 300, one need not go back to the previously observed micro-region 300 over the time course of the assay.

Further, having cells patterned in identical predetermined starting positions in each macro-well 151, the effects of a first test agent on a cell population in a first macro-well 151 can more accurately be compared to effects of a second test agent on a cell population in a second macro-well 151.

The flexibility of the cell migration assay plate of the present invention and the flexibility in the methods of patterning cells using the cell migration assay plate of the present invention provide for numerous cell migration assay configurations. A virtually unlimited amount of configurations can be achieved simply by choosing various dimensions, numbers, shapes and pitch of micro-orifices 300 and macro-orifices 170, as well as by modifying the coating 220 on the support 140.

Using the cell migration system and the cell migration assay plate of the present invention, novel cell migration assays can be performed. These assays measure the migration or motility of patterned cells. Since the present invention provides for patterning cells in discrete arrays, the measurement of cell movement/migration is more accurate as it measures motility or migration away from a predetermined starting position created by the micro-orifices of the first layer. In addition, the cell migration/motility assays of the present invention provide for ongoing/real-time monitoring of the cells as the cells can be visualized through light or fluorescent microscopy and need not be stained and fixed for counting as previously required by the Boyden chambers. The present invention contemplates the monitoring and observation of cellular movement or migration of numerous cell types, which will provide much needed information about processes in the body that occur as a result of cell movement.

Cellular movement is implicated in numerous systems and responses in the body. For example, leukocyte movement is involved in inflammatory and immune responses. Leukocyte cell classes that participate in cellular immune responses include lymphocytes, monocytes, neutrophils, eosinophils, and mast cells. Leukocytes accumulate at a site of inflammation and release their granular contents such as various hydrolytic enzymes an other toxic components into the extracellular spaces. As a result, the surrounding tissue is damaged. Numerous chronic inflammatory disease are thought to involve the aberrant presence of leukocytes in tissues. Infiltration of these cells is responsible for a wide range of chronic inflammatory and autoimmune diseases, and also organ transplant rejection. These diseases include rheumatoid arthritis, psoriasis contact dermatitis, inflammatory bowel disease, multiple sclerosis, atherosclerosis, sarcoidosis, idiopathic pulmonary fibrobsis, allograft rejection and graft-versus-host disease, to name a few.

In another process of the body, cancer cells break off from a tumor and metastasize to other parts of the body. Thus, cell migration assays that provide a reliable study on the ability of potential drug candidates to inhibit cancer cell growth and/or metastasis would provide valuable information to the field of oncology.

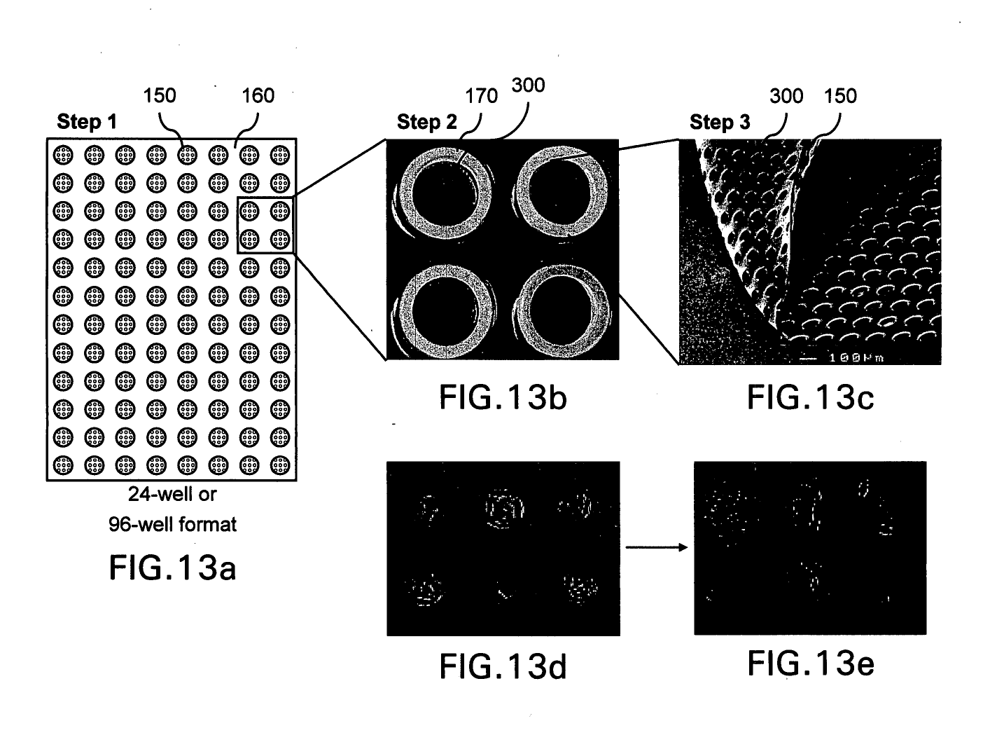

In one embodiment of the cell migration/motility assay of the present invention, cells are first allowed to migrate through the micro-orifices 300 of the first layer 150 onto the support 140 to produce an arrayed support 140. The cells are allowed to attach and grow to confluence within the micro-orifices 300. The first layer 150 is then removed. The second layer 160 is placed on top of the arrayed support 140 to form macro-wells 151 encompassing areas of patterned cells. A test solution is added through the macro-orifices 170 of the second layer 160 and allowed to contact the arrayed cells. The effects of this test solution on cell movement or migration is then observed. FIGS. 13(a) through 13(c) illustrate the stages according to the above embodiment of the assay of the present invention. FIG. 13(a) illustrates a second layer 160 sealed to a first layer 150. FIG. 13(b) illustrates cells that have been patterned through the first and second layers 150 and 160 onto the support 140 and are allowed to grow to confluence within the micro-orifices 300. An example of this is shown in FIG. 13(d). As shown in FIG. 13(c), the first layer 150 is then removed, and the cells arrayed on the support 140 are permitted to migrate, an example of which is shown in FIG. 13(e). The observation can be performed using any method known in the art, including but not limited to light microscopy and fluorescent microscopy.

In another embodiment of the cell migration/motility assay of the present invention used in conjunction with embodiments shown in FIGS. 1(a)-7(c), the support 140 is treated directly with test agents or coated with a membrane having test agents coated thereon. The agents are then tested to determine whether they exert any chemotactic effect. In such a scenario, the micro-orifices 300 of the first layer 150 are smaller in diameter than the size of an individual cell to be plated. The cells are plated and allowed to squeeze through pre-defined arrays of micro-orifices 300 in response to the chemotactic agent on the support 140. The support 140 or the membrane is then observed for the cells. Since the micro-orifices 300 are designed in a pre-determined geometric pattern, the analysis and determination of cell migration through the first layer 150 onto the support results from a quick visual inspection of the support 140 for cells. For example, if the micro-orifices are arrayed in a 10×10 pattern (for a total of 100 cells), a quick visual review of the support or membrane would inform the scientist what percentage of cells migrated through the microorifices. A high percentage of cells migrating corresponds to a strong chemotactic substance and a low percentage corresponds to a weak chemoattractant. In contrast to transwell chemotactic assays that involve establishing a top and bottom base line, no base line measurements are needed for the above assay to analyze the strength or weakness of a chemotactic substance.

In another embodiment of the cell migration/motility assay of the present invention, the support, such as support 140, is first coated with a coating 220 such as extracellular matrix proteins or matrigel (not shown). Cells are then plated onto the coated support. The migration or movement of the cells through the matrigel is observed. In still another embodiment of the assay of the present invention, the matrigel can contain test agents.

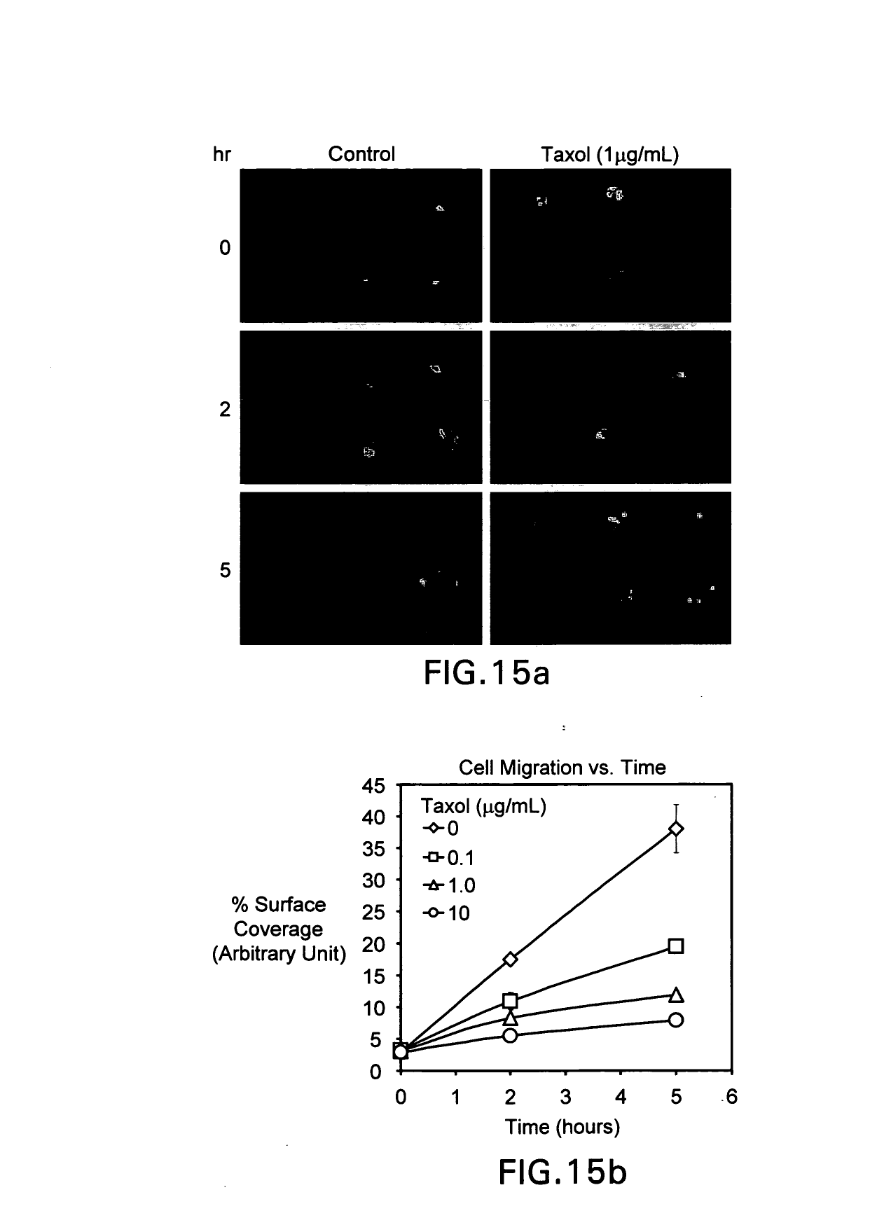

The cell migration/motility assay of the present invention allows one to study the effect of test agents and others both on cell motility and on cell shape. For example, cells may be patterned through micro-orifices, such as micro-orifices 300, of the first layer 150. The cells are allowed to attach to the support 140 and to grow to confluence. The walls of the micro-orifice 300 constrain the cell(s) and the cells take on the shape of the micro-orifice 300, e.g., circular. A test agent is applied through the micro-orifices 300 and is allowed to contact the cells. The first layer 150 is removed and the cells are observed. If the test agent affects cell movement, the cell will be “stuck” in place as it was patterned and may not change shape, i.e., it will remain circular if the patterning member had circular orifices. On the other hand, if the test agent does not effect cell movement, the cell will move away from its original patterned position and change shape from the patterned circular shape since the constraints of the first layer 150 had been removed. FIG. 15(a) illustrates, in its left column, an example wherein control cells, at various time intervals, e.g., 2 hours and 5 hours, are shown to have migrated away from their original pattern, designated as “hr 0.” In contrast, cells treated with a common cancer drug, taxol, have retained their original circular pattern after these same time intervals, as shown in the right column of FIG. 15(a). FIG. 15(b) is a graph of the effect of various concentrations of taxol on cell movement as performed by a cell migration/motility assay of the present invention.

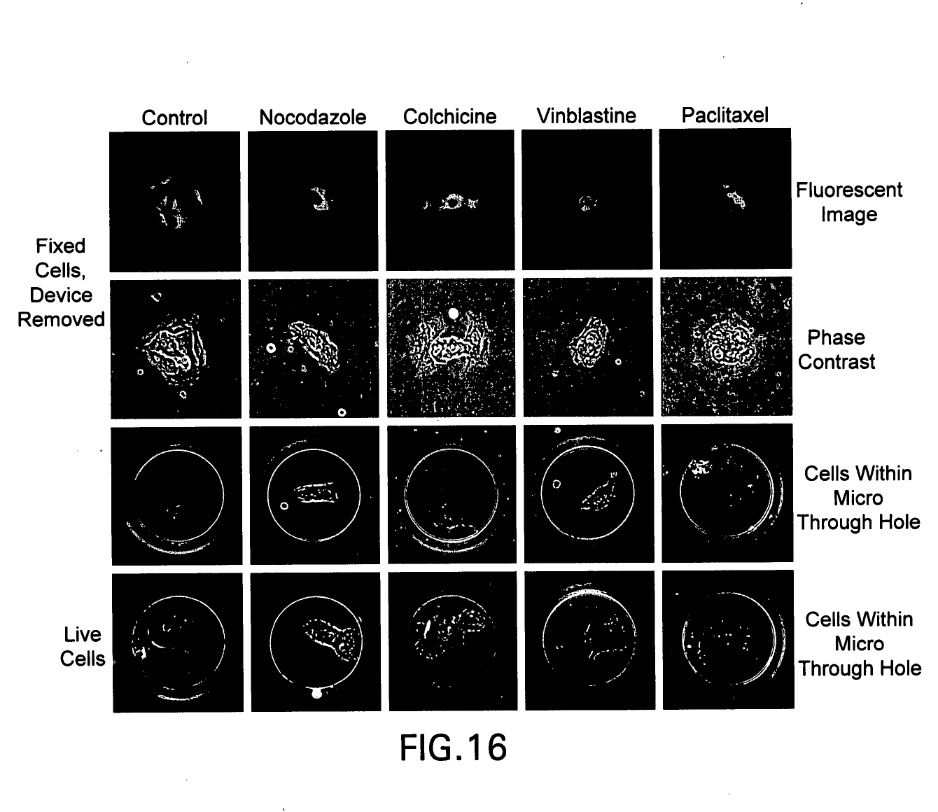

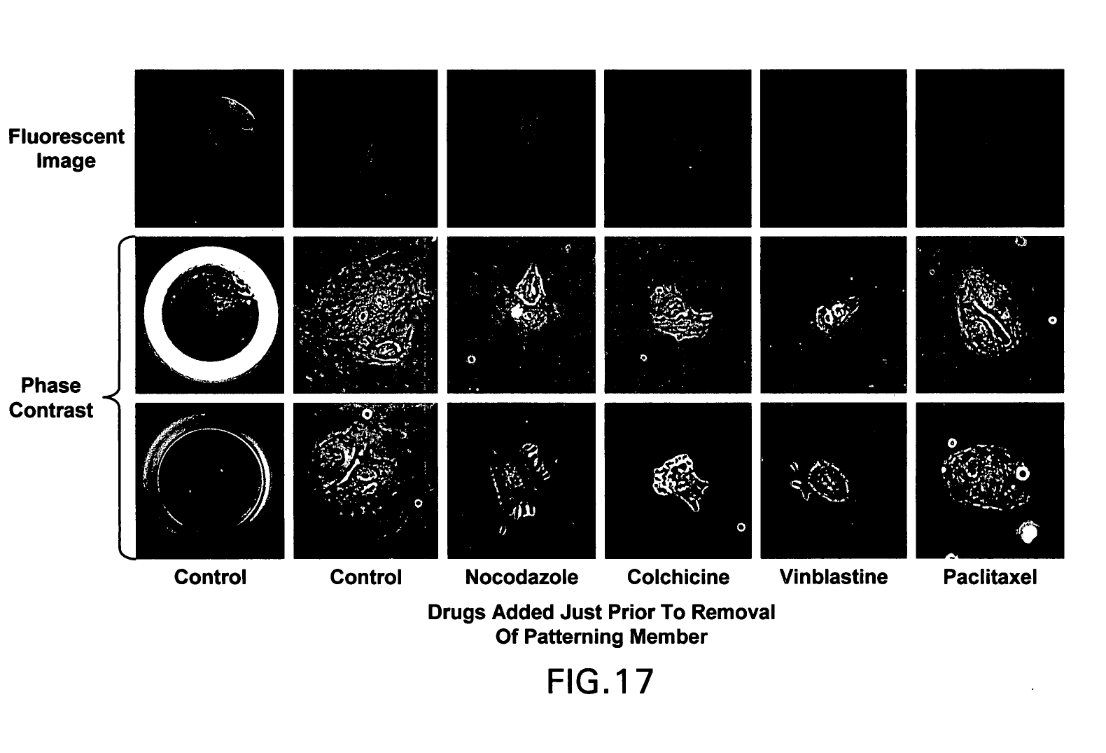

Alternatively, the test agent can be added before the cells have grown to confluency, i.e. the test agent is added to the cells before being patterned through the micro-orifices 300. If the test agent has no effect on cell motility, the cells will spread and achieve the shape of the micro-orifice 300. In FIGS. 16 and 17, a micro-orifice 300 is circular in shape. In the left column of FIGS. 16 and 17 are the control panel, which illustrate the cells having grown to a confluent circular pattern. As shown in the remaining columns, the cells that were treated with various test agents (nocodazole, colchicine, vinblastine, and paclitaxel) had their cellular movement arrested and thus never achieved a circular confluent pattern.

One embodiment of the present invention allows one to study the effect of test agents on cell proliferation as well as cell movement. This is particularly useful in cancer studies where proliferation rates are high. In this embodiment, the cells to be patterned are preferably stained or fluorescently tagged with two different stains or tags: the nuclei are stained with a different dye or fluorescent tag than the rest of the cell (i.e. a cytoplasmic dye or tag). The cells are patterned through the micro-orifices 300 of first layer 150. The cells are allowed to attach to the support 140 and to grow to confluence. A test agent is applied through the micro-orifices 300 and allowed to contact the cells. Alternatively, the test agent is added to the cells before the cells are patterned through the micro-orifices. The first layer 150 is removed. The cells are then observed for migration or movement and/or proliferation. Using two different tags or dyes, allows for the observation and recordation of cell number and increase thereof, and/or cell movement. Using this information in combination allows one to deconvolute the effect of motility from proliferation. That is, when the cells are later observed, having moved away from the original pattern, one can determine whether it is because of cell movement alone, proliferation alone, or the combination of movement and proliferation, by simply counting and comparing the number of nuclei at some later point in time compared to the number of nuclei at the beginning of the assay, i.e. at time zero.

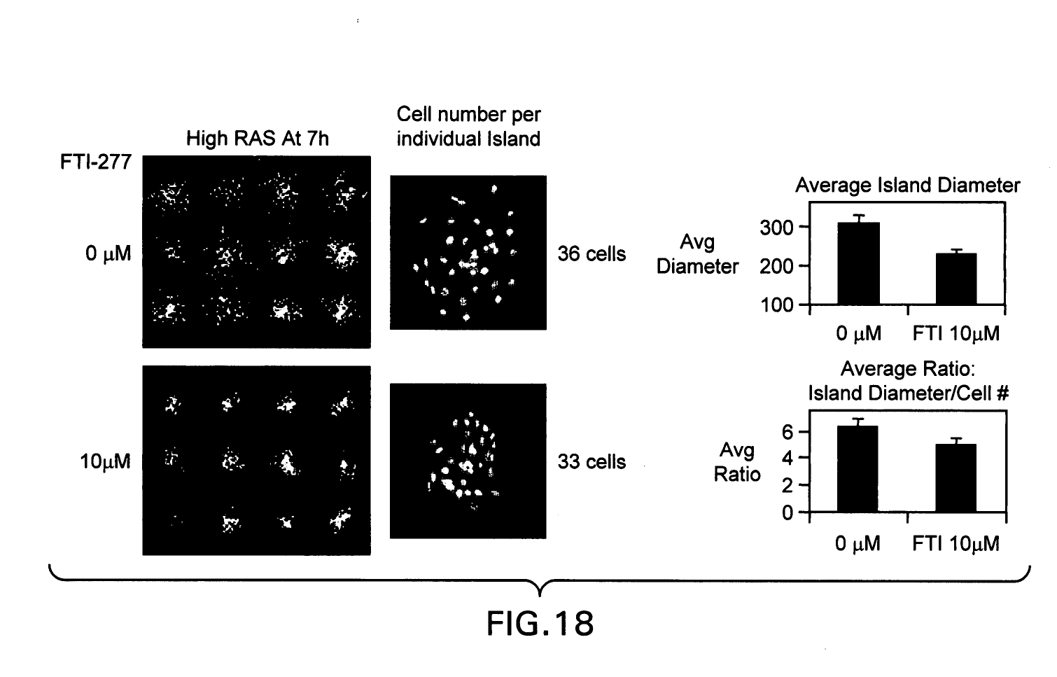

FIG. 18 demonstrates that the assays of the present invention can measure cell movement and are not merely measuring cell division. Over time the cells are seen to spread/move away form their original pattern, but their number remains essentially constant.

The present invention also includes methods of identifying microbes, methods of screening for the activity of drugs, methods for detecting toxic substances and methods for detecting intercellular reactions. In these various methods, solutions or suspensions containing the desired cell affecting agent are flowed in intimate contact with the living cells through the macrowells/macro-orifices. The effect(s) of the cell affecting agent on cell motion or migration is then monitored and measured.

The present invention may be used with a wide variety of prokaryotic and/or eukaryotic cells. Examples of such cells include, but are not limited to, human keratinocytes, murine L fibroblastic cells, canine MDCK epithelial cells, hamster BHK fibroblastic cells, murine CTLL lymphocyte cells, tumor cells and bacteria. In general, any living cells, including transfected cells, that can be successfully patterned may be used. The cells may be labeled with fluorescent markers known in the art, such as fluorescein, to assist in microscopic viewing.

Cell affecting agents can be anything that affects cell motility or migration. Examples of cell affecting agents include, but are not limited to, irritants, drugs, toxins, other cells, receptor ligands, receptor agonists, immunological agents, viruses, pathogens, pyrogens, and hormones. Examples of such cell affecting agents further include irritants such as benzalkonium chloride, propylene glycol, methanol, acetone, sodium dodecyl sulfate, hydrogen peroxide, 1-butanol, ethanol, and dimethylsulfoxide, drugs such as valinomycin, doxorubicin, vincristine, ribavirin, amiloride and theophylline; hormones such at T₃ and T₄, epinephrine and vasopressin; toxins such as cyanide, carbonylcyanide chlorophenylhydiazone, endotoxins and bacterial lipopolysaccharides; immunological agents such as inter-leukin-2, epidermal growth factor and monoclonal antibodies; receptor agonists such as isoproterenol, carbachol, prostaglandin E₁ and atropine; and various other types of cell affecting agents such as phorbol myristate acetate, magnesium chloride, other cells, receptor ligands, viruses, pathogens and pyrogens. In addition, the present invention can also test the synergistic effect that some of the cell affecting agents may have on other agents. In other words, the test agents maybe combined and mixed as necessary to better understand their combined synergistic properties.

In one cell migration/motility assay of the present invention, cells are patterned onto the support 140 through the micro-orifices 300 of the first layer 150. The cells are grown to a certain cell cycle stage and arrested in that stage of cell growth. Test agents are then added to the patterned cells and the effects of the agents are observed and monitored. The same test agent may be applied to the same cells at different life cycle stages and compared against each other to shed light on the effect of the test agent at different points along the cell cycle. In another embodiment, cells are “captured” at a certain cell stage by incubating them elsewhere but capturing them on a support having a coating of a ligand that would “grab” a cellular “tag” such as a protein, that is expressed only at a specific desired cell life cycle (e.g. G1, S, G2, M(standard cell cycle) or S, M(early embryonic cell cycle). In such an embodiment, the coated support would capture only those cells at desired life cycle stage.

In the qualitative cell migration system of the present invention, such as system 190 shown in FIG. 1(a), the observation system 110 and the controller 120 may be used to observe and analyze the real-time movement and behavior of cells as they respond to different and various stimuli. The observation system 110 and controller 120 may provide for real-time observation via a monitor (which is not shown). They may also provide for subsequent playback via a recording system either integrated with these components or coupled to them. In either case, these components may also monitor and analyze the cells as they progress through their reaction to the stimulus. System 190 may include any suitable observation system and controller as would be within the knowledge of a person skilled in the art.

The observation system 110 may include a microscope, high-speed video camera, or high-resolution digital camera, and/or an array of video cameras, and an array of individual sensors. Standard optical microscopy techniques can be used in a parallel setup to quantify the migration. Preferably, an inverted light field phase contrast microscope can be used to view the live cells. The observation system is connected to a controller to receive input for various observation parameters. The data observed by the observation system is sent to the controller for processing in a conventional manner.

Each of these embodiments allow the monitoring of the movement and behavior of the cells before, during, and after the stimuli, reactant or other test compound is introduced. At the same time, the observation system 110 may also generate signals for the controller 120 to interpret and analyze. This analysis can include determining the physical movement of the cells over time as well as their change in shape, activity level or any other observable characteristic. In each instance, the conduct of the cells being studied may be observed in real-time, at a later time or both.

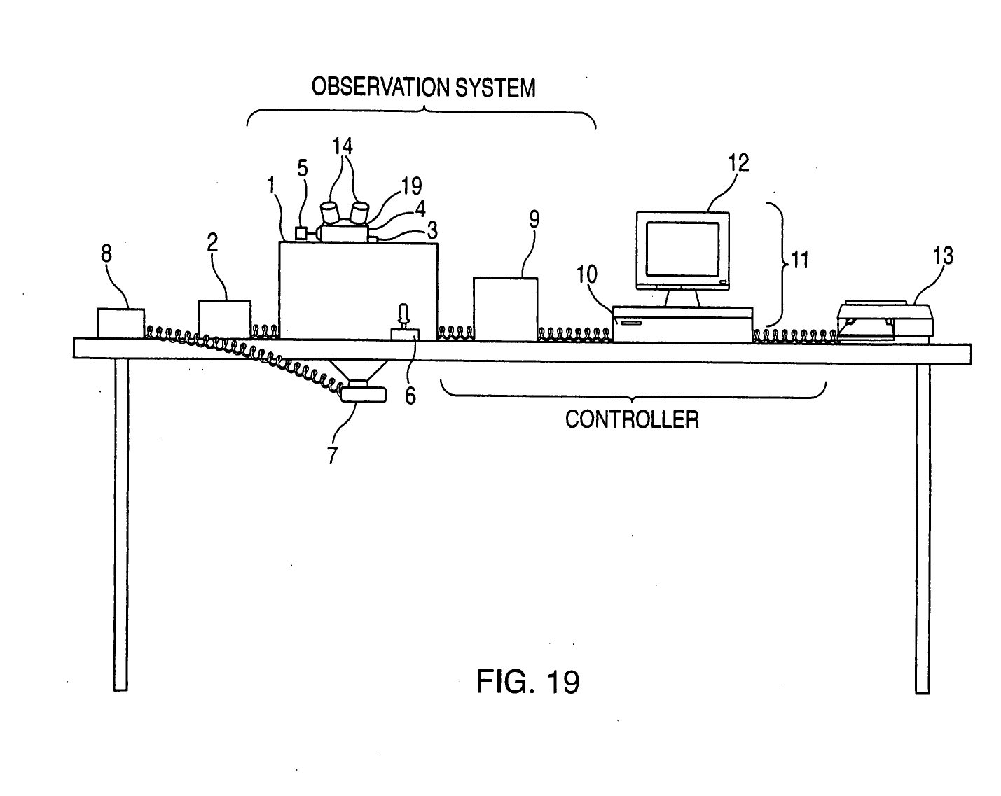

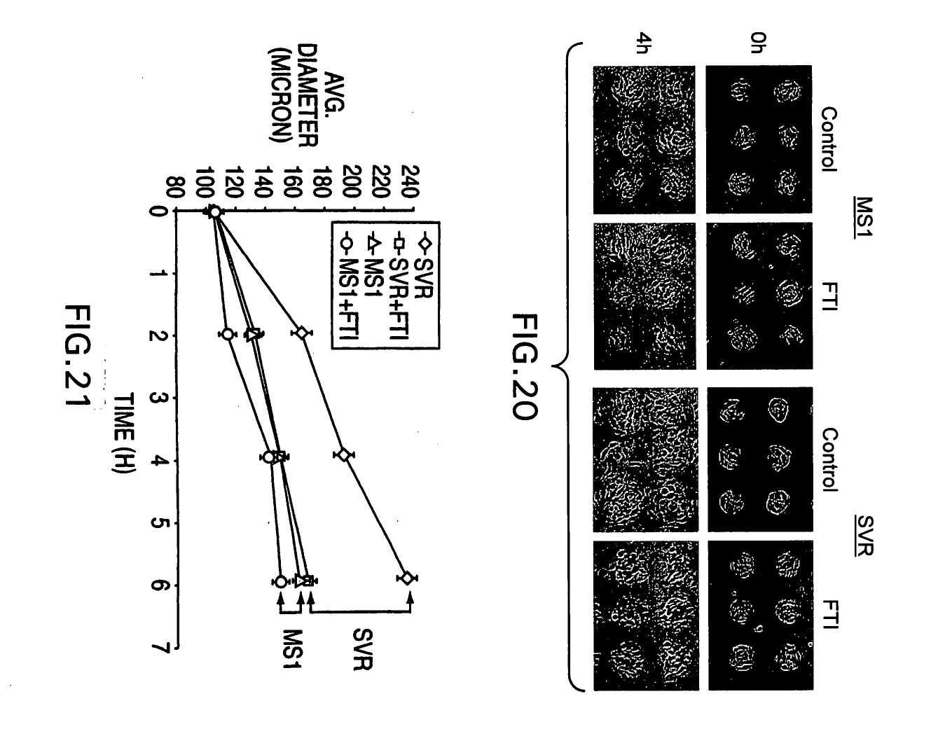

FIG. 19 is a schematic diagram of a system for measuring the migration or motility of cells, in accordance with one embodiment of the present invention. The system may use an inverted microscope 1 as shown in FIG. 19, which uses standard objectives with magnification of 1-100× to the camera, and a white light source (e.g. 100 W mercury-arc lamp or 75W xenon lamp) with power supply 2. In alternate embodiments, the system may use an upright microscope. The system also includes an XY stage 3 to move the qualitative cell migration assay plate 4 in the XY direction over the microscope objective. A Z-axis focus drive 5 moves the objective in the Z direction for focusing. A joystick 6 provides for manual movement of the stage in the XYZ direction. A high resolution digital camera 7 acquires images from each well or location on the qualitative cell migration assay plate 4. A camera power supply 8 provides power to the camera 7. An automation controller 9 controls the automated aspects of the observation system, and is coupled to a central processing unit 10. A PC 11 provides a display 12 and has associated software, as is described briefly below. A printer 13 prints data corresponding to the observed cell migration/motility. Microscope oculars 14 are positioned so as to be looked through by a user of the system.

In a preferred embodiment of the present invention, the observation and control systems may be automated and motorized to acquire images automatically. In one embodiment, at the start of an automated scan, the operator enters assay parameters corresponding to the sample to be observed and to the arrangement of the qualitative cell migration assay plate. Assay parameters can include variables such as cell type, number of cells to be patterned into each micro-orifice, shape and pitch of micro-orifices, shape and pitch of macro-orifices, time periods between each image capture (scan), number of images to capture per macro-well and per scan, etc. Other parameters may include filter settings and fluorescent channels to match biological labels being used, etc. The camera settings may be adjusted to match the sample brightness. These parameters are advantageously stored in the system's database for easy retrieval for each automated run. The user specifies which portion of the assay plate the system will scan and how many fields in each macrowells to analyze on each plate. Depending on the setup mode selected by the user at step, the system either automatically pre-focuses the region of the plate to be scanned using an autofocus procedure to “find focus” of the plate or the user interactively pre-focuses the scanning region.

During an automated scan, the software dynamically displays the status of a scan in progress, such as by displaying data corresponding to the number of fields in macrowells that have been analyzed, the current macrowell that is being analyzed, and images of each independent wavelength as they are acquired, and the result of the screen for each macrowell as it is acquired. The assay plate may be scanned in any number of scanning patterns such as top to bottom, left to right, or in a serpentine style as the software automatically moves the motorized microscope XY stage 3 from macrowell to macrowell within the device. Those skilled in the programming art will recognize how to adapt software for scanning of standard microplate formats such as 24, 48, 96, and 384 well plates. The scan pattern of the entire plate as well as the scan pattern of fields within each well are programmed. The system adjusts sample focus with an autofocus procedure 104 through the Z axis focus drive 5, and optionally controls filter selection via a motorized filter wheel 19 and acquires and analyzes images.

Automatic focusing algorithms are described in the prior art in Harms et al. in Cytometry 5 (1984), p. 236-243, Groen et al. in Cytometry 6 (1985), p. 81-91, and Firestone et al. in Cytometry 12 (1991), p. 195-206, which is incorporated by reference herein in its entirety. U.S. Pat. No. 5,989,835 describes a variation on the above methods, which is incorporated by reference herein in its entirety. The autofocus procedure is called at a user-selected frequency, typically for the first field in the first macrowell and then once every 4 to 5 fields within each macrowell. The autofocus procedure calculates the starting Z-axis point by interpolating from the pre-calculated plane focal model. Starting a programmable distance above or below this set point, the procedure moves the mechanical Z-axis through a number of different positions, acquires an image at each, and finds the maximum of a calculated focus score that estimates the contrast of each image. The Z position of the image with the maximum focus score determines the best focus for a particular field.

Because the locations and geometric patterns of the micro-regions and the macro regions are predetermined, the system can be designed or programmed to scan the plate at those locations. The migration or motility of a cell may be detected by any of a variety of known methods in the art, including visual monitoring, fluorescence or spectrophotometric assays based upon binding of fluorescently labeled antibodies or other ligands, cell size or morphology, or by the cells' spectrophotometric transmission, reflection or absorption characteristics either with or without biological staining. Standard light or electron microscopy can also be employed. When the detection system is a microscope, it may be positioned either above or below the assay plate. In the case of fluorescence assays, a detector unit may be placed above the assay plate or, if the assay plate is translucent, below the assay plate. In the case of transmission spectrophotometric assays, a translucent assay plate is used, a source of electromagnetic radiation is placed on one side of the assay plate and a detector unit on the other. In addition to visual monitoring, physical monitoring may also be employed. For example, movement of the cells may contact detectors placed on the assay plate causing changes in the detectors, which can be received and analyzed by the CPU. Because of the small distances between individual isolated cells permitted by the present invention, detectors employing fiber optics are particularly preferred. Such sources of electromagnetic radiation and such detectors for electromagnetic transmission, reflection or emission are known in the applicable art and are readily adaptable for use with the invention disclosed herein.

When an automated detector unit is employed, a standard or control plate may also be provided. Such an assay plate would contain micro-regions including micro-regions to which the cells have not migrated so that a reference would be provided and the detector would recognize such micro-regions. In addition, micro-regions bearing cells of known types could be provided to act as references to allow the detector unit to classify the cells on a subject assay plate. Furthermore, depending upon the nature of the support or treatment on the support which is chosen, cells of different types may adhere to the assay plate with differing affinities. Thus, depending upon the cells to be studied and the nature of the support or coatings, a standard cytometric method may be employed on a sample first and then the assay plate and method of the present invention may be employed on the same or a substantially similar sample to calibrate the system.

For acquisition of images, the camera's exposure time may be separately adjusted. If the cells are labeled with fluorescent dye, the exposure time is adjusted for each dye to ensure a high-quality image from each channel. Software procedures can be called, at the user's option, to correct for registration shifts between wavelengths by accounting for linear (X and Y) shifts between wavelengths before making any further measurements. The electronic shutter of the camera is controlled so that sample photo-bleaching is kept to a minimum. Background shading and uneven illumination can also be corrected by the software using algorithms known in the art.

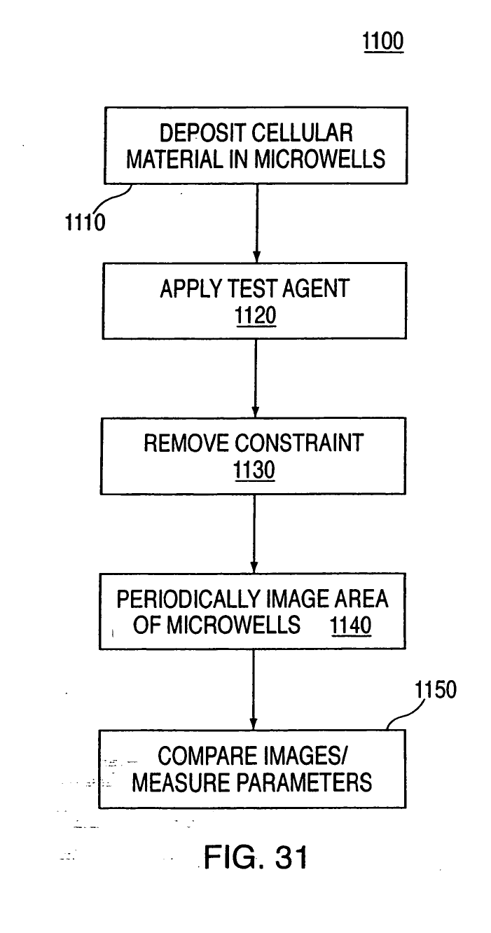

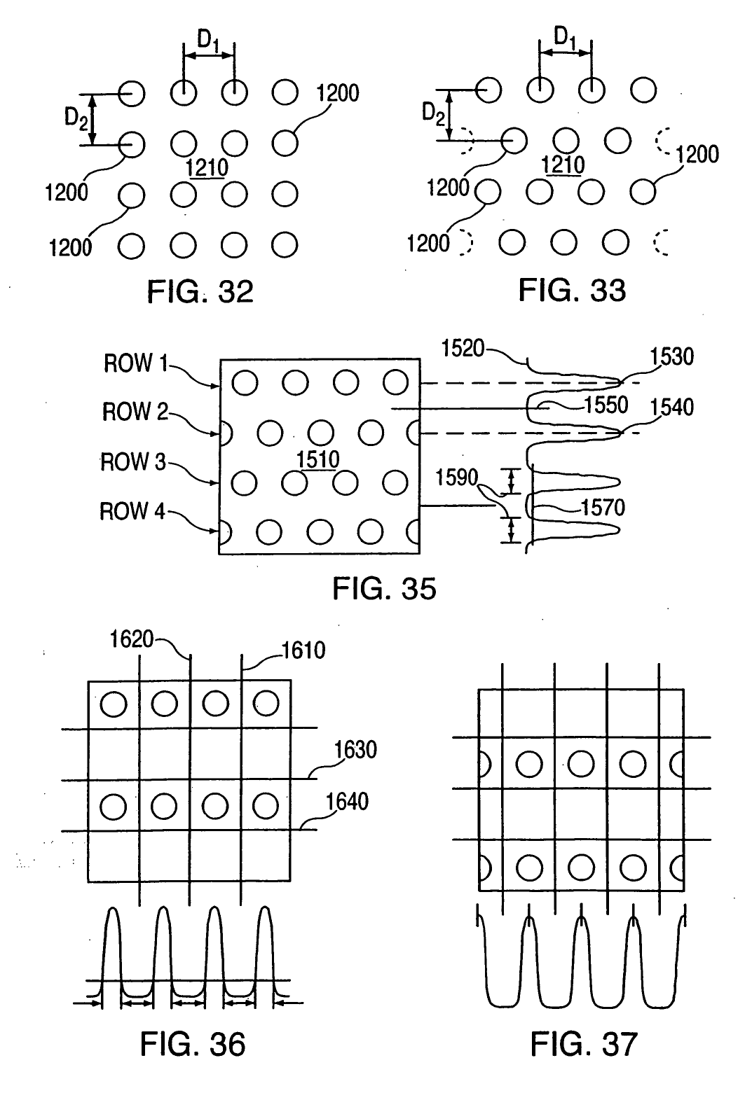

FIG. 31 illustrates a method 1100 for testing cellular material according to an embodiment of the present invention. According to the method, cellular material may be provided in a test bed that initially defines a constraint that imposes physical limitations to migration and growth of the material (block 1110). A testing agent may be applied to the cellular material and the constraint may be removed (blocks 1120, 1130). Thereafter, the cellular material may be imaged periodically (block 1140). Resultant image data may be compared over time to measure parameters to be captured under test (block 1150). The parameters, as noted, may include cellular growth, cellular multiplication or cellular migration under influence of the reactant.

For example, cells may be patterned through micro-orifices, such as micro-orifices 1300, of the first layer 1150. The cells are allowed to attach to the support 1140 and grow to confluence. The walls of the micro-orifice 1300 constrain the cell(s) and the cells take on the shape of the micro-orifice 1300, e.g. circular. A test agent is applied through the micro-orifices 1300 and is allowed to contact the cells. The first layer 1150 is removed and the cells are observed

Embodiments of the present invention provide image acquisition and analysis processing for use in connection with the foregoing method and apparatus. During one or more stages of testing, imaging apparatus may capture image data of the test apparatus and cellular material therein. As noted the captured image data may represent fluorescent cellular material, stained nuclear material or both among other image content contributed by background objects or noise. Image processing stages may analyze the contents of the captured image data to identify groups of cells, also referred to as “islands,” within the test apparatus. From the identified islands, multiple measurements may be calculated to evaluate parameters such as movement (cell motility), reproduction or multiplication (cell proliferation), growth (cell spreading), shrinking or decrease in size (cell rounding), or cell death.

According to an embodiment of the present invention, acquisition of islands from within image data may occur according to a coarse acquisition stage and a fine acquisition stage. The image acquisition phase attempts to identify islands and individual cells within an island throughout the test apparatus.

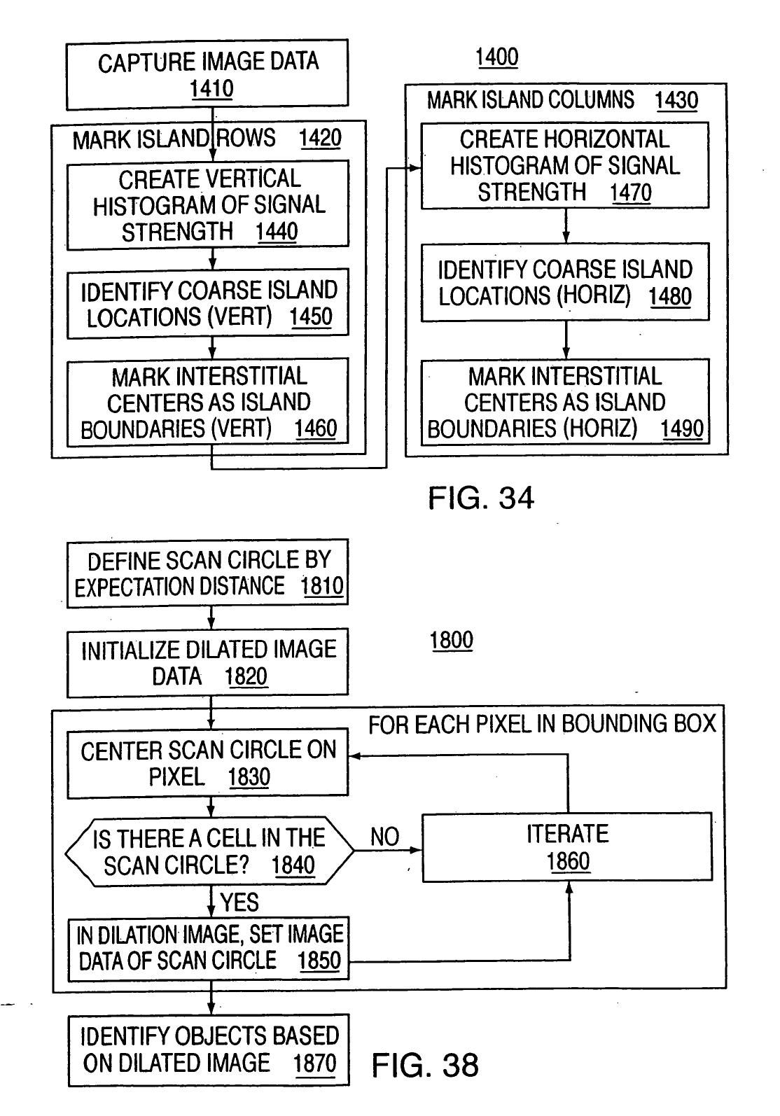

FIG. 34 illustrates a method 1400 of performing coarse island acquisition according to an embodiment of the present invention. The method may begin from captured image data (block 1410) in which the micro-orifices 1210 are oriented with respect to horizontal and vertical axes of the image data. From the image data, the method 1400 may attempt to identify island rows and columns of micro-orifices at a coarse granularity (blocks 1420, 1430). Identification of island rows may occur by creating a histogram of image data energy along a first axis of the image data (say, a vertical axis) (block 1440). From the histogram, coarse island locations may be identified (block 1450) and island boundaries may be marked between the islands (block 1460).

FIG. 35 illustrates exemplary image data 1510 (created within the constraints of the draftsperson's graphics application) and a histogram 1520 that may be created therefrom. FIG. 35 illustrates two alternate approaches to the identification of island locations. In the first approach, shown with reference to rows 1 and 2 of micro-orifices, island centers may be identified from relative maxima 1530, 1540 of the histogram. The maxima 1530, 1540 may be taken as coinciding with the center of respective rows of micro-orifices. Island boundaries 1550, 1560 may be taken as the midpoints between these calculated row centers. Alternatively, when it is known, for example, that micro-orifices occur with a predetermined spatial distance between rows, row centers may be generated from a calculation that considers both the histogram maxima 1530, 1540 and the predetermined row spacing, such as a least squares fit

FIG. 35 illustrates a second approach for detecting island positions from the histogram 1520 in connection with rows 3 and 4 of the image data. In this approach, coarse island locations may be generated from a threshold-tested histogram 1520. A predetermined energy threshold 1570 may be applied to the histogram and all vertical regions for which the histogram exceeds the threshold may be assigned to respective islands. A midpoint 1580 between adjacent region boundaries 1590 may be taken as a dividing line between rows of islands. Again, where predetermined geometric relationships between the micro-orifices are known, such as micro-orifice spacing, midpoint 1580 information may be integrated into a larger calculus with the geometric information to identify island locations.

Returning to FIG. 34, the method 1400 may identify island columns from the image data as well (block 1430). From a set of image data, the method 1400 may create another histogram of signal strength, taken along another axis of the image data (say, a horizontal axis) (block 1470). The method may identify coarse island locations from the histogram (block 1480) and, thereafter, mark island boundaries to be between the island locations (block 1490).

FIGS. 36 and 37 illustrate operation of the column identification performed with respect to the exemplary image data of FIG. 35. In certain embodiments, it may be expected that individual islands will not coincide with each other in predetermined columns. Thus, where micro-orifices are deployed according to a staggered layout, such as that shown in FIG. 33, or some other layout, it may be appropriate to perform the column identification individually on subsets of image data rather than the entirety of the image data. Thus, FIGS. 36 and 37 illustrate operation of the column identification performed respectively on odd numbered and even numbered rows of the captured image data. FIG. 36 illustrates operation of the column identification process with threshold-testing of the histogram defines island regions. FIG. 37 illustrates operation of the column identification where histogram maxima are used to identify column centers. These operations may be performed in a manner that is similar to the row identification described above.

The row and column identification processes 1420, 1430 generate dividing lines between respective rows and columns of islands in the image data. These dividing lines may be used to identify boxes that define a boundary (herein, “bounding boxes”) for each island of cells in the captured image data. Shown with respect to FIG. 36, dividing lines 1610, 1620, 1630 and 1640 define a bounding box for an island 1650 of cells. Captured image data of each bounding box may be further analyzed in a fine analysis process, described below.

The foregoing processing may be performed on captured image data of almost any format. Conventionally, image data occurs as black-and-white image data, grayscale image data or color image data. In the case of black-and-white image data, typically each pixel is assigned a single bit value (either 0 or 1). Grayscale image data typically represents each pixel by a multi-bit value, such as an eight bit value which would permit 256 quantization levels to be assigned to each pixel. In either of the foregoing cases, the histograms described above may be created simply by summing the pixel values along each axis. For example, if a histogram is to be created along a vertical axis of the image data, the summing may occur along each pixel row to generate a histogram value at a corresponding position along the vertical axis.

Color image data typically includes separate values for each color component at each pixel. Thus, a pixel may have a red color component, a green color component and a blue color component. An alternative color system may represent image information as a luminance color component and a pair of chrominance color components. Histograms may be generated by summing a predetermined one of the color components, by summing all of the color components or by calculating an “energy value” of each pixel from the components and summing the calculated energy values.

A fine island identification process may follow the coarse identification process described above. FIG. 38 illustrates a method 1800 of identifying islands from image data of bounding boxes, such as the bounding boxes described from the foregoing embodiments. The method 1800 may begin by defining a dilation kernel dimensioned according to a predetermined expectation distance (box 1810). The expectation distance may be an arbitrary distance chosen by an operator and is related to the size of the identified island. The operator may alter the expectation distance at any time to achieve a larger or smaller identified island as desired. For example, the expectation distance may define the radius or diameter of the dilation kernel. The method 1800 also may initialize data of a “dilated image” (box 1820). Thereafter, the method may consider each pixel in the bounding box. For each pixel, the method considers the captured image data that falls within a dilation kernel centered at the current pixel (box 1830). If the image data of the dilation kernel indicates that cellular material is represented therein, the method 1800 may set pixels occupied by the dilation kernel in the dilated image data (boxes 1840, 1850). Thereafter or if the image data indicates that no cellular material is represented therein, the method may advance to the next pixel (box 1860).

The method 1800 generates a second image from the captured data, a dilated image. Once all pixels have been considered, the resulting image, referred to as the dilated image, may contain one or more dilated islands.

According to an embodiment, the methods of FIGS. 34 and 38 may be applied serially to captured image data to provide both coarse and fine island acquisition. Of course, other implementations are possible. In the circumstance where an image represents a test to be run on a single micro-orifice, it would not be necessary to perform the method of FIG. 34 to identify bounding boxes of coarse locations of islands.

In an embodiment, it is not necessary for the method to iterate over every pixel of a bounding box. The method may consider pixels having predetermined spacing from each other (e.g., every other pixel, every third pixel, etc.) in each direction. The method need not consider pixels on the outer boundaries of the bounding boxes over which it traverses.

The foregoing description of the island acquisition method 1800 introduces the concept of an expectation distance. Generally, the expectation distance is related to a maximum expected distance of separation that may occur between any two pairs of cells for which it is appropriate to consider the cells as part of the same “island.” Typically, the expectation distance may be derived from the biological test to be run and may depend on cell types, number of cells, amount and type of test agents and other factors that are known to influence the biological properties being measured. Therefore, it may be set on a case-by-case basis.

As in the foregoing methods, the method of FIG. 38 finds application with various types of image data and may be used with varying levels of sensitivity. For example, in black-and-white data, white pixels (those having values of 1) may represent the presence of cellular material. Thus, the determination of whether dilation kernel data represents cellular material may be answered affirmatively if even a single pixel had a value of one. Similarly, in grayscale data, cellular material may be identified for a pixel having a predetermined value (say, half scale or greater—a value of 127 in an 8 bit word). Again, if the value of any pixel exceeds the threshold value, the method would be permitted to indicate that cellular material is present therein. For color image data, similar calculations may be made. Since cellular material fluoresces at a predetermined wavelength, it may be possible to examine only predetermined color components of the image data to determine if cellular material is present in a dilation kernel.

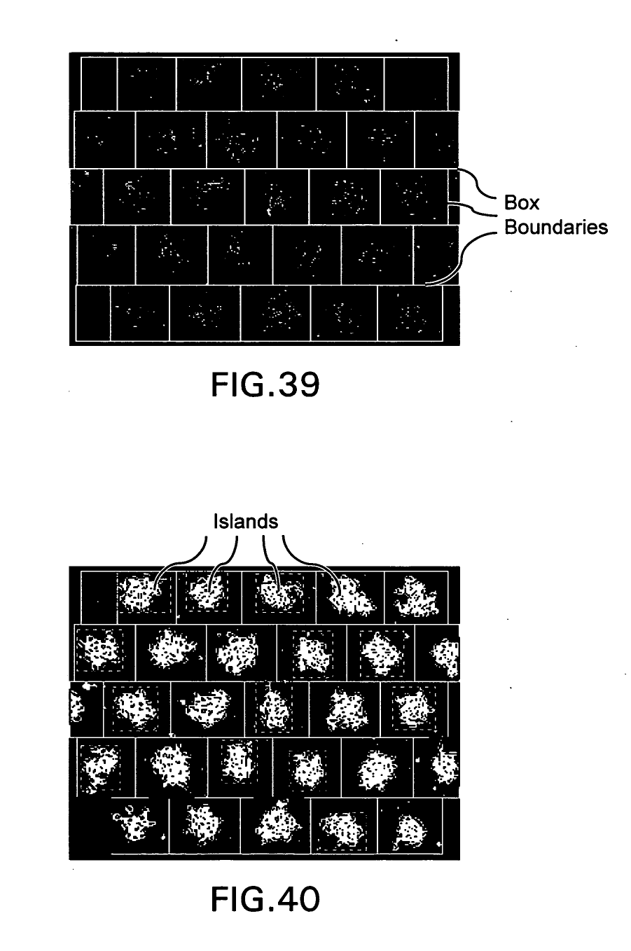

FIGS. 35-37 illustrate operation of the image processing methods upon idealized data in which cellular material is confined to the micro-orifices. While such presentation is useful to explain operation of the methods, the methods are most useful when applied to image data that captures cellular migration, spreading, proliferation, rounding, or death. FIGS. 39 and 40 are screen shots illustrating operation of the foregoing methods upon image data in which cellular material has been permitted to migrate without limitation. FIG. 39 illustrates exemplary source data and bounding boxes identified from operation of the method 1400 of FIG. 34. FIG. 40 illustrates exemplary dilated image data developed from the source image data of FIG. 39. FIG. 40 also illustrates island that may have been recognized from the source image data. They are circumscribed by bounding boxes of their own.

Having identified islands of cellular material, the image acquisition process may generate several independent measurements of the islands that may provide statistically useful biological information, and more preferably, information related to one or more of cell motility, cell growth, cell proliferation, cell rounding or cell death.

Additionally, where more than one cell type is deposited in the micro-orifice, the measurements may be calculated based on one type of cell within a population of mixed cell types rather than on the entire population of cells. These measurements may be calculated for each type of cell within the micro-orifice and then may be compared to each other to produce relevant biological information.

For example, prior to deposition in the micro-orifice, each cell type may be treated with an appropriate label, tag, stain, or dye so as to distinguish and identify each cell type within the same micro-orifice.

Such information may include, for example:

Pixelated cellular area;

Dilated cellular area;

Vertical and horizontal lengths;

Average minimum distance between cells;

Average distance between cells;

First polar moment of inertia taken about the island centroid;

Second polar moment of inertia taken about the island centroid; and

First and/or second polar moments of inertia taken about the island centroid, normalized to cellular area.

Each Measurement is Discussed in Turn.

The pixelated cellular area calculus counts from source image data the number of pixels in a given island that represents the presence of cellular material. The dilated cellular area counts from dilated image data the number of pixels in a dilated island that represents the presence of cellular material. The vertical and horizontal lengths calculus respectively represents the height and width of a bounding box that surrounds an island or dilated island of cellular material; these dimensions may be taken from the source image data or dilated image data of an island as desired.

The method also may capture the average minimum distance between cells and the average distance between cells. For these measurements, it may be useful to identify cell nuclei and compute distances between them. For example, cells may have a nuclear staining agent applied to them in addition to a fluorescing agent. Captured image data then may capture not only the cytoplasm as a fluorescent material but they also may captured cell nuclei as a predetermined color that may be distinguishable from the fluorescence within the image. It may be useful to capture two images of the cells, a first image to capture the fluorescent material and a second image to capture the cell nuclei. In either embodiment, cell nuclei may be identified and distinguished from other artifacts within a captured image.

The distance parameters may consider the positions of various cell nuclei in a given island. To compute the average distance between cells within a given population of cells, the distances between the nuclei of each pair of cells within the population are summed and the sum then divided by the number of unique pairs in the population. The image may contain different populations of cells which may include the population of cells defined by a single island within a bounding box, the population of cells defined by two or more islands within a bounding box or the population of cells defined by the bounding box.

The average minimum distance between cells also considers the distance between a given cell and all others in an island. The minimum of these distances is logged. The process may repeat for all other cells in an island until a set of minimum distances is identified, one for each cell. Thereafter, these minimum distance values may be averaged to determine the average minimum distance between cells.

The first polar moment of inertia considers an island's centroid and the distance of cellular material from this centroid. It involves a computation of the island centroid and a measurement of each pixel representing cellular material from this centroid. Thereafter, one integrates the sums of vector distances from the centroid to each of these pixels and multiplies by the area of the island squared.

The second polar moment of inertia also involves a computation of the island's centroid and a measurement of each pixel representing cellular material from this centroid. Thereafter, an integration of the sums of the squares of the vector distances from the centroid to each pixel may be applied.

Either the first or second polar moment of inertia calculations may be made from the source image data or dilated image data of an island.

Additionally, calculations of the first or second polar moments of inertia may be normalized to the island's area. If the source image data is used for the polar moment of inertia calculations, then naturally the island's source image area can be used for normalization. Similarly, if the dilated image data is used for the inertia calculations, the island's dilated image area can be used for normalization.

The foregoing measurements may, alone or in conjunction with at least one other measurement, provide biologically relevant information, and more preferably, information related to cell motility, cell growth, cell proliferation, cell rounding, or cell death.

For example, an increase in pixelated cell area may be indicative of cell spreading and/or cell proliferation. As another example, a decrease in pixelated cell area may be indicative of cell rounding or cell death.

An increase in dilated cell area may indicate one or more of cell proliferation, cell spreading or cell motility. A decrease in dilated cell area may indicate cell rounding or cell death.

A change in the horizontal or vertical lengths of the bounding box or change in the average distance between cells or a change in the average minimum distance between cells may indicate one or more of cell motility, cell proliferation, cell spreading, cell rounding or cell death.

The relative levels of each of these (e.g., cell spreading, cell rounding, etc.) can be measured more easily by combining cytoplasmic and nuclear stains. For example, when the cells are stained with a nuclear stain, individual cell nuclei may be distinguished from other cell nuclei within a population of cells, thus allowing the number of detected nuclei to be summed. The number of detected nuclei may directly correlate to the number of cells in a population. When quantified at different time points, the change in the number of cell nuclei detected over time may be calculated, which may directly correlate to the change in the number of cells in a population over time. A nuclear stain used in conjunction with a cytoplasmic stain may possibly elucidate the cause of a change in an aforementioned measurement. For example, it may be determined that there is no change in the number of cell nuclei detected and thus, no change in the number of cells in a population over time. One may conclude that a change in a measurement (e.g., pixelated cell area) is due primarily or wholly to a parameter other than cell proliferation or cell death.

After a scan of a plate is complete, images and data can be reviewed with the system's image review, data review, and summary review facilities. All images, data, and settings from a scan are archived in the system's database for later review. Users can review the images of the area of the plate analyzed by the system with an interactive image review procedure. The digital images produced by the camera are stored in the computer.

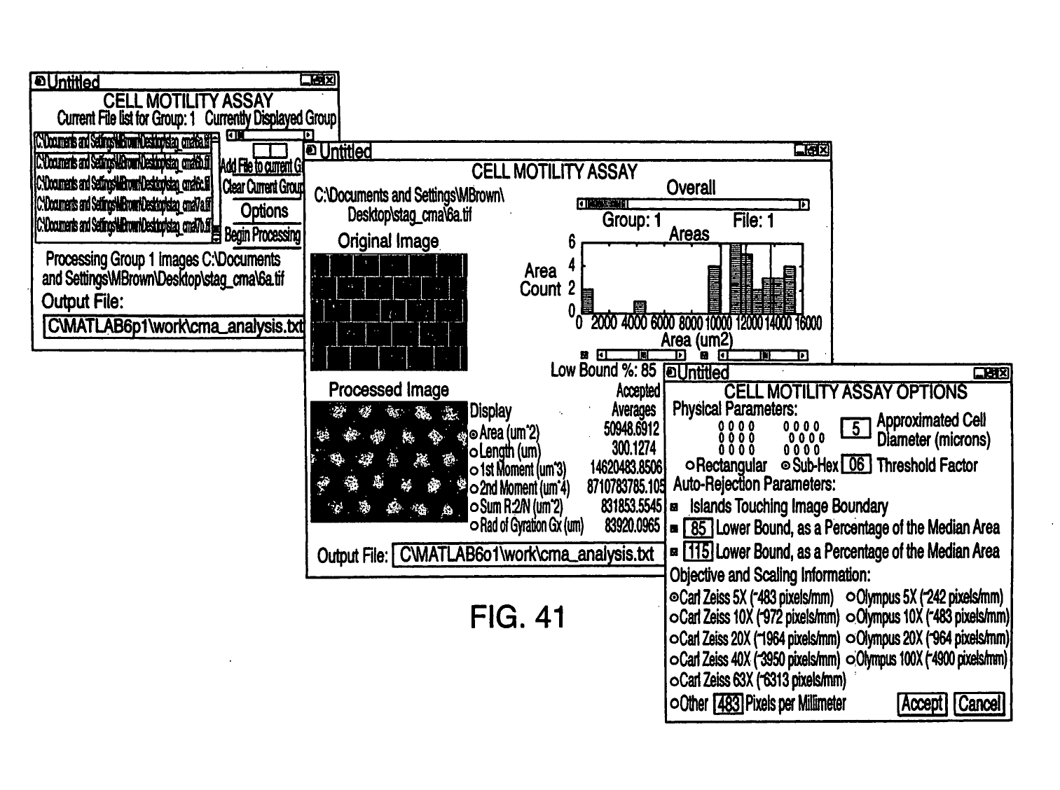

The user can review data using a combination of interactive graphs, a data spreadsheet of features measured, and images of the area of the assay plate of interest with the interactive data review procedure. See FIG. 41. Graphical plotting capabilities are provided in which data can be analyzed via interactive graphs such as histograms and scatter plots. Users can review summary data that are accumulated and summarized for all cells within each micro-region with an interactive micro-region-by-micro-region. Hard copies of graphs and images can be printed on a wide range of standard printers. All images and data may be stored in the system's database for archival and retrieval or for interface with a network laboratory management information system. Data can also be exported to other third-party statistical packages to tabulate results and generate other reports.

As a final phase of a complete scan, reports can be generated on one or more statistics of features measured. Multiple reports can be generated on many statistics and be printed. Reports can be previewed for placement and data before being printed.

### Definitions

It is understood that the terminology and definitions used herein are for the purpose of describing particular embodiments only and are not intended to be limiting.

The term “leukocytes” as used herein refers to granulocytes including neutrophils, eosinophils, basophils, monocytes, and lymphocytes including B cells and T cells and unless otherwise specified, platelets. The term “leukocytes” includes leukocytes obtained from both normal blood samples and pathological blood samples.

The term “leukocyte migration cascade” refers to the cascade of sequential events involving a leukocyte's migration along the endothelium lining a blood vessel. The leukocyte migration cascade includes the capture, rolling, arrest, and transmigration of a leukocyte on, along, or through the endothelium.

The term “leukocyte migration mediator” as used herein refers to any molecule that mediates the migration of leukocytes along the endothelium lining a blood vessel. The term “mediates” as used in the context of a “leukocyte migration mediator” means influencing the migration of a leukocyte by, for example, binding to the ligand or counter-receptor of the leukocyte migration mediator. In particular, the term “leukocyte migration mediator” refers to any molecule involved in the leukocyte migration cascade. As such, a leukocyte migration mediator includes a leukocyte capture mediator, a leukocyte rolling mediator, a leukocyte arrest mediator, a leukocyte transmigration mediator, or any combination thereof.

The term “capture” as used herein refers to a step in the leukocyte migration cascade characterized by the tethering or first contact of leukocyte with the endothelium of a blood vessel so that the motion of the leukocyte along the endothelium is temporarily delayed relative to the flow of fluid containing free flowing leukocytes.

The term “leukocyte capture mediator” as used herein refers to a leukocyte migration mediator that mediates the capture of a leukocyte on the endothelium of a blood vessel. Non-limiting examples of leukocyte capture mediators are P-selectin and L-selectin binding ligands.

The term “capture mediator binding partner” refers to any ligand or counter-receptor that binds a leukocyte capture mediator. Non-limiting examples of capture mediator binding partners are PSGL-1 and L-selectin.

The term “rolling” as used herein refers to a step in the leukocyte migration cascade, and is characterized by the rolling of a leukocyte along the endothelium of a blood vessel from receptor to receptor on the endothelium further characterized by leukocytes forming and breaking adhesive bonds with endothelial ligands or counter-receptors.

The term “leukocyte rolling mediator” as used herein refers to any leukocyte migration mediator that mediates the rolling of a leukocyte along the endothelium of a blood vessel. Non-limiting examples of leukocyte rolling mediators are P-selectin, E-selectin, and L-selectin binding ligands.

The term “rolling mediator binding partner” as used herein refers to any ligand or counter-receptor that binds to a leukocyte rolling mediator. Non-limiting examples of rolling mediator binding partners are PSGL-1, E-selectin binding ligand, and L-selectin.

The term “arrest” as used herein refers to a step in the leukocyte migration cascade characterized by the adherence of leukocytes to the endothelium of a blood vessel.

The term “leukocyte arrest mediator” as used herein refers to any leukocyte migration mediator that mediates the arrest of a leukocyte on the endothelium of a blood vessel. Non-limiting examples of arrest mediators are integrin binding ligands, such as ICAM-1, ICAM-2, and VCAM-1 that bind integrins expressed on the surface of leukocytes.

The term “arrest mediator binding partner” as used herein refers to any ligand or counter-receptor that binds to a leukocyte arrest mediator. Non-limiting examples of arrest mediator binding partners are integrins including LFA-1, Mac-1, p150,95, VLA-4, and VLA-5.

The term “transmigration” as used herein refers to a step in the leukocyte migration cascade characterized by the exit of leukocytes from a blood vessel to surrounding tissue through passage between cells of the endothelium of the blood vessel.

The term “leukocyte transmigration mediator” as used herein refers to any leukocyte migration mediator that mediates the transmigration of a leukocyte through the endothelium of a blood vessel. Non-limiting examples of leukocyte transmigration mediators are PECAM-1 and JAM.

The term “transmigration binding partner” as used herein refers to any ligand or counter-receptor that binds to a leukocyte transmigration mediator.

The term “physiological shear flow” includes shear flow under normal and pathological conditions. Physiological shear flow rate under normal conditions is about 0.1 to about 20 dynes/cm.2

The term “test agent” as used herein refers to any substance that inhibits or promotes leukocyte migration, for example, by inhibiting or promoting capture, rolling, arrest, or transmigration.

The term “pitch” as used herein refers to the distance between respective vertical centerlines between adjacent wells in the test orientation of the device.

The term “well region” as used herein is meant to refer to a region that comprises one or a plurality of wells.

The term “well” as used herein is meant to indicate any cavity that is able to receive a fluid therein.

The term “channel region” as used herein refers to a region that comprises one or a plurality of channels therein, while “channel” refers to any passageway.

In the context of the present invention, “conformal contact” is meant to designate a substantially fluid-tight, form-fitting contact with a planar or non-planar surface, and “reversible conformal contact” is meant to designate a conformal contact that may be interrupted without compromising a structural integrity of the members making the conformal contact.

In the context of the present invention, the “test orientation” of the device is meant to refer to a spatial orientation of the device during the monitoring of leukocyte migration. In one embodiment, the test orientation of the device for use in a method of monitoring leukocyte migration contemplates the orientation of the device such that a migration path along the channel region of any cells occurs in a substantially horizontal plane. In another embodiment, the test orientation of the device for use in monitoring leukocyte migration contemplates the orientation of the device such that a migration path along the channel region of any cells occurs in a substantially vertical plane.

The present invention generally provides devices and methods for in vitro monitoring the interaction of cells with a substratum. Non-limiting examples of cell types that may be monitored by the devices and methods of the present invention include leukocytes, red blood cells, platelets, non-blood cells, and tumor cells. Non-limiting examples of types of substratum that may interact with the cells include the endothelium, immobilized ligands, physisorbed adhesion and rolling molecules and basal lamina or basal lamina mimic. In particular, the present invention provides a device and method for in vitro monitoring of leukocyte migration in the presence of shear flow in order to study the cascade of events involved in the inflammatory response in vivo. The present invention also provides a device and method for the high-throughput screening of test agents that potentially target these events. In particular, the present invention is directed to study and target the capture, rolling, arrest, and transmigration of a leukocyte on, along, or through the endothelium (such events collectively referred to as the “leukocyte migration cascade”).

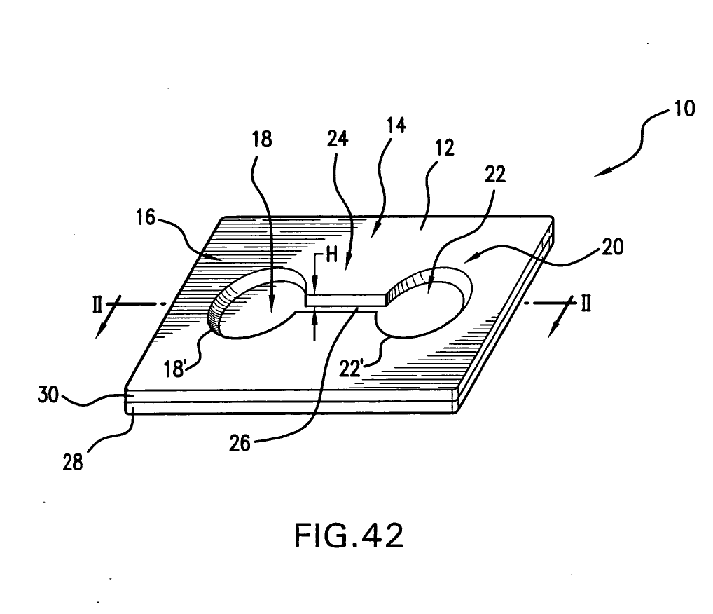

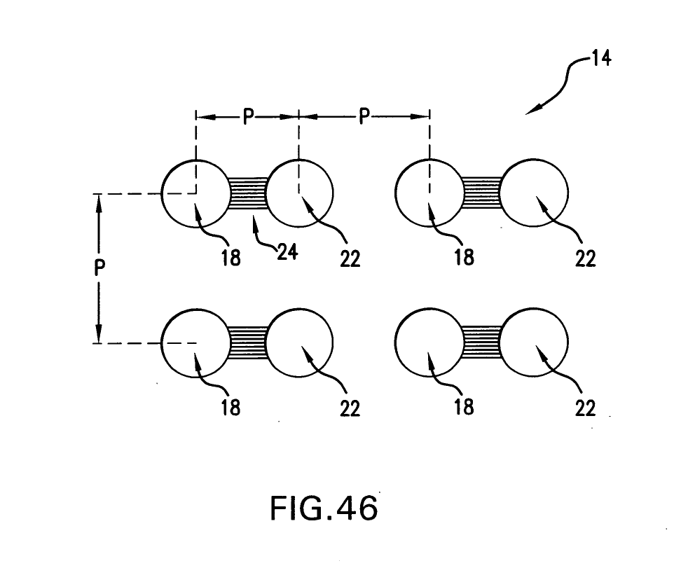

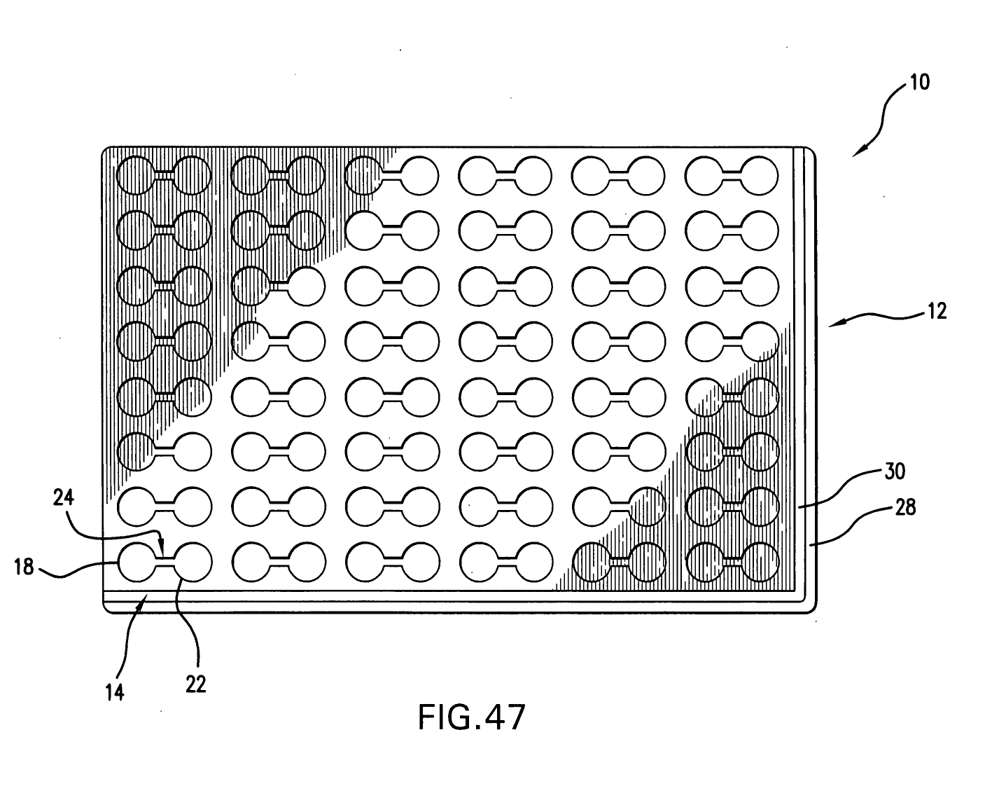

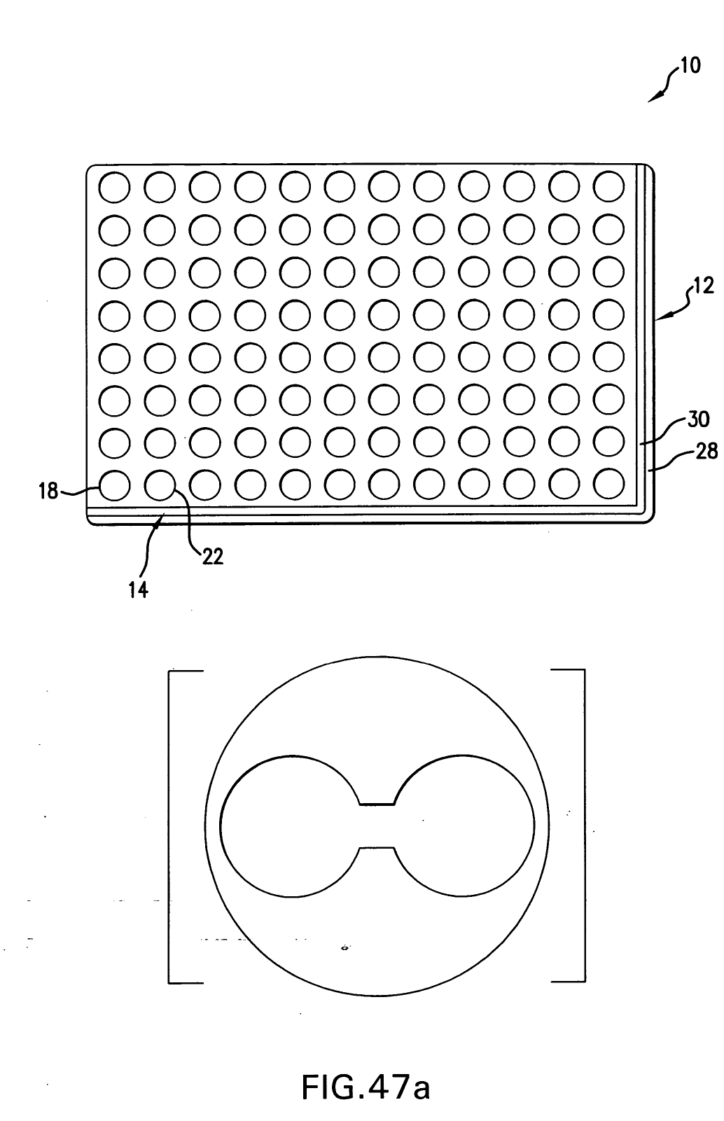

As schematically depicted in FIGS. 42-47, device 10 generally includes a housing 12 defining a plurality of chambers 14 therein, such as, by way of example, embodiments of chamber 14 depicted in FIGS. 42-47. Each chamber 14 includes: a first well region 16 including at least one first well 18 and a second well region 20 including at least one second well 22. The chamber 14 further includes a channel region 24 including at least one channel 26 connecting the first well region 16 and the second well region 20 with one another. As illustrated in FIG. 46 and 47, the first well regions 16 and the second well regions 20 of the respective ones of the plurality of chambers are disposed relative to one another to match a pitch of a standard microtiter plate. The plurality of chambers may also be disposed relative to one another to match a pitch of standard microtiter plate. Generally, first well 18 and second well 22 are adapted to receive a sample comprising leukocytes and channel 26 is adapted to receive endothelial cells or leukocyte migration mediators thereon and is configured to support physiological shear flow there along.

In one embodiment of the present invention, channel 26 contains endothelial cells disposed therein. The endothelial cells may be activated prior to exposure to channel 26 or may have chemokines immobilized on the surface opposite the basal lamina therein upon exposure to channel 26. Various cytophilic substances may be disposed in channel 26 to assist in the attachment of endothelial cells. Cytophilic substances are generally substances that have an affinity for cells or substances that promote cell attachment to the surface and include, for example, gelatin, collagen, fibronectin, fibrin, basal lamina, including, but not limited to MATRIGEL™ or other hydrogels.

In another embodiment of the present invention, channel 26 includes at least one leukocyte migration mediator disposed therein. Preferably, the at least one leukocyte migration mediator comprises a plurality of leukocyte migration mediators. More preferably, the plurality of leukocyte migration mediators comprises at least one first leukocyte migration mediator and at least one second leukocyte migration mediator, wherein the at least one first and the at least one second leukocyte migration mediators are different from one another. The leukocyte migration mediators may also be disposed in channel 26 so as to form a surface concentration gradient along a longitudinal axis of chamber 14 in increasing concentration from first well 20 to second well 22.

In yet another embodiment of the present invention, channel 26 includes chemokines disposed therein to interact with chemokine receptors on the surface of rolling leukocytes.

The present invention also contemplates a method of monitoring leukocyte migration. In one embodiment where channel 26 contains endothelial cells disposed therein, a sample including leukocytes is placed in first well 18 (or second well 22), the sample is allowed to flow along channel 26, the interaction (such interaction including a lack thereof) between the leukocytes and the endothelial cells is observed, and the sample including leukocytes is collected in second well 22 (or the first well 18) as the leukocytes exit channel 26. A chemoattractant may be added to channel 26 to activate the endothelial cells before a sample containing leukocytes is added to first well 18 (or second well 22).

In one embodiment, a test agent is placed in channel 26 and the interaction between the leukocytes and endothelial cells in the presence of the test agent is observed.

In one embodiment where channel 26 contains a leukocyte migration mediator disposed therein, a sample including leukocytes is placed in first well 18 (or second well 22), the sample is allowed to flow along channel 26, the interaction (such interaction including a lack thereof) between the leukocytes and the leukocyte migration mediator is 35 observed, and the sample including leukocytes is collected in second well 22 (or the first well 18) as the leukocytes exit channel 26. In one embodiment, a test agent is placed in channel 26 and the interaction between leukocytes and the leukocyte migration mediator in the presence of the test agent is observed.

Because device 10, or elements of device 10, may match the footprint of an industry standard microtiter plate, an advantage of device 10 is that device 10 may be used to conduct multiple assays simultaneously in the same device, and to high throughput screen various test agents. In one embodiment, as illustrated in FIG. 46, the first well regions 16 and the second well regions 20 of the respective ones of the plurality of chambers 14 are disposed relative to one another to match a pitch of a standard microtiter plate. Taking P to designate a pitch between respective wells 18/22, the wells may be disposed relative to one another to match a pitch of one of a 24-well microtiter plate, a 96-well microtiter plate, a 384-well microtiter plate, 768-well microtiter plate and a 1536-well microtiter plate. By way of example, in the configuration of chambers 14 as shown in FIG. 46, pitch P will be set to about 9 mm. Preferably, device 10 itself fits in the footprint of an industry standard microtiter plate. As such, device 10 preferably has the same outer dimensions and overall size of an industry standard microtiter plate. By way of example, in the configuration of device 10 as shown in FIG. 47, device 10 comprises 48 chambers designed in the format of a standard 96-well plate, such that the respective wells 18/22 are disposed relative to one another to match a pitch of a standard 96-well microtiter plate with each well fitting in the space of each well of the plate. In this embodiment, 48 experiments can be conducted. Alternatively, as seen in FIG. 47A, chambers 14 may be disposed relative to one another to match a pitch of a standard microtiter plate. In this alternative embodiment, chambers 14 are sized so that a chamber 14 fits in the area normally required for a single well of a standard microtiter plate. For example, in this embodiment, device 10, designed in the footprint of a 96-well microtiter plate configuration, has 96 chambers and therefore allows 96 experiments to be performed. By conforming to the exact dimensions and specification of standard microtiter plates, embodiments of device 10 would advantageously fit into existing infrastructures of fluid handling, storage, registration and detection. Device 10 is also conducive to high throughput screening as it allows robotic fluid handling and automated detection and data analysis. The use of robotic and automated systems also decreases the amount of time to prepare and perform the assays and analyze the results of the assays. In addition, by using automated systems, the use of device 10 decreases the occurrence of human error in preparing and performing assays and analyzing data. Moreover, because the size of the wells 18/22, or the size of an entire chamber 12, of device 10 matches the size of a well of a microtiter plate, the number of leukocytes needed to perform an individual assay range from only about 103 to about 106. This allows for the study of rare leukocyte populations, such as basophils or certain lymphocyte subsets. In addition, large amounts of test agents, such as inhibitors and promoters of leukocyte migration, need not be used in order to conduct assays monitoring the effect of these agents on leukocyte migration.

Based on the configuration of device 10, the present invention also contemplates a method of screening a plurality of test agents. In this embodiment, the method of screening test agents includes providing a device comprising a housing defining a plurality of chambers. Each chamber includes: a first well region including at least one first well; a second well region including at least one second well; and a channel region including at least one channel connecting the first well region and the second well region with one another. In one embodiment, the at least one channel includes at least one leukocyte migration mediator disposed therein. In another embodiment, the at least one channel includes endothelial cells disposed therein. In both embodiments, at least one of the plurality of chambers on the one hand, and the first well regions and the second well regions of respective ones of the plurality of chambers on the other hand, are disposed relative to one another to match a pitch of a standard microtiter plate. The method of screening test agents further includes providing leukocytes in each of the channels of respective ones of the plurality of chambers; placing at least one of a plurality of test agents in each of the channels of respective ones of the plurality of chambers; and observing the interaction between the leukocytes and the endothelial cells or the interaction between the leukocytes and the at least one leukocyte migration mediator in the presence of the test agents. For example, it can be determined whether the test agents have an effect on the number of leukocytes that are captured, arrested, or have transmigrated as well as whether the test agents have an effect on velocity and number of leukocytes that roll along channel 26. The test agent may include any desired biological, chemical, or electrical substance, including but not limited to, an inhibitor of leukocyte migration, a promoter of leukocyte migration, or any other therapeutic agent. Further examples of test agents include proteins, nucleic acids, peptides, polypeptides, carbohydrates, lipids, hormones, enzymes, small molecules or pharmaceutical agents. This method is particularly useful in the area of drug discovery where a plurality of test agents may be screened in a single device 10. Accordingly, it is preferable that each of the test agents is different from one another and a single test agent is placed in each channel. Of course, if it is desirable to test the effects of a combination of test agents, for example to determine if there is any synergistic effect of two or more test agents, than two or more test agents of the plurality of test agents may be placed in each channel of each of the plurality of chambers.

The device of the present invention may also be used to monitor the steps of the leukocyte migration cascade under a normal or pathological physiological shear flow condition. A normal physiological flow condition refers to the shear flow rate during a non-pathological state and is in the range of about 0.1 dynes/cm² to about 20 dynes/cm². A pathological physiological flow condition refers to the shear flow rate during the inflammatory response and is generally varied depending on the disease state. Although the physiological shear flow is preferably produced by hydrostatic pressure, or microcapillary action, the flow can be produced by any means known in the art. For example, if a sample containing leukocytes is to be introduced into channel 26 via first well 18, then physiological shear flow can be created by applying pressure through a vacuum adjacent to second well 22 or by applying pressure through a syringe pump adjacent to first well 18. The shear flow may be manipulated by altering the dimensions of the channels or modifying the degree of pressure applied through the vacuum or syringe pump.

With respect to particular embodiments of device 10 and methods of using these embodiments, as mentioned above, channel 26 may have endothelial cells disposed therein or leukocyte migration mediators disposed therein. The endothelial cells may be grown on channel 26 in the presence or absence of shear flow. In one embodiment where channel 26 has endothelial cells disposed therein, several different assays may be performed to observe the interaction between leukocytes and the endothelial cells during the leukocyte migration cascade. For example, to study the process of rolling, a sample containing leukocytes is introduced into channel 26 via first well 18 or second well 22. The number of leukocytes rolling as well as the rolling velocity of the leukocytes may then be determined. Assays measuring the inhibition of rolling may also be performed by adding to channel 26, for example, inhibitors that block the interaction between leukocytes and endothelial cells. Similarly, assays measuring the enhancement of rolling may be performed by adding to channel 26, for example, promoters that promote the interaction between leukocytes and endothelial cells. A test agent could also be added to channel 26 to determine the effect of the test agent on the interaction between leukocytes and endothelial cells.

To study the process of arrest, preferably a chemoattractant is introduced into channel 26 in order to “activate” the endothelium. The chemoattractants may be any molecule suitable to stimulate the endothelium to express integrin binding ligands such as ICAMs and VCAMs. Non-limiting examples of chemoattractants include cytokines such as IL-1 and TNF-∀. A sample including leukocytes is then introduced in channel 26 via first well 18 or second well 22. Preferably, the sample including leukocytes is preincubated with a chemoattractant capable of triggering the activation of arrest mediator binding partners, for example integrins, on the surface of leukocytes. The chemoattractant is any suitable substance capable of triggering integrin expression by leukocytes and includes, for example, formyl peptides, intercrines, IL-8, GRO/MGSA, NAP2, ENA-78, MCP-1/MCAF, RANTES, I-309, other peptides, platelet activating factor (PAF), lymphokines, collagen, fibrin, and histamines. The number of arrested cells may then be determined. Assays measuring the inhibition of arrest may also be performed, for example, by adding inhibitors that block the interaction between chemoattractants and chemoattractant receptors on the surface of the leukocytes or the endothelium, or that block the interaction between leukocyte arrest mediators and arrest mediator binding partners. A test agent could also be added to channel 26 to determine the interaction between the leukocytes and the endothelial cells in the presence of the test agent.

In another embodiment directed to examining the process of transmigration, a layer of endothelial cells is placed in channel 26. In a preferred embodiment to more closely simulate in vivo conditions, channel 26 may first be coated with a layer of fibronectin or any other basement membrane mimic before adding the endothelial cells to channel 26. Preferably the endothelial cells are exposed to eotaxins or chemokines, including RANTES or monocyte chemoattractant protein (MCP-3 or MCP-4) prior to introduction of the sample containing leukocytes. The sample including leukocytes is then introduced into channel 26 via first well 18 or second well 22. Preferably, the leukocytes are preincubated with a chemoattractant capable of triggering the activation of arrest mediator binding partners, for example integrins, on the surface of leukocytes. After the leukocytes are allowed to flow along channel 26, the number of cells that transmigrated through the endothelium are counted. Transmigrated cells may be characterized by appearing flattened and phase-dark under a microscope. Flattened, phase-dark cells may be confirmed as being under the endothelial cell monolayer by observing the focal plane of the leukocytes and the endothelial cells using a microscope. A cell may be considered transmigrated if, for example, greater than 50% of the cell is under the endothelial cell monolayer at the point of quantification. Transmigration may be expressed as the number of transmigrated cells divided by the total cells counted. Inhibition of transmigration may also be examined by blocking, for example, the receptor on endothelium cells that binds the chemoattractant responsible for activating the endothelium and then determining the number of cells that transmigrate across the endothelium. A test agent may also be introduced in channel 26 to determine the interaction between the leukocytes and the endothelial cells in the presence of the test agent.

In another embodiment, the endothelial cells disposed in channel 26 have been altered or modified through known techniques in molecular biology. For example, the cells may be modified to overexpress particular genes or to not express particular genes coding for the various leukocyte migration mediators responsible for the leukocyte migration cascade. Such an embodiment affords control over the expression of precise leukocyte migration mediators and allows greater manipulation of the mediator involved in the leukocyte migration cascade.

For example, the endothelial cells may be genetically modified to reduce or inhibit the expression of a gene believed to encode a protein involved in the leukocyte migration cascade to assist in the elucidation of the proteins involved in leukocyte migration cascade. Methods for genetically modifying a cell are known in the art. One such method is disclosed in U.S. Pat. No. 6,025,192 to Beach et al. and involves replication-deficient retroviral vectors, libraries comprising such vectors, retroviral particles produced by such vectors in conjunction with retroviral packaging cell lines, integrated provirus sequences derived from the retroviral particles of the invention and circularized provirus sequences which have been excised from the integrated provirus sequences of the invention.

In another non-limiting example, the endothelial cells may be transfected with a vector to genetically modify a protein expressed by the endothelial cells. For various techniques for transfecting mammalian cells, see Keown et al. (1990) Methods in Enzymology 185:527-537. For example, the endothelial cells may be modified to express a variant of the protein to be tested. For example, if it is believed that a certain protein is involved in the cascade, the gene expressing the particular protein can be modified to express a variant. Then using the device and assays of the present invention, the effect of this variant on the various parts of the cascade can be monitored.

The variant can be created using techniques known in the art by making deletions, additions or substitutions in the sequence encoding the protein. A “variant” of a polypeptide is defined as an amino acid sequence that is altered by one or more amino acids. Similar minor variations can also include amino acid deletions or insertions, or both. Guidance in determining which and how many amino acid residues may be substituted, inserted or deleted without abolishing biological or immunological activity can be found using computer programs well known in the art, for example, DNAStar software. A “deletion” is defined as a change in either amino acid or nucleotide sequence in which one or more amino acid or nucleotide residues, respectively, are absent as compared to an amino acid sequence or nucleotide sequence of a naturally occurring polypeptide. An “insertion” or “addition” is that change in an amino acid or nucleotide sequence which has resulted in the addition of one or more amino acid or nucleotide residues, respectively, as compared to an amino acid sequence or nucleotide sequence of a naturally occurring polypeptide. A “substitution” results from the replacement of one or more amino acids or nucleotides by different amino acids or nucleotides, respectively as compared to an amino acid sequence or nucleotide sequence of a naturally occurring polypeptide. The variant can have “conservative” changes, wherein a substituted amino acid has similar structural or chemical properties, e.g., replacement of leucine with isoleucine. More rarely, a variant can have “nonconservative” changes wherein a substituted amino acid does not have similar structural or chemical properties such as replacement of a glycine with a tryptophan.

In addition to creating a variant of the protein of interest, reduction or inhibition of expression of a protein that is expressed by the endothelial cell can be accomplished using known methods of genetic modification. For example, an endothelial cell expressing a leukocyte rolling mediator such as P-selectin can be genetically modified such that the expression of the P-selectin is reduced or inhibited using a homologous recombination gene “knock-out” method (see, for example, Capecchi, Nature, 344:105 (1990) and references cited therein; Koller et al., Science, 248:1227-1230 (1990); Zijlstra et al., Nature, 342:435-438 (1989), each of which is incorporated herein by reference; see, also, Sena and Zarling, Nat. Genet., 3:365-372 (1993), which is incorporated herein by reference). A “knock-out” of a target gene means an alteration in the sequence of the gene that results in a decrease of function of the target gene, preferably such that target gene expression is undetectable or insignificant. A knock-out of a gene means that function of the gene has been substantially decreased so that protein expression is not detectable or only present at insignificant levels. A “knock-in” of a target gene means an alteration in a host cell genome that results in altered expression or increased expression of the target gene, e.g., by introduction of an additional copy of the target gene, or by operatively inserting a regulatory sequence that provides for enhanced expression of an endogenous copy of the target gene.

The expression of the leukocyte migration mediator by an endothelial cell also can be reduced or inhibited by providing in the endothelial cell an antisense nucleic acid sequence, which is complementary to a nucleic acid sequence or a portion of a nucleic acid sequence encoding a leukocyte migration mediator. Methods for using an antisense nucleic acid sequence to inhibit the expression of a nucleic acid sequence are known in the art and described, for example, by Godson et al., J. Biol. Chem., 268:11946-11950 (1993), which is incorporated herein by reference.

Another embodiment creating control over the precise leukocyte migration mediators to be studied, including control over the type and amount of leukocyte migration mediator expressed, involves an embodiment of device 10 wherein at least one leukocyte migration mediator is disposed in channel 26 therein. For the purpose of clarity, the term “leukocyte migration mediator” used herein necessarily refers to at least one leukocyte migration mediator, unless otherwise specified. By disposing a leukocyte migration mediator in channel 26, it is possible to examine the ligand/receptor interactions underlying the leukocyte migration cascade, including the individual events of the cascade to gain a further understanding of this process. Disposing a leukocyte migration mediator in channel 26 also allows for the precise targeting of the ligand/receptor interactions underlying the individual events of the leukocyte migration cascade.

For example, in one embodiment, device 10 may be used to examine the capture of a leukocyte wherein the leukocyte migration mediator disposed in channel 26 may comprise a leukocyte capture mediator. As a consequence of the initial immune response to infection, inflammatory mediators induce the expression of adhesion molecules on the surface of the endothelium, resulting in an “activated endothelium.” The first contact of a leukocyte with the activated endothelium is known as “capture” and is thought to involve a capture mediator P-selectin and a capture mediator binding partner L-selectin. P-selectin is thought to be the primary adhesion molecule involved the capture process and the binding of P-selectin to its main capture mediator binding partner, PSGL-1, is strongly implicated in this process. L-selectin has also been implicated in capture although its precise ligand on endothelial cells is unknown. Accordingly, in this embodiment of the present invention, the leukocyte capture mediator disposed in channel 26 may comprise, for example, P-selectin and/or an L-selectin binding ligand.

In another embodiment of the present invention, device 10 may be used to examine the rolling of a leukocyte wherein the leukocyte migration mediator may comprise a leukocyte rolling mediator. Once leukocytes are captured, they may transiently adhere to the endothelium and begin to roll along the endothelium. The rolling of leukocytes is thought to involve: a rolling mediator, P-selectin; a rolling mediator binding partner, L-selectin; and a rolling mediator, E-selectin, although P-selectin is considered the primary adhesion molecule involved in this process. Accordingly, in this embodiment of the present invention, the leukocyte rolling mediator disposed in channel 26 may include, for example P-selectin, E-selectin, and/or an L-selectin ligand.

In another embodiment of the present invention, device 10 may be used to examine the arrest of a leukocyte wherein the leukocyte migration mediator may comprise a leukocyte arrest mediator. It is thought that most, if not all, leukocytes adhere to the endothelium only after having rolled along the endothelium. This adhesion, or “arrest” of the leukocytes on the top surface of the endothelium is initiated by chemoattractants such as IL-1 and TNF-” produced by cells at the injured site. These chemoattractants stimulate the endothelium to produce chemokines and arrest mediators on the surface of the endothelium opposite the basal lamina. The arrest mediators comprise, for example, integrin binding ligands such as ICAMs, including ICAM-1, ICAM-2, or/and ICAM-3 and VCAMs, including VCAM-1 and/or VCAM-2. The chemokines interact with chemokine receptors on the surface of the rolling leukocytes, which triggers the activation of arrest mediator binding partners on the surface of leukocytes. Arrest mediator binding partners include integrins, such as, for example, LFA-1, Mac-1, and p150,95, and VLA-4. Activation of these arrest mediator binding partners is thought to cause the slowly rolling leukocytes to “arrest” and strongly bind to the arrest mediators, such as ICAM-1, VCAM-1, and other integrin binding ligands such as collagen, fibronectin, and fibrinogen, on the endothelium. Accordingly, in this embodiment of the present invention, the leukocyte arrest mediator disposed in channel 26 may include at least one integrin binding ligand.

In yet another embodiment of the present invention, device 10 may be used to examine the transmigration of a leukocyte wherein the leukocyte migration mediator disposed in channel 26 comprises a leukocyte transmigration mediator. Once bound to the endothelium, the leukocytes flatten and squeeze between the endothelium to leave the blood vessel and enter the damaged tissue. The leukocytes follow a chemotactic gradient of chemoattractants released by cells in the damaged tissue area. Although much still remains unknown about transmigration, transmigration is thought to be mediated by platelets and endothelial cell adhesion molecule-1 (PECAM-1). Other potential transmigration mediators may be junctional adhesion molecule (JAM), ICAM-1 VE-cadherin, LFA-1, IAP, VLA-4 and possibly CD99, a transmembrane protein. Accordingly, in this embodiment of the present invention, the leukocyte transmigration mediator disposed in channel 26 may include at least one of the aforementioned adhesion molecules or any other molecule determined to be implicated in transmigration.

Device 10 of the present invention may be used to study each aforementioned step in the leukocyte migration cascade in isolation, a combination of two or more steps in the leukocyte migration cascade, or the leukocyte migration cascade in its entirety. For example, if understanding and targeting rolling are desired, then preferably only leukocyte rolling mediators may be disposed in channel 26. If both rolling and arrest of leukocytes are desired to be studied, then both rolling and arrest mediators may be disposed in channel 26. If the entire leukocyte migration cascade is to be examined, then capture mediators, rolling mediators, arrest mediators, and transmigration mediators may be disposed in channel 26. It is understood that because certain molecules belong in more than one category of migration mediators (for example P selectin and an endothelial ligand binding L-selectin function as both capture mediators and rolling mediators) and because certain mediators may be present in conjunction (for example to study arrest, both rolling and arrest mediators may be present in channel 26 since direct adhesion from free-flowing leukocytes is thought to be extremely rare), certain steps, with the knowledge currently available, may not be monitored in isolation. Because much is still unknown about the specific details of the cascade of events occurring during the inflammatory response, this invention contemplates several methods of monitoring leukocyte migration in order to gain further understanding of the basic mechanisms controlling these events.

For example, to study the process of capture, a leukocyte migration mediator comprising a capture mediator is disposed in channel 26. A sample comprising leukocytes is introduced into channel 26 via first well 18 or second well 22. Capture events are defined as adhesive interactions of those freely flowing leukocytes moving closest to the surface of channel 26 containing the capture mediators and that are therefore the only leukocytes potentially capable of interacting with the capture mediators on channel 26. Different types of initial leukocyte capture can be characterized, observed, and monitored. For example, transient capture involving leukocytes only attaching briefly to channel 26 without initiating rolling motions, and rolling capture involving leukocytes that remain rolling on channel 26, can be determined. The number of each type of captured leukocyte can be divided by the total number of free flowing leukocytes to determine the frequency of initial capture of leukocytes.

The leukocytes can also be observed via any method known in the art and via methods disclosed in co-pending application entitled “Test Device and Method of Making Same,” which is herein incorporated by reference in its entirety. Briefly, the leukocytes may be observed by using a microscope, including phase-contrast, fluorescence, luminescence, differential-interference contrast, dark field, confocal laser-scanning, digital deconvolution, and video microscopes; a high-speed video camera; and an array of individual sensors. For example, a digital movie camera may be used to monitor leukocyte activity under continuous flow conditions or a camera may be used to obtain still photographic images at particular points in time. Such observations reveal the interaction between the capture mediator binding partner expressed by the leukocytes and the capture mediator expressed by the endothelium. To detect such interaction, the cells may be incubated with staining agents and then detected based upon color or intensity contrast using any suitable microscopy technique(s). Alternatively, fluorescence-labeling may be used to detect whether capture mediator binding partners bind to capture mediators.

In another embodiment, non-labeled cells may be used to monitor migration. For example, a heterogeneous mixture of multiple cell types may be introduced into channel 26 with only one cell type capable of interacting with the capture mediators in channel 26. After the cells have been introduced into channel 26, an antibody specific to any antigen on the surface of this cell type may be used to label this cell type. If a multiple number of cell types can interact with the capture mediators, antibodies labeled with specific fluorophores can be used to distinguish different cell types.

In another embodiment directed to examining the process of rolling, a leukocyte migration mediator comprising a rolling mediator is placed in channel 26. A sample comprising leukocytes is introduced into channel 26 via first well 18 or second well 22. The number of leukocytes rolling and the rolling velocity of the leukocytes can be determined. In one embodiment, a camera is operatively linked to device 10 to obtain images of leukocytes rolling along channel 26 during predetermined intervals over a predetermined period of time. In this embodiment, the rolling velocity of the cells is determined by measuring the length the cells traveled (lframe) in an image obtained by the camera and determining the exposure time of the image (texposure). To determine the rolling velocity (V), the following formula is used: V=c(lframe/texposure) where c is a conversion factor for determining the actual distance the cells have traveled. It may vary from image to image.

In another embodiment, several different assays utilizing different types of leukocytes are performed to characterize and compare the rolling velocities associated with the different cell types. In another embodiment, several different assays utilizing different rolling mediators are performed to characterize and compare the rolling velocities of cells associated with the different rolling mediators.

In another embodiment directed to examining the process of arrest, a leukocyte migration mediator comprising a first leukocyte migration mediator and a second leukocyte migration mediator, the first and second leukocyte migration mediators being different from one another is utilized. For the purpose of clarity, the term “first leukocyte migration mediator” used herein necessarily refers to at least one first leukocyte migration mediator and the term “second leukocyte migration mediator” used herein necessarily refers to at least one second leukocyte migration mediator. In this embodiment, the first leukocyte migration mediator comprising a rolling mediator and the second leukocyte migration mediator comprising an arrest mediator are placed in channel 26. A fluid sample comprising leukocytes is preincubated with a chemoattractant capable of triggering the activation of arrest mediator binding partners, for example, integrins, on the surface of the leukocytes. The chemoattractant is any suitable substance capable of triggering integrin expression by leukocytes and includes, for example, a formyl peptide, intercrines, IL-8 GRO/MGSA, NAP-2, ENA-78, MCP-1/MCAF, RANTES, I-309, other peptides, platelet activating factor (PAF), lymphokines, collagen, fibrin and histamines. The number of arrested cells can then be determined and assays similar to those performed with only rolling mediators can be performed.

In order to further understand the biological influences that underlie the leukocyte migration cascade, particularly the interaction between leukocytes and their counter-receptors on the endothelium, device 10 may also be used to analyze the effects of various test agents on the leukocyte migration cascade. These test agents may comprise any biological, chemical or electrical substance that includes, but is not limited to potential inhibitors of the leukocyte migration mediator or potential promoters of migration mediated by the leukocyte migration mediator. Further examples of such test agents include proteins, peptides, polypeptides, enzymes, hormones, lipids, carbohydrates, small molecules, and pharmaceutical agents. For example, the device may be used to identify an inhibitor or promoter that competitively or noncompetitively inhibits or promotes a capture mediator and capture mediator binding partner interaction; rolling mediator and rolling mediator binding partner interaction; arrest mediator and arrest mediator binding partner interaction; and/or transmigration mediator and transmigration mediator binding partner interaction. As mentioned earlier, preferably the leukocyte migration mediator comprises a first leukocyte migration mediator and a second leukocyte migration mediator, the first and second leukocyte migration mediators beings different from one another. As such, in one embodiment, the test agent comprises a potential inhibitor of the first leukocyte migration mediator, the second leukocyte migration mediator, or both. In another embodiment, the test agent comprises a potential promoter of migration mediated by the first leukocyte migration mediator, the second leukocyte migration mediator, or both. After identifying inhibitors and promoters of the leukocyte migration cascade, these inhibitors and promoters can be tested for efficacy in vivo and ultimately utilized as therapeutic agents.

To screen a test agent that is a potential inhibitor of capture, a leukocyte migration mediator comprising a capture mediator is disposed in channel 26. After the potentially inhibitory test agent is incubated with a fluid sample comprising leukocytes, the sample is introduced into channel 26 via first well 18 or second well 22. Capture events are defined as adhesive interactions of those freely flowing leukocytes moving closest to the surface of channel 26 containing the capture mediators and that are, therefore, the only leukocytes potentially capable of interacting with the capture mediators on channel 26. Different types of initial leukocyte capture can be characterized, observed, and monitored. For example, transient capture involving leukocytes only attaching briefly to channel 26 without initiating rolling motions, and rolling capture involving leukocytes that remain rolling on channel 26 can be determined. The number of each type of captured leukocyte can be divided by the total number of free flowing leukocytes to determine the frequency of initial capture of leukocytes incubated with the potential inhibitory test agent and this frequency can be compared to the frequency of initial leukocyte capture in the absence of the potential inhibitory test agent. If the frequency of initial leukocyte capture is lower in the presence of the test agent relative to the frequency of initial leukocyte capture in the absence of the test agent, then the test agent is likely an inhibitor of leukocyte capture.

To screen a test agent that is a potential inhibitor of rolling, a leukocyte migration mediator comprising a rolling mediator is placed in channel 26. After the potentially inhibitory test agent is incubated with a fluid sample comprising leukocytes, the sample is introduced into channel 26 via first well 18 or second well 22. Alternatively, the potentially inhibitory test agent is introduced into the fluid sample during passage of the fluid sample in channel 26 when leukocytes have begun rolling. A decrease in rolling (e.g. as measured by a decrease in their velocity, or a decrease in the number of rolling leukocytes per volume) in the presence of the test agent, relative to that observed in the absence of the test agent, may indicate that the molecule is an inhibitor of capture and/or rolling.

To test a potentially inhibitory test agent of arrest, a leukocyte migration mediator comprising a first leukocyte migration mediator and a second leukocyte migration mediator, the first and second leukocyte migration mediators being different from one another may be utilized. In this embodiment, the first leukocyte migration mediator comprising a rolling mediator and the second leukocyte migration mediator comprising an arrest mediator are placed in channel 26. A fluid sample comprising leukocytes is preincubated with a chemoattractant capable of triggering the activation of arrest mediator binding partners, for example, integrins, on the surface of the leukocytes. After the fluid sample is preincubated with the potentially inhibitory test agent, the sample is introduced into channel 26 via first well 18 or second well 22. Alternatively, the potentially inhibitory test agent is introduced into the fluid sample during passage of the fluid sample in channel 26 when leukocytes have begun rolling. A decrease in arrest of the leukocytes (e.g., as measured by a decrease in the percentage of leukocytes that are arrested, or in the number of arrested leukocytes per volume) in the presence of the test agent relative to that observed in the absence of the test agent, indicates that the test agent may be an inhibitor of leukocyte arrest.

Device 10 can also be used to identify whether a test agent acts as a promoter of the inflammatory response by increasing the efficiency of the leukocyte migration cascade or by acting as a functional component thereof (e.g. a capture mediator, a rolling mediator, an arrest mediator, or a transmigration mediator). Such a functional component may be detected by its ability to promote capture, rolling, arrest or transmigration of a leukocyte where such action was previously lacking (due to lack of appropriate cellular specificity of a rolling mediator or arrest mediator previously present in channel 26 of chamber 14 or lack of any rolling mediator or arrest mediator). For example, device 10 comprising a first leukocyte migration mediator comprising a rolling mediator and second leukocyte migration mediator comprising an arrest mediator disposed in channel 26 may be used to identify an arrest mediator functional in leukocyte migration. In addition, device 10 comprising an arrest mediator and/or a rolling mediator disposed in channel 26 may be used to identify a rolling mediator functional in leukocyte migration.

To identify an arrest mediator, rolling mediators are disposed in channel 26 that have rolling binding partners present on the surface of leukocytes in a fluid sample to be introduced into channel 26 through first well 18 or second well 22. One or more chemoattractants capable of activating the leukocytes to express arrest mediator binding partners are preincubated with the fluid sample comprising leukocytes. A test agent to be tested for arrest mediating function is disposed in channel 26. After the fluid sample comprising leukocytes is introduced into channel 26 via first well 18 or second well 22 and the sample passes along channel 26, it is determined whether any leukocytes have arrested on channel 26. Arrest of leukocytes indicates that the test agent may be an arrest mediator that recognizes an arrest mediator binding partner on the surface of the same leukocytes that express the rolling mediator binding partner.

To identify a rolling mediator, the test agent to be tested for rolling mediator function is disposed in channel 26 and the fluid sample comprising leukocytes is introduced into channel 26 via the first well 18 or second well 22 and the sample is allowed to flow along channel 26. Rolling of the leukocytes along channel 26 indicates that the test agent has rolling mediator function and that the leukocytes express a binding partner for the rolling mediator. A rolling mediator is also identified by disposing the test agent to be tested for rolling mediator function in channel 26 and also disposing an arrest mediator in channel 26. One or more chemoattractants capable of activating the leukocytes to express arrest mediator binding partners, such as integrins, are preincubated with the fluid sample comprising leukocytes. The fluid sample comprising leukocytes is then introduced into channel 26 via the first well 18 or second well 22 and the sample is allowed to flow along channel 26. Arrest of leukocytes indicates that the test agent has rolling mediator function and that the leukocytes that express the arrest mediator binding partner and the chemoattractant receptor also express a binding partner for the test agent.

A test agent may also be identified as a functional component in the processes of leukocyte rolling or rolling and arrest, or an enhancer thereof, by the aforementioned methods in which an increase in number or percentage of leukocytes rolling or arrested is detected relative to the number or percentage of such leukocytes in the absence of the test agent. The migration of the leukocytes may be observed, monitored, recorded, and analyzed by any method known in the art and via the methods disclosed in co-pending application, “Test Device and Method of Making Same” referred to above.

The present invention also provides a kit to conduct the aforementioned assays. For example, the kit comprises a device including a housing 12 defining a plurality of chambers 14. Each of the plurality of chambers 14 includes a first well region 16 including at least one first well 18; a second well region 20 including at least one second well 22; and a channel region 24 including at least one channel 26 connecting the first well region 16 and the second well region 20 with another. The first well regions 16 and the second well regions 20 of the respective ones of the plurality of chambers 14 are disposed relative to one another to match a pitch of a standard microtiter plate, thus advantageously allowing for high through-put screening of tests agents. The kit further includes a first leukocyte migration mediator. The kit may also contain a sample comprising leukocytes. The first leukocyte migration mediator and the sample comprising leukocytes may be packaged in the kit in any manner known in the art. For example, the first leukocyte migration mediator may be contained in a vial or container and the sample comprising leukocytes may similarly be contained in a separate vial or container. The kit may further include a second leukocyte migration mediator different from the first leukocyte migration mediator. The kit may additionally include an inhibitor adapted to inhibit the first leukocyte migration mediator, the second leukocyte migration mediator, or both. The kit may further include a promoter adapted to promote migration mediated by the first leukocyte migration mediator, the second leukocyte migration mediator, or both. The kit may also include any media and buffers necessary for use with the device and particular assays.

With respect to particular details of device 10, preferably, as shown by way of example in FIGS. 42 and 47, the housing 12 of device 10 comprises a support member 28, and a top member 30 mounted to the support member 28, wherein the support member 28 and the top member 30 are configured such that they together define the plurality of chambers 14. Preferably, the housing is also sized to match dimensions of a standard microtiter plate, for example, the dimensions of a 24-well microtiter plate, a 96-well microtiter plate, a 384-well microtiter plate, 768-well microtiter plate and a 1536-well microtiter plate. The top member may be made of any suitable material known in the art including glass, plastic, or an elastomeric material such as polydimethylsiloxane (PDMS). The support member may be made of glass, polystyrene, polycarbonate, polyacrylates, polymethyl methacrylate (PMMA), PDMS and other plastics. Preferably, top member 30 is in conformal contact with support member 28.

In another embodiment of the present invention, device 10 comprises a support member 28; and top member 30, the top member 30 mounted to the support member 28 by being placed in conformal contact with the support member 28. The support member 28 and the top member 30 are configured such that they together define at least one chamber 14. The at least one chamber 14 includes a first well region 16 including at least one first well 18; a second well region 20 including at least one second well 22; and a channel region 24 including at least one channel 26 connecting the first well region 16 and the second well region 20 with one another. In one embodiment, the at least one channel 26 includes at least one leukocyte migration mediator disposed therein. In another embodiment, the at least one channel 26 includes endothelial cells disposed therein. Preferably, the top member 30 is configured to be placed in reversible, conformal contact with the support member 28. As such, top member 30 is preferably made of a material that is adapted to effect conformal contact, preferably reversible conformal contact, with support member 28. According to this embodiment, the flexibility of such a material, among other things, allows top member 30 to form-fittingly adhere to support member 28 in such a way as to form a substantially fluid-tight seal therewith. The conformal contact should preferably be strong enough to prevent slippage of top member 30 on support member 28. Where the conformal contact is reversible, top member 30 may be made of a material having the structural integrity to allow top member 30 to be removed by a simple peeling process. This would allow top member 30 to be removed from support member 28 after experimentation, properly cleansed, and then reused for future assays. Preferably, the peeling process does not disturb any surface treatment, such as leukocyte migration mediators or endothelial cells, on support member 28. Additionally, the substantially fluid-tight seal effected between top member 30 and support member 28 by virtue of the conformal contact of top member 30 with support member 28 prevents fluid from leaking from one chamber to an adjacent chamber, and also prevents contaminants from entering the wells. The seal preferably occurs essentially instantaneously without the necessity to maintain external pressure. The conformal contact obviates the need to use a sealing agent to seal top member 30 to support member 28. Although embodiments of the present invention encompass use of a sealing agent, the fact that such a use is obviated according to a preferred embodiment provides a cost-saving, time-saving alternative, and further eliminates a risk of contamination of each chamber 14 by a sealing agent. Preferably, the top member 30 is made of a material that does not degrade and is not easily damaged by virtue of being used in multiple tests, and that affords considerable variability in the top member's configuration during manufacture of the same. More preferably, the material may be selected for allowing the top member 30 to be made using photolithography. In a preferred embodiment, the material comprises an elastomer such as silicone, natural or synthetic rubber, or polyurethane. In a more preferred embodiment, the material is PDMS. Support member 28 provides a support upon which top member 30 rests, and may be made of any material suitable for this function. Suitable materials are known in the art such as glass, polystyrene, polycarbonate, PMMA, polyacrylates, PDMS, and other plastics.

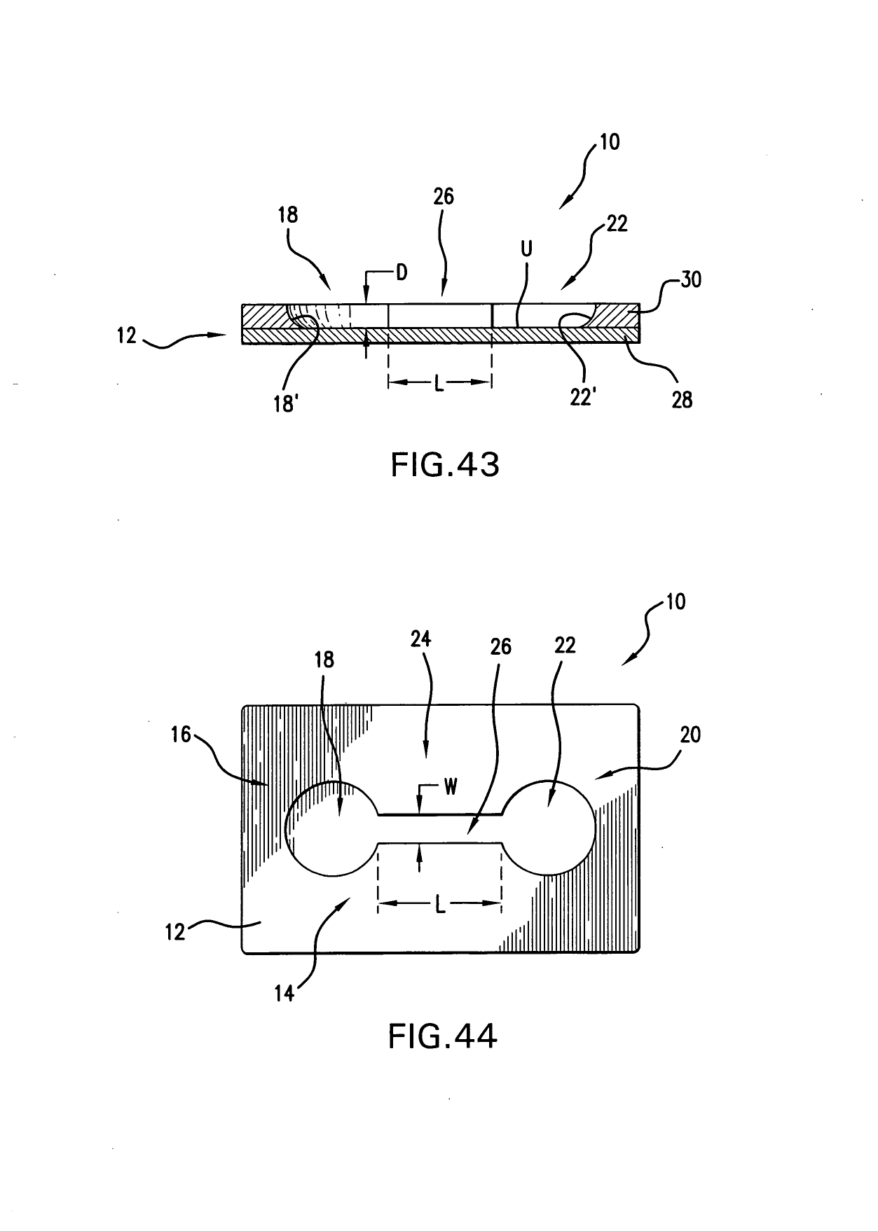

With respect to portions of chamber 14, in one embodiment, well regions 16 and 20 are vertically offset with respect to one another is a test orientation of device 10. In a preferred embodiment, well regions 16 and 20 are horizontally offset with respect to one another is a test orientation of device 10. Wells 18 and 22 of respective well regions 16 and 20 of each chamber 14 are not limited in their configuration to any particular three dimensional contour, it being only required that they be adapted to receive a fluid therein, preferably a sample comprising leukocytes. Preferably, wells 18 and 22 are configured such that they substantially define circles in top plan views thereof, as shown by way of example in FIGS. 42-47. However, other contours in the top plan view of a given well is within the scope of the present invention, as readily recognized by one skilled in the art. Where the wells define circles in top plan views thereof, and where, the well regions are disposed relative to one another to match a pitch of a standard 96-well microtiter plate, the pitch P is set to be equal to about 9 mm, and the diameter Dw of a top plan contour of the wells is set to be equal to about 6 mm. In such a case, length L of each channel 26 is equal to about 3 mm. As shown in particular in FIG. 43, wells 18 and 22 are defined in part by respective through-holes 18 and 22 in top member 30, and in part by an upper surface U of support member 28. In particular, the sides of each well 18 and 22 are defined by respective walls of the through holes 18 and 22 in the top member 30, and the bottoms of wells 18 and 22 are defined by a corresponding portion of the upper surface U of support member 28.

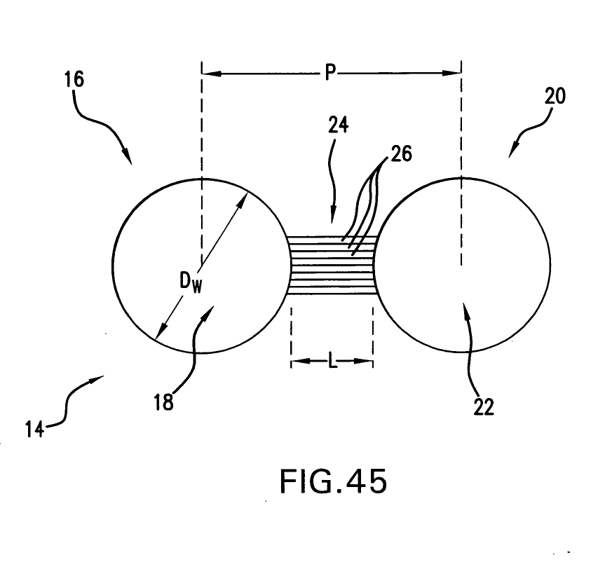

With respect to channel region 24 of chamber 12, as seen collectively in FIGS. 43-45, a length L of a channel 26 is defined in a direction of the longitudinal axis thereof. In addition, depth D of a channel 26 is defined in a direction normal to a top surface of housing 12; and a width W of a channel region 26 is defined in a direction normal to length L and depth D. Preferably, channel region 24 comprises a plurality of rectilinear, parallel channels 26 extending between well regions 16 and 20. Preferably, channels 26 have lengths L that are substantially identical, as shown schematically by way of example in FIG. 45. More preferably, the plurality of channels 26 comprises eight channels. By using multiple channels, multiple assays can be performed simultaneously using one sample comprising leukocytes. In such an embodiment, all assays are performed under uniform and consistent conditions and therefore provide statistically more accurate results. Channels 26 preferably each have a width W of 50:m to 5 mm; a length L of about 1-10 mm; and a height H of about 10-100:m. More preferably, the channels 26 each have a width W of about 100 microns, a length L of about 3 mm and a height of about 50:m to about 80:m. The dimensions of the channels 26 of channel region 24 should be configured to support the migration of leukocytes under conditions simulating such migration during an inflammatory response. As such, the channel region should be adapted to support the migration of leukocytes under shear flow and to support at least one leukocyte migration mediator disposed therein. It is to be noted that the embodiments of device 10 described in relation to FIGS. 42-47 are merely exemplary, and that various other configurations are within the scope of the present invention. Other examples for the configuration of device 10 are provided in the co-pending application entitled “Test Device and Method of Making Same,” referenced to above.

Device 10 of the present invention can be fabricated, according to a preferred embodiment of a method of the present invention, by standard photolithographic procedures. Photolithographic procedures can be used to produce a master that is the negative image of any desired configuration of top member 30. For example, the dimensions of chamber 14, such as the size of well region 16 and 18, or the length of channel region 24, can be altered to fit any advantageous specification. Once a suitable design for the master is chosen and the master is fabricated according to such a design, the material for top member 30 is either spin cast, injected, or poured over the master and cured. Once the mold is created, this process can be repeated as often as necessary. This process not only provides great flexibility in the top member's design, it also allows the top members to be massively replicated.

Once the device is fabricated, leukocyte migration mediators can be disposed in channel 26. The leukocyte migration mediators can be disposed in channel 26 by affixing them or physioadsorbing them directly on the upper surface U of support member 28, or by coating a solution or suspension comprising the leukocyte migration mediators on the upper surface U of support member 28, as long as the mediators are accessible to leukocytes flowing by the upper surface U. In one embodiment, the leukocyte migration mediators are either covalently or non-covalently affixed directly to upper surface U by techniques such as covalent bonding via an amide, ester or lysine side chain linkage or adsorption. Other method of disposing leukocyte migration mediators, including immobilizing them on upper surface U of support member 28 are disclosed in co-pending application, “Test Device and Method of Making Same” referred to above.

The present invention also provides a device comprising a housing 12; means associated with the housing defining a plurality of chambers 14 in the housing 12. Each of the plurality of chambers 14 includes: an inlet means for receiving a sample comprising leukocytes; an outlet means in flow communication with the inlet means for receiving the sample comprising leukocytes from the inlet means; and connection means connecting the inlet means and the outlet means to one another, the connection means including at least one leukocyte migration mediator disposed therein. An example of means associated with the housing defining a plurality of chambers in the housing comprises a top member mounted to a support member as shown in FIG. 47. The above means have been substantially shown and described in relation to the embodiments of the FIG. 42-47. Other such means would be within the knowledge of persons skilled in the art.

Throughout this application, reference has been made to various publications, patents, and patent applications. The teachings and disclosures of these publications, patents, and patent applications in their entireties are hereby incorporated by reference into this application to more fully describe the state of the art to which the present invention pertains.

In another embodiment, the present invention provides methods of assaying and studying biological phenomenon that either depend on or react to gradient formation and/or flow conditions. Such biological phenomenon include many of the processes in the body such as cell-surface interactions such as that occurring during leukocyte adhesion and rolling. In addition, studies involving chemotaxis, haptotaxis and cell migration will be better served with assays that are able to study such cell movement in the presence of gradients and/or flow conditions.

Various types of gradients are useful in the study of biological systems. Such useful gradients include static gradients, which have concentrations that are fixed, or set or substantially fixed or set. One example of a static gradient is a gradients of immobilized molecules on a surface. Non-limiting examples of static gradients include the use of differing concentrations of immobilized biomolecules (proteins, antibodies, nucleic acids, and the like) or immobilized chemical moieties (drugs and small molecules). Other useful gradients include dynamic gradients, which have concentrations that may be varied. One example of a dynamic gradient is a gradient of fluid streams having molecules in varying concentrations. Non-limiting examples of fluid gradients include the use of fluid streams containing biomolecules such as growth factors, toxins, enzymes, proteins, antibodies, carbohydrates, drugs or other chemical and small molecules in varying concentrations.

In one embodiment of the present invention, a dynamic/solution based gradient is created by laminar flow technology. Laminar flow technology typically involves two or more fluid streams from two or more different sources. These fluid streams are brought together into a single stream and are made to flow parallel to each other without turbulent mixing. Fluids with different characteristics such as varying low Reynolds numbers will flow side by side and will not mix in the absence of turbulence. Since the fluids do not mix, they create pseudo-channels (pseudo by the fact that there are no physical separation between the fluids). The generation of solution and surface gradients is discussed in U.S. patent application 2002/0113095 and an article, Jeon, Noo Li, et al., Langmuir, 16, 8311-8316 (2000). Both of these references are herein incorporated by reference in their entirety.

In these references a PDMS microfluidic device was used to generate a gradient through a microfluidic network of capillaries. Solutions containing different chemicals were introduced into three separate inlets and allowed to flow through the network of capillaries. The fluid streams were repeatedly combined, mixed, and split to yield distinct mixtures with distinct compositions in each of the branching channels. When all of the branches were recombined, a concentration gradient was established across the outlet channel, perpendicular to the flow direction. See FIG. 54.

By combining the devices of the present invention with the formation of a dynamic gradient, a vast number of assay parameters can be generated by altering any portion of the device. For example, by combining the device as disclosed herein with cell patterning techniques, along with the introduction of a dynamic gradient, various conditions can be created to test numerous biological interactions. Further, the device and assays may be useful in drug discovery and drug testing as many cells and biological materials behave differently ex vivo when not exposed to gradients than compared to when the cells or biological materials are present in vivo and thus exposed to gradients and flow conditions.

Accordingly, in one embodiment of the present invention, cells can be patterned across the channel. Cell patterning can be achieved by methods known in the art, as well as disclosed in the present invention (such as, but not limited to, microcontact printing or by the use of elastomeric stencils). A solution containing any desired biomolecule or chemical/drug can then be flowed across the patterned cells. Additionally, the cells could be first treated by a biomolecule such as an activator to more closely recreate a biological system, and then be subsequently exposed to a chemical or drug. By creating a gradient, such as by laminar flow, different amounts of biomolecules or chemicals/drugs can be delivered to the patterned cells and thus the effect of concentration of each biomolecule or chemical/drug be tested simultaneously against each other. This side by side, same time comparison thus reduces the variability of assay to assay conditions.

Creating dynamic gradients with laminar flow in combination with the devices of the present invention provides numerous assay configurations. For example, by varying the combinations of the cells on the surface, the biomolecule in the channels and the compounds in the channel, one can create a vast multitude of assays.

With respect to immobilized cells or other immobilized biomolecules such as proteins, antibodies, nucleic acids, etc. different assay configurations are possible. In one embodiment, a single cell type is immobilized throughout the entire channel region. In another embodiment, a mixture of cell types are immobilized, one cell type per region. In another embodiment, a mixture of cell types is immobilized throughout the entire channel region. This may be advantageous in monitoring cell-cell interactions. In yet another embodiment, different cell types are immobilized in each different region.

In addition to the various immobilization schemes, further assay design flexibility centers around the biomolecules present in the channels. For example, in one embodiment, one type of biomolecule is present in each channel at the same concentration. In another embodiment, one type of biomolecule is present in each channel at differing concentrations. In another embodiment, different biomolecules are present in each channel. In another embodiment, there is a mixture of biomolecules in each channel. Each channel may have the same mixture or a different mixture. When the mixture is the same, the ratios or concentrations of the different biomolecules may be different in each channel.

Likewise with respect to compounds, such as drugs or test substances, the present invention provides flexibility in assay design. For example, in one embodiment a single compound is present in all the channels at the same concentration throughout. In another embodiment, the same compound is present in all the channels but each channel has a different concentration of that compound. In another embodiment, each channel has a different compound. In another embodiment, there is more than one compound. When there is more than one compound, each channel may have the same mixture of compounds or may have a different mixture of compounds. Further, when the mixtures of the compounds are the same, each channel may receive a different concentration of that mixture. Yet, even further, each channel may receive the mixture of the compounds, with each channel having a different ratio of compounds to each other.

Such assay systems can be used to test among many numerous biological interactions, the effects of chemical or drugs on cells or other biomolecules. For example, one may use the device and the assays of the present invention to measure the IC50 of a compound by using a laminar flow gradient of a compound present from a low concentration to a high concentration flowed across immobilized biomolecules.

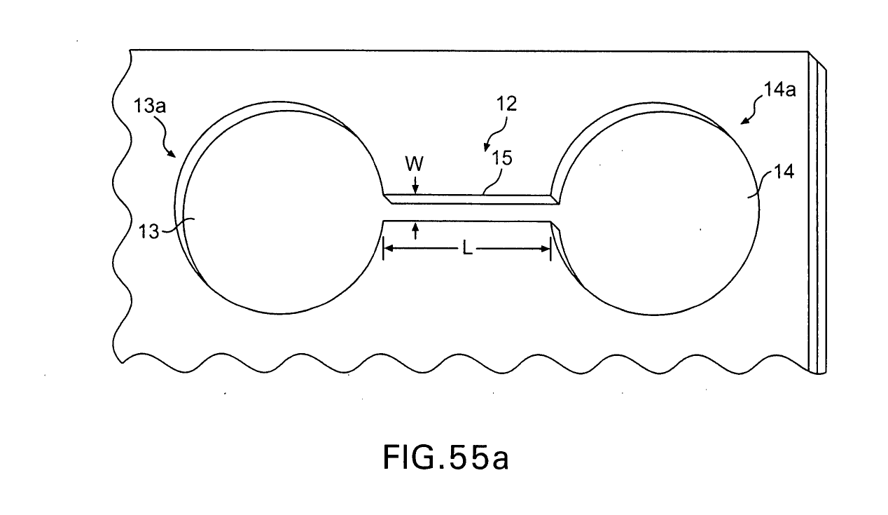

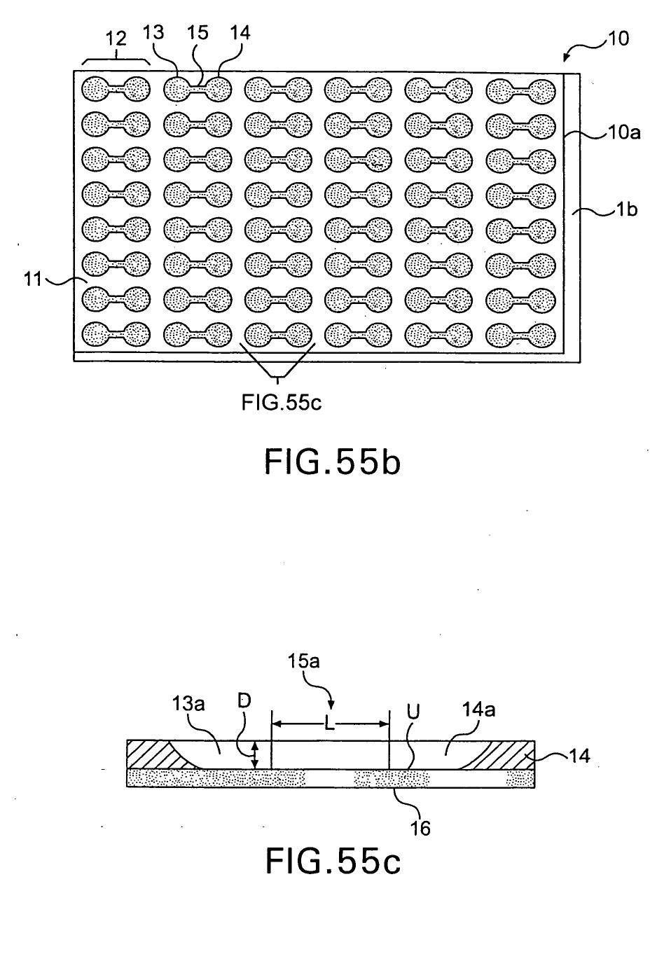

As shown in FIG. 55AA, according to one embodiment of the present invention, a test device 10, such as, for example, a cellular chemotaxis/haptotaxis and/or chemoinvasion device, includes a housing 10a comprising a support member 16 and a top member 11 mounted to the support member 16 by being placed in substantially fluid-tight, conformal contact with the support member 16. In the context of the present invention, “conformal contact” means substantially form-fitting, substantially fluid-tight contact. The support member 16 and the top member 11 are configured such that they together define a discrete chamber 12 as shown. Preferably test device 10 comprises a plurality of discrete chambers, as shown by way of example in the embodiment of FIG. 55B. The discrete chamber 12 includes a first well region 13a including at least one first well 13 and second well region 14a including at least one second well 14, the second well region further being horizontally offset with respect to the first well region in a test orientation of the device. The “test orientation” of the device is meant to refer to a spatial orientation of the device during testing. As shown in FIG. 55C, device 10 further includes a channel region 15a including at least one channel 15 connecting the first well region 13a and the second well region 14a with one another. In the embodiments of FIGS. 55A-55C, each well region includes a single well, and the channel region includes a single channel. As seen in FIG. 55C, each well is defined by a through-hole in top member 11, corresponding to well 13 and well 14 respectively, and by an upper surface U of support member 16. In particular, the sides of each well 13 and 14 are defined by the walls of the through holes in the top member 11, and the bottoms of well 13 and 14 are defined by the upper surface U of support member 16. It is noted that in the context of the present invention, “top,” “bottom,” “upper” and “side” are defined relative to the test orientation of the device. As seen collectively in FIGS. 55A and 55C, a length L of channel region 15a is defined in a direction of the longitudinal axis of channel region 15a; a depth D of channel region 15a is defined in a direction normal to upper surface U of support member 16; a width W is defined in a direction normal to the length L and depth D of channel region 15a. According to one embodiment of the present invention, the chamber's first well 13 is adapted to receive a test agent, a soluble test substance and/or a test agent comprising immobilized biomolecules, which potentially affects chemotaxis or haptotaxis. Biomolecules include, but not limited to, DNA, RNA, proteins, peptides, carbohydrates, cells, chemicals, biochemicals, and small molecules. The chamber's second well 14 is adapted to receive a biological sample of cells. Immobilized biomolecules are biomolecules that are attracted to support member 16 with an attractive force stronger than the attractive forces that are present in the environment surrounding the support member, such as solvating and turbulent forces present in a fluid medium. Non-limiting examples of the test agent include chemorepellants, chemotactic inhibitors, and chemoattractants, such as growth factors, cytokines, chemokines, nutrients, small molecules, and peptides. Alternatively, the chamber's first well 13 is adapted to receive a biological sample of cells and the chamber's second well 14 is adapted to receive a test agent.

In one embodiment of the present invention, when a soluble test substance is used as the test agent, channel region 15a preferably contains a gel matrix. The gel matrix allows the formation of a solution concentration gradient from first well region 13a towards second well region 14a as the solute diffuses from an area of higher concentration (well region 13a) through a semi-permeable matrix (the gel matrix) to an area of lower concentration (well region 14a). If the soluble test substance comprises a chemoattractant, in order for the cells to migrate through the matrix in the direction of the solution concentration gradient towards well region 13a, the cells must degrade this matrix by releasing enzymes such as matrix metalloproteases. This cell chemotaxis and invasion may be subsequently observed, measured, and recorded.

In one embodiment of the present invention, utilizing immobilized biomolecules as the test agent, the biomolecules are preferably immobilized or bound on the portion of support member 16 underlying channel region 15a and underlying through hole for well region 13a. The concentration of biomolecules decreases along the longitudinal axis of the device from well region 13a towards well region 14a forming a surface concentration gradient of immobilized biomolecules and the biological sample of cells potentially responds to this surface gradient. This cell haptotaxis may be subsequently observed, measured, and recorded.

With respect to particular specifications of device 10, top member 11 is made of a material that is adapted to effect conformal contact, preferably reversible conformal contact, with support member 16. According to embodiments of the present invention, the flexibility of such a material, among other things, allows the top member to form-fittingly adhere to the upper surface U of support member 16 in such a way as to form a substantially fluid-tight seal therewith. The conformal contact should preferably be strong enough to prevent slippage of the top member on the support member surface. Where the conformal contact is reversible, the top member may be made of a material having the structural integrity to allow the top member to be removed by a simple peeling process. This would allow top member 11 to be removed and cells at certain positions collected. Preferably, the peeling process does not disturb any surface treatment or cell positions of support member 16. Physical striations, pockets, SAMs, gels, peptides, antibodies, or carbohydrates can be placed on support member 16 and the top member 11 subsequently can be placed over support member 16 without any damage to these structures. Additionally, the substantially fluid-tight seal effected between top member 11 and support member 16 by virtue of the conformal contact of top member 11 with support member 16 prevents fluid from leaking from one chamber to an adjacent chamber, and also prevents contaminants from entering the wells. The seal preferably occurs essentially instantaneously without the necessity to maintain external pressure. The conformal contact obviates the need to use a sealing agent to seal top member 11 to support member 16. Although embodiments of the present invention encompass use of a sealing agent, the fact that such a use is obviated according to a preferred embodiment provides a cost-saving, time-saving alternative, and further eliminates a risk of contamination of each chamber 12 by a sealing agent. Preferably, the top member 11 is made of a material that does not degrade and is not easily damaged by virtue of being used in multiple tests, and that affords considerable variability in the top member's configuration during manufacture of the same. More preferably, the material may be selected for allowing the top member to be made using photolithography. In a preferred embodiment, the material comprises an elastomer such as silicone, natural or synthetic rubber, or polyurethane. In a more preferred embodiment, the material is polydimethylsiloxane (“PDMS”).

In another embodiment of the present invention, device 10 includes a housing defining a chamber, the chamber including a first well region including at least one first well; a second well region including at least one second well; and a channel region including a plurality of channels connecting the first well region and the second well region with one another. The second well region is preferably horizontally offset with respect to the first well region is a test orientation of the device.

According to a preferred embodiment of a method of the present invention, standard photolithographic procedures can be used to produce a silicon master that is the negative image of any desired configuration of top member 11. For example, the dimensions of chambers 12, such as the size of well regions 13a and 14a, or the length of channel region 15a, can be altered to fit any advantageous specification. Once a suitable design for the master is chosen and the master is fabricated according to such a design, the material is either spin cast, injected, or poured over the master and cured. Once the mold is created, this process may be repeated as often as necessary. This process not only provides great flexibility in the top member's design, it also allows the top members to be massively replicated. The present invention also contemplates different methods of fabricating device 10 including, for example, e-beam lithography, laser-assisted etching, and transfer printing.

Device 10 preferably fits in the footprint of an industry standard microtiter plate. As such, device 10 preferably has the same outer dimensions and overall size of an industry standard microtiter plate. Additionally, when chamber 12 comprises a plurality of chambers, either the chambers 12 themselves, or the wells of each chamber 12, may have the same pitch of an industry standard microtiter plate. The term “pitch” used herein refers to the distance between respective vertical centerlines between adjacent chambers or adjacent wells in the test orientation of the device. The embodiment of device 10, shown in FIG. 55B, comprises 48 chambers designed in the format of a standard 96-well plate, with each well fitting in the space of each macrowell of the plate. The size and number of the plurality of chambers 12 can correspond to the footprint of standard 24-, 96-, 38-, 768- and 1536-well microtiter plates. For example, for a 96 well microtiter plate, device 10 may comprise 48 chambers 12 and therefore 48 experiments can be conducted, and for a 384 well microtiter plate, the device may comprise 192 chambers 12, and therefore 192 experiments can be conducted. The present invention also contemplates any other number of chambers and/or wells disposed in any suitable configuration. For example, if pitch or footprint standards change or new applications demand new dimensions, then device 10 may easily be changed to meet these new dimensions. By conforming to the exact dimension and specification of standard microtiter plates, embodiments of device 10 would advantageously fit into existing infrastructure of fluid handling, storage, registration, and detection. Embodiments of device 10, therefore, may be conducive to high throughput screening as they may allow robotic fluid handling and automated detection and data analysis.

Top member 11 may additionally take on several different variations and embodiments. Depending on the test parameters, such as, for example, where chemotaxis, haptotaxis and/or chemoinvasion are to be monitored, the cell type, cell number, or distance over which chemotaxis or haptotaxis is required, chamber 12 of top member 11 may have various embodiments of which a few exemplary embodiments are discussed herein. With respect to a discrete chamber 12, the shape, dimensions, location, surface treatment, and numbers of channels in channel region 15a and the shape and number of wells 13 and 14 may vary.

Regarding the shape of channel region 15a, each channel 15 in the channel region 15a is not limited to a particular cross-sectional shape, as taken in a plane perpendicular to its longitudinal axis. For example, the cross section of any given channel 15 can be hexagonal, circular, semicircular, ellipsoidal, rectangular, square, or any other polygonal or curved shape.

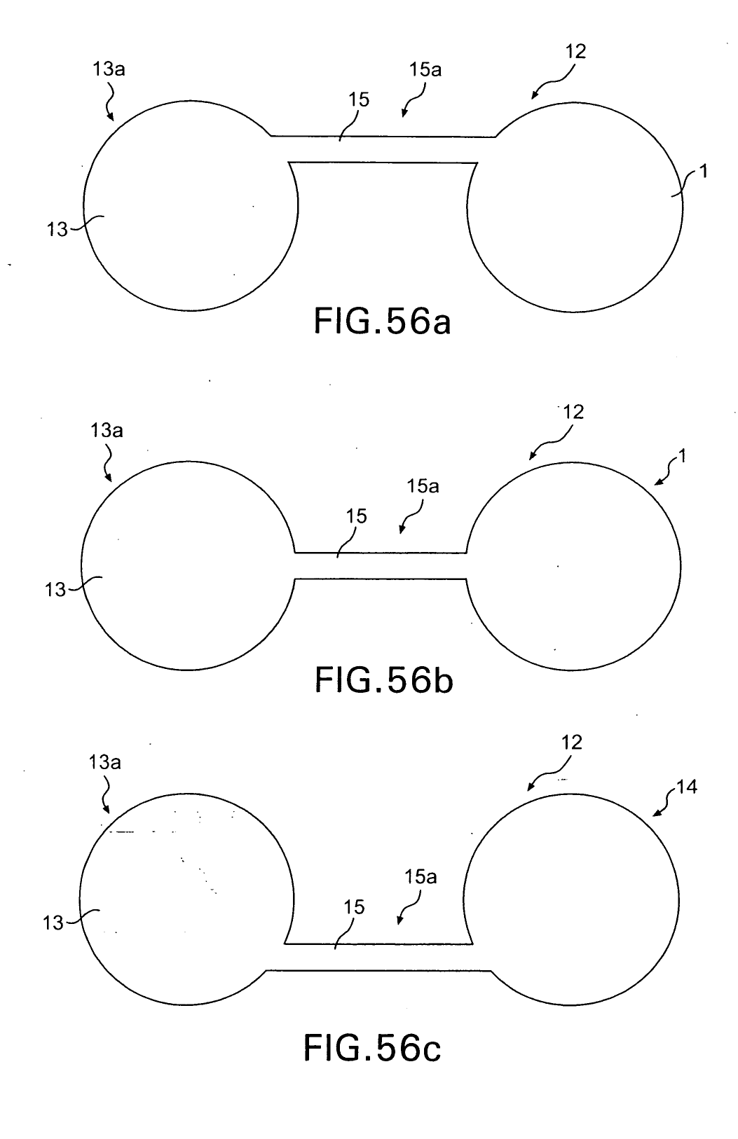

Regarding the dimensions of a channel 15, the length L of a given channel 15 can vary based on various test parameters. For instance, the length L of a given channel 15 may vary in relation to the distance over which chemotaxis or haptotaxis is required to occur. For example, the length L of a given channel 15 can range from about 3 μm to about 18 mm in order to allow cells sufficient distance to travel and therefore sufficient opportunity to observe cell chemotaxis/haptotaxis and chemoinvasion. The width W and depth D of a given channel 15 may also vary as a function of various test parameters. For examples, the width W and depth D of a given channel 15 may vary, in a chemotaxis, haptotaxis and/or chemoinvasion device, depending on the size of the cell being studied and whether a gel matrix is added to the given channel 15. Generally, where the test device is a chemotaxis, haptotaxis and/or chemoinvasion device, a given channel 15's width W and depth D may be approximately in the range of the diameter of the cell being assayed. To discount random cellular movement, at least one of the depth D or width W of a given channel 15 should preferably be smaller than the diameter of the cell when no gel matrix is placed in the given channel 15 so that when the cells are activated, they can “squeeze” themselves through the given channel toward the test agent. If a given channel 15 contains a gel matrix, then, the depth D and width W of the given channel 15 may be greater than the diameter of the cell being assayed. Referring by way of example to the embodiments of FIGS. 55A-56C, if suspension cells such as leukocytes, which are about 3-12 μm in diameter, are in well 14 and channel 15 contains no gel, then the width W of channel 15 should range from about 3 microns to about 20 μm, and the depth D of channel 15 should range from about 3 microns to about 20 μm but at least either the depth D or width W of channel 15 should be smaller than the diameter of the cell. If leukocytes are in well 14 and channel 15 contains a gel matrix, then the width W of channel 15 should range from about 20 to about 100 μm and the depth D should range from about 20 μm to about 100 μm, and both the width W and depth D of channel 15 can be greater than the diameter of the cell assayed. Similarly, if adherent cells, such as endothelial cells which are 3-10 microns in diameter before adherence, are in well 14 and channel 15 contains no gel, then the width W and depth D of channel 15 can range from about 3 to about 20 μm, but at least either the width W or depth D of channel 15 should be smaller than the diameter of the cell assayed. If adherent cells are in well 14 and channel 15 contains a gel matrix then the width W and depth D of channel 15 should range from about 20 μm to about 200 μm and both the width W and depth D of channel 15 can be greater than the diameter of the cell assayed.

As seen in FIGS. 56A-56C channel 15 may connect the first well 13 to the second well 14 at respective sides of the wells, as shown in FIGS. 56A and 56C or at a central region of the wells, as shown in FIG. 56B.

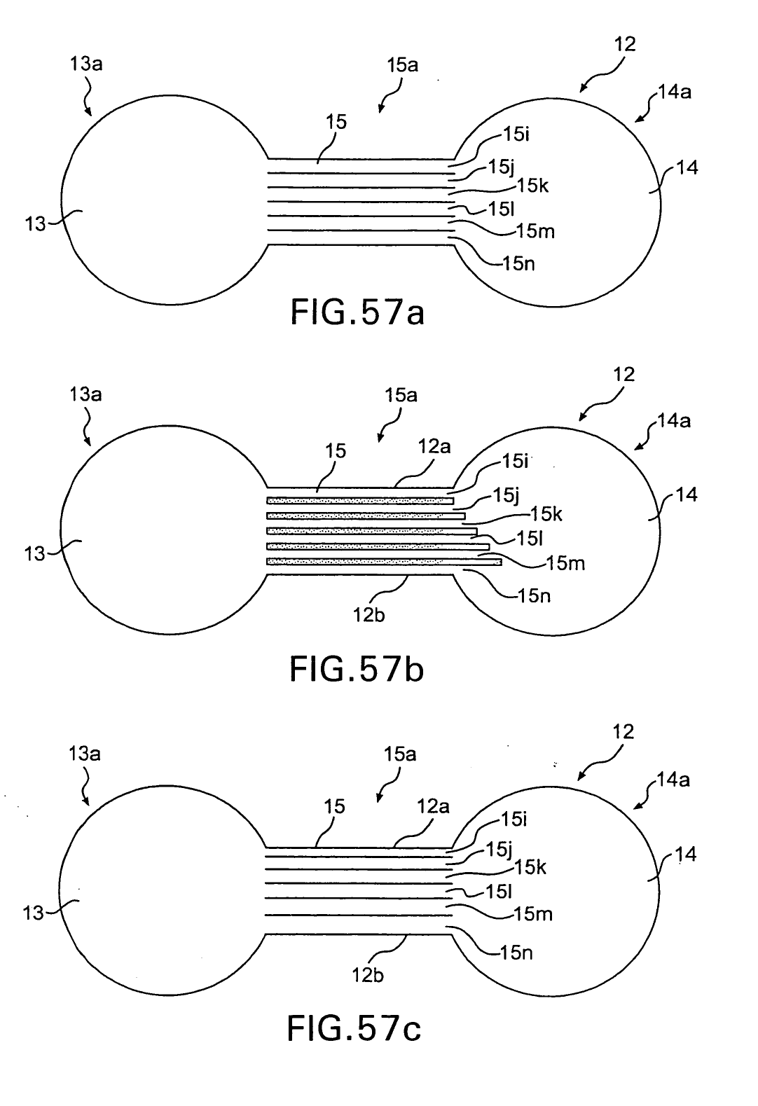

The number of channels in channel region 1Sa between well regions 13a and 14a can also vary. Channel region 15a may include a plurality of channels, as shown by way of example in FIGS. 57A-57C. As seen in FIG. 57A, in a preferred configuration, the length L of each channel 15i-n between well 13 and well 14 is identical. In another embodiment as seen in FIG. 57B, the length L of each channel 15i-15n of channel region 15a increases in the direction of well 14, starting from channel 15i in the side portion 12a of chamber 12 to channel 15n in the side portion 12b of chamber 12. In one embodiment, as seen in FIG. 57B, the length L of each successive channel in the plurality of channels 15 of chamber 12 increases in a direction of a width W of the channels with respect to a preceding one of the plurality of channels such that respective channel inlets at one of the first well region and the second well region, such as well region 13a as shown, are aligned along the direction of the width W of the channels. Although, in this configuration, the cells traveling in any particular channel will exit the channels and enter well 14 at points longitudinally offset with respect to one another, the section of channel region 15a closest to well region 13a is positioned so that cells ultimately entering the different channels will be aligned in a direction of the width W of the channels so that there is no longitudinal offset between them. Therefore, in comparing two adjacent channels, a first group of cells entering channel 15i has an entry position that is not longitudinally offset with respect to a second different group of cells entering channel 15j, but the first group of cells exiting channel 15i has an exit point longitudinally offset from the second group of cells exiting channel 15j. In a different embodiment of the present invention illustrated in FIG. 57C, the width W of each channel 15i-15n increases starting from channel 15i in the side portion 12a of chamber 12 to channel 15n in the side portion 12b of chamber 12. Preferably, the width W or depth D of each successive channel of the plurality of channels increases in a direction of a width W of the channels with respect to a preceding one of the plurality of channels. Alternatively, a depth D of each successive channel could increase (not shown) along a direction of the width W of the channels. It is understood to those skilled in the art, that various embodiments altering the dimensions of the channels in the channel region 15a are within the scope of the present invention. For example, the length of the channels 15i-15n need not increase in a continuous manner from channel 15i to 15n as illustrated in FIG. 57B. Instead, channel 15i-15n may have varying lengths following no particular order or pattern.

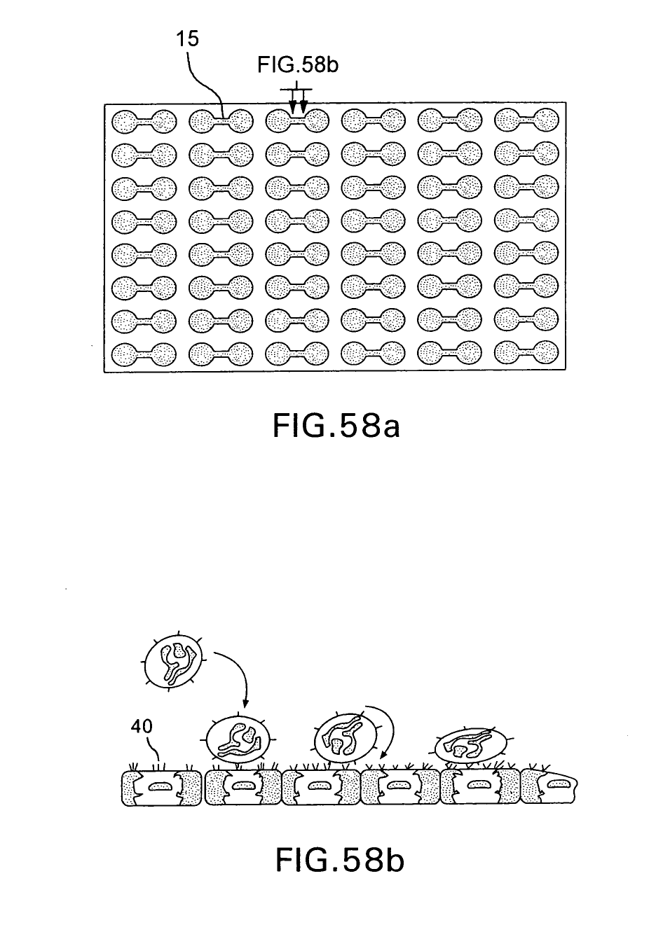

With respect to surface treatment of a given channel 15, to simulate in vivo conditions where cells are surrounded by other cells, the lateral walls of a given channel 15 may be coated with cells, such as endothelial cells 40 as seen in FIG. 58B. Non-limiting examples of endothelial cells include human umbilical vein endothelial cells or high endothelial venule cells. In another embodiment, a given channel 15 is filled with a gel matrix such as gelatin, agarose, collagen, fibrin, any natural or synthetic extracellular proteinous matrix or basal membrane mimic including, but not limited to MATRIGEL™ (Becton Dickenson Labware), or ECM GEL, (Sigma, St. Louis, Mo.), or other hydrogels containing certain factors such as cytokines, growth factors, antibodies, ligands for cell surface receptors, or chemokines. Preferably, the gel has a substantially high water content and is porous enough to allow cell chemotaxis and invasion. As mentioned above, when the test agent comprising a soluble test substance is placed in well 13, the gel facilitates formation of a solution concentration gradient along the longitudinal axis of chamber 12. Additionally, adding a gel matrix to a given channel 15 simulates the natural environment in the body, as enzyme degradation through extracellular matrix is a crucial step in the invasive process.

According to the present invention, the individual wells of each well region 13a or 14a may have any shape and size. For example, the top plan contour of a given well may be circular, as shown in FIGS. 55A-56C, or trapezoidal as shown in FIGS. 5 and 6. Alternatively, the top plan contour of a given chamber may be generally in the shape of a “figure 8” as shown in FIG. 61. Preferably when using a soluble test substance as the test agent, the shape of well 13 is such that soluble test substance is readily able to access the channel 15 and thereby form the necessary solution concentration gradient along the length L of channel 15. Preferably, the shape of well 14 is such that cells are not deferred, detained, or hindered from migrating out of the first well 14, for example, by accumulating in a corner, side or other dead space of well 14. Although possible accumulation of cells in a dead space of well 14 is not restricted to any particular cell number, there exists a greater likelihood of cells accumulating in a corner of well 14 if a large number of cells are used. Therefore to maximize accessibility to the concentration gradient and to minimize the “wasting” of cells when a large cell sample is utilized, it is important that the shape of well 14 be such that a sufficiently high percentage of cells, particularly the cells in the area of well 14 furthest from channel 15, are capable of migrating out of well 14. In a different embodiment that also addresses the problem of the wasting of cells, well 14 may be shaped such that all cells have a higher probability of accessing the concentration gradient. For example as seen in FIG. 8, the length L, of well 14 in a top plan view thereof is minimized to decrease the surface area of the well. As such, the cells are closer to the concentration gradient formed in channel 15. In a preferred embodiment, the L, of well 14 in a top plan view thereof is about 1 mm to about 2 mm.

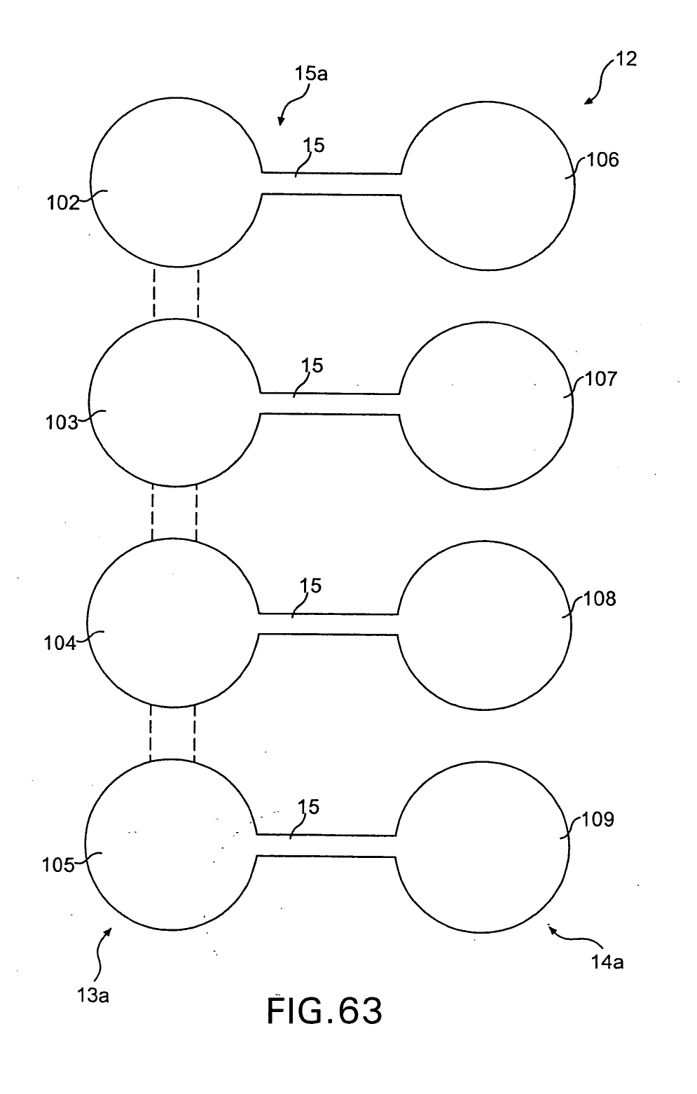

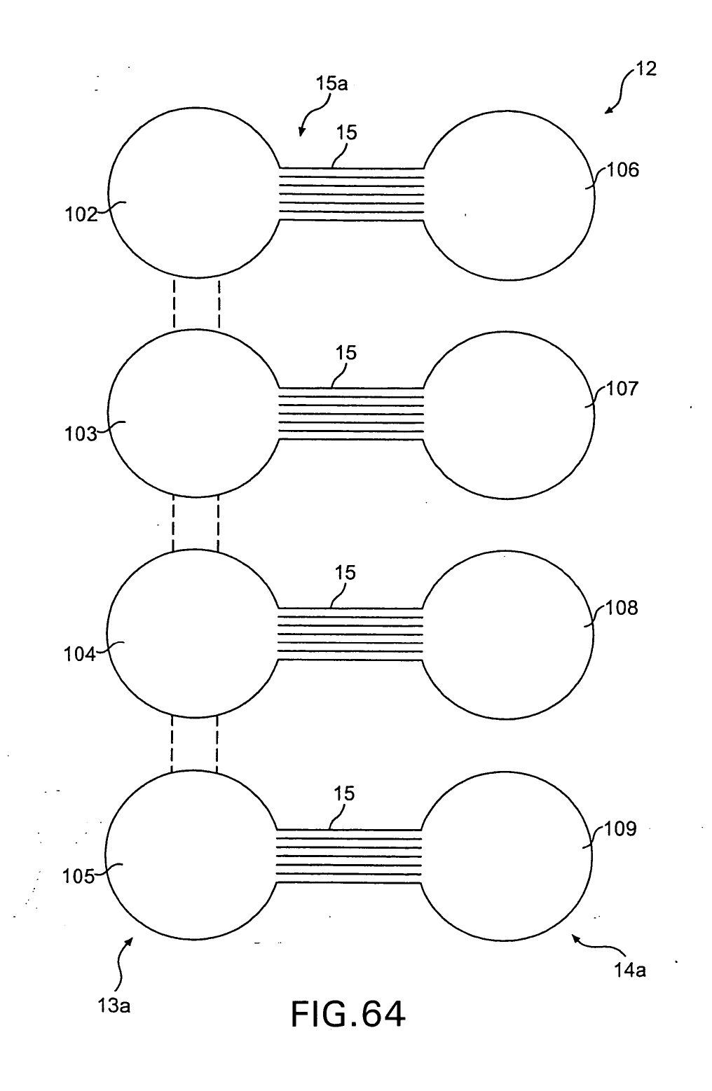

In addition to variations of components of a discrete chamber 12, the present invention also contemplates variations in the overall chamber 12 as well as variations from chamber to chamber. With respect to the overall chamber 12, in one embodiment, the chambers 12 are sized so that a complete chamber 12 fits into the area normally required for a single well of a 96-well plate. In this configuration, 96 different assays could be performed in a 96-well plate. In another embodiment, the 1:1 ratio of a first well to second well, as present in the aforementioned embodiments, is altered by modifying chamber 12. For example as seen in FIG. 63, device 10 includes a chamber 12 having a first well region 13a having a plurality of first wells 102, 103, 104 and 105 connected to one another, a second well region 14a having a plurality of wells 106, 107, 108 and 109, and a channel region 15a having a plurality of channels 15 connecting respective ones of the first wells to respective ones of the second wells. Each well of the first well region 13a may receive the same test agent, and each well of the second well region 14a may receive a different cell type. Alternatively, each well of the first well region 13a may receive a different test agent, and each well of the second well region 14a may receive the same cell type. This configuration allows several different cell types or different test agents to be tested simultaneously. In an alternative embodiment as seen in FIG. 64, each channel 15 of channel region 15a comprises subchannels as shown. This arrangement not only allows several different cell types or test agents to be tested simultaneously but also generates several tests of each test agent or cell type.

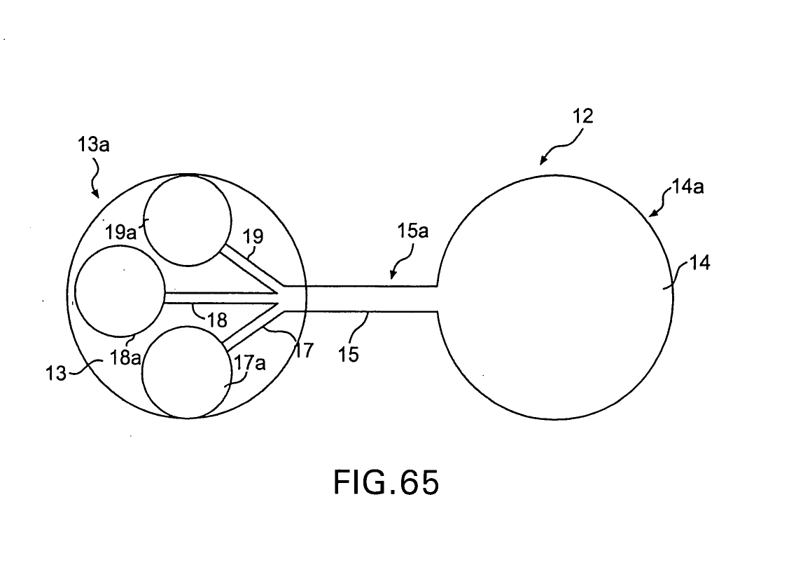

FIG. 65 illustrates an alternative chamber configuration of a test device according to an alternative embodiment of the present invention. In this embodiment, chamber 12 comprises a first well region 13a connected by a channel region 15a including a single channel 15 to a second well region 14a including a single well 14. The first well region contains a plurality of first wells, 17a, 18a, and 19a and a plurality of capillaries, a first perimeter capillary 17, a center capillary 18, and a second perimeter capillary 19 connected to respective ones of the plurality of first wells. All three of the capillaries converge at a junction into channel 15, which is connected with the second well region 14a. Well region 13a is not limited to containing only three capillaries and can contain any number of additional capillaries (not shown). First wells 17a-19a may, for example, be adapted to receive solutions of biomolecules, which are allowed to flow into channel 15 and adsorb nonspecifically to the regions of the surface over which the solution containing the biomolecules flows. First wells 17a-19a are also adapted to subsequently receive cells.

With respect to variations from chamber to chamber, in one embodiment, the length L of each channel 15 increases along one or more dimensions of top member 11 from one chamber to the adjacent chamber. In an alternative embodiment, all chambers 12 have channel 15 of the same length L. The width W of each channel 15 can also vary and can increase along one or more dimensions of top member 11 from one chamber to the adjacent chamber. In an alternative embodiment, all chambers 12 have channel 15 of the same width W. FIG. 58A is a top plan view of an embodiment of the present invention where, within top member 11, different chambers have various channel sizes and shapes, such sizes and shapes being in no particular order, pattern, or arrangement. By employing this varied configuration, the best channel region design for a given test may be obtained. In other words, where the optimal channel region design is determined, a new assay plate configured solely to those specifications may be employed.

Support member 16 of device 10 provides a support upon which top member 11 rests and can be made of any material suitable for this function. Suitable materials are known in the art such as glass, polystyrene, polycarbonate, PMMA, polyacrylates, and other plastics. Where device 10 is a chemotaxis, haptotaxis and/or chemoinvasion device, it is preferable that support member 16 comprise a material that is compatible with cells that may be placed on the surface of support member 16. Suitable materials may include standard materials used in cell biology, such as glass, ceramics, metals, polystyrene, polycarbonate, polypropylene, as well as other plastics including polymeric thin films. A preferred material is glass with a thickness of about 0.1 to about 2 mm, as this may allow the viewing of the cells with optical microscopy techniques.

Similar to top member 11, support member 16 can have several different embodiments. In particular, the configuration and surface treatment of support member 16 may vary.

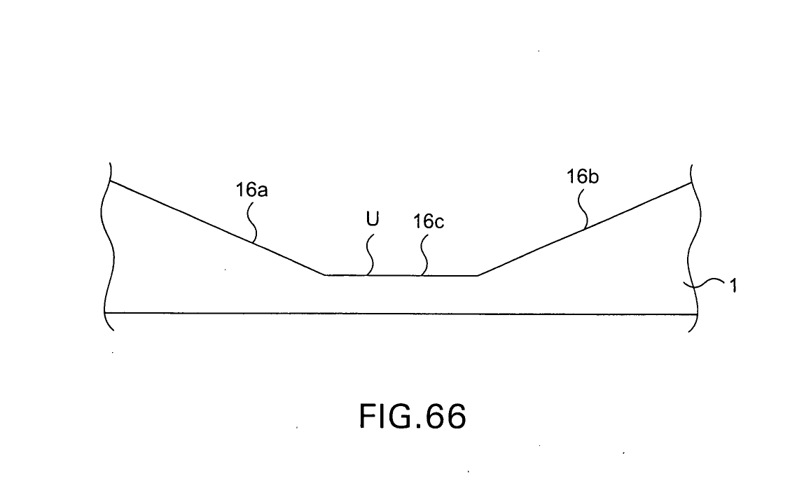

As seen in a side view of support member 16 in FIG. 66, the upper surface U of support member 16, which underlies top member 11, may be sloped at predetermined regions thereof with respect to a horizontal plane at less than a 90° angle. In the shown embodiment, the predetermined regions correspond to bottom surfaces of respective wells, surface 16a corresponding to a bottom surface of a well 13, and surface 16b corresponding to a bottom surface of well 14. Surface 16c, in turn, corresponds to a bottom surface of channel 15. In this embodiment, the given configuration facilitates suspended cells flowing in the direction of the downward slope of top surface 16b of support member 16 to become more readily exposed to the concentration gradient. If a soluble test substance is used as the test agent in well 13 of device 10, then top surface 16a of support member 16 may also be downwardly sloped with respect to a horizontal plane at less than a 90° angle to facilitate exposure of the test substance to channel 15 in order to facilitate formation of the solution concentration gradient.

Support member 16 may also have a treatment on or embedded into its surface. This treatment may serve numerous functions, including, for example, facilitating the placement, adhesion or movement of cells being studied, and simulating in vivo conditions. Numerous surface configurations and chemicals may be used alone or in conjunction for this treatment.

For example, in one embodiment support member 16 includes a patterned self-assembled monolayer (SAM) on a gold surface or other suitable material. SAMs are monolayers typically formed of molecules each having a functional group that selectively attaches to a particular surface, the remainder of each molecule interacting with neighboring molecules in the monolayer to form a relatively ordered array. By using SAMs, various controls of biological interactions may be employed. For example, SAMs may be arrayed or modified with various “head groups” to produce “islands” of biospecific surfaces surrounded by areas of bio-inert head groups. Further, SAMs may be modified to have “switchable surfaces” that may be designed to capture a cell and then be subsequently modified to release the captured cell. Moreover, it may also be desirable to utilize a bioinert support member material to resist non-specific adsorption of cells, proteins, or any other biological material. Consequently, the use of SAMs on support member 16 may be advantageous.

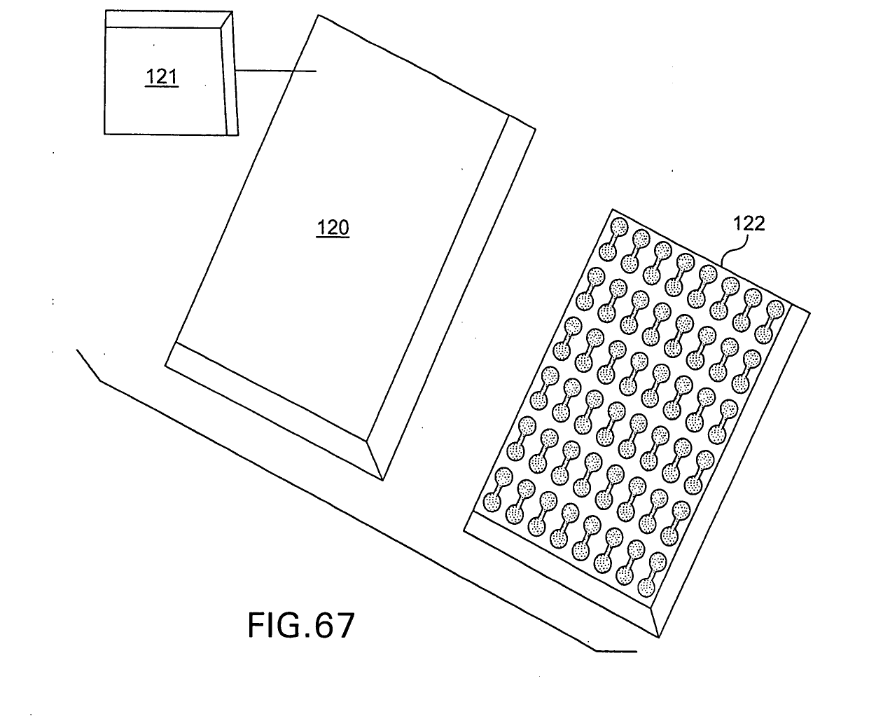

The present invention also contemplates, as seen in FIG. 67, the use of any system known in the art to detect and analyze cell chemotaxis, haptotaxis, and chemoinvasion. In particular, the present invention contemplates the use of any system known in the art to visualize changes in cell morphology as cells move across channel 15, to measure the distance cells travel in channel 15, and to quantify the number of cells that travel to particular points in channel 15. As such the present invention contemplates both “real-time” and “end-point” analysis of chemotaxis, haptotaxis, and chemoinvasion. In one embodiment, the device 122 includes an observation system 120 and a controller 121. The controller 121 is in communication with the observation system 120 via line 122. The controller 121 and observation system 120 may be positioned and programmed to observe, record, and analyze chemotaxis and chemoinvasion of the cells in the device. The observation system 120 may be any of numerous systems, including a microscope, a high-speed video camera, and an array of individual sensors. Nonlimiting examples of microscopes include phase-contrast, fluorescence, luminescence, differential-interference-contrast, dark field, confocal laser-scanning, digital deconvolution, and video microscopes. Each of these embodiments may view or sense the movement and behavior of the cells before, during, and after the test agent is introduced. At the same time, the observation system 120 may generate signals for the controller 121 to interpret and analyze. This analysis can include determining the physical movement of the cells over time as well as their change in shape, activity level or any other observable characteristic. In each instance, the conduct of the cells being studied may be observed in real time, at a later time, or both. The observation system 120 and controller 121 may provide for real-time observation via a monitor. They may also provide for subsequent playback via a recording system of some kind either integrated with these components or coupled to them. For example, in one embodiment, cell behavior during the desired period of observation is recorded on VHS format videotape through a standard video camera positioned in the vertical ocular tubes of a triocular compound microscope or in the body of an inverted microscope and attached to a high quality video recorder. The video recorder is then played into a digitization means, e.g., PCI frame grabber, for the conversion of analog data to digital form. The electronic readable (digitized) data is then accessed and processed by an appropriate dynamic image analysis system, such as that disclosed in U.S. Pat. No. 5,655,028 expressly incorporated in its entirety herein by reference. Such a system is commercially available under the trademark DIAS® from Solltech Inc. (Oakland, Iowa). Software capable of assisting in discriminating cells from debris and other detection artifacts that might be present in the sample should be particularly advantageous. In either case, these components may also analyze the cells as they progress through their reaction to the test agent.

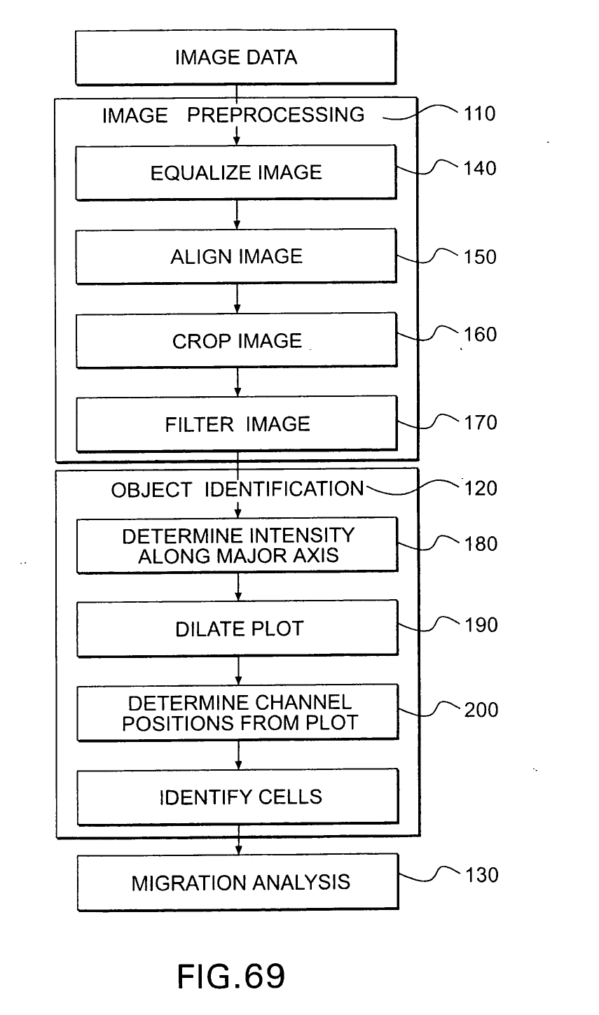

In one embodiment, the present invention contemplates the use of an automated analysis system, as illustrated in FIG. 69, to analyze data measuring the distance cells travel in channel 15, and to quantify the number of cells that travel to particular points in channel 15. FIG. 69 is a block diagram of an automated analysis system 100 including, for example, an image preprocessing stage 110, an object identification stage 120 and a migration analysis stage 130. The image preprocessing stage 110 may receive digital image data of chamber 12 from a digital camera or other imaging apparatus as described above. The data typically includes a plurality of image samples at various spatial locations (called, “pixels” for short) and may be provided as color or grayscale data. The image preprocessing stage 110 may alter the captured image data to permit algorithms of the other stages to operate on it. The object identification stage 120 may identify objects from within the image data. Various objects may be identified based on the test to be performed. For example, the object identifier may identify channels 15, cells or cell groups from within the image data. The migration analysis stage 130 may perform the migration analysis designated for testing.

FIG. 69 illustrates a number of blocks that may be included within the image preprocessing stage 110. Essentially, the image preprocessing stage 110 counteracts image artifacts that may be present in the captured image data as a result of imperfections in the imager or the device. In one embodiment, the image preprocessing stage 110 may include an image equalization block 140. The equalization 140 may find application in embodiments where sample values of captured image data do not occupy the full quantization range available for the data. For example, an 8-bit grayscale system permits 256 different quantization levels for input data (0-255). Due to imperfections in the imaging process, it is possible that pixel values may be limited to a narrow range, say the first 20 quantization levels (0-20). The equalization 140 may re-scale sample values to ensure that they occupy the full range available in the 8-bit system.

In another embodiment, the equalization block 140 may re-scale sample values based on a color or wavelength. Conventional cellular analysis techniques often cause cells to appear in predetermined colors or with predetermined wavelengths, which permits them to be distinguished from other materials captured by the imager. For example, in fluorescent applications, cells emit light at predetermined wavelengths. In nuclear staining applications, cell nuclei are dyed with a material that causes them to appear in the image data with predetermined colors. The equalization block 140 may re-scale sample values having components that coincide with these expected colors or wavelengths. In so doing, the equalization block 140 effectively filters out other colors or wavelengths, a consequence that may be advantageous in later image processing.

Image rotation is another image artifact that may occur from imperfect imaging apparatus. Although the channels 15 are likely to be generally aligned with columns and rows of pixels in the image data, further analysis may be facilitated if the alignment is improved. Accordingly, in an embodiment, the image preprocessing stage 110 may include an image alignment block 150 that rotates the captured image data to counteract this artifact. Once the rotation artifact has been removed from the captured image data, then image from individual channels 15 are likely to coincide with a regular row or column array of pixel data.

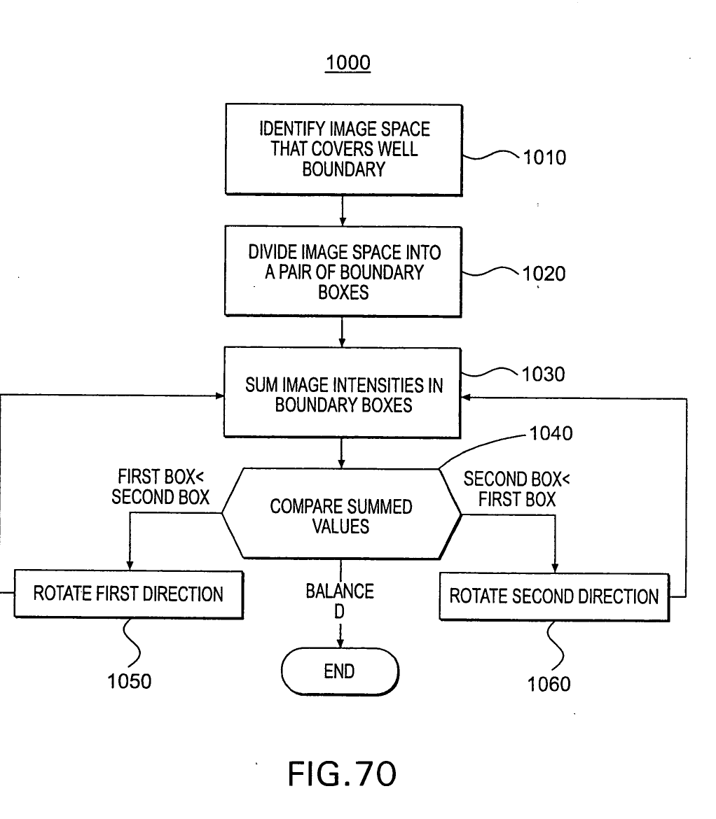

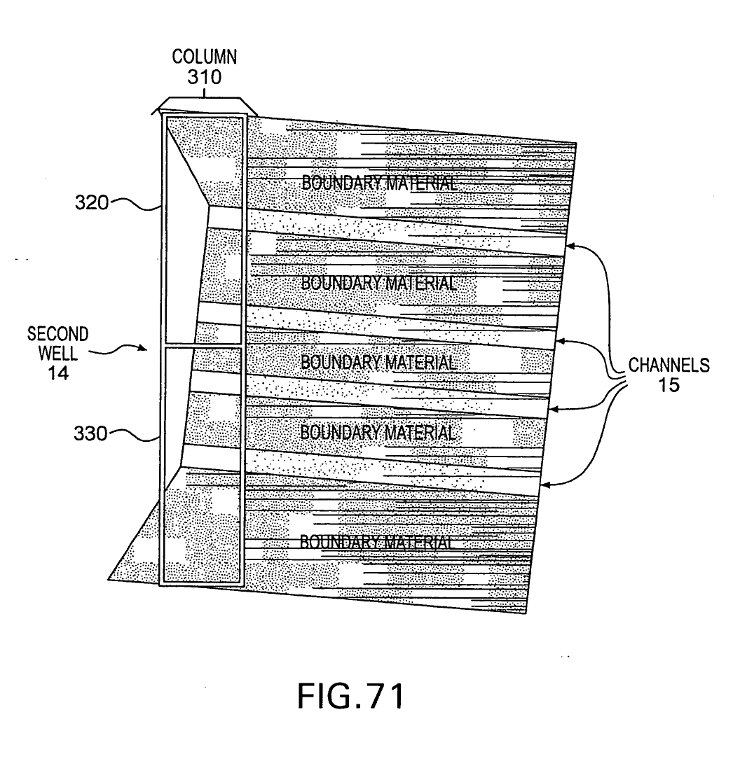

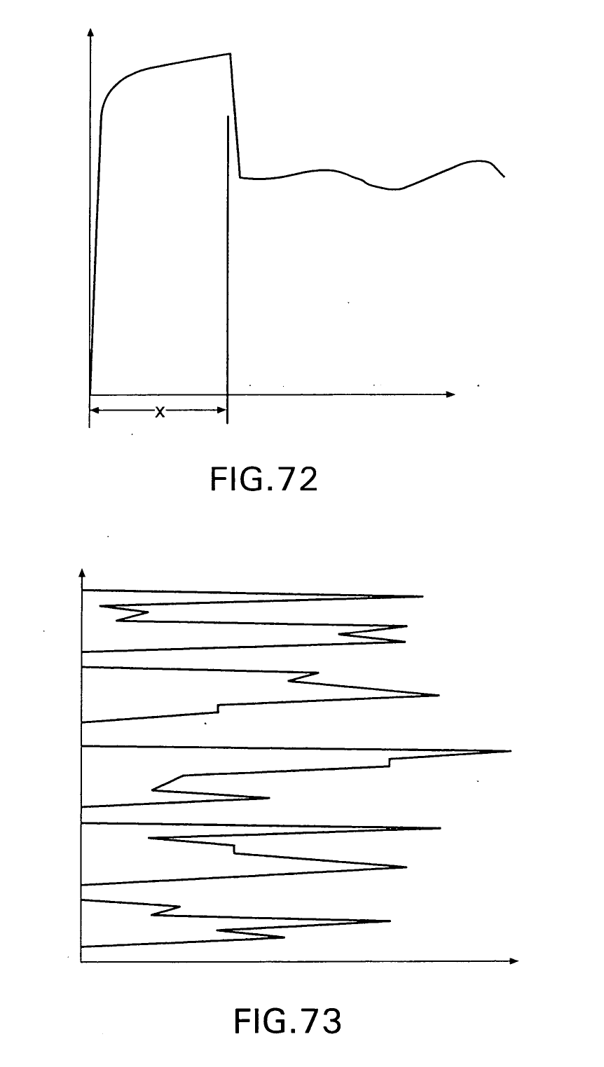

FIG. 70 illustrates a method of operation for the image alignment block 150 according to an embodiment of the present invention and described in connection with exemplary image data illustrated in FIG. 70. In the example of FIG. 71, channels 15 are aligned generally with rows of image data but for the rotation artifact. To counteract the rotation artifact, the image preprocessor may identify a band of image data coinciding with a boundary between second well 14 and the channels 15 themselves (block 1010). In the case of FIG. 71, the band may constitute column 310. Generally, the area of second well 14 will be bright relative to the area of channels 15 due the greater number of cells present therein. Thus, a histogram of image data values along a presumed direction of the channels 15 may appear as shown in FIG. 72. The band 310 may be identified from an abrupt change in image data values along this direction.

Having identified a column of image data to be considered, the column 310 may be split into two boundary boxes 320, 330 (block 1020). By summing the intensity of the image data in each of the two boundary boxes and comparing summed values to each other, an orientation of the rotation artifact may be determined (blocks 1030, 1040). In the example of FIG. 71, the rotation artifact causes more of second well 14 to fall within the area of boundary box 320 than of boundary box 330 (a clockwise artifact). The image data may be rotated counterclockwise until the summed values of each boundary box 320, 330 become balanced.

Thus, if the image intensity of the first bounding box is greater than that of the second bounding box 330, the image data may be rotated in a first direction (block 1050). If the image intensity of the second bounding box 330 is greater than that if the first bounding box 320, the image data may be rotated in a second direction (block 1060). And when the image intensities are balanced, the method 1000 may conclude; the rotation artifact has been corrected.

Returning to FIG. 69, the image preprocessing stage 110 also may process the captured image data by cropping the image to the area occupied by channels 15 themselves (block 160). As described, each test bed may include a pair of wells interconnected by a plurality of channels. For much of the migration analysis, it is sufficient to measure cellular movement or activity within channels 15 only. Activity in second well 14 or the first well 13 need not be considered. In such an embodiment, the image preprocessing stage 110 may crop the image data to remove pixels that lie outside channels 15.

The image preprocessing stage 110 also may include a thresholding block 170, performing threshold detection upon the image data. The thresholding block 170 may truncate to zero any sample having a re-scaled value that fails to exceed a predetermined threshold. Such thresholding is useful to remove noise from the captured image data. In an embodiment, the thresholding block 170 may be integrated with the equalization block 140 discussed above. It need not be present as a separate element. In some embodiments, particularly those where the equalization block 140 scales pixel values according to wavelength components, the thresholding block 170 may be omitted altogether. An output of the image preprocessing stage 110 may be input to the object identification stage 120.

The object identification stage 120 identifies objects from within the image data, including the channels themselves and, optionally, individual cells. According to an embodiment, in a fluorescent system, channels 15 may be identified by developing a histogram of the fluorescent light along a major axis in the system (block 180). FIG. 73 illustrates image data that may have been determined from the example of FIG. 71. The major axis may coincide with the boundary between the well adapted to receive cells and the channel region. Light intensity from within channel region 15a, area may be summed along this axis, yielding a data set represented in FIG. 73. In a second stage, the data set is “dilated” (block 190). Dilation may be achieved by applying a high pass filter to the data set or any other analogous technique. FIG. 20 illustrates the data set of FIG. 73 having been subject to dilation.

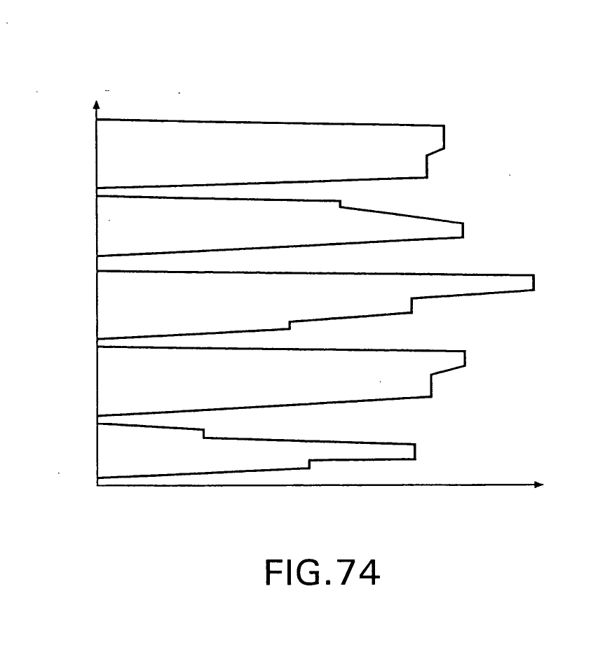

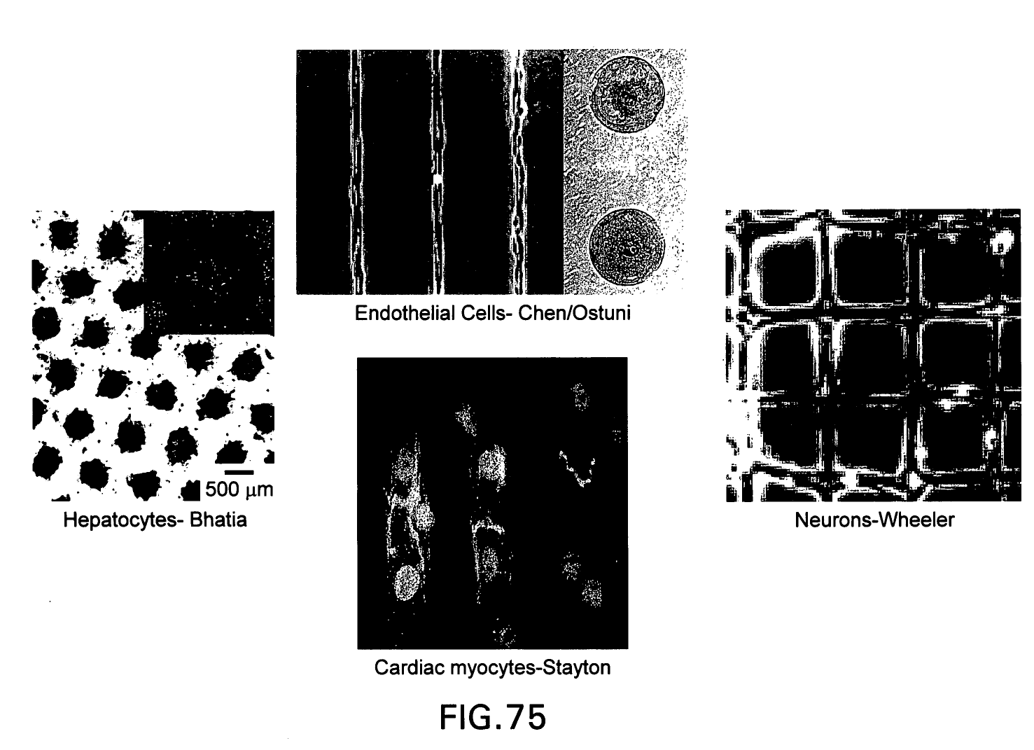

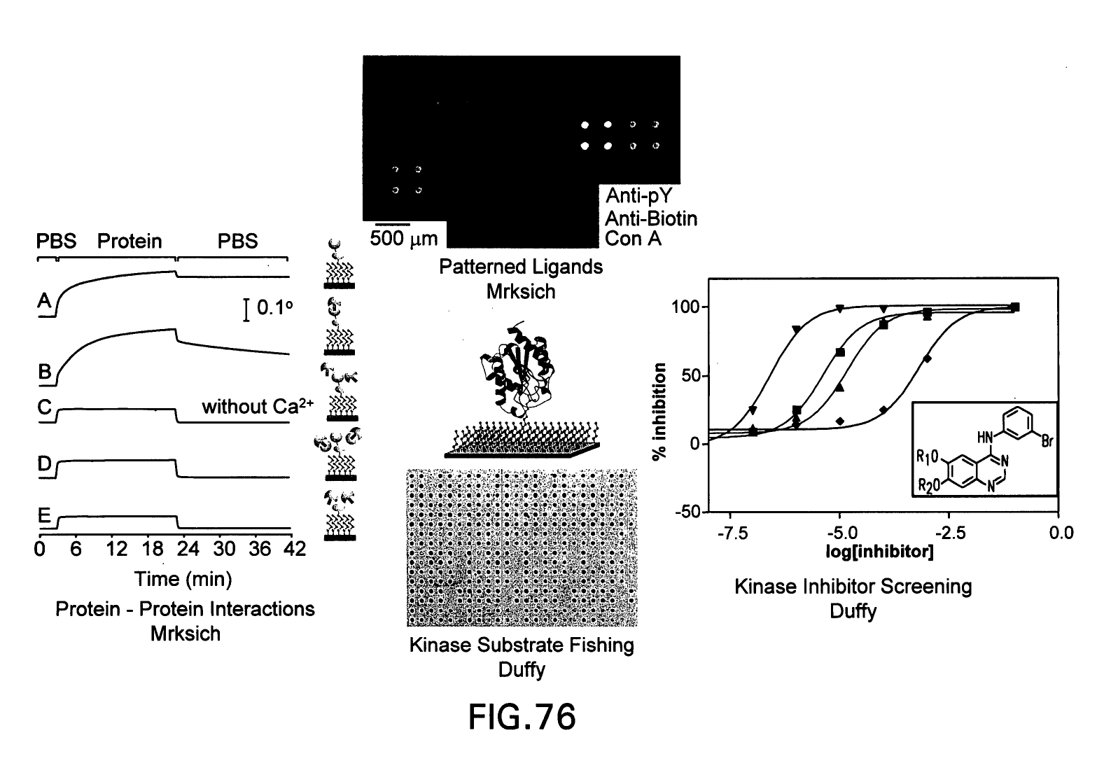

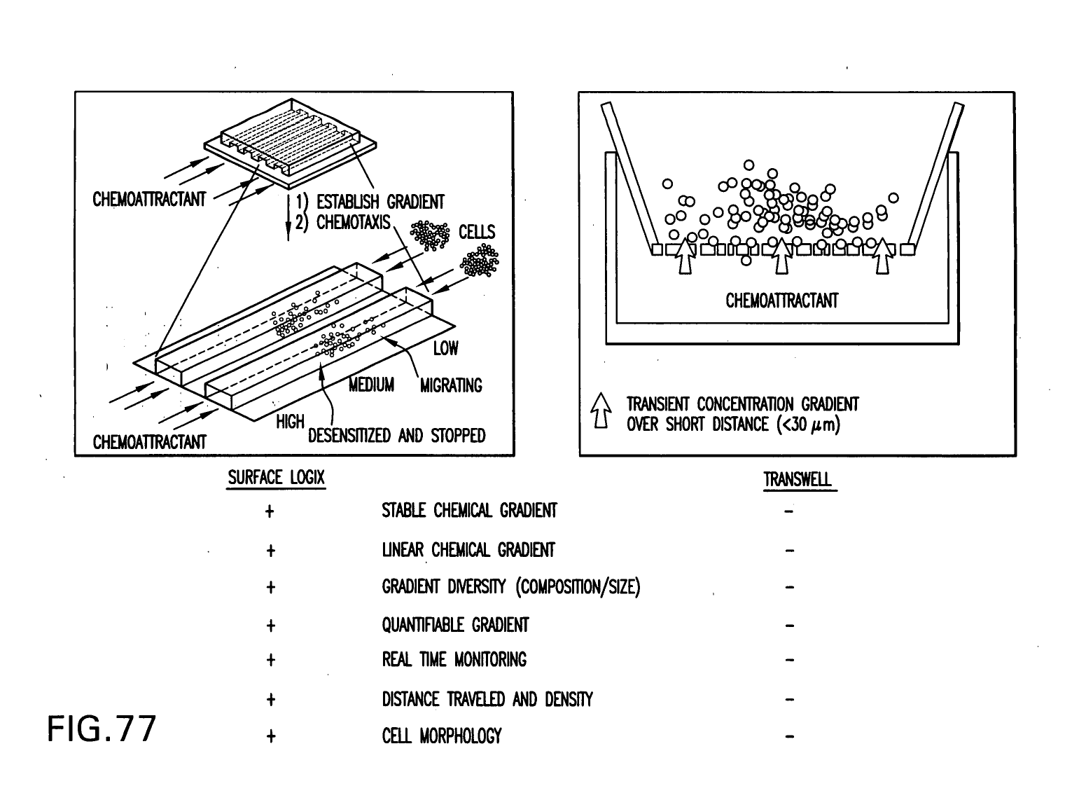

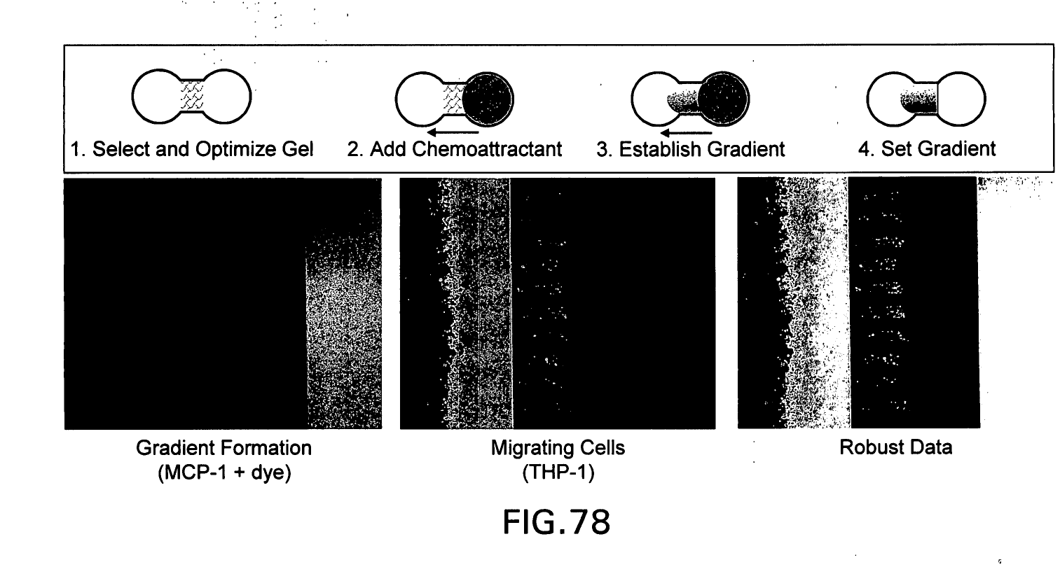

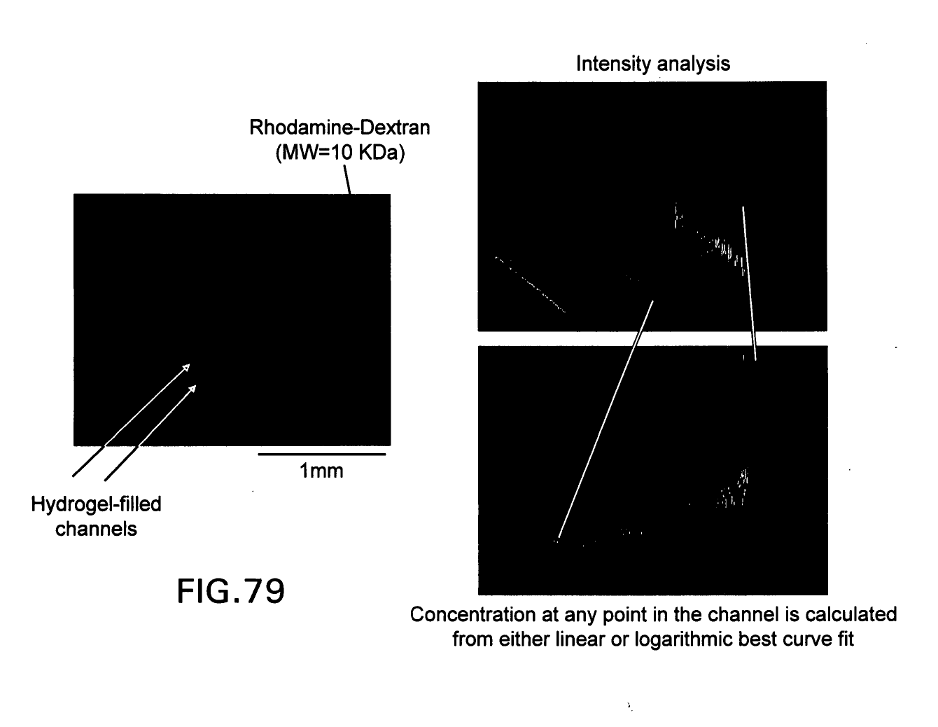

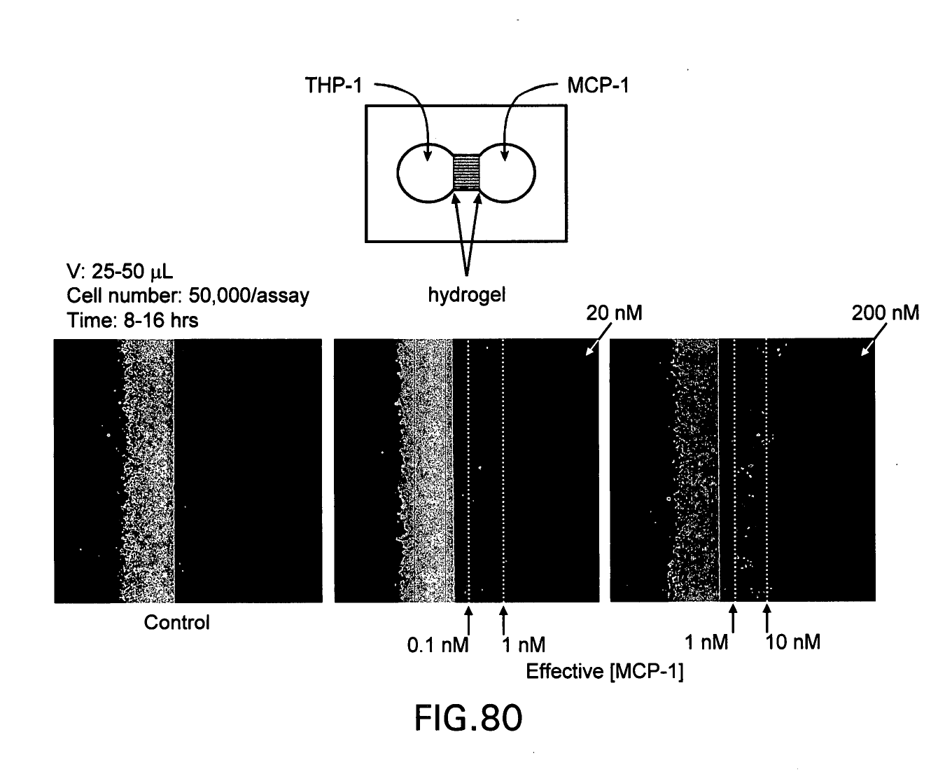

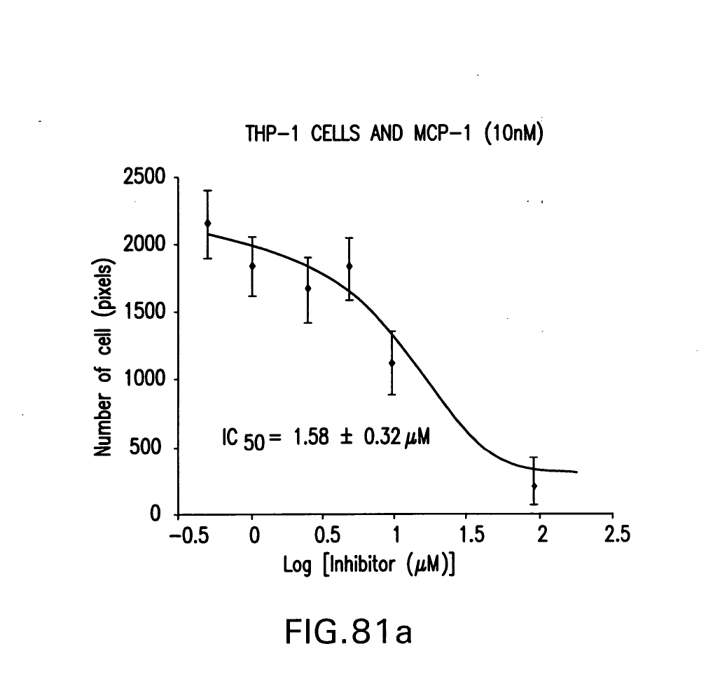

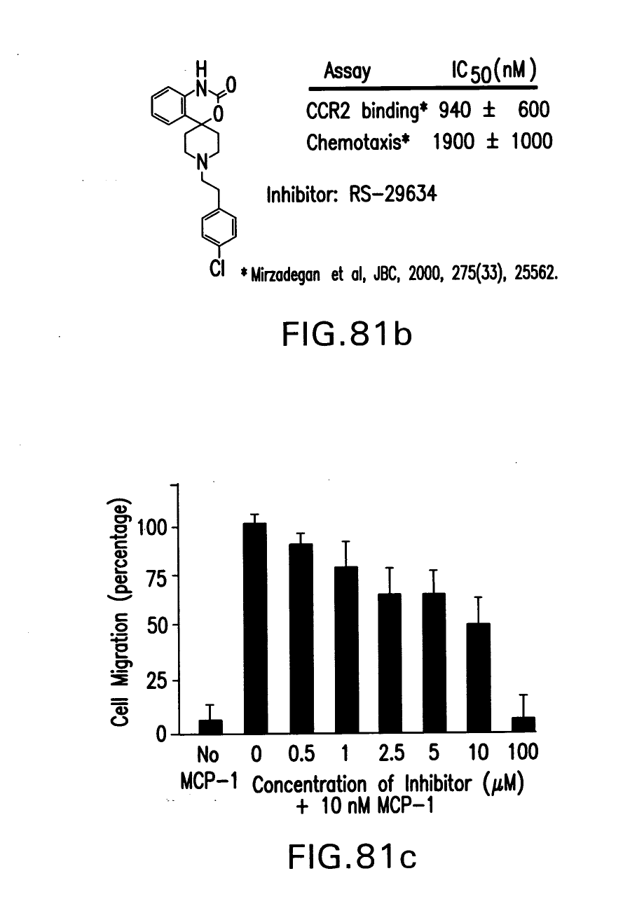

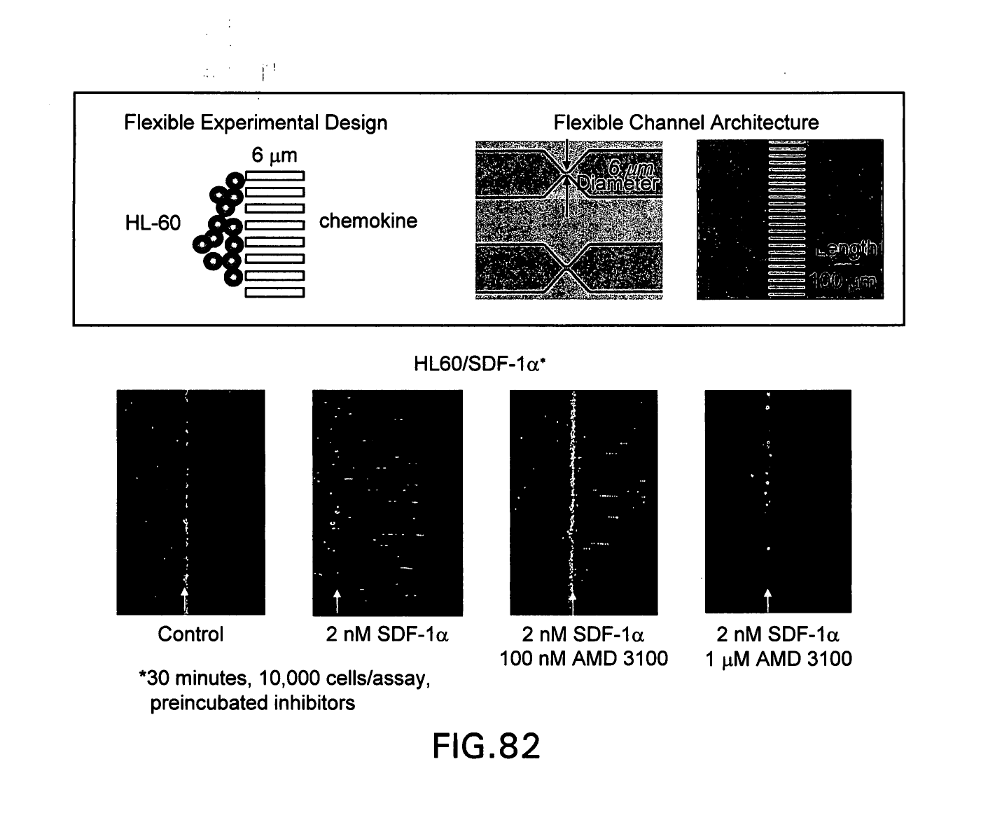

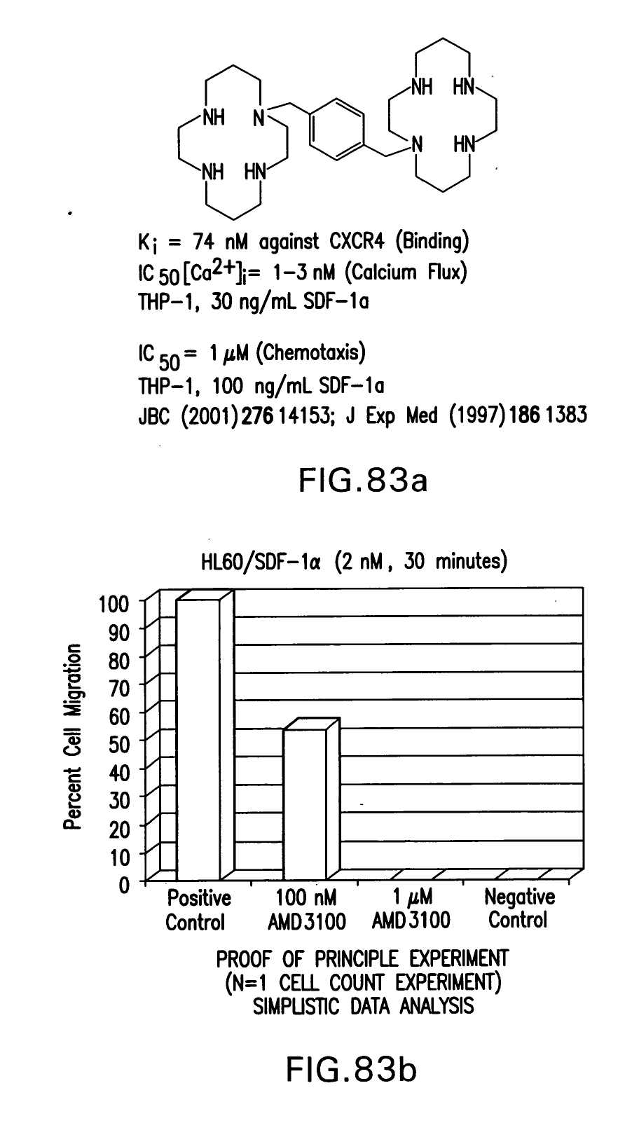

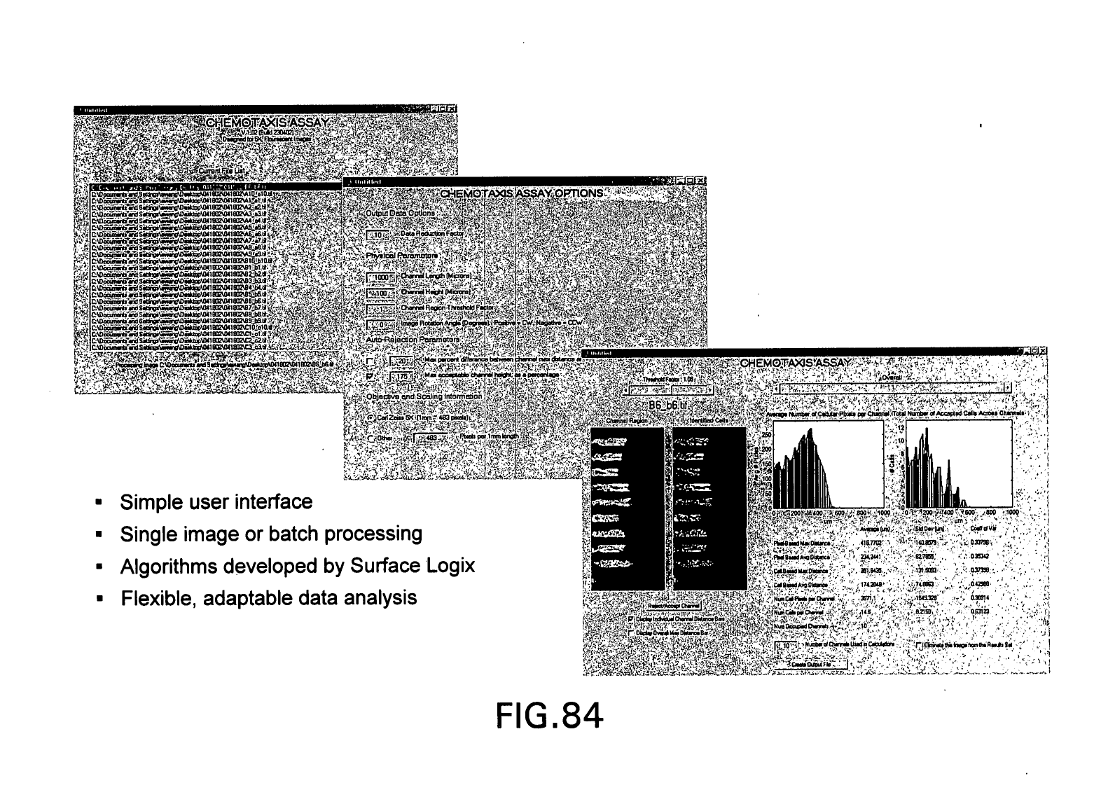

From the data set of FIG. 74, the channels may be identified. Candidate channel 15 positions may be identified to coincide with relative maximums of the data set. Alternatively, candidate positions of boundaries between channels 15 may be determined from relative minimums from within the data set of FIG. 74. A final set of channel 15 positions may be determined from a set of parameters known about channel region 15a itself. For example, if channels 15 are known to have been provided with a regular spacing among channels 15, any candidate channel 15 position that would violate the spacing can be eliminated from consideration.

Returning to FIG. 69, in addition to identifying channels 15, individual cells may be identified within the image data (block 200). In an application where cells are marked with nuclear staining, identification of individual cells merely requires an image processor to identify and count the number of marked nuclei. The nuclei appear is a number of dots of a predetermined color. In an application using fluorescing cells, identification of individual cells becomes more complicated. Individual cells can be identified relatively easily; they appear as objects of relatively uniform area in the image data. Identifying a number of cells clustered together becomes more difficult. In this case, the number of cells may be determined from the area or radius of the cluster in the image data. The cluster is likely to appear in the image having some area or cluster radius. By comparing the cluster's area or radius to the area or radius of an individual cell, the number of cells may be interpolated. Of course, identification of individual cells may be omitted depending upon the requirements of the migration analysis.

The final stage in the image processing system is the migration analysis 130 itself. In one embodiment, coordinate data of each cell in the channels 15 may be gathered and recorded. However, some testing need not be so complicated. In a first embodiment, it may be sufficient merely to identify the number of cells present in channel 15. In this case, identification of individual cells may be avoided by merely summing quantities of fluorescent light detected in each channel 15. From this measurement, the number of cells may be derived without investing the processing expense of identifying individual cells.

The foregoing description presents image analysis that is relevant to a single channel 15 to be tested. Of course, depending upon the requirements of the migration analysis 130, it may be desired to generate image samples of a number of different channels 15. Further, it may be desirable to generate image samples of a single channel 15 at different times. The image processing described above may be repeated for different channels 15 and different times to accommodate for such test scenarios.

According to an embodiment, the image processing may account for manufacturing defects of individual channels 15. During image processing, manufacturing defects may prevent cell migrations into a channel 15. In an embodiment, when the system 100 counts a number of cells in the channel 15 (or derives the number from identified cell locations), it may compare the number to an expectation threshold. If the number is below the expectation threshold, the system 100 may exclude the channel 15 from migration analysis. In practice, this expectation threshold may be established as a minimum number of cells that are likely to enter a properly configured cell given the test conditions being analyzed under the migration analysis. If the actual number of cells falls below this threshold, it may lead to a conclusion that channel 15 blocking conditions may be present.

The foregoing operations and processes of the analysis system 100 may be performed by general purpose processing apparatus, such as computers, workstations or servers, executing software. Alternatively, some of the operations or processes may be provided in a digital signal processor or application specific integrated circuit (colloquially, an “ASIC”). Additionally, these operations and processes, particularly those associated with image preprocessing, may be distributed in processors of a digital microscope system. Such variations are fully within the scope of the present invention.

The present invention also contemplates the use of the aforementioned embodiments of device 10 to assay various elements of chemotaxis, haptotaxis and chemoinvasion. In general, the present invention provides for a first assay comprising high throughput screening of test agents to determine whether they influence chemotaxis, haptotaxis, and chemoinvasion. Test agents generally comprise either soluble test substances or immobilized test biomolecules and are generally placed in first well region 13a of chamber 12 of device 10. After determining which test agents influence chemotaxis, by acting as chemoattractants and promoting or initiating chemotaxis, by acting as chemorepellants and repelling chemotaxis, or by acting as inhibitors and halting or inhibiting chemotaxis, then a second assay can be performed screening test compounds. The test compounds generally comprise therapeutics or chemotaxis/haptotaxis inhibitors and are generally introduced in second well region 14a, which contains a biological sample of cells. The test compounds are screened to determine if and how they influence the cells' chemotaxis or haptotaxis in response to the test agents.

In particular, a chemotaxis/haptotaxis and/or chemoinvasion assay according to an embodiment of the present invention involves a device 10 including a housing comprising a top member 11 mounted to a support member 16. The top member and the support member are configured such that they together define a discrete assay chamber 12. The discrete assay chamber 12 includes a first well region 13a connected by a channel 15 to a second well region 14a. The first well region 13a includes at least one first well 13, each of the at least one first well 13 being adapted to receive a test agent therein. The second well region 14a includes at least one second well 14 horizontally offset with respect to the first well region 13a in a test orientation of the device, each of the at least one second well 14 being adapted to receive a cell sample therein. Channel 15 includes at least one channel connecting the first well region 13a and the second well region 14a to one another. The test agent received in first well 13 is a soluble test substance and/or immobilized test biomolecules. When the test agent comprises immobilized test biomolecules, the biomolecules are immobilized on an upper surface U of support member 16 constituting the bottom surface of well region 13a as well as on upper surface U of support member 16 constituting the bottom surface of channel region 15a.

Nonlimiting examples of biological samples of cells include lymphocytes, monocytes, leukocytes, macrophages, mast cells, T-cells, B-cells, neutrophils, basophils, eosinophils, fibroblasts, endothelial cells, epithelial cells, neurons, tumor cells, motile gametes, motile forms of bacteria, and fungi, cells involved in metastasis, and any other types of cells involved in response to inflammation, injury, or infection. Well region 14a may receive only one cell type or any combination of the above-referenced exemplary cell types. For example, as described above, it is often desirable to provide a mixed cell population to more effectively create an environment similar to in vivo conditions. Well region 14a may also receive cells at a particular cell cycle phase. For example, well region 14a may receive lymphocytes in G₁ phase or G₀ phase.

Nonlimiting examples of soluble test substances include chemoattractants, chemorepellants, or chemotactic inhibitors. As explained above, chemoattractants are chemotactic substances that attract cells and once placed in well region 14a, cause cells to migrate towards well region 14a. Chemorepellents are chemotactic substances that repel cells and once placed in well region 14a, cause cells to migrate away from well region 14a. Chemotactic inhibitors are chemotactic substances that inhibit or stop chemotaxis and once placed in well region 14a, cause cells to have inhibited migration or no migration from well region 14a. Non-limiting examples of chemoattractants include hormones such as T₃ and T₄, epinephrine and vasopressin; immunological agents such as interleukein-2, epidermal growth factor and monoclonal antibodies; growth factors; peptides; small molecules; and cells. Cells may act as chemoattractants by releasing chemotactic factors. For example, in one embodiment, a sample including cancer cells may be added to well 13. A sample including a different cell type may be added to well 14. As the cancer cells grow they may release factors that act as chemoattractants attracting the cells in well 14 to migrate towards well 13. In another embodiment, endothelial cells are added to well 13 and activated by adding a chemoattractant such as TNF-∀ or IL-1 to well 13. Leukocytes are added to well 14 and may be attracted to the endothelial cells in well 14.

Non-limiting examples of chemorepellants include irritants such as benzalkonium chloride, propylene glycol, methanol, acetone, sodium dodecyl sulfate, hydrogen peroxide, 1-butanol, ethanol, and dimethylsulfoxide; and toxins such as cyanide, carbonylcyanide chlorophenylhydrazone, endotoxins and bacterial lipopolysaccharides; viruses; pathogens; and pyrogens.

Nonlimiting examples of immobilized biomolecules include chemoattractants, chemorepellants, and chemotactic inhibitors as described above. Further non-limiting examples of immobilized chemoattactants include chemokines, cytokines, and small molecules. Further non-limiting examples of chemoattractants include IL-8, GCP-2, GRO-∀, GRO-β, MGSA-β, MGSA-γ, PF₄, ENA-78, GCP-2, NAP-2, IL-8, IP10, I-309, I-TAC, SDF-1, BLC, BRAK, bolekine, ELC, LKTN-1, SCM-1β, MIG, MCAF, LD7α, eotaxin, IP-110, HCC-1, HCC-2, Lkn-1, HCC-4, LARC, LEC, DC-CK1, PARC, AMAC-1, MIP-20, ELC, exodus-3, ARC, exodus-1, 6Ckine, exodus 2, STCP-1, MPIF-1, MPIF-2, Eotaxin-2, TECK, Eotaxin-3, ILC, ITAC, BCA-1, MIP-1∀, MIP-1∃, MIP-3∃, MIP-3∃, MCP-1, MCP-2, MCP-3, MCP-4, MCP-5, RANTES, eotaxin-1, eotaxin-2, TARC, MDC, TECK, CTACK, SLC, lymphotactin, and fractakine; and other cells. Further non-limiting examples of chemorepellants include receptor agonists and other cells.

In order to perform a test, such as a chemotaxis and/or chemoinvasion assay utilizing a soluble test substance, the test device 10 is first fabricated. A preferred embodiment of the method of making the device according to the present invention will now be described. A master that is the negative of top-plate 11 is fabricated by standard photolithographic procedures. A predetermined material is spin coated or injection molded onto the master. The predetermined material is then cured, peeled off the master to comprise top member 11 and placed onto support member 16.

Where the test device 10 is a chemotaxis, haptotaxis and/or chemoinvasion device, a rigid frame with the standard microtiter footprint is preferably placed around the outer perimeter of top member 11. In one embodiment, a gel matrix is poured into well region 13a and allowed to flow into channel region 15a. After the gel matrix sets, excess gel is removed from well regions 13a and 14a. In another embodiment, no gel matrix is added to channel region 15a. Subsequently, a biological sample of cells is placed in well region 14a and a test substance is placed in well region 13a. In one embodiment, a low concentration of a test substance is placed in well region 14a in order to activate the cells and expedite the beginning of the assay. Alternatively, depending on the cells being studied and the soluble test substance being used, the soluble test substance may be introduced during or after the cells have been placed in well region 14a. Once the soluble test substance has been introduced, by the process of diffusion, a solution concentration gradient of the test substance forms along the longitudinal axis of channel region 15a from well region 13a containing the test agent towards well region 14a containing the biological sample of cells. A secondary effect of this solution gradient is the formation of a physisorbed (immobilized) gradient. When this solution gradient is established, some fraction of the solute of the test substance may adsorb onto support member 16. This adsorbed layer of test solute may also contribute to chemotaxis and chemoinvasion. The biological sample of cells may respond to this concentration gradient and migrate towards the higher concentration of the test substance, migrate away from the higher concentration of the test substance, or exhibit inhibited movement in response to the higher concentration of the test substance. It is through this chemotaxis in response to the gradient, that the chemotactic influence of the chemotactic substance can be measured. Chemotaxis is assayed by measuring the distance the cells travel and the amount of time the cells take to reach a predetermined point in the channel region 15a or the distance the cells travel and the amount of time the cells take to reach a certain point in well region 14a (in the case of a chemorepellant that causes cells to move away from the chemotactic substance).

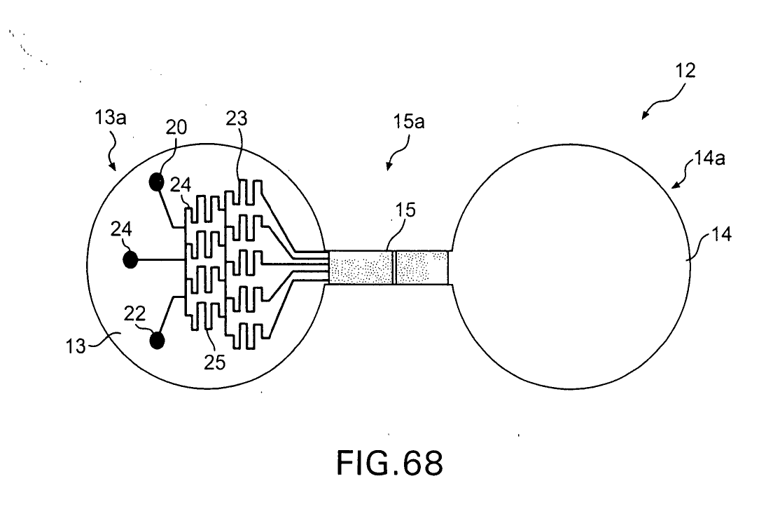

Utilizing an alternative embodiment of device 10 containing an alternative design of chamber 12, a solution concentration gradient is formed using a network of microfluidic channel regions. In this embodiment as seen in FIG. 68, first well region well region 13a of chamber 12 has first wells, 20, 21, and 22, connected by a network of microfluidic capillaries 23 to channel 15. In particular, first well region 13a includes a plurality of first wells connected by a plurality of capillaries 24 connected to respective ones of the plurality of first wells and a plurality of subcapillaries 25 branched off such that each of the plurality of subcapillaries is connected to each of the plurality of capillaries at one end thereof and to channel 15 at another end thereof. Each first well, 20, 21, and 22 receives a different concentration of soluble test substance. After the three first wells, 20, 21, and 22 are simultaneously infused with the three different concentrations of soluble test substance, the solution streams travel down the network of channel regions, continuously splitting, mixing and recombining. After several generations of branched subcapillaries, each subcapillary containing different proportions of soluble test substances are merged into a single channel 15, forming a concentration gradient across channel 15, perpendicular to the flow direction.

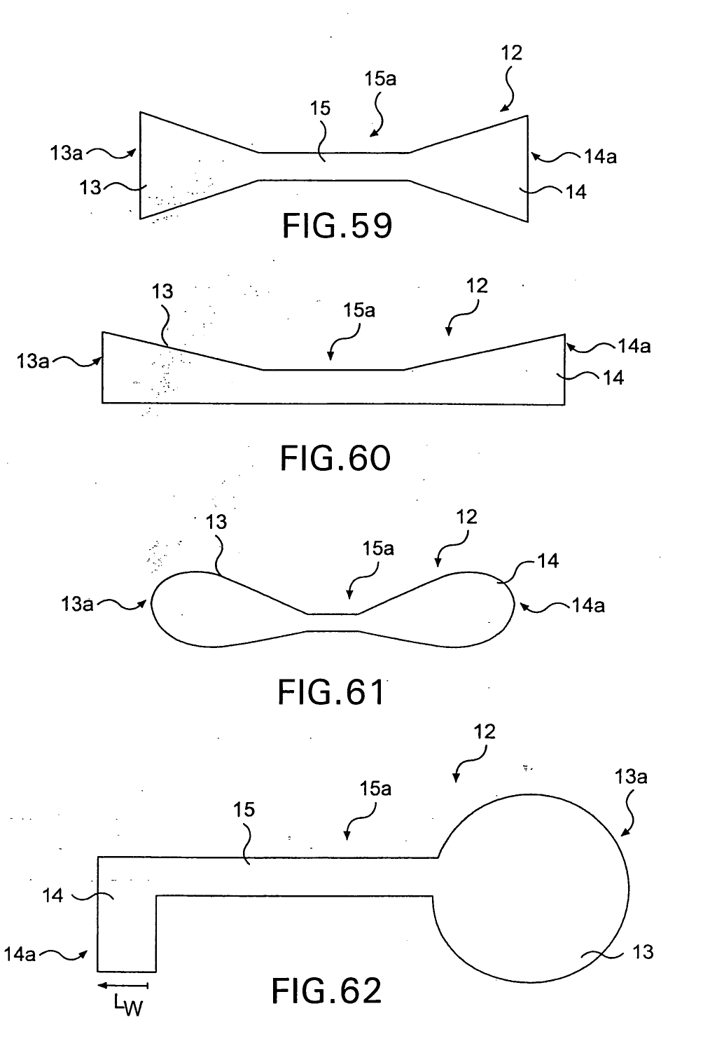

According to one embodiment of the present invention, biomolecules are immobilized onto support member 16, preferably on the portion of upper surface U constituting the bottom surface of channel 15 and of well region 13a in any one of the embodiments of the test device of the present invention, such as the embodiments shown in FIGS. 55a-68. The concentration of biomolecules increases or decreases along the longitudinal axis of the device from the upper surface of support member 16 constituting the bottom surface of well region 13a towards the upper surface U of support member 16 constituting the bottom surface of well region 14a thus forming a surface gradient. After the test biomolecules are immobilized on support member 16, the top member is placed onto support member 16 and a rigid frame with the standard microtiter footprint is placed around the outer perimeter of top member 11 and cells are added to well region 14a. In an alternative embodiment, after the test biomolecules are immobilized on support member 16 and the top member is placed over support member 16, a gel matrix is added to channel region 15a. Cells are subsequently added to well region 14a. The biological sample of cells potentially respond to the concentration gradient of immobilized biomolecules and migrates towards the higher concentrations of the test biomolecules, away from the higher concentrations of the test biomolecules, or exhibit inhibited migration in response to the higher concentrations of the test biomolecules. The surface gradient can increase linearly or as a squared, cubed, or logarithmic function or in any surface profile that can be approximated in steps up or down.

The test biomolecules can be attached to and form surface gradients on the upper surface U of support member 16 by various specific or non-specific approaches known in the art as described in K. Efimenko and J. Genzer, “How to Prepare Tunable Planar Molecular Chemical Gradient,” 13 Applied Materials, 2001, No. 20, October 16; U.S. Pat. No. 5,514, incorporated herein by reference. For example, microcontact printing techniques, or any other method known in the art, can be used to immobilize on upper surface U of support member 16a layer of SAMs presenting hexadecanethiol. Support member 16 is then exposed to high energy light through a photolithographic mask of the desired gradient micropattern or a grayscale mask with continuous gradations from white to black. When the mask is removed, a surface gradient of SAMs presenting hexandecanethiol remains. Support member 16 is then immersed in a solution of ethylene glycol terminated alkanethiol. The regions of support member 16 with SAMs presenting hexadecanethiol will rapidly adsorb biomolecules and the regions of the support member with SAMs presenting oligomers of the ethylene glycol group will resist adsorption of protein. Support member 16 is then immersed in a solution of the desired test biomolecules and the biomolecules rapidly adsorb only to the regions of support member 16 containing SAMs presenting hexadecanethiol creating a surface gradient of immobilized biomolecules.

In another embodiment, the test biomolecules are immobilized on the support member 16 and a surface concentration gradient forms after the top member 11 has been placed over support member 16 in any one of the embodiments of the test device of the present invention, such as the embodiments shown in FIGS. 55-68 In this embodiment, discrete concentrations of solution containing test biomolecules are consecutively placed in well region 14a and allowed to adsorb non-specifically to support member 16. For example, first, a 1 milligram/milliliter (mg/ml) of solution can first be placed in well region 14a; second, a 1 microgram/milliliter (μg/ml) solution can be placed in well region 14a; last, a 1 nanogram/milliliter (ng/ml) solution of test biomolecules can be placed in well region 14a. The differing concentrations of test biomolecules in solution result in differing amounts of adsorption on support member 16.

Utilizing an alternative embodiment of device 10 containing an alternative design of chamber 12 as seen in FIG. 65, an immobilized biomolecular surface gradient is formed based on the concept of laminar flow of multiple parallel liquid streams, a method known in the art. Based on this concept, when two or more streams with low Reynolds numbers are joined into a single stream, also with a low Reynolds number, the combined streams flow parallel to each other without turbulent mixing. According to one embodiment, a solution of chemotactic biomolecules is placed in 17a and 19a and a protein solution is placed in 18a. The solutions are allowed to flow into channel region 15a under the influence of gentle aspiration at well region 14a. Biomolecules adsorb nonspecifically to the regions of the surface over which the solution containing the biomolecules flows forming a surface gradient. The wells are then filled with a suspension of cells and potential haptotaxis of the cells towards the increasing concentration gradient of biomolecules is observed and monitored. See generally, S. Takayama et al., “Patterning Cells and their Environment Using Multiple Laminar Fluid Flows in Capillary Networks” Pro. Natl. Acad. Sci. USA, Vol. 96, pp. 5545-5548, May 1999.

The present invention also contemplates an assay using both a soluble and surface gradient to determine whether the soluble test substance or the immobilized test biomolecules more heavily influence chemotaxis and chemoinvasion. In this embodiment, an assay is performed by forming a surface gradient as described above, an assay is performed by forming a solution gradient as described above, an assay is performed by forming both types of gradients and the results of all three assays are compared. With respect to the combined gradient assay, test biomolecules are immobilized on the upper surface U of support member 16 constituting the bottom surface of well region 13a and on the upper surface of support member 16 underlying channel region 15a and the concentration of biomolecules decreases along the longitudinal axis of chamber 12 from well region 13a to well region 14a, in any one of the embodiments of the test device of the present invention, such as the embodiments shown in FIGS. 55a-68. Additionally, a soluble test substance is added to well region 13a. Such an embodiment creates surface and soluble chemotactic concentration gradients that decrease in the same direction. If the combined concentration gradients have a synergistic effect on chemotaxis and/or chemoinvasion, then both gradients should be used in screening both the cell receptor binding the chemotactic ligands of the soluble chemotactic substance and the cell receptor binding the immobilized biomolecules. Both types of receptors are identified as important and therapeutic agents that target both these receptors or a combination of therapeutic agents, one targeting one receptor and another targeting the other receptor can be screened. If the combined concentration gradients do not have a synergistic effect, then the individual gradient that more strongly promotes chemotaxis and/or chemoinvasion can be identified and the cell receptor that binds to the chemotactic ligands of the test agent forming the gradient can be targeted.

Identifying optimal chemotactic ligand and receptor pairs is important in understanding the biological pathways implicated in chemotaxis and/or chemoinvasion and developing therapeutic agents that target these pathways. Accordingly, the present invention generally provides using chemotactic test agents to determine which chemotactic receptors expressed on a cell's surface most heavily influence chemotaxis and/or chemoinvasion. In one embodiment, the present invention provides for high throughput screening of a class of chemoattractants known to attract a particular cell type having a receptor on the cell's surface for each chemoattractant within this class in order to identify which receptor is more strongly implicated in the chemotaxis and/or chemoinvasion process. After identifying this receptor, the present invention contemplates high-throughput screening of therapeutic agents that potentially block this receptor or bind to this receptor, depending on whether chemotaxis and/or chemoinvasion is desired to be promoted or prevented. In another embodiment, the present invention provides for high throughput screening of different chemoattractants known to bind to the same receptor on a particular cell type's surface, in order to determine which chemoattractant ligand/receptor pair more heavily influences chemotaxis and/or chemoinvasion. After identifying this ligand/receptor pair, the present invention contemplates high throughput screening of therapeutic agents that target this receptor and either block or activate this receptor depending one whether chemotaxis and/or chemoinvasion is desired to be promoted or prevented.

The present invention also contemplates high-throughput screening of a class of chemotactic inhibitors known to inhibit chemotaxis of a particular cell type having various chemotactic receptors on the cell's surface in order identify which receptor is more strongly implicated in the chemotaxis and chemoinvasion process. After identifying this receptor, the present invention provides for high throughput screening of therapeutic agents that potentially block this receptor as well (if such action is desired).

In one embodiment of the present invention, an assay is performed to determine whether a test compound inhibits cancer cell invasion. In this embodiment, untreated cancer cells are placed in well region 14a and a test agent is placed in well region 13a of chamber 12 in any one of the embodiments of the test device of the present invention, such as the embodiments shown in FIGS. 55a-68. Cell chemotaxis and invasion is measured and recorded. After a suitable test agent is identified (one that chemically attracts the cancer cells) another assay is run in chamber 12. In this subsequent assay, cancer cells are placed in well region 14a and a test compound, for example, a therapeutic, is also placed in well region 14a. In another embodiment, the test compound is also placed in channel region 15a. If a gel matrix is to be added to channel region 15a, the test compound can be mixed with the gel matrix before the gel is contacted with channel region 15a during fabrication of device 10. A subsequent sample of the test agent identified in the first assay is placed in well region 13a and the chemotaxis and invasion of the cells treated with the test compound is compared to the chemotaxis and invasion of the cells not treated with the test compound. The test compound's anti-cancer potential is measured by whether the treated cancer cells have a slower chemotaxis and invasion rate than the untreated cancer cells.

With respect to another exemplary use of the chemotaxis and chemoinvasion device of the present invention, the device can be used to assay cells' response to the inflammatory response. A local infection or injury in any tissue of the body attracts leukocytes into the damaged tissue as part of the inflammatory response. The inflammatory response is mediated by a variety of signaling molecules produced within the damaged tissue site by mast cells, platelets, nerve endings and leukocytes. Some of these mediators act on capillary endothelial cells, causing them to loosen their attachments to their neighboring endothelial cells so that the capillary becomes more permeable. The endothelial cells are also stimulated to express cell-surface molecules that recognize specific carbohydrates that are present on the surface of leukocytes in the blood and cause these leukocytes to adhere to the endothelial cells. Other mediators released from the damaged tissue act as chemoattractants, causing the bound leukocytes to migrate between the capillary endothelial cells into the damaged tissue. To study leukocyte chemotaxis, in one embodiment, channel region 15a is treated to simulate conditions in a human blood capillary during the inflammatory response. For example, the side walls of channel region 15a are coated with endothelial cells expressing cell surface molecules such as selectins, for example as shown in FIG. 58B. Leukocytes are then added to well region 14a and a known chemoattractant is added to well region 13a in any one of the embodiments of the test device of the present invention, such as the embodiments shown in FIGS. 55A-68. Other suitable cell types that can be added to well region 14a are neutrophils, monocytes, T and B lymphocytes, macrophages or other cell types involved in response to injury or inflammation. The leukocytes' chemotaxis across channel region 15a towards well region 13a is observed. Depending on the type of infection to be studied, different categories of leukocytes can be used. For example, in one embodiment studying cell chemotaxis in response to a bacterial infection, well region 14a receives neutrophils. In another embodiment studying cell chemotaxis in response to a viral infection, well region 14a receives T-cells.

In another embodiment simulating the process of angiogenesis, it is known in the art that growth factors applied to the cornea induce the growth of new blood vessels from the rim of highly vascularized tissue surrounding the cornea towards the sparsely vascularized center of the cornea. Therefore in another exemplary assay utilizing the chemotaxis and chemoinvasion device, cells from corneal tissue are placed in well region 13a and endothelial cells are placed in well region 14a in any one of the embodiments of the test device of the present invention, such as the embodiments shown in FIGS. 55A-68. A growth factor is added to well region 13a and chemotaxis of the endothelial cells is observed, measured and recorded. Alternatively, since angiogenesis is also important in tumor growth (in order to supply oxygen and nutrients to the tumor mass), instead of adding growth factor to well region 13a, cancer cells from corneal tissue that produce angiogenic factors such as vascular endothelial growth factor (VEGF) could be added to well region 13a and normal endothelial cells added to well region 14a. In a different embodiment also related to the study of angiogenesis, mast cells, macrophages, and fat cells that release fibroblast growth factor during tissue repair, inflammation, and tissue growth are placed in well region 13a and endothelial cells are placed in well region 14a. Since during angiogenesis, a capillary sprout grows into surrounding connective tissue, to further simulate conditions in vivo, channel region 15a can be filled with a gel matrix.

There are several variations and embodiments of the aforementioned assays. One embodiment involves the number of channels connecting well region 13a and well region 14a of chamber 12 of device 10. In one embodiment, such as the ones shown in FIGS. 57A-57C, there are multiple channels connecting well region 13a to well region 14a. By using multiple channels, multiple assays can be performed simultaneously using one biological sample of cells. In such an embodiment, all assays are performed under uniform and consistent conditions and therefore provide statistically more accurate results. For example, each assay begins with exactly the same number of potentially migratory cells and exactly the same concentration of test agent. Once a concentration gradient forms, each assay is exposed to the gradient for the same period of time. These multiple channels also provide redundancy in case of failure in the assay.

Another embodiment of the cell invasion and chemotaxis assay of the present invention involves the placement of cells in well region 14a of chamber 12 in any one of the embodiments of the test device of the present invention, such as the embodiments shown in FIGS. 55A-68. The cells may be patterned in a specific array on the upper surface U of support member 16 constituting the bottom surface of well region 14a or may simply be deposited in no specific pattern or arrangement in well region 14a. If the cells are patterned in a specific array on the upper surface of support member 16 constituting the bottom surface of well region 14a, then preferably, during the fabrication of device 10, the upper surface of support member 16 constituting the bottom surface of well region 14a is first patterned with cells and then top member 11 is placed over support member 16. It is desirable to monitor cellular movement from a predetermined “starting” position to accurately measure the distance and time periods the cells travel. As such, in one embodiment, the cells are immobilized or patterned upon the support member underlying the first well in such a manner that the cells' viability is maintained and their position is definable so that chemotaxis and invasion may be observed. There are several techniques known in the art to immobilize and pattern the cells into discreet arrays onto the support member. A preferred technique is described in copending application No. 60/330,456. In one embodiment, a cell position patterning member is used to pattern the cells into definable areas onto the upper surface U of support member 16 constituting the bottom surface of well region 14a of top member 11.

If, for example, top member 11 is fabricated in the footprint of a standard 96-well microtiter plate such that wells 13 and 14 correspond to the size and shape of the macrowells of the microtiter plate (not shown), then the cell position pattern member has outlined areas which correspond to the size and shape of wells 13 and 14 and therefore correspond to the size and shape of the macrowells of the microtiter plate. Each outlined area has micro through holes through which the cells will be patterned. In order to pattern the cells, the cell position patterning member iscontacted with support member 16 and the outlined areas of the cell position patterning member are aligned with portion of upper surface U of support member 16 that constitutes the bottom surface of well region 14a, and will ultimately correspond to well region 14a once top member 11 is contacted with support member 16. Cells are then deposited over the cell position patterning member and filter through the micro through holes of the patterning member onto the support member underlying the areas corresponding to through-holes corresponding to second well regions 14a of chambers 12. Top member 11 is then placed over support member 16 such that through-holes 14a are placed over the area of support member 16 in which the cells are patterned. These patterning steps result in discrete arrays of cells in well region 14a.

Preferably, the cell position patterning member comprises an elastomeric material such as PDMS. Using PDMS for the patterning member provides a substantially fluid-tight seal between the patterning member and the support member. This substantially fluid-tight seal is preferable between these two components because cells placed in the wells are less likely to infiltrate adjoining wells if such a seal exists between the patterning member and the support member. The arrangement of the micro through holes of the patterning member may be rectangular, hexagonal, or another array resulting in the cells being patterned in these respective shapes. The width of each micro-through hole may be varied according to cell types and desired number of cells to be patterned. For example, if the width of both cell and micro through hole is 10 microns, only one cell will deposit through each micro through hole. Thus, in this example, if the width of micro through hole is 100 microns up to approximately 100 cells may be deposited.

The present invention also contemplates the patterning of more than one cell type on the upper surface of support member 16 constituting the bottom surface of well region 14a in any one of the embodiments of the test device of the present invention, such as the embodiments shown in FIGS. 55A-68. Since cells of one type in vivo rarely exist in isolation and are instead in contact and communication with other cell types, it is desirable to have a system in which cells can be assayed in an environment more like that of the body. For example, since cancer cells are never found in isolation, but rather surrounded by normal cells, an assay designed to test the effect of a drug on cancer cells would be more accurate if the cancer cells in the assay were surrounded by normal cells. In testing an anti-cancer drug, cancer cells may be patterned on the upper surface of support member 16 constituting the bottom surface of well region 14a in any given one of the embodiments of the test device of the present invention, such as the embodiments of FIGS. 55A-68., and then through a separate patterning procedure, the cancer cells may be surrounded by stromal cells. To pattern two different cell types on the upper surface of support member 16 constituting the bottom surface of well region 14a, a micro cell position patterning member, as described above, is contacted with support member 16 and the outlined areas of the cell position patterning member are aligned with the portion of upper surface U of support member 16 that constitutes the bottom surface of well region 14a, and will ultimately correspond to well region 14a once top member 11 is contacted with support member 16. Cells of a first type may then be deposited over the cell position patterning member and filter through the micro through holes of the patterning member onto the portion of the upper surface U of support member 16 constituting the bottom surface of well region 14a. The micro cell position patterning member may then be removed from support member 16. A macro cell position patterning member with outlined areas that correspond to the size and shape of wells 13 and 14 and may therefore correspond to the size and shape of the macrowells of a 96 well microtiter plate. The macro cell position patterning member has macro through holes. A macro through hole of the macro cell position patterning member encompasses an area larger than the surface area defined by a micro through hole of the micro cell position patterning member, but smaller than the surface area defined by well region 14a of chamber 12. The macro cell position patterning member may then be contacted with support member 16. Cells of a second type may then be deposited over the macro cell position patterning member and filter through the macro through holes of the macro cell position patterning member onto the portion of upper surface U of support member 16 constituting the bottom surface of well regions 14a once top member 11 is contacted with support member 16. Such patterning arrangement may result in cells of a second type surrounding and “stacking” cells of a first type. If it is desired to only have the cells of the second type stack the cells of the first type, then the same micro cell position patterning member used to deposit the first cell type or a different micro cell position patterning member having the exact same configuration as the patterning member used to deposit cells of a first type, may be used to deposit cells of a second type. After the cells are patterned on support member 16, top member 11 may be contacted with support member 16 such that through holes in top member 11 corresponding to the well region 14a encompass the areas patterned with cells. This essentially results in cells being immobilized in a specific array within well region 14a.

Notwithstanding how many different cell types are patterned on the upper surface of support member 16 constituting the bottom surface of well region 14a, the cells may be patterned on the support member through several methods known in the art. For example, the cells may be patterned on support member 16 through the use of SAMS. There are several techniques known in the art to pattern cells through the use of SAMs of which a few exemplary techniques disclosed in U.S. Pat. No. 5,512,131 to Kumar et al., U.S. Pat. No. 5,620,850 to Bambad et al., U.S. Pat. No. 5,721,131 to Rudolph et al., U.S. Pat. Nos. 5,776,748 and 5,976,826 to Singhvi et al. are incorporated by reference herein.

Several methods are known in the art to tag the cells in order to observe and measure the aforementioned parameters. In one embodiment, an unpurified sample containing a cell type of interest is incubated with a staining agent that is differentially absorbed by the various cell types. The cells are then placed in well region 14a of chamber 12 in any given one of the embodiments of the test device of the present invention, such as the embodiments of FIGS. 55A-68. Individual, stained cells are then detected based upon color or intensity contrast, using any suitable microscopy technique(s), and such cells are assigned positional coordinates. In another embodiment, an unpurified cell sample is incubated with one or more detectable reporters, each reporter capable of selectively binding to a specific cell type of interest and imparting a characteristic fluorescence to all labeled cells. The sample is then placed in well region 14a of chamber 12 in any given one of the embodiments of the test device of the present invention, such as the embodiments of FIGS. 55A-68. The sample is then irradiated with the appropriate wavelength light and fluorescing cells are detected and assigned positional coordinates. One skilled in the art will recognize that a variety of methods for discriminating selected cells from other components in an unpurified sample are available. For example, these methods can include dyes, radioisotopes, fluorescers, chemiluminescers, beads, enzymes, and antibodies. Specific labeling of cell types can be accomplished, for example, utilizing fluorescently-labeled antibodies. The process of labeling cells is well known in the art as is the variety of fluorescent dyes that may be used for labeling particular cell types.

Cells of a chosen type may be also differentiated in a mixed-cell population, for example, using a detectable reporter or a selected combination of detectable reporters that selectively and/or preferentially bind to such cells. Labeling may be accomplished, for example, using monoclonal antibodies that bind selectively to expressed CDs, antigens, receptors, and the like. Examples of tumor cell antigens include CD13 and CD33 present on myeloid cells; CD10 and CD19 present on B-cells; and CD2, CD5, and CD7 present on T-cells. One of skill in the art will recognize that numerous markers are available that identify various known cell markers. Moreover, additional markers are continually being discovered. Any such markers, whether known now or discovered in the future, that are useful in labeling cells may be exploited in practicing the invention.

Since few, if any markers are absolutely specific to only a single type of cell, it may be desirable to label at least two markers, each with a different label, for each chosen cell type. Detection of multiple labels for each chosen cell type should help to ensure that the chemotaxis and chemoinvasion analysis is limited only to the cells of interest.

The present invention further provides a test device comprising: support means; means mounted to the support means for defining a discrete chamber with the support means by being placed in fluid-tight, conformal contact with the support means. The discrete chamber includes a first well region including at least one first well; a second well region including at least one second well, the second well region further being horizontally offset with respect to the first well region in a test orientation of the device; and a channel region including at least one channel connecting the first well region and the second well region with one another. An example of the support means comprises the support member 16 shown in FIGS. 55A, 55B, 66 and 67, while an example of the means mounted to the support means comprises the top member 11 shown in FIGS. 55A-65, 67 and 68. Other such means would be well known by persons skilled in the art.

From the foregoing, it will be observed that numerous modifications and variations can be effected without departing from the true spirit and scope of the novel concept of the present invention. For example, different embodiments of a device of the present invention may be combined. Embodiments of the present invention further contemplate different types of assays, for example, an assay wherein the test agent comprises a buffer solution instead of a chemotactic agent. In such an assay, cell migration through channel region 15a in observed in the absence of a chemotactic gradient.

It will be appreciated that the present disclosure is intended to set forth the exemplifications of the invention, and the exemplifications set forth are not intended to limit the invention to the specific embodiments illustrated. The disclosure is intended to cover by the appended claims all such modifications as fall within the spirit and scope of the claims.

In another embodiment, the present invention provides methods of assaying and studying biological phenomenon that either depend on or react to gradient formation and/or flow conditions. Such biological phenomenon include many of the processes in the body such as cell-surface interactions such as that occurring during leukocyte adhesion and rolling. In addition, studies involving chemotaxis, haptotaxis and cell migration will be better served with assays that are able to study such cell movement in the presence of gradients and/or flow conditions.

Various types of gradients are useful in the study of biological systems. Such useful gradients include static gradients, which have concentrations that are fixed, or set or substantially fixed or set. One example of a static gradient is a gradients of immobilized molecules on a surface. Non-limiting examples of static gradients include the use of differing concentrations of immobilized biomolecules (proteins, antibodies, nucleic acids, and the like) or immobilized chemical moieties (drugs and small molecules). Other useful gradients include dynamic gradients, which have concentrations that may be varied. One example of a dynamic gradient is a gradient of fluid streams having molecules in varying concentrations. Non-limiting examples of fluid gradients include the use of fluid streams containing biomolecules such as growth factors, toxins, enzymes, proteins, antibodies, carbohydrates, drugs or other chemical and small molecules in varying concentrations.

In one embodiment of the present invention, a dynamic/solution based gradient is created by laminar flow technology. Laminar flow technology typically involves two or more fluid streams from two or more different sources. These fluid streams are brought together into a single stream and are made to flow parallel to each other without turbulent mixing. Fluids with different characteristics such as varying low Reynolds numbers will flow side by side and will not mix in the absence of turbulence. Since the fluids do not mix, they create pseudo-channels (pseudo by the fact that there are no physical separation between the fluids). The generation of solution and surface gradients is discussed in U.S. patent application 2002/0113095 and an article, Jeon, Noo Li, et al., Langmuir, 16, 8311-8316 (2000). Both of these references are herein incorporated by reference in their entirety.

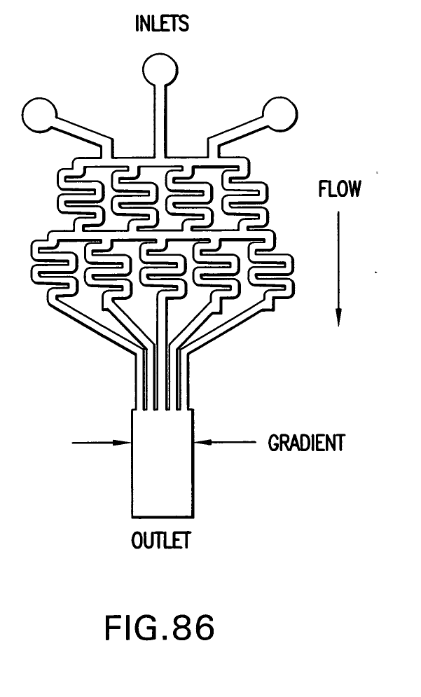

In these references a PDMS microfluidic device was used to generate a gradient through a microfluidic network of capillaries. Solutions containing different chemicals were introduced into three separate inlets and allowed to flow through the network of capillaries. The fluid streams were repeatedly combined, mixed, and split to yield distinct mixtures with distinct compositions in each of the branching channels. When all of the branches were recombined, a concentration gradient was established across the outlet channel, perpendicular to the flow direction. See FIG. 86.

By combining the devices of the present invention with the formation of a dynamic gradient, a vast number of assay parameters can be generated by altering any portion of the device. For example, by combining the device as disclosed herein with cell patterning techniques, along with the introduction of a dynamic gradient, various conditions can be created to test numerous biological interactions. Further, the device and assays may be useful in drug discovery and drug testing as many cells and biological materials behave differently ex vivo when not exposed to gradients than compared to when the cells or biological materials are present in vivo and thus exposed to gradients and flow conditions.

Accordingly, in one embodiment of the present invention, cells can be patterned across the channel. Cell patterning can be achieved by methods known in the art, as well as disclosed in the present invention (such as, but not limited to, microcontact printing or by the use of elastomeric stencils). A solution containing any desired biomolecule or chemical/drug can then be flowed across the patterned cells. Additionally, the cells could be first treated by a biomolecule such as an activator to more closely recreate a biological system, and then be subsequently exposed to a chemical or drug. By creating a gradient, such as by laminar flow, different amounts of biomolecules or chemicals/drugs can be delivered to the patterned cells and thus the effect of concentration of each biomolecule or chemical/drug be tested simultaneously against each other. This side by side, same time comparison thus reduces the variability of assay to assay conditions.

Creating dynamic gradients with laminar flow in combination with the devices of the present invention provides numerous assay configurations. For example, by varying the combinations of the cells on the surface, the biomolecule in the channels and the compounds in the channel, one can create a vast multitude of assays.

With respect to immobilized cells or other immobilized biomolecules such as proteins, antibodies, nucleic acids, etc. different assay configurations are possible. In one embodiment, a single cell type is immobilized throughout the entire channel region. In another embodiment, a mixture of cell types are immobilized, one cell type per region. In another embodiment, a mixture of cell types is immobilized throughout the entire channel region. This may be advantageous in monitoring cell-cell interactions. In yet another embodiment, different cell types are immobilized in each different region.

In addition to the various immobilization schemes, further assay design flexibility centers around the biomolecules present in the channels. For example, in one embodiment, one type of biomolecule is present in each channel at the same concentration. In another embodiment, one type of biomolecule is present in each channel at differing concentrations. In another embodiment, different biomolecules are present in each channel. In another embodiment, there is a mixture of biomolecules in each channel. Each channel may have the same mixture or a different mixture. When the mixture is the same, the ratios or concentrations of the different biomolecules may be different in each channel.

Likewise with respect to compounds, such as drugs or test substances, the present invention provides flexibility in assay design. For example, in one embodiment a single compound is present in all the channels at the same concentration throughout. In another embodiment, the same compound is present in all the channels but each channel has a different concentration of that compound. In another embodiment, each channel has a different compound. In another embodiment, there is more than one compound. When there is more than one compound, each channel may have the same mixture of compounds or may have a different mixture of compounds. Further, when the mixtures of the compounds are the same, each channel may receive a different concentration of that mixture. Yet, even further, each channel may receive the mixture of the compounds, with each channel having a different ratio of compounds to each other.

Such assay systems can be used to test among many numerous biological interactions, the effects of chemical or drugs on cells or other biomolecules. For example, one may use the device and the assays of the present invention to measure the IC50 of a compound by using a laminar flow gradient of a compound present from a low concentration to a high concentration flowed across immobilized biomolecules.

The present invention also provides the ability to humanize the preclinical stages of drug discovery. By using the devices and assays of the present invention, patient profiles are created and analyzed. Preferably primary cells are used to create the profiles.

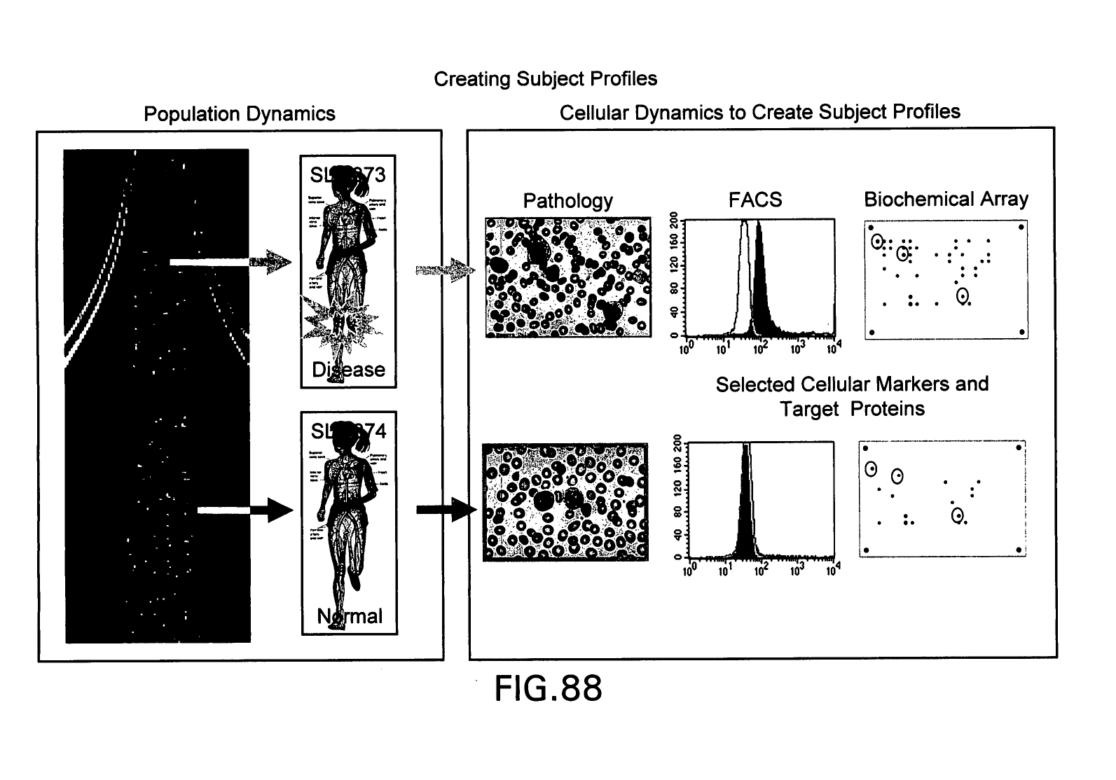

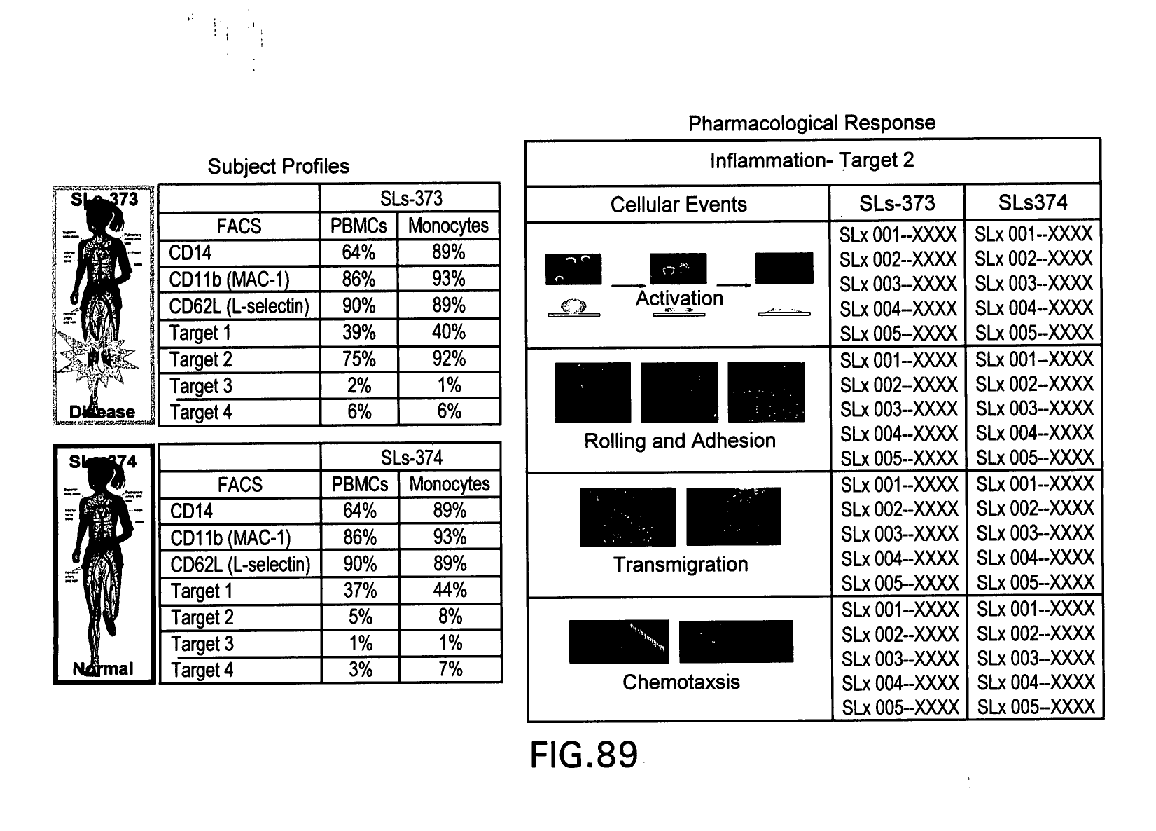

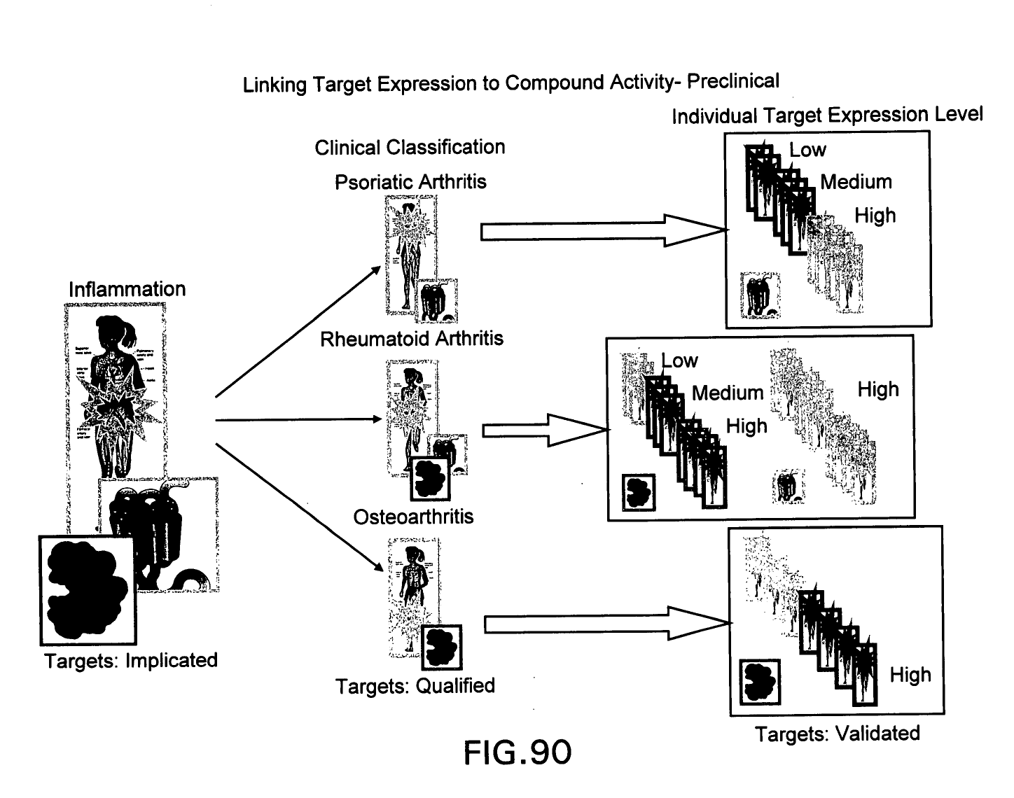

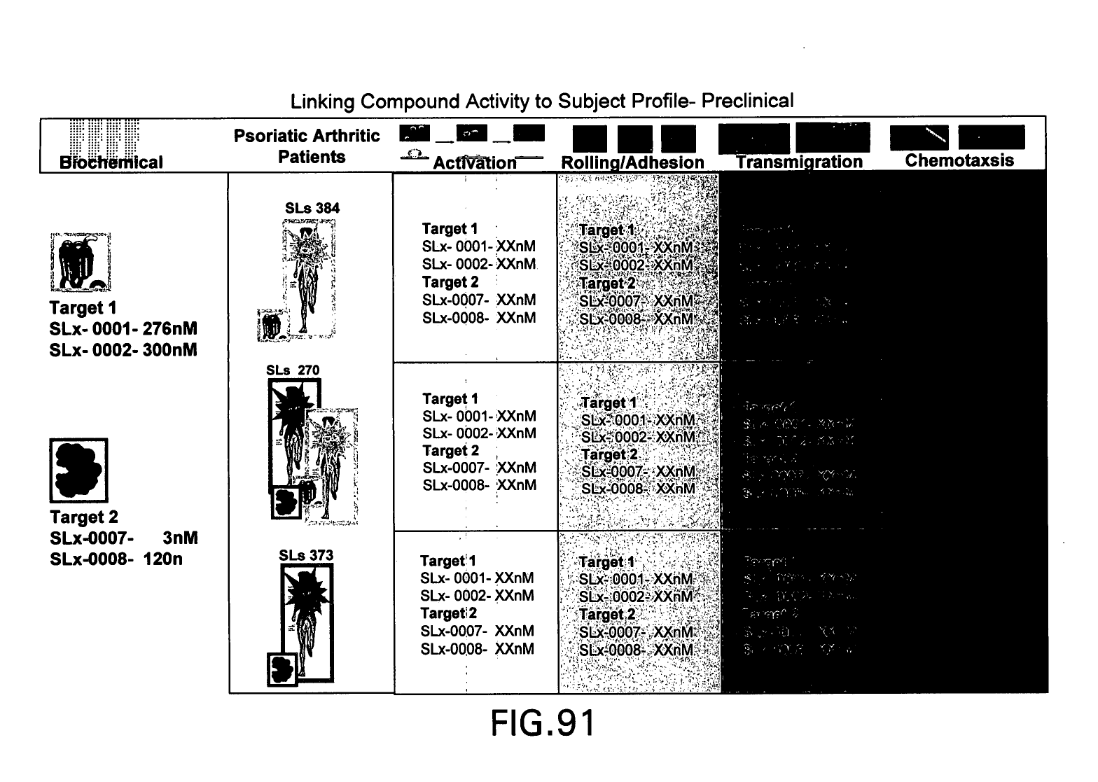

As used herein, “primary cell profile” refers to a composite of cellular dynamic and phenotypic information regarding cells taking from a human subject and grown in primary culture. The invention envisages quantification of various primary cell phenotypes or dynamics under a variety of culture conditions and assays that mimic a donor patients' primary cells' in vivo conditions, into a primary cell profile. A primary cell profile is preferably determined by assaying cellular phenotypes and dynamics using a methodology comprising monitoring a patient's primary cells' morphology, molecular marker expression pattern, state of selective activation, their rolling and adhesive properties, ability to transmigrate and/or their chemo-, haptotactic and chemoinvasive properties. FIGS. 88 and 89. These methodologies are disclosed herein.

Although the techniques disclosed herein are readily adaptable to a wide variety of primary cell types, the preferable primary cells are leukocytes. Candidate molecular markers used for ascertaining a primary leukocyte profile include but are not limited to CD14, CD11 (MAC-1), and CD62 (L-selectin). Other suitable leukocyte markers include T cell Antigen, CD1, CD2, CD58 (LFA-3), CD3, CD4, CD5, CD7, CD8, LeuCAM, CD11a (LFA-1), CD11b, CD11c (CR4), CD16 (FcR111), CD21 (CR2), CD23 (FCeR11), CD25, CD30, CD35 (CR1), CD41, CD51, CD44, Mel-14, GRHL1, Mel-14, CD49a-f(VLA-1), VLA-2, VLA-3, VLA-4, CD56, NKH1, CD71. See FIG. 89.

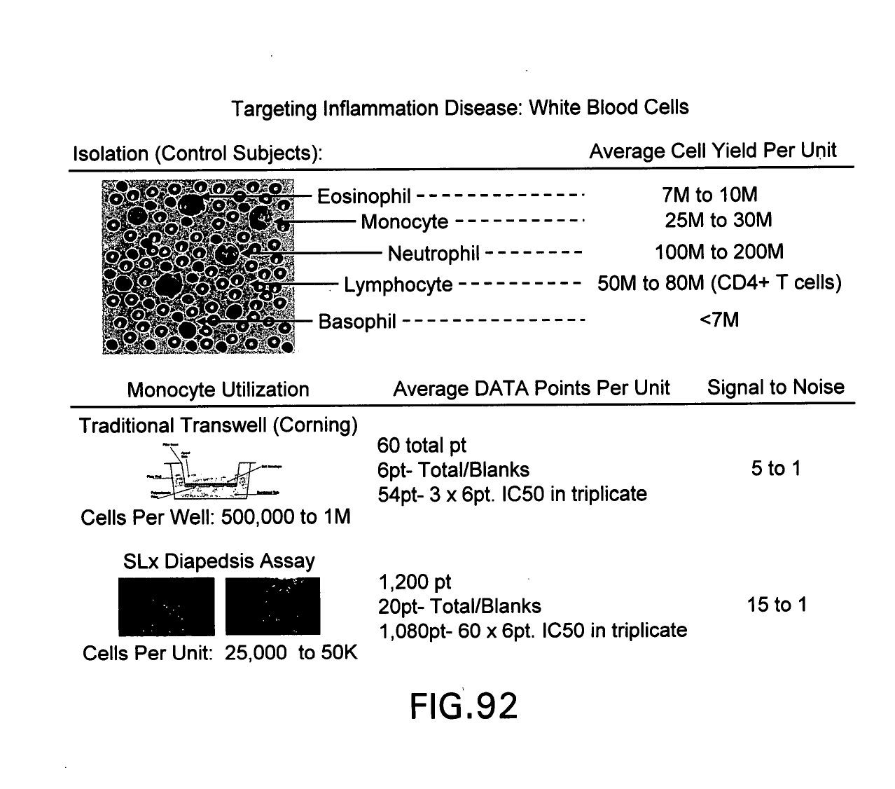

In another embodiment, the invention utilizes monocytes. In yet a further embodiment, the method uses between about 25,000 and about 50,000 monocytes per assaying unit. FIG. 92.

The primary cell profile may also contain information derived from the methods of monitoring leukocyte migration disclosed herein. The methods taught herein provide information relating ascertaining, quantifying and monitoring the activation, rolling/adhesion properties, and transmigration with respect to cultured leukocytes.

The primary cell profile may also contain information derived from the methods taught herein provide information relating ascertaining, quantifying and monitoring cellular chemo-, haptotaxis and chemoinvasion disclosed herein. In particular, the present invention contemplates the use of any system known in the art to visualize and quantify changes in cell morphology, cell movement, distance traveled and number of cells that travel to particular points. As such the present invention contemplates both “real-time” and “end-point” analysis of chemotaxis, haptotaxis, and chemoinvasion.

One aspect of the present invention relates to methods for correlating a pharmacological therapy with primary cell profiles derived from a subject patient. See FIGS. 88 and 89. Given the methods disclosed herein, a profile based on a primary cell sample may be readily obtained and correlated with previous profiles derived from either normal healthy or diseased individuals for diagnostic purposes or to ascertain the efficacy of a particular therapeutic regimen. For example, a profile comprising the status of the pathological and molecular markers are measured diseased and healthy individuals are compared. FIGS. 88 and 89. These show a diseased individual versus a healthy individual having an increase in leukocyte numbers, change in activation markers, and upregulation and stronger signals in biochemical arrays.

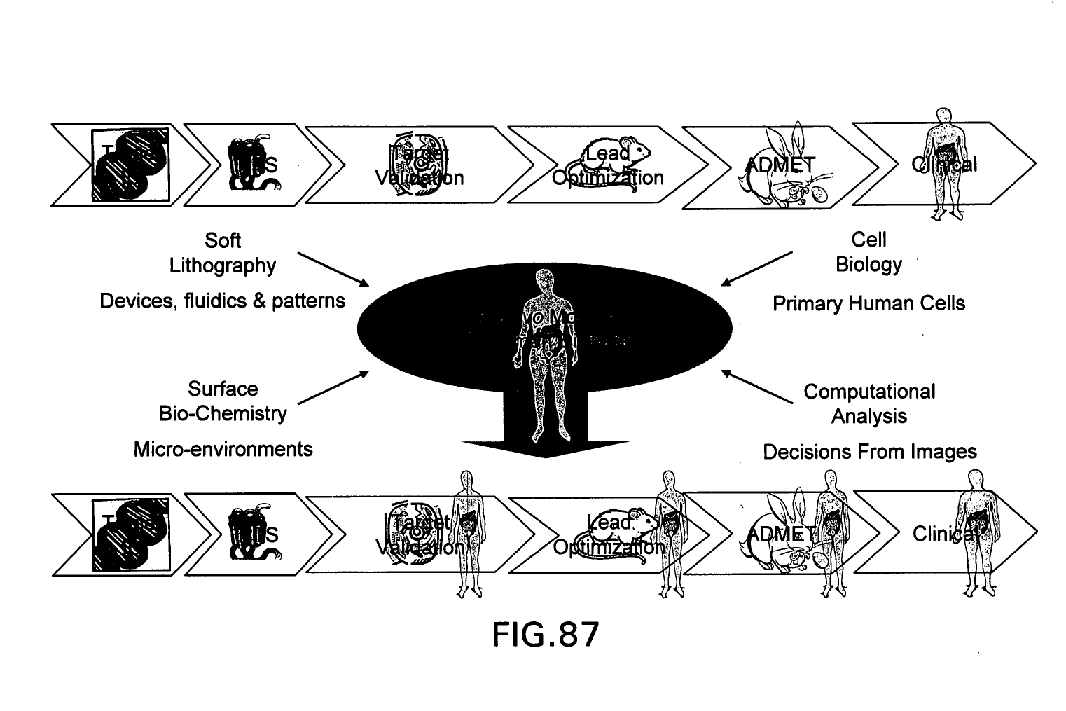

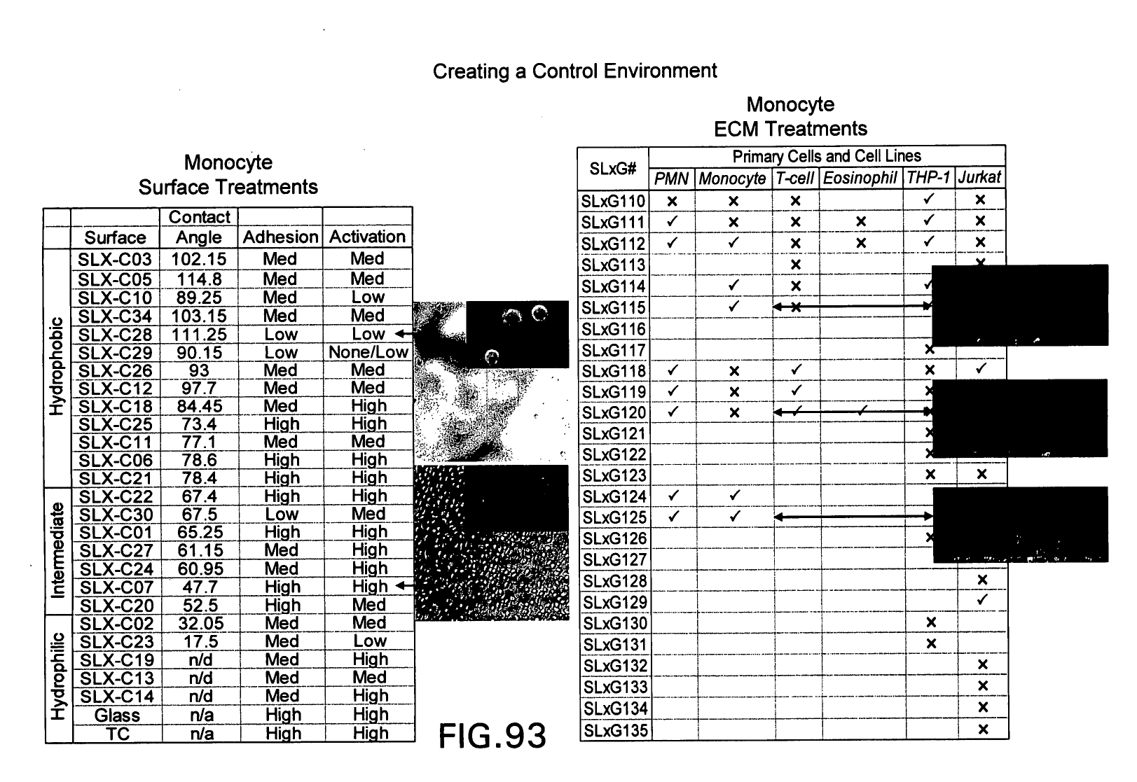

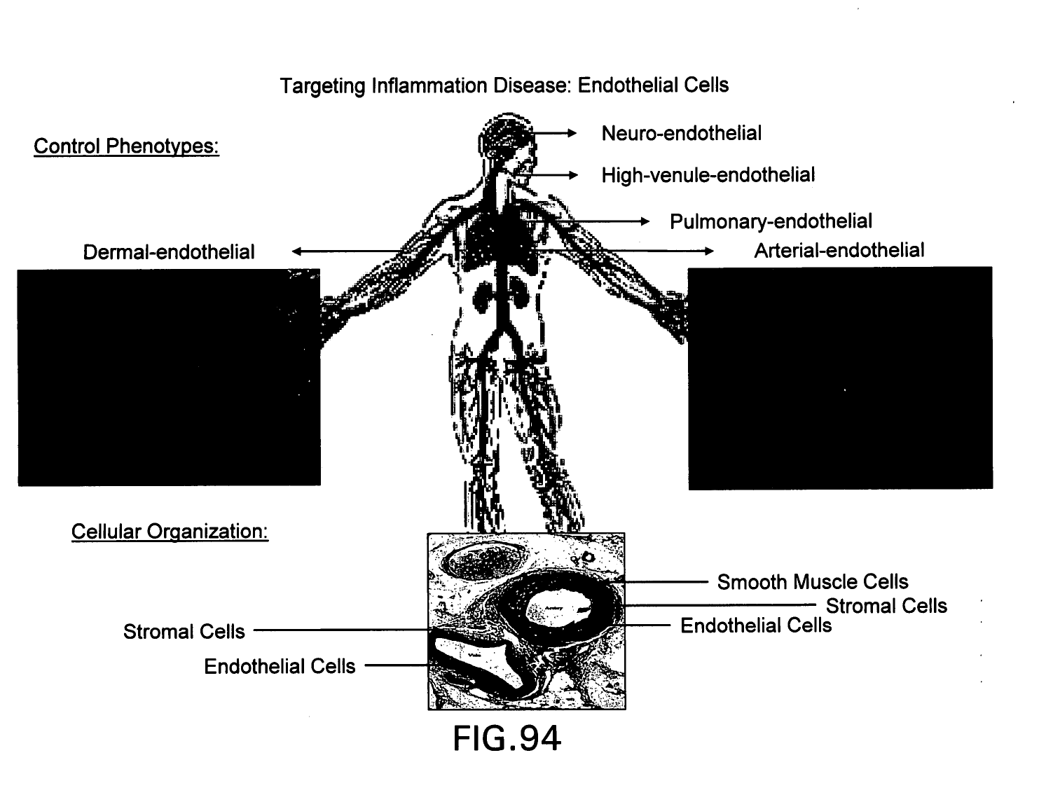

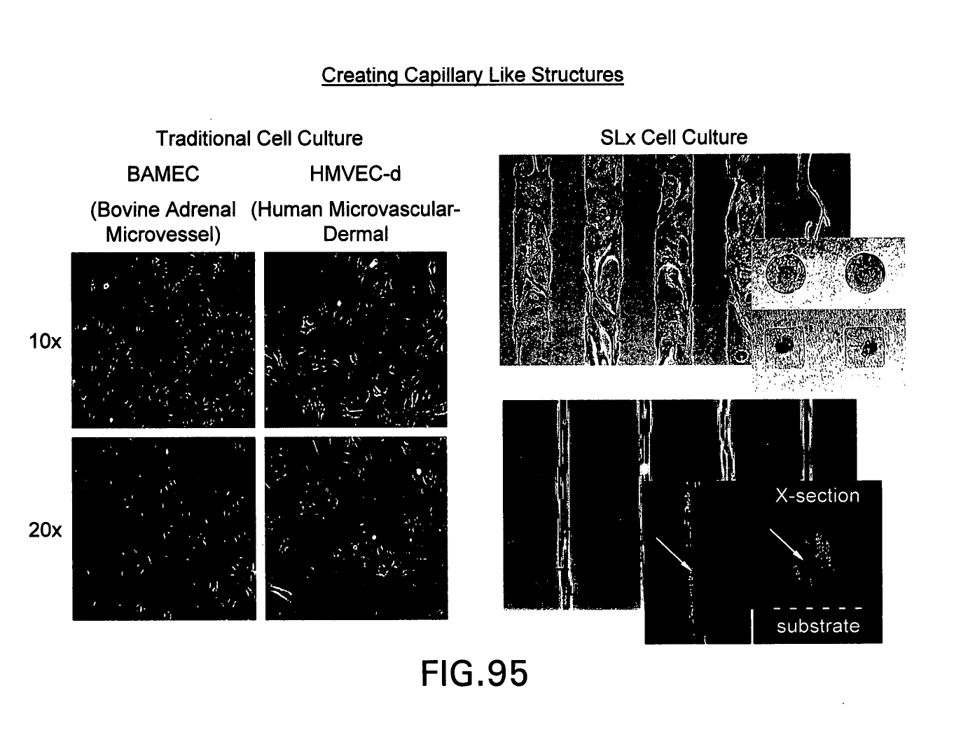

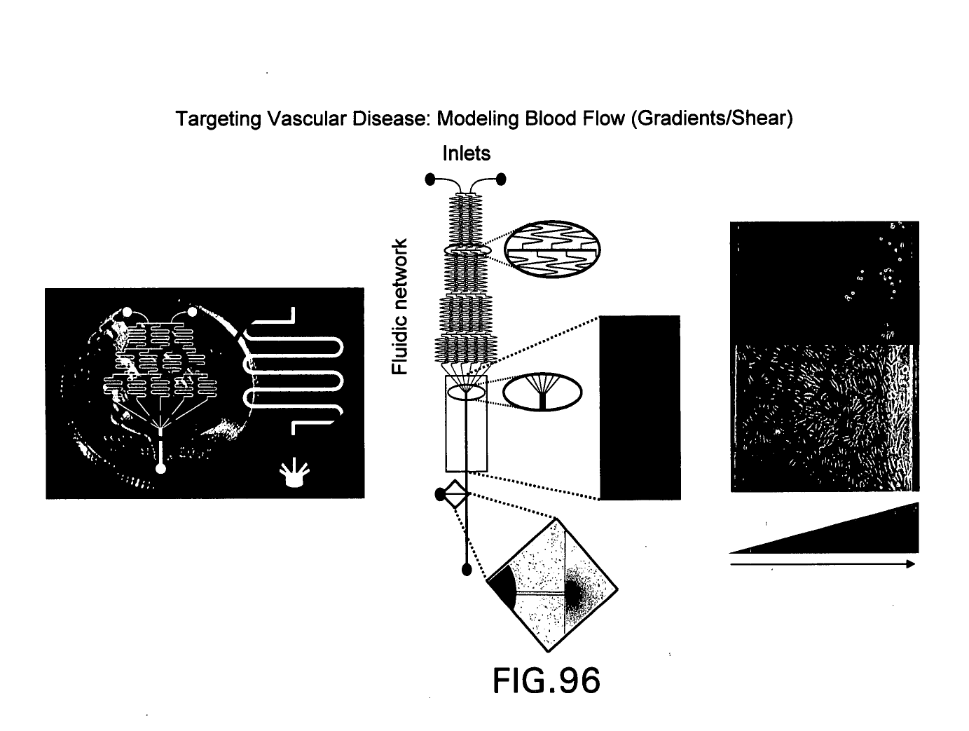

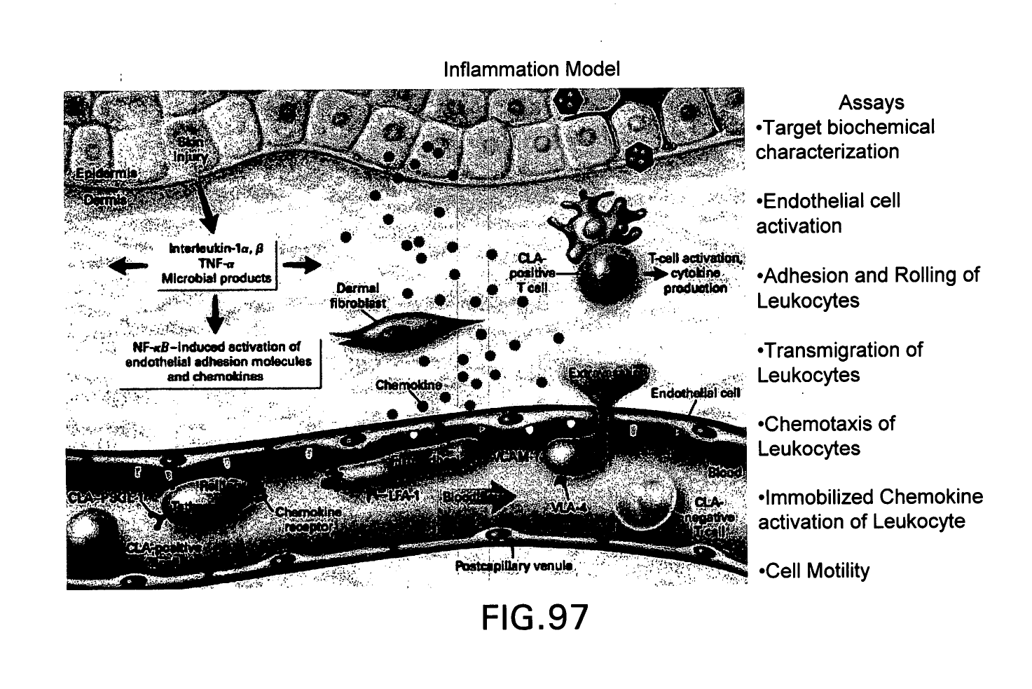

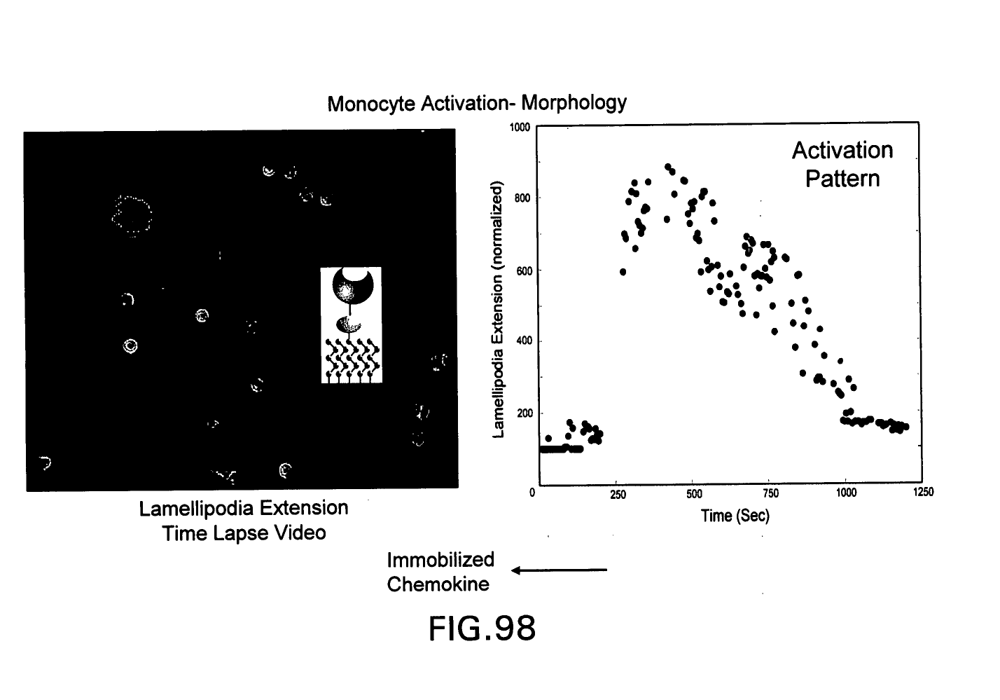

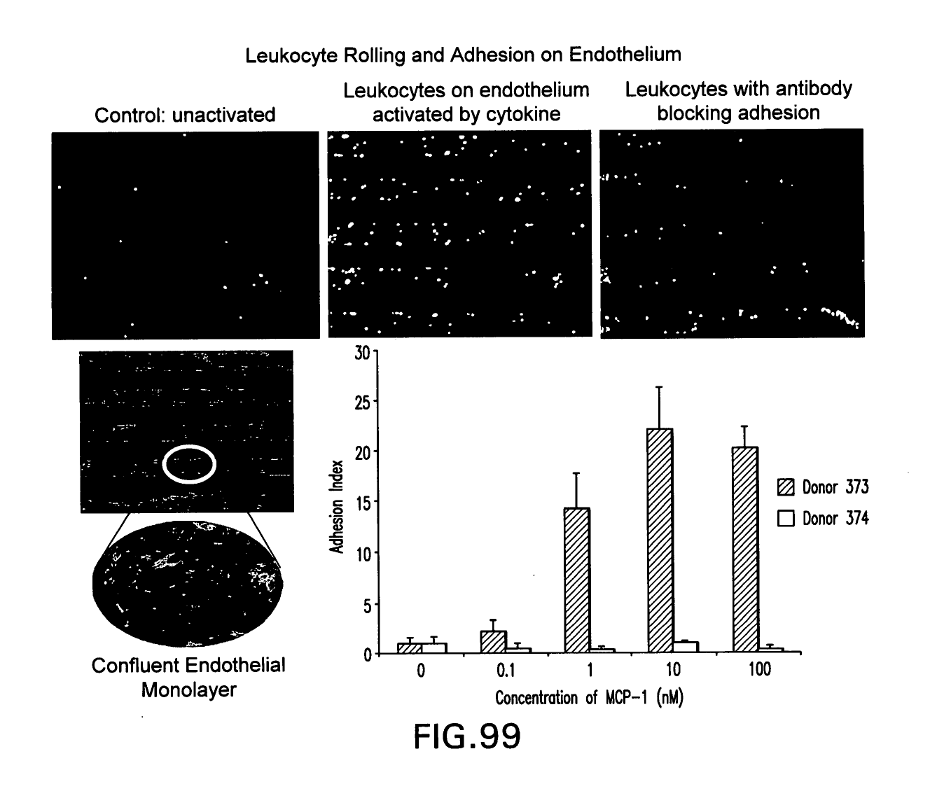

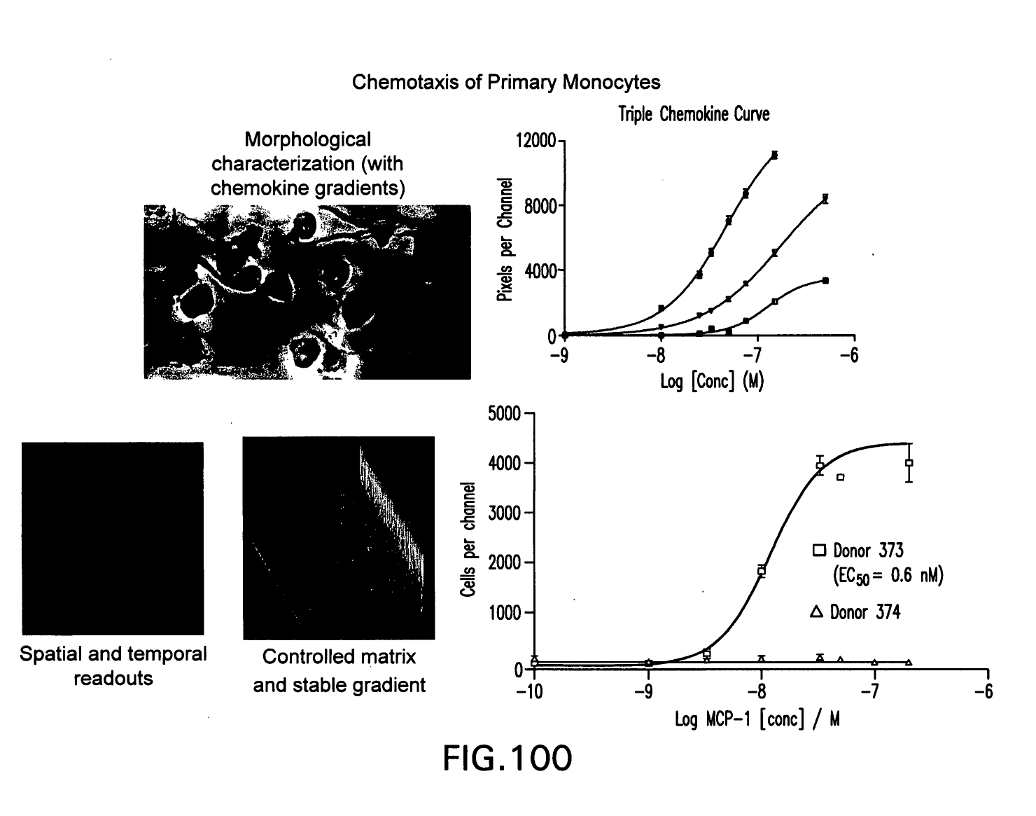

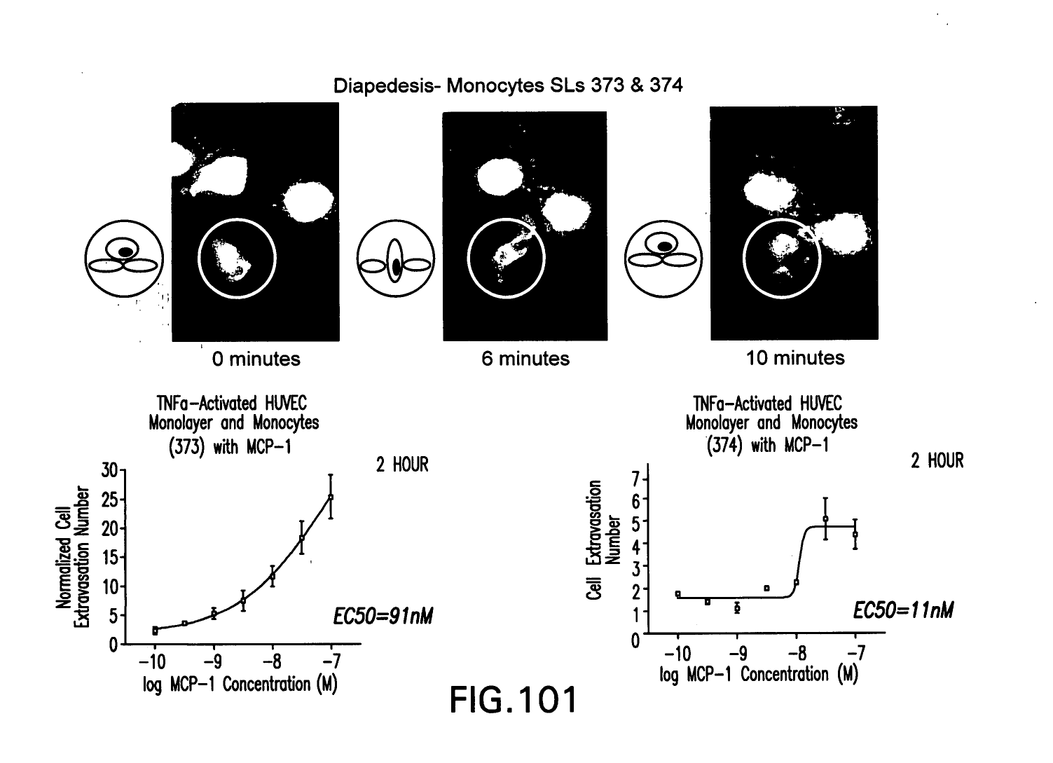

Another aspect of the invention relates to testing the biological activity of test compounds by assaying their ability to perturb a primary cell profile. The more closely a cell culture based assay resembles the in vivo cellular state of affairs with respect to a particular disease, the more effective the assay will be for identifying potential drug candidates for treating that disease. Traditionally, the human element has only introduced at the clinical stage of the drug discovery/development process. However, the present invention envisages humanizing the preclinical stages of drug discovery. In other words, the inventors bring the human element into the target validation, lead optimization, and ADMETox stages. See FIG. 87. For example, this technology allows the pharmacologist to readily obtain an IC50 profile of a candidate drug in an individual over the suite of assays for that target. This is accomplished by creating primary cell cultures and cell culture conditions that mimic cells' in vivo chemical and mechanical milieu. See FIGS. 93-101.

One embodiment of this aspect of the invention, creates cellular microenvironments that mimic primary cells' in vivo chemical and mechanical milieu for complex cell cultures. FIG. 93. For example, neuronal cells are grown in a predetermined array on a substrate based on patterned surface chemistry. In another example, endothelial cells are cultured to create an endothelial scaffold such that they form a lumen and are exposed to sheer forces to monitor leukocyte migration and assay endothelial activation.

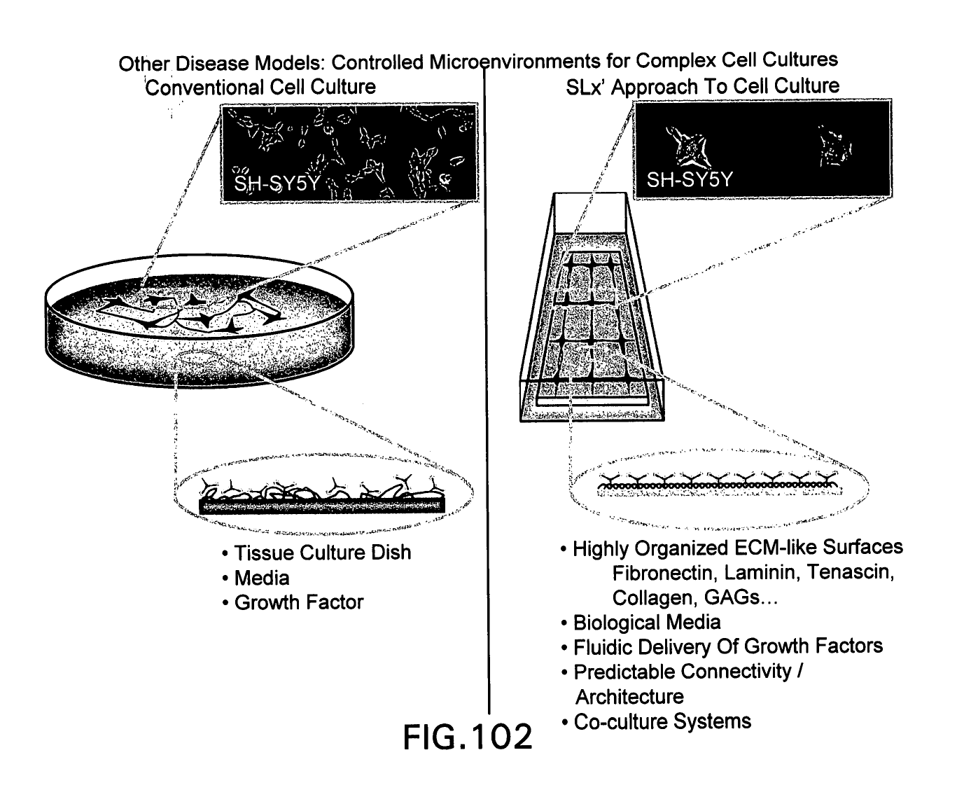

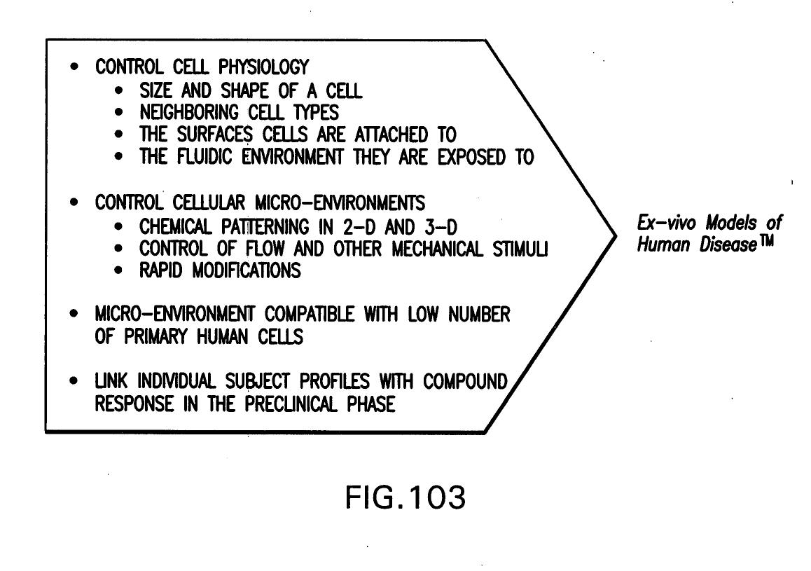

In another embodiment, neuronal cells are grown in a predetermined array on a substrate based on patterned surface chemistry. FIG. 102. In another embodiment, a controlled cellular microenvironment is created by co-culturing hepatocytes and fibroblasts. In yet a further embodiment, a controlled cellular microenvironment is created by co-culturing non-cancerous cells and cancerous cells.

In a preferred embodiment of this aspect of the invention, the cells are leukocytes. In another embodiment the test compounds are anti-inflammatory drugs.

### EXAMPLES

### Example 1

### Produced for Cell Migration Assay Plate Fabrication

A topographically patterned master having a plurality of posts is prepared from a photolithographic mask. These posts are elevated approximately 100 μm above the background. In one embodiment, the pattern is made up of 24 micro-regions, each containing a circular array of 200 μm posts spaced on a 500 μm center. Alternately, instead of having discrete regions of posts, the entire surface of the master may contain posts. In one preferred embodiment, the master is made of photoresist patterned on a 150 mm silicon wafer. To prepare this master, SU-850n photoresist spun at 1300 rpm was used and processed according to the supplier's specifications.

A two-component poly(dimethylsiloxane) (PDMS) prepolymer (Gelest Optical Encapsulant 41) was mixed and degassed under vacuum before it is spun onto the master. This spin coating was done at a speed high enough to produce a polymeric membrane (i.e., the thickness of the resulting PDMS film is less than that of the elevated features on the master). The prepolymer was spun at 2250 rpm for 40 seconds. A rigid frame with the standard microtiter footprint was then placed around the outer perimeter of the membrane. The master/membrane/frame was then placed on a hotplate 109 and the PDMS was cured for seven minutes at 95° C.

After cooling the master to room temperature, a group of 24 rigid plastic rings was “inked” in thin film of liquid PDMS. The rings were then placed around the post arrays on the master and the entire assembly was again heated on a hotplate 100 for two minutes at 95° C.

The final fabrication step involved filling the area between the rings with PDMS to make up the bulk of the device. Here, the PDMS was injected via syringe into the space between the rings. The PDMS “ink” on the rings, which had been partially cured by this point, prevented leakage of PDMS into the membrane regions. The master was again placed on 95° C. hotplate 100 and the PDMS was cured for 30 minutes.

To remove the cured device from the master, the top surface was first covered with a thin layer of ethanol, which quickly wetted the PDMS. A dull knife was used to cut the interface between the inside of the frame and the polymer, which allowed the frame to be removed from the master. While the device may be removed with the frame intact (i.e. the frame becomes part of the final device), in this example the frame was used for molding purposes only.

The device was then covered again with a thin layer of ethanol (to prevent sticking) and manually peeled from the master. Upon removal, the device was rinsed one final time with ethanol before it was dried with nitrogen gas and placed in a 65° C. oven for solvent evaporation. The device was then stored in a polystyrene dish, which can optionally be used as the support for studying cell motility.

### Example 2

### Patterning of Cells on a Support

In this example, macro-wells of a stencil which is engaged with a the first layer 150 and support are filled with PBS and a vacuum is applied for two minutes to remove air bubbles. The support may then be treated with fibronectin (50 mg/ml) or other extracellular matrix protein for 30 minutes, followed by washing twice with PBS. After aspirating PBS, cells may then be plated in freshly warmed medium at a density of 5-25×10³ cells/cm² (=1-4×10⁴ cells per macro-well of a 24-well plate 100, in a volume of 300 ml per macro-well; or 5-25×10⁴ cells per 35 mm dish in a volume of 2 ml). The cells deposit through the micro-orifices of the first layer, and attach to the support.

After the cells have attached to the support (30 minutes-2 hours), the cell culture medium in each macro-well is replaced with fresh medium. Cells are left to spread in a 37° C. incubator for two hours to overnight. The cells are washed with PBS and fresh medium containing the treatment of interest is added to the wells. The stencil/first layer is then removed and the effects of the test compound on cell motility, cell shape or viability are observed.

### Example 3

### Image Acquisition

Imaging is performed using an inverted microscope equipped with the following: epifluorescence, motorized and programmable stage, autofocus mechanism, and CCD camera. Two to three randomly selected areas per macro-well are imaged. The stage translated from one macro-well to another, and images were focused using automatic focus (Z axis). Images were captured in either phase contrast or epifluorescence.

Acquired images shared a common file name, but different suffix corresponding to the macro-well number and position. For example, an experiment called TEST with 24 wells generated TEST01-TEST24 when one image per macro-well was taken. Images are generated prior to application of a test compound or other external stimulus, and at various times after treatment.

### Example 4

### Data Analysis

Automated data analysis was performed using software that processed information in the following order: a) recall of files in consecutive order; b) identify cells (using various methods such as thresholding, erosion, and gradient contrasting; c) define cells in a cluster using a clustering algorithm; d) measure relevant parameters. Some of the relevant parameters are based on cellular clusters or micro-regions: average values of perimeter, diameter, surface area, percentage of cell coverage per unit area, perimeter to surface area ratio, and other parameters. The data analysis is capable of correlating any or all these parameters with cell motility. The final data set may be based on normalized average of multiple parameters or one specific parameter based on biological observation.

### Example 5

### 3T3/TAXOL

Macro-wells orifices of a stencil engaged with a support were filled with PBS and a vacuum was applied for two minutes to remove air bubbles. NIH-3T3 fibroblast cells (prelabeled with green cell tracker, CMFDA, Molecular Probes) were collected in DMEM/10% bovine calf serum and plated in the macro-wells at a concentration of 2×10⁴ cells/cm2. After one hour, unadhered cells were washed off with fresh medium. After an overnight incubation, fresh medium containing increasing dosages of paclitaxel (Sigma, 0.1-10 mg/ml) was added to the wells and the stencil was peeled off. Control cells were left untreated. Images of migrating cells were taken at time points, from 0-24 h.

### Example 6

### Farnesyl Transferase Inhibition in MS1 and SVR

The qualitative cell migration assay plates of the present invention are useful in the study of biological pathways, such as the RAS pathway, for example. The assays allow for the study of various metabolic pathways and allows for analysis of the effect(s) of agents or biological entities such as inhibitors of cell migration and/or motility on cell motility or cell shape. RAS (a guanine nucleotide binding protein) plays a pivotal role in the control of both normal and transformed cell growth. Following stimulation by various growth factors and cytokines, RAS activates several downstream effectors, leading to gene transcription and proliferation. In many cancers, including 90% and 50% of pancreatic and colon cancers respectively, ras gene mutations produce a mutated RAS that remains locked in an active state, thereby relaying uncontrolled proliferative signals. Much is known about the RAS pathway including strategies to inhibit it. For example, Farnesyl Transferase inhibitors inhibit RAS targeting the cell membrane since Farnesyl Transferase is believed to assist RAS in membrane localization. Additionally, it is believed that downstream effectors, P13-K and MAPK, can be inhibited, thus in turn inhibit the effect of RAS.

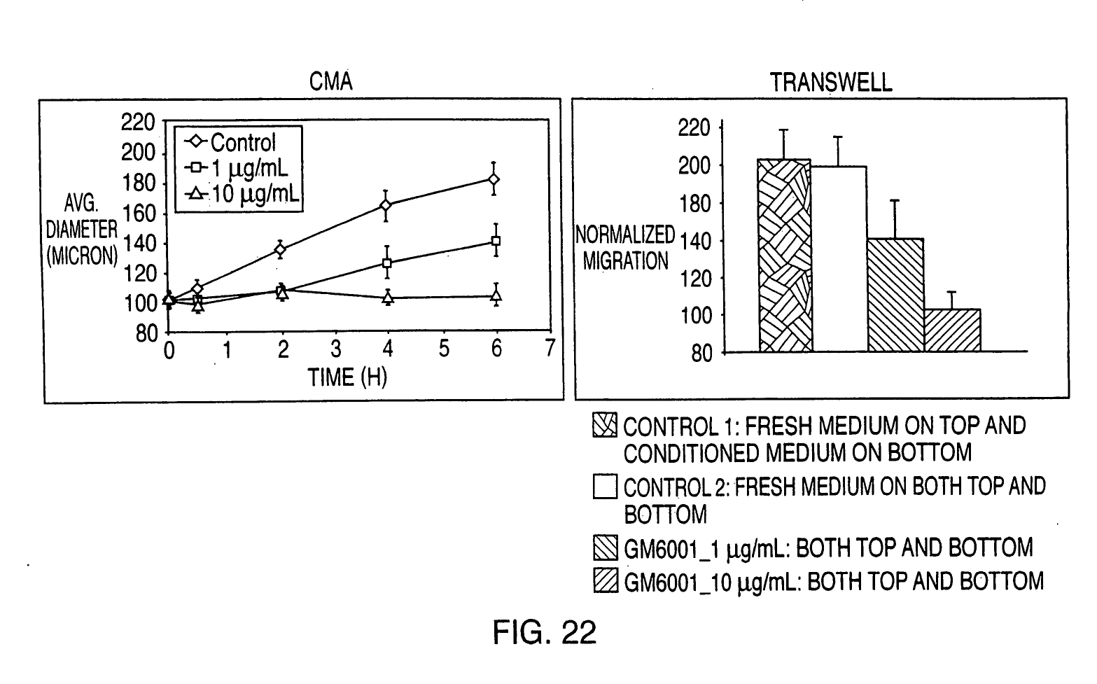

Using standard protocols, MS1 (T antigen-immortalized endothelial cells, ATCC) and SVR (H-ras-overexpressing derivative of MS1, ATCC) were plated into macrowells at densities of 12×10³ and 6×10³ cells/cm², respectively, in DMEM/5% fetal bovine serum. Unattached cells were washed off after 1 hour, and the cells were replenished with fresh media. To the media was also added farnesyl transferase inhibitor (FTI-277, Calbiochem) to concentration of 10 mm. Cells were cultured overnight under fresh media in an incubator at 37° C. and 5% CO₂. At the start of experiment, the stencil/first layer was removed after first on the support to allow cell migration. At different time points (time zero and time four hours) images were taken and analyzed for effects of FTI-277 on cell motility. FIG. 21 contains the pictorial results of an assay showing farnesyl transferase inhibition in MS1 and SVR cells. The control cells are shown to have migrated further away from their original starting positions than the cells treated with FTI. FIG. 22 graphically depicts the results of the same assay as shown in FIG. 21.

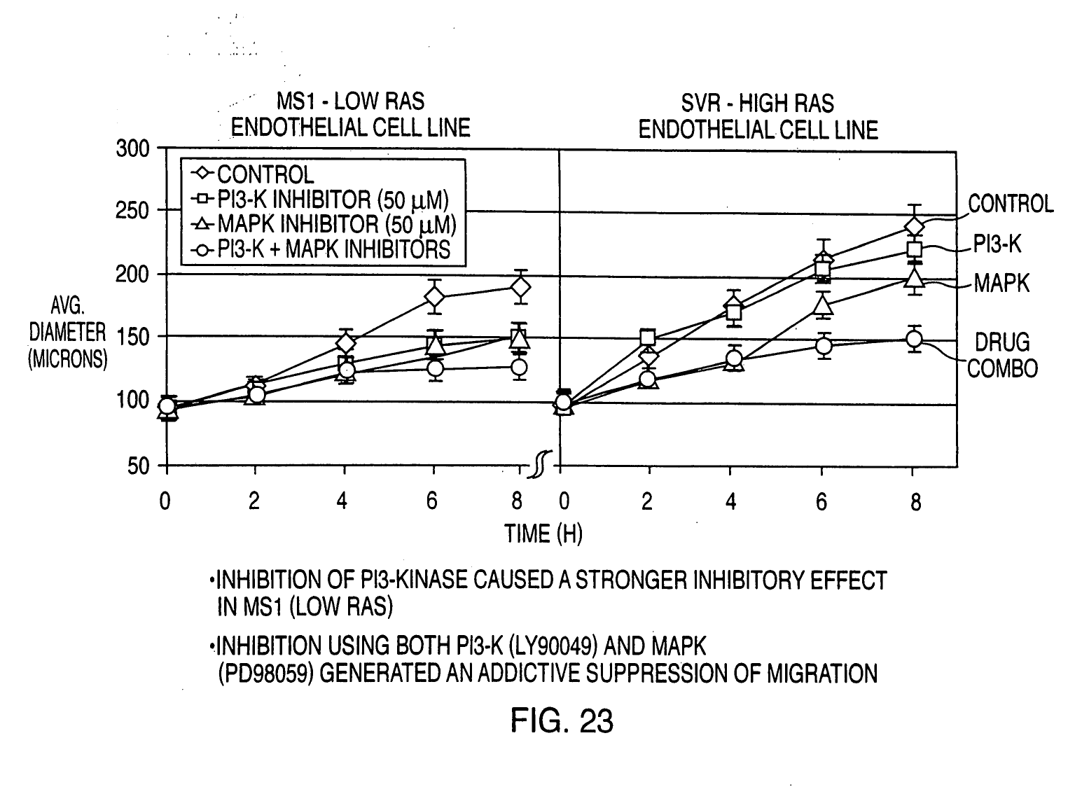

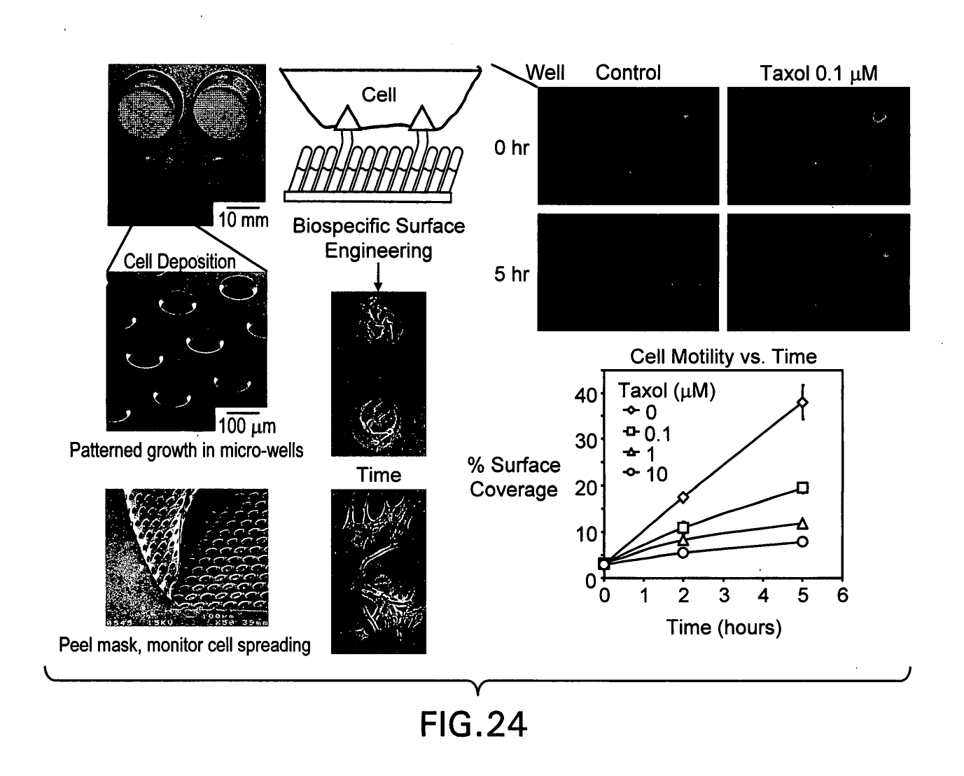

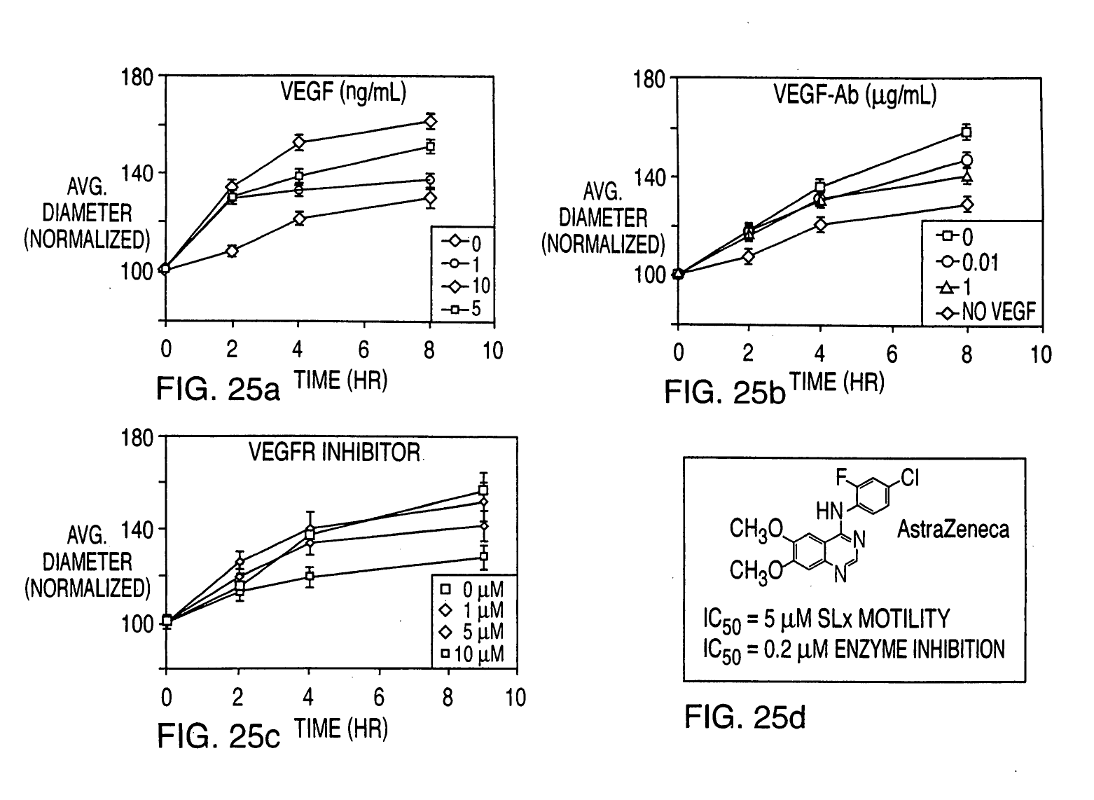

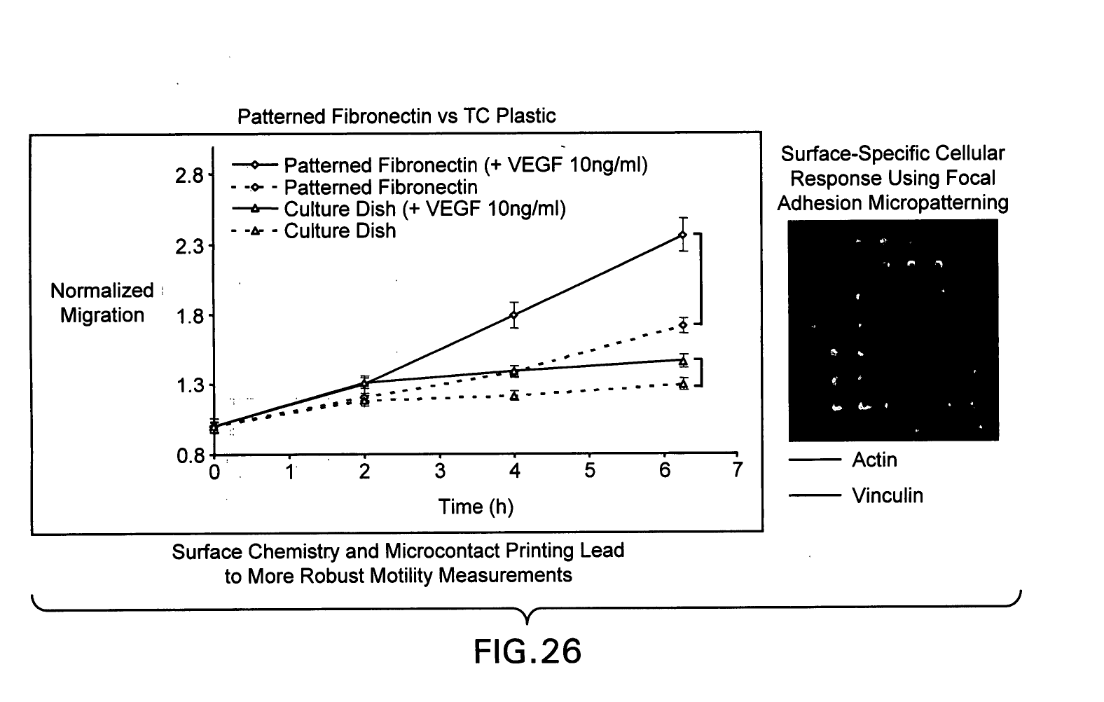

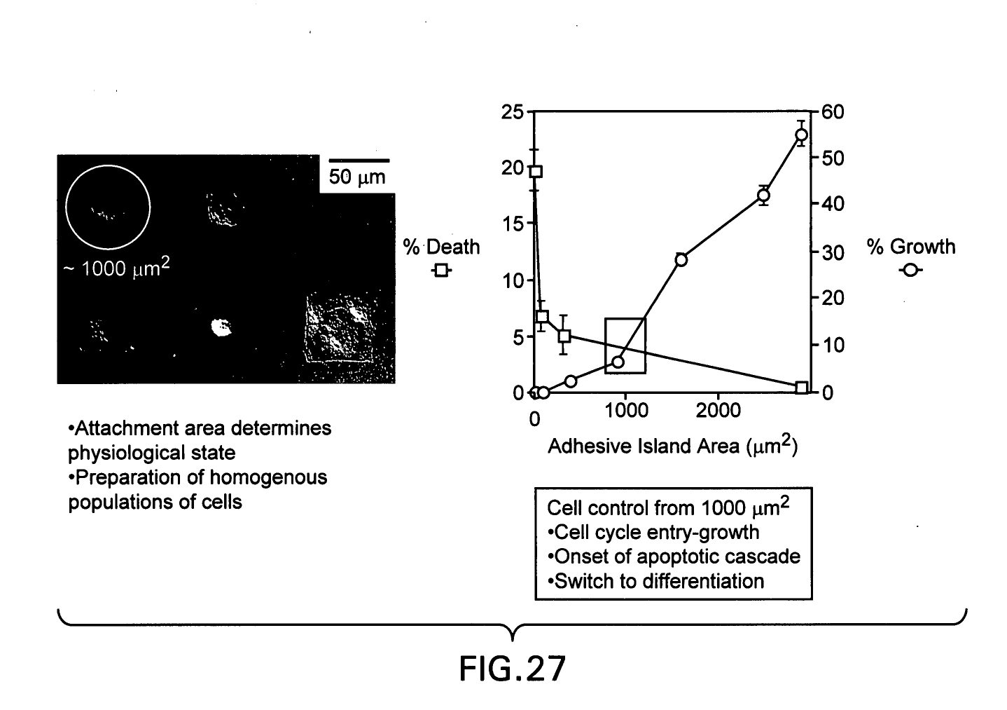

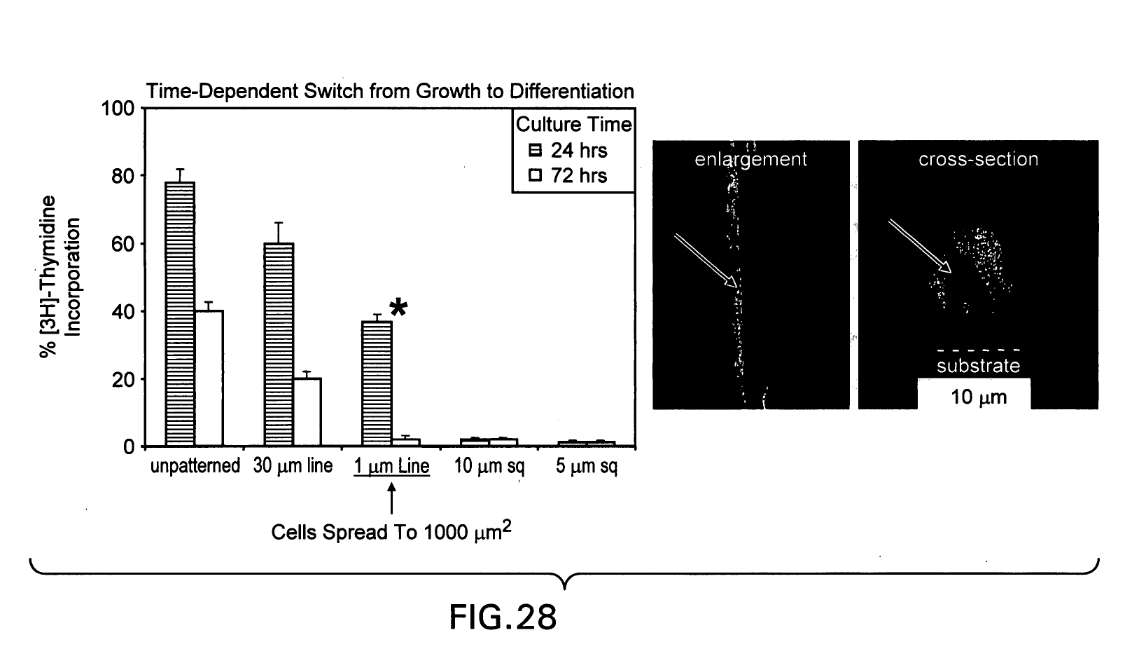

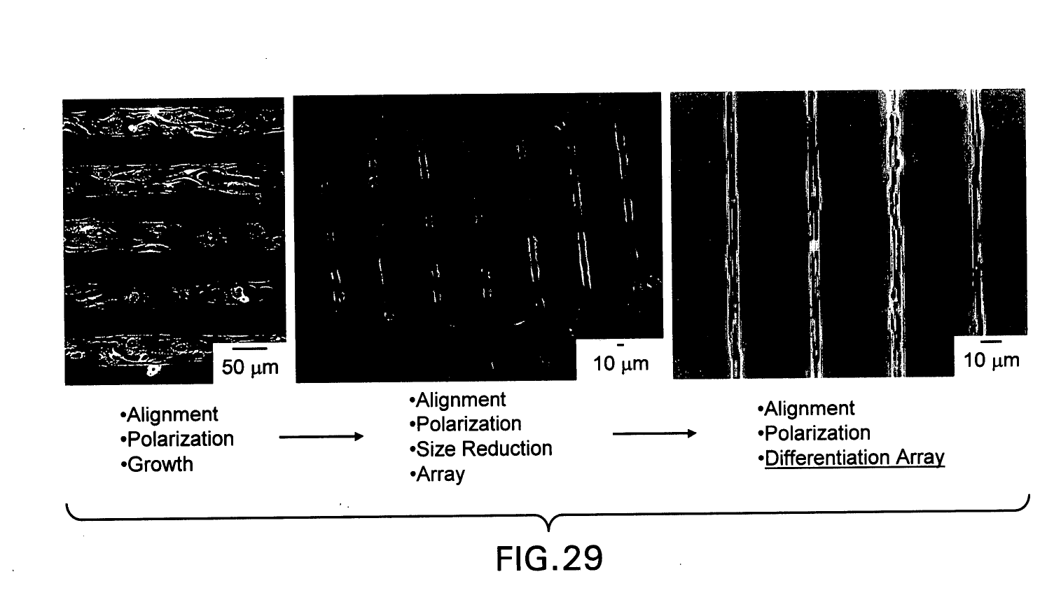

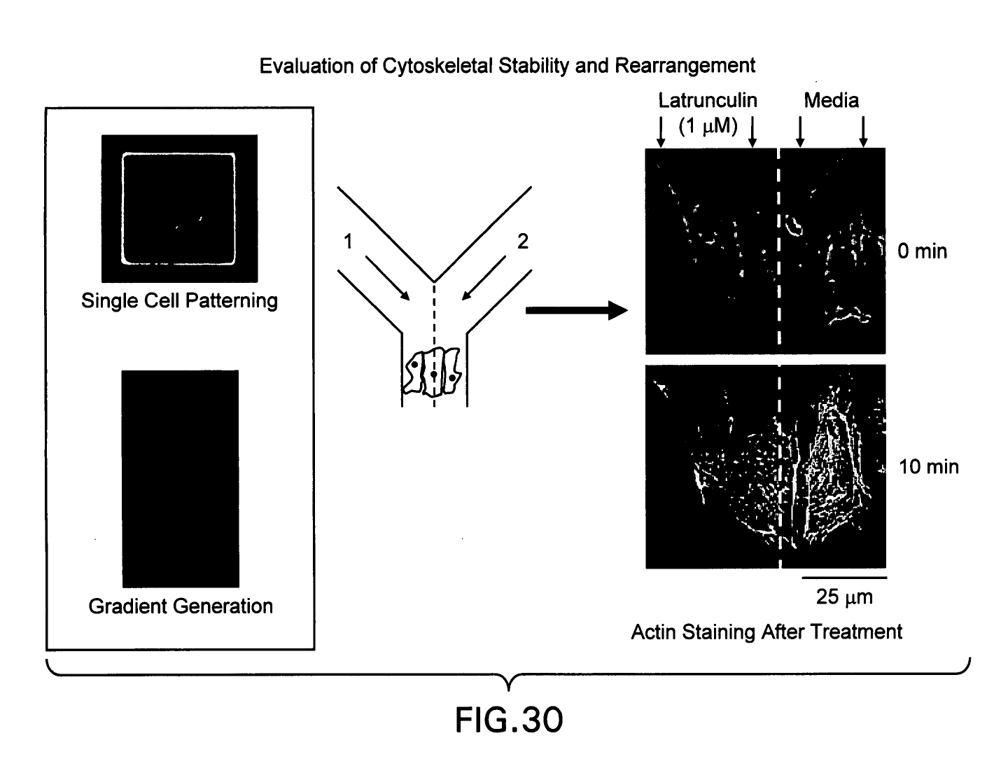

FIG. 23 presents the results of an assay where the effects of several inhibitors in the RAS pathway were measured. The graph reveals that the various inhibitors (P13-K, MAPK, and a mixture of both) show an effect on the diameter of the cell islands. Measurements were taken at 0, 2, 4, 6 and 8 hour increments. Over time, the control cells showed a larger increase in diameter over the cells treated with the inhibitors. The graph reveals that the combination therapy had a greater effect on cell motility (the diameter increased less as the cells moved less).

### Example 7

### Inhibition of Cell Motility of Renal Cells Via Matrix Metalloproteinase Inhibition

Two renal cell lines were used to study the effect of matrix metalloproteinase (MMP) inhibition on cell motility. Standard protocols were used to plate 100 769-P cells (renal carcinoma, purchased from ATCC) and HK-2 (proximal tubule cells from human kidney, from ATCC) in qualitative cell migration assay plate.

After allowing the cells to attach and spread for 8 hours, the stencil and the first layer were removed and MMP inhibitor (GM6001, Calbiochem) was added at various concentrations. The following data represents that MMP inhibition reduces cell motility of 769-P, but has no effect on the HK-2 cell line. Comparison of a qualitative cell migration assay plate to a conventional motility assay using Becton Dickinsions' transwell (6 well, 8 micron pores) showed that the qualitative cell migration assay plate data correspond to the transwell data. See FIG. 23, which demonstrates that data from CMA showed more sensitive determination of cell motility.

### Example 8

### Microtubule Experiments

Microtubule formation is necessary for cell movement and cell division. Common cancer drugs such as colchicine, nocodazole, vinblastine and paclitaxel are known to effect cell movement and migration by acting on the cell's microtubules. Colchicine, nocodazole and vinblastine disrupt the cell's normal tubulin equilibrium. These drugs “tie up” the tubulin that is present in the cell cytoplasm. This causes the tubulin that is present in the microtubules to disassemble and reenter the cytoplasm to reestablish equilibrium. These drugs also disrupt microtubule formation by interacting with binding sites on the microtubules, causing them to break up.

A first layer 150 having multiple orifices was applied to a support 140. The orifices (100 mM diameter holes, separated by 500 mM) were rendered inert to the adsorption of proteins and the adhesion of cells using the standard procedures described in earlier disclosures: silanes terminated with ethylene glycol groups were reacted covalently with the surface of the PDMS devices. The stencil was washed three times with PBS, and vacuum was applied for two minutes to remove air bubbles. Human microvasular endothelial cells from lung (HMVEC-L, Clonetics/Biowhittaker), were seeded into the macro-wells of the stencil at a density of 5×10³ cells/cm2 into the dishes in growth medium (EGM, Clonetics/Biowhittaker), and washed with fresh medium after an initial attachment period of 30 minutes to one hour. After an overnight incubation in the membranes, cells were treated with the following microtubule-disrupting agents: nocodazole (10 mg/ml), colchicine (10 mg/ml), vinblastine (10 mg/ml), or paclitaxel (10 mg/ml). Control cells were left untreated. Two different experiments were then performed. In the first experiment, cells were treated with the compounds while maintained within the macro-wells of the stencil. After two hours of treatment, the cells were imaged, the stencil was peeled off, and the cells were fixed with cold methanol (−20° C.) for ten minutes and washed three times with PBS. Immunofluorescence staining was performed using a monoclonal antibody to alpha-tubulin (1:100 dilution, DM1a, Sigma), followed by a FITC-conjugated goat anti-mouse antibody (25 mg/ml, Rockland Immunochemicals) and DAPI (3 mg/ml, Sigma) to stain the nucleus. Stained cells were mounted under a glass coverslip with Fluoromount G (Southern Biotechnology Associates) and imaged in a Zeiss fluorescence microscope.

In the second experiment, the stencil was peeled at the time of compound addition. After two hours of treatment, one set of samples was fixed and stained as described above. Another set of samples was left in the treatment compound and imaged over time, to monitor cell motility. Images were taken at 0, 2, 4, 8, and 24 hours. Cell motility was determined by taking the average diameter of the micro-regions, using ImageProPlus imaging software.

### Example 9

### I. Procedure for Fabrication of the Device for Monitoring Leukocyte Migration

A master of the device according to the present invention is made using photolithography. A silicon substrate is patterned based on a negative pattern of the top member using a suitable photoresist. Thereafter, polydimethyl siloxane (PDMS) is poured on top of the master and placed under vacuum in order to extract air bubbles therefrom. The thus poured PDMS layer is allowed to cure in an oven at about 30° C. for about 17 hours. Thereafter, the device is washed thoroughly with 2% Micro-90 (a product of International Products Corp.), rinsed for 10 minutes at 70° C. in “Sonic Bath,” and rinsed with de-ionized water, followed by a rinsing with 100% ethanol. The PDMS layer is then dried under nitrogen. At the same time, a pre-cleansed glass slide, such as a rectangular one having dimensions of about 4.913±0.004 inches (in.) by about 3.247±0.004 in. and a thickness of about 1.75 millimeters (mm), mm, is washed three times with ethanol and twice with methanol. Preferably, the surfaces of the PDMS layer and the glass slide to be bound together are both plasma oxidized for about 0.84 seconds. The PDMS layer and the glass slide are then pressed together using forceps to squeeze out air pockets there between. In this manner, a fluid-tight, conformal contact is established between the PDMS layer as top member and the glass slide and support member. In addition, by virtue of PDMS having been used as the top member material, the conformal contact between the PDMS layer and the glass slide is reversible.

It is to be noted that the method of making the device of the present invention described above is merely an example. Other examples for the method of making the device are provided in the co-pending application entitled “Test Device and Method of Making Same” referred to above.

### Example 10

### II. Leukocyte Migration Assay Utilizing Device for the Present Invention with a Rolling Mediator Disposed in a Channel Therein

A. Isolation of Leukocytes

Neutrophils are isolated from a volume of 5 milliliters (ml) of human blood from a healthy volunteer. The 5 ml of blood is diluted with Hanks Balance Salt Solution (HBSS) in a 1:2 ratio thereby increasing the total volume of blood to equal 15 ml. The whole blood dilution is layered over 10 ml of Ficoll-Paque Plus (obtained from Amersham Pharmacia Biotech AB, catalog #17-1440-02). The blood is then centrifuged for 30 minutes at 400 g at room temperature. The supernatant is aspirated off without disturbing the pellet. The pellet is resuspended on 10 ml of HBSS and 150 μl of 6% dextran to make up a 1% solution. The red blood cells are allowed to settle for at least one hour at room temperature. The neutrophils remain inside the supernatant while the red blood cells mostly settle down forming a pellet. The supernatant is pipetted out and diluted in a 1:2 ratio using HBSS. This suspension is centrifuged for 10 minutes at a velocity of 600 g. The supernatant is aspirated and the pellet is dissolved in 19 ml of deionized water. After one minute, the pellet is resuspended in 1 ml of 10× PBS. This suspension is centrifuged at 400 g for 10 minutes. The red blood cells are lysed in this process and the remaining cells are mostly neutrophils. The resulting pellet may be dissolved in media containing BSA in order to avoid the clumping of cells after a prolonged period of time at room temperature. The cell density is determined by counting the number of cells using a hemocytometer.

B. Placement of Leukocytes and Leukocyte Migration Mediators in Chamber

20 μl of water are pipetted in the first well of the chamber of the device fabricated according to the method disclosed in Section I and microcapillary action draws the water into the channel. After ensuring no air bubbles are inside the channel, an additional 10 μl of water are pipetted in the second well of the chamber. After 15 minutes pass and the hydrostatic pressure equalizes, 10 μl of P-Selectin at a concentration of 50:g/mL (obtained from R&D Systems, catalog #ADP3) is pipetted in both wells. The device is incubated for two hours at room temperature in a dish with a cover in order to keep the wells from drying out. After the incubation, the channel is washed four times using 0.1% Bovine Serum Albumin (BSA) in Phosphate Buffer Saline (PBS). After this last wash, all the liquid inside the wells is pipetted out leaving only liquid in the channel. 20 μl of 0.1% BSA in PBS is added to the first well and 10 μl of BSA in PBS is added to the second well. After 15 minutes pass and the hydrostatic pressure equalizes, neutrophils obtained from the method described in part A in 60 μl of media are added to the first well of each chamber (about 103 to about 106 cells per well of a 24 well plate, in volume of 60 μl of media per well) (non-labeled and fluorescently labeled monocytic cell lines-U937 (obtained from ATCC, catalog # TIB-202 and THP-1 (obtained from ATCC, catalog # CRL-1593.2) as well as other primary leukocytes may also be used. As seen in FIG. 7, it is preferred that 40 μl-60 μl of media be used to generate the range of flow velocity under normal physiological conditions (about 0.1 dynes/cm2 to about 20 dynes/cm2).

C. Data Acquisition

Digital images are taken on a Zeiss inverted microscope using AXIOCAM™ beginning 15 seconds after the sample comprising leukocytes is added to the first well. Data is analyzed on AXIOVISION™ software. Time-lapsed images are taken every 30 seconds for 5 minutes and 15 seconds. 10× objective lens is used to view and record the number of cells rolling along the channel.

D. Determining the Rolling Velocity of the Leukocytes

In order to characterize the rolling velocity of the leukocytes at a particular time, an image obtained using the method described in part C is used measure the distance the leukocytes traveled during the exposure time of the image. To determine rolling velocity (V), the following formula is used:
V=c(ltime/texposure) where
c: conversation factor for determining the actual distance the cells traveled. This factor may vary from image to image.
ltime: the length of the leukocytes migration in the captured image.
texposure: the exposure time of the image.
Preferably texposure is 100 milliseconds (ms) when the flow rate is about 0.1 dynes/cm2 to about 20 dynes/cm2.

### Example 11

### III. Leukocyte Migration Assay Utilizing Device of the Present Invention with a Rolling Mediator and Arrest Mediator Disposed in a Channel Therein

A. Isolation of Leukocytes

Neutrophils are isolated according to the method disclosed in section II, part A.

B. Placement of Leukocytes and Leukocyte Migration Mediators in Chamber

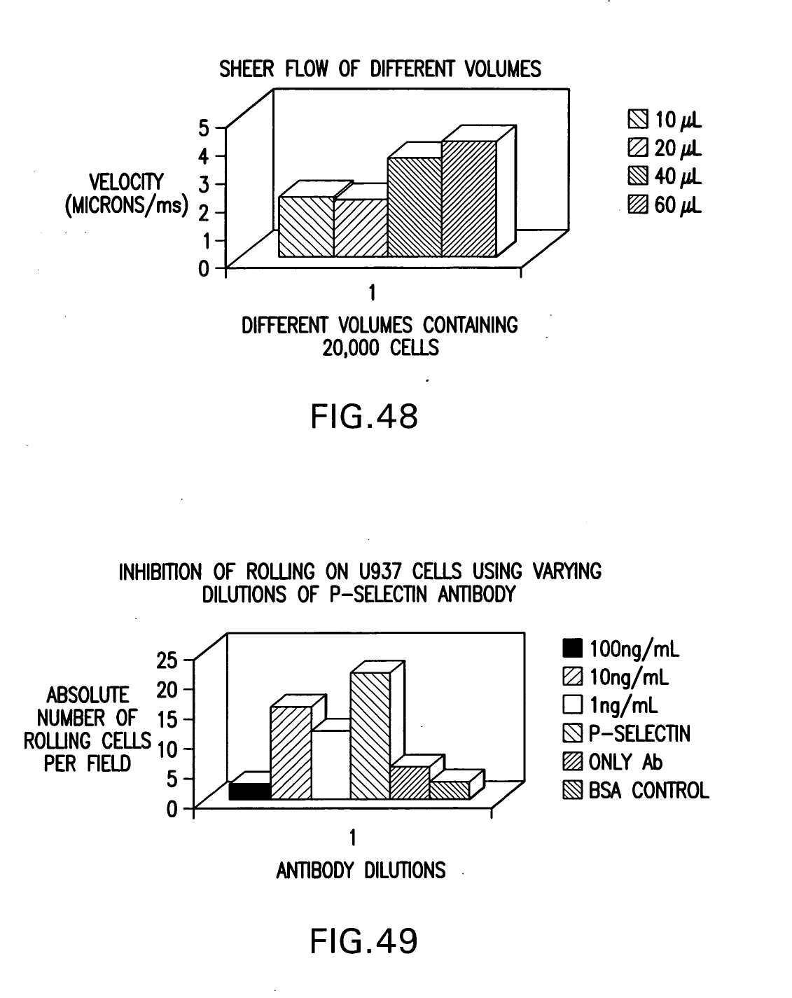

20 μl of water are pipetted in the first well of the chamber of the device fabricated according to method disclosed in section I. Microcapillary action draws the water into the channel. After ensuring no air bubbles are inside the channel, an additional 10 μl of water are pipetted out in the second well of the chamber. After 15 minutes pass and the hydrostatic pressure equalizes, 10 μl of P-Selectin with a concentration of 50:g/mL (obtained from R&D Systems, catalog #ADP3) is pipetted in the first well and 10 μl of ICAM-1 with a concentration of 50:g/mL (obtained from R&D Systems) is simultaneously pipetted in the second well. The device is incubated for two hours at room temperature in a dish with a cover in order to keep the wells from drying out. After the incubation, the channel is washed four times using 0.1% Bovine Serum Albumin (BSA) in Phosphate Buffer Saline (PBS). After this last wash, all the liquid inside the wells is pipetted leaving only liquid in the channel. 20 μl of 0.1% BSA in PBS is added to the first well and 10 μl of BSA in PBS is added to the second well. After 15 minutes pass and the hydrostatic pressure equalizes, neutrophils isolated from part A in 60 μl of media are added to the first well of each chamber (about 103 to about 106 cells per well of a 24 well plate, in volume of 60 μl of media per well) (non-labeled and fluorescently labeled monocytic cell lines-U937 and THP-1 as well as primary leukocytes may also be used). As seen in FIG. 48, it is preferred that 40 μl-60 μl of media be used to generate the range of flow velocity under normal physiological conditions (about 0.1 dynes/cm2 to about 20 dynes/cm2).

C. Data Acquisition

Digital images are taken on a Zeiss inverted microscope using AXIOCAM™ beginning 15 seconds after the sample comprising leukocytes is added to the first well. Data is analyzed on AXIOVISION™ software. Time-lapsed images are taken every 30 seconds for 5 minutes and 15 seconds. 10× objective lens is used to view and record the number of cells rolling along the channel and adhering to the channel.

### Example 12

### IV. Leukocyte Migration Assay Utilizing Confluent Layers of Endothelial Cells

A. Isolation of Leukocytes

Neutrophils are isolated according to the method disclosed in section II, part A.

B. Placement of Leukocytes and Endothelial Cells in Chamber

10 μl of a 10× dilution of MATRIGEL™ (obtained from BD Bioscience, catalog #356231) is added to the first well of the device fabricated according to the method disclosed in Section I. 10 L are added to the first well and the microcapillary action draws the solution into the channel. The MATRIGEL™ is then allowed to gel for about 15 minutes at room temperature. Another option is to coat the channel with 1 mg/mL concentration of fibronectin (obtained from GibcoBRL, catalog #33016-015) that is obtained by diluting the stock concentration of fibronectin using a 0.1% BSA solution. 5 μL of fibronectin at a concentration of 1 mg/mL are pipetted into the first well and microcapillary action draws the solution in to the channel.

Once the channel has been coated with either MATRIGEL™ or fibronectin, the endothelial cells are prepared for seeding. Cells are obtained from Clonetics at Bio-Whittaker in cryogenic vials. They are grown in T75 flasks until ready to be split using 0.025% Trypsin/EDTA. The cells are seeded on the channel at a density of 1×105 cells per 5 μl of media per assay for approximately two days to form a confluent monolayer of endothelial cells. During these two days, the endothelial cells are replenished with 40 μL of fresh media added into each well. After approximately two days, the endothelial cells are exposed to a concentration of 1 ng/ml of TNF-∀ (other chemokines may alternatively be used) for a period of four hours at 37° C. At the end of the four hours, the TNF-∀ is washed using 60 μL of fresh media twice. The volume of media inside each well is replaced with 15 μL of fresh media. Neutrophils isolated from Section II, part A in 60 μl of media are added to the first well of chamber the (about 103 to about 10⁶ cells per well of a 24 well plate, in volume of 60 μl of media per well) (non-labeled and fluorescently labeled monocytic cell lines-U937 and THP-1 as well as primary leukocytes may also be used.) If a monocytic cell line is used, the cells are fluorescence labeled using cell tracker probes (obtained from Molecular Probes, catalog #s C-2925 and C-2927). The cells are incubated with a 1 μM concentration of probes for 30 minutes at 37° C. The media is then changed and the cells are placed inside an incubator for an additional 30 minutes.

As seen in FIG. 48, it is preferred that 40 μl-60 μl of media be used to generate the range of flow velocity under normal physiological conditions (about 0.1 dynes/cm2 to about 20 dynes/cm2).

C. Data Acquisition

Digital images are taken on a Zeiss inverted microscope using AXIOCAM™ beginning 15 seconds after the sample comprising leukocytes is added to the first well. Data is analyzed on AXIOVISION™ software. Time-lapsed images are taken every 30 seconds for 5 minutes and 15 seconds. 10× objective lens is used to view and record the number of cells rolling along the channel.

D. Determining the Rolling Velocity of the Leukocytes

In order to characterize the rolling velocity of the cells at a particular time, an image obtained from the method described in part C is used to measure the distance the leukocytes traveled during the exposure time of the image. To determine rolling velocity (V), the following formula is used:
V=c(ltime/texposure) where
c: conversation factor for determining the actual distance the cells traveled. This factor may vary from image to image.
ltime: the length of the leukocytes migration in the captured image.
texposure: the exposure time of the image.
Preferably texposure is 100 ms when the flow rate is about 0.1 dynes/cm² to about 20 dynes/cm2.

### Example 13

### V. Inhibition of Leukocyte Migration Assay Utilizing Device of the Present Invention with a Rolling Mediator and an Arrest Mediator Disposed in a Channel Therein

A. Isolation of Leukocytes

Neutrophils are isolated according to the method disclosed in section II, part A.

B. Placement of Leukocytes, P-selectin, and P-selectin Antibodies in the Chamber

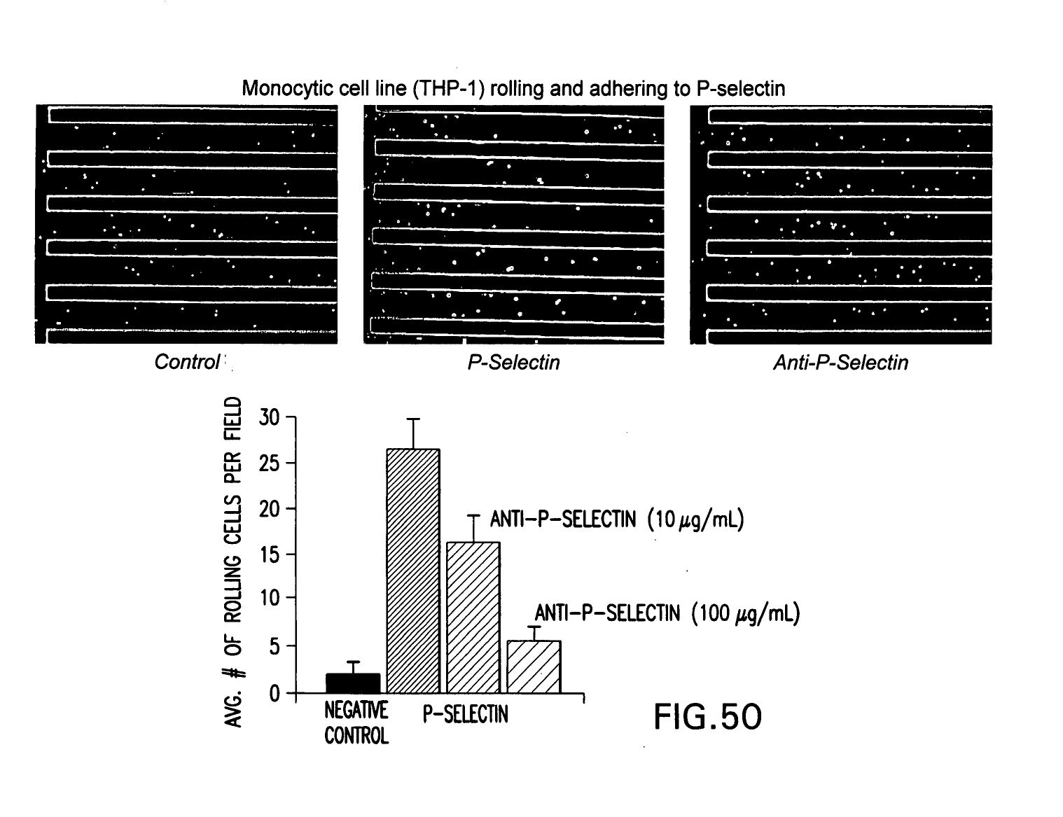

With respect to five chambers, 20 μl of 0.1% BSA are pipetted in the first well of each chamber of the device fabricated according to the method described in Section I. Microcapillary action draws water into the channels. After ensuring no air bubbles are inside the channels, an additional 10 μl of BSA are pipetted in the second well of each chamber. After 15 minutes pass and the hydrostatic pressure equalizes, 10 μl of P-Selectin (50:g/mL) are pipetted in first wells and 10 μl of ICAM-1 (50:g/mL) are pipetted into the second wells using a multipipettor. The device is incubated for two hours at room temperature in a dish with a cover in order to keep the wells from drying out. After the incubation, the channels of each well are washed four times using 0.1% Bovine Serum Albumin (BSA) in Phosphate Buffer Saline (PBS). With respect to the five different chambers, 100 ng/mL of P-selectin antibody is pipetted into the first well of chamber #1; 10 ng/mL of P-selectin antibody is pipetted into first well of chamber #2; and 1 ng/mL of P-selectin antibody is pipetted into the first well of chamber #3; 100:g/mL of P-selectin antibody is pipetted into the first well of chamber #4; and 0.1% BSA in PBS is pipetted into the first well of chamber #5. The device is incubated for thirty minutes at room temperature in a dish with a cover in order to keep the wells from drying out. After incubation, the channels are washed first with 20 μl of BSA, then with 10 μl of BSA and then 0.1% BSA in PBS. Neutrophils in 20 μl of media are added to the first well of each chamber (about 103 to about 106 per well of a 24 well plate, in volume of 20 μL of media per well) (non-labeled and fluorescently labeled monocytic cell lines-U937 and THP-1 as well as primary leukocytes may be used). Digital images are taken on a Zeiss inverted microscope using AXIOCAM™ beginning 15 seconds after the sample comprising leukocytes is added to the first well. Data is analyzed on AXIOVISION™ software. Time-lapsed images are taken every 30 seconds for 5 minutes and 15 seconds. 10× objective lens is used to view and record the number of cells rolling after the treatment with P-selectin antibody. As seen from FIGS. 49 and 50, a 100 ng/mL dilution of the antibody is a preferred concentration to inhibit the rolling of the cells. As seen from the still photo images of FIG. 50, the number of leukocytes that roll and adhere to the endothelium are reduced in the presence of anti-P selectin.

C. Placement of Leukocytes, E-Selectin, and E-Selectin Antibodies in the Chamber

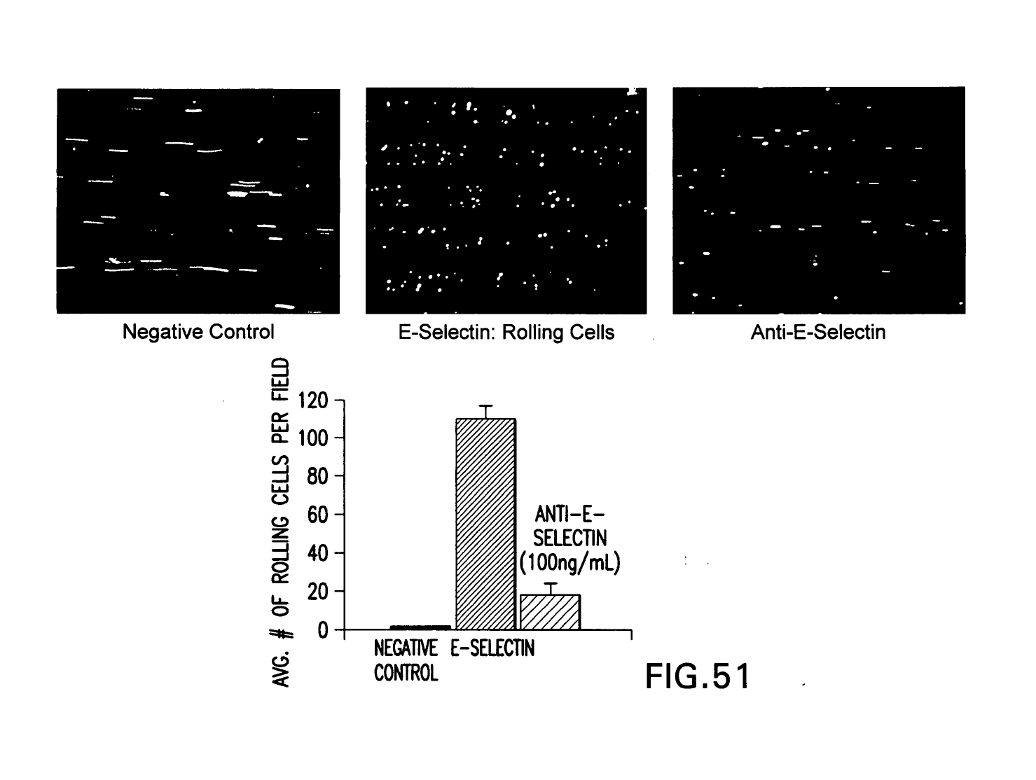

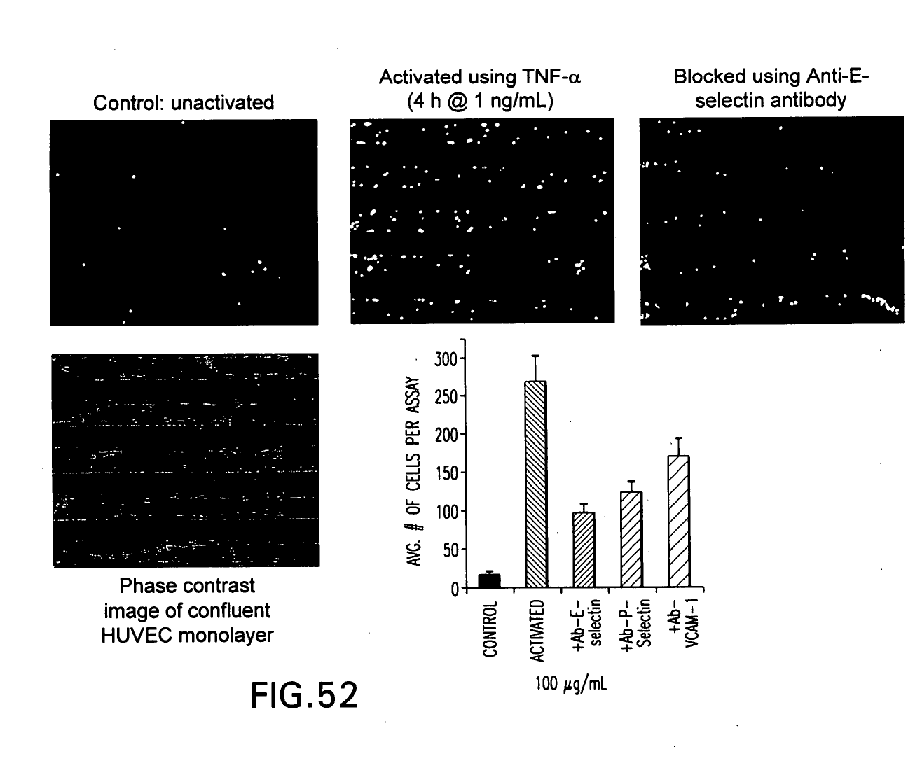

With respect to five chambers, 20 μl of 0.1% BSA are pipetted in the first well of each chamber of the device fabricated according to the method described in Section I. Microcapillary action draws the BSA into the channels. After ensuring no air bubbles are inside the channels, an additional 10 μl of 0.1% BSA are pipetted in the second well of each chamber. After 15 minutes pass and the hydrostatic pressure equalizes, 10 μl of E-Selectin (50:g/mL) are pipetted in the first wells and 10 μl of ICAM-1 (50:g/mL) are pipetted into the second wells using a multipipettor. The device is incubated for two hours at room temperature in a dish with a cover in order to keep the wells from drying out. After the incubation, the channels of each well are washed four times using 0.1% Bovine Serum Albumin (BSA) in Phosphate Buffer Saline (PBS). With respect to the five different chambers, 100 ng/mL of E-selectin antibody is pipetted into the first well of chamber #1; 10 ng/mL of E-selectin antibody is pipetted into first well of chamber #2; and 1 ng/mL of E-selectin antibody is pipetted into the first well of chamber #3; 100:g/mL of E-selectin antibody is pipetted into the first well of chamber #4; and 0.1% BSA in PBS is pipetted into the first well of chamber #5. The device is incubated for thirty minutes at room temperature in a dish with a cover in order to keep the wells from drying out. After incubation, the channels are washed four times with 0.1% BSA in PBS. Neutrophils in 20 μl of media are added to the first well of each chamber (about 103 to about 106 cells per well of a 24 well plate, in volume of 20 μl of media per well) (non-labeled and fluorescently labeled monocytic cell lines-U937 and THP-1 as well as primary leukocytes may be used). Digital images are taken on a Zeiss inverted microscope using AXIOCAM™ beginning 15 seconds after the sample comprising leukocytes is added to the first well. Data is analyzed on AXIOVISION™ software. Time-lapsed images are taken every 30 seconds for 5 minutes and 15 seconds. 10× objective lens is used to view and record the number of cells rolling after the treatment with E-selectin antibody. As seen from FIG. 10, a 100 ng/mL dilution of the antibody is a preferred concentration to inhibit the rolling of the cells. As seen from the still photo images of FIG. 51, the number of leukocytes that roll and adhere to the endothelium are reduced in the presence of anti-E selectin.

### Example 14

### VI. Inhibition of Leukocyte Migration Assay Utilizing Device of the Present Invention with Confluent Layers of Endothelial Cells Disposed in a Channel Therein

A. Isolation of Leukocytes

Neutrophils are isolated according to the method disclosed in section IV, part

B. Placement of Leukocytes and Endothelial Cells in Chamber

Endothelial cells are placed and activated in four different channels of four chambers (#1-#4) according to the method disclosed in section IV, part B. With respect to a fifth (#5) chamber, endothelial cells are placed in the channel, but are not activated. With respect-to these five different chambers, 100 μg/ml of P-selectin antibody is pipetted into the first well of chamber #1; 100 μg/ml of E-selectin antibody is pipetted into the first well of chamber #2; 100 μg/ml of VCAM-1 antibody is pipetted into the first well of chamber #3; and 100 μg/ml of BSA in PBS is pipetted into the first well of chamber #4. The device is incubated for thirty minutes at room temperature in a dish with a cover in order to keep the wells from drying out. After incubation, the channels are washed four times with 0.1% BSA in PBS. Neutrophils in 20 μl of media are added to the first well of each chamber (about 103 to about 106 cells per well of a 24 well plate, in volume of 20 μl of media per well) (non-labeled and fluorescently labeled monocytic cell lines-U937 and THP-1 as well as primary leukocytes may be used). Digital images are taken on a Zeiss inverted microscope using AXIOCAM™ beginning 15 seconds after the sample comprising leukocytes is added to the first wells. Data is analyzed on AXIOVISION™ software. Time-lapsed images are taken every 30 seconds for 5 minutes and 15 seconds. 10× objective lens is used to view and record the number of cells rolling after the treatment with the antibodies as seen in FIG. 51.

### Example 15

### VII. Selective Activation of Endothelial Cells by Delivery of TNF-∀ in a Gradient Created by Laminar Flow

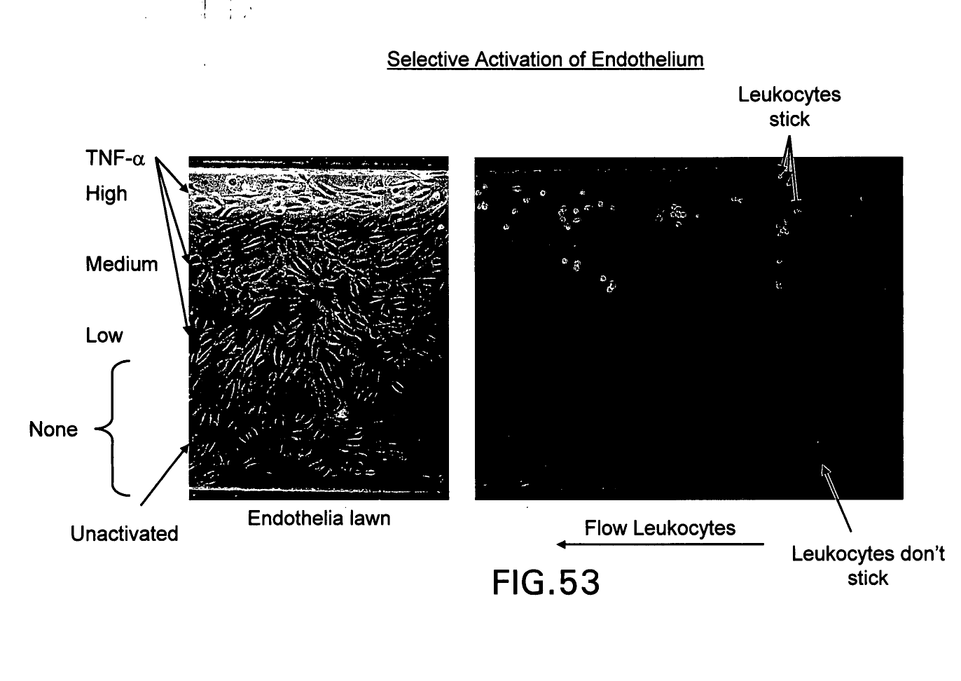

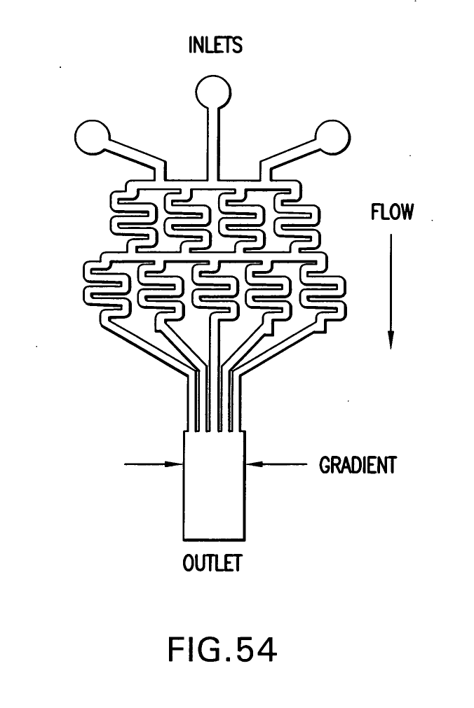

The surface of a device of the present invention was coated with endothelial cells and allowed to grow to confluence (to create a “lawn” of cells). TNF-∀ was delivered to the lawn of endothelial cells via laminar flow to “activate” the endothelial cells. Each stream of solutions containing TNF-∀ were at different concentrations, thus creating a gradient perpendicular to the channel. This gradient effectively delivered TNF-∀ to the lawn of endothelial cells at different concentrations at different positions on the lawn of cells. Leukocytes were then flowed over the lawn of activated endothelial cells. Only those endothelial cells that were activated by TNF-∀ provide suitable “attachment” sites for the leukocytes. The leukocytes did not attach equally to the entire lawn, but attached to the areas of the endothelial cell lawn that had been exposed to high concentrations of TNF-∀ and did not attach to those areas of the lawn that had been exposed to low concentrations of TNF-∀, or those areas not exposed to TNF-∀ at all. These results indicate that there was indeed a creation of a concentration gradient of TNF-∀ by the laminar flow. See FIG. 53.

### Example 16

### Procedure of Fabrication of Chemoinvasion Device

A silicon wafer (6 inches) is spin coated with photoresist (SU8-50) at 200 rpm for 45 seconds. After baking the wafer on a hot plate at 115 C for 10 minutes, the wafer is allowed to cool to room temperature. A mask aligner (EVG620) is used to expose the photoresist film through a photomask. Exposure of 45 seconds is followed by another hard bake at 115 C for 10 minutes. The silicon wafer is allowed to cool to room temperature for over 30 minutes. The uncrosslinked photoresist is removed using propylene glycol methyl ether acetate (PGMEA). The wafer is dried under a stream of nitrogen, and the patterned photoresist is ready for subsequent processing.

In one embodiment, the patterned photoresist is spin-coated with another layer of SU8-100 at 1500 rpm for 45 seconds. A mask aligner is used to selectively expose macrofeatures (i.e. wells) of the top member but not expose channel regions connecting the wells and other areas of the top member. After post exposure processing and photoresist removal, the master contains multiple layered features. This step may be repeated to introduce macro-features on the master, which have the height of approximately 3 mm.

When a PDMS prepolymer is cast against the master, it faithfully replicates the features in the master. When casting, PDMS is added in an amount slightly lower than the height of the macrofeatures. After curing the PDMS for four hours at 65 degrees C., the PDMS is peeled off the silicon master and thoroughly cleaned with soap and water and rinsed with 100% ethanol. A glass support member is also cleaned and rinsed with ethanol. The PDMS membrane and glass support member are plasma oxidized for 1 minute with the sides that would be bonded together facing upward. The PDMS membrane is then placed onto the glass support member and pressure is applied to remove any air bubbles that may have formed between the PDMS membrane and the glass support member. The assembled device is then cooled to 4 EC. Within 15 minutes of the plasma oxidation of the PDMS membrane and the glass support member, 20 microliters (μl) of Matrigel (any other hydrogel may be used) is poured into the first well and allowed to flow into the capillaries. The device is placed at room temperature for 15 minutes to set the Matrigel. Excess gel is then removed from the wells of the top member using a vacuum and a Pasteur pipette.

### Example 17

### Cell Chemoinvasion Assay

Placement of Cells and Test Agent in Chamber

The first and second wells of a chamber of a top member are filled with phosphate buffered saline solution, PBS. The bottom of the second well may be treated with fibronectin (1 mg/ml) or other extracellular matrix protein for 30 minutes, followed by washing twice with PBS. After aspirating PBS, astrocytoma cells (U87-MG) are plated in 50 μl of freshly warmed medium in the second well (25,000 cells per well of a 24-well plate, in volume of 50 μl of solution per well). The cells deposit through the second well of the chamber, and attach to the bottom of the second well.

Cells are left to attach and spread in the second well overnight in a 37° C. incubator. At the start of the experiment, the cell medium is exchanged for fresh serum-free medium. 10 μg of bFGF (basic fibroblast growth factor) per ml of medium is added to the first well of each chamber.

Image Acquisition and Data Analysis

Digital Images are taken on a Zeiss inverted microscope using AXIOCAM™. Data was analyzed on AXIOVISION™ software. Time-lapsed images are taken every day at the same time for four days.

### Example 18

### Cells Chemoinvasion Inhibition Assay Using Solution Gradient

Placement of Cells and Test Agent in Chambers

With respect to three chambers, the wells of each chamber of a top member are filled with PBS. The bottom of the second wells may be treated with fibronectin (1 mg/ml) or other extracellular matrix protein for 30 minutes, followed by washing twice with PBS. After aspirating PBS, U87-MG cells are plated in 50 μl of freshly warmed medium in the second wells (10,000 cells per well of a 24-well plate, in volume of 50 μl of medium per well). The cells deposit through the second wells of each chamber, and adhere to the bottom of the second wells.

Cells are left to attach and spread in the second wells overnight in a 37° C. incubator. At the start of the experiment, the cell medium is exchanged for fresh serum-free medium or 1% serum. 1 μg of bFGF (basic fibroblast growth factor) per ml of medium is added to the first wells of the chamber. A solution gradient is allowed to form for one hour.

With respect to the three different chambers, 100 μM of LY294002 are placed in the second well of chamber #1, 10 μM LY294002 of are placed in the second well of chamber #2, and 1.0 μM of LY294002 are placed in the second well of chamber #3.

Image Acquisition and Data Analysis

Digital Images are taken on a Zeiss inverted microscope using AXIOCAM™. Data was analyzed on AXIOVISION™ software. Time-lapsed images are taken every day at the same time for four days.

### Example 19

Immobilization of Biomolecules on Support Member

After assembling the device as described above, the channel regions are filled with ethanolic solution containing (CH₃CH₂O)₃Si(CH₂)₃NH₂. After 20 minutes at room temperature, the channel regions are washed off using ethanol. The device is incubated at 105 C for one hour to crosslink the siloxane monolayer formed on the support member. The device is washed with ethanol to remove residues. The channel regions are filled with a solution of diisocyanate, either hexamethylene diisocyanate or tolyl diisocyanate (1% in acetonitrile or N-methyl pyrrolidinone). The diisocyanate is allowed to react for two hours with the terminal amino groups of the siloxane monolayer formed on the support member. The diisocyanate is washed off. The channel regions are filled with 1 mg/ml solution of heparan sulfate or other sulfated carbohydrates (for example, di-acetylated form of heparin, heparin fragments, lectins containing sulfated sugars, etc). The heparan sulfate is allowed to react with the support member to form immobilized species. The heparan sulfate solution and other reagents are washed off. A chemokine solution (any chemokine from CC, CXC, CX3C, or XC families may be used) is introduced into the channel region. By electrostatic interaction, chemokines that have higher pI (˜9-10) adsorb onto the negatively charged sulfated support member.

### Example 20

### Chemotaxis Inhibition Assay Using Surface Gradient

Two wells are filled with 50 μl of PBS, and hydrostatic pressure is allowed to equalize. 5 μl of anti-hisx6 antibody are added to the first well and 5 μl of buffer are added to the second well to equalize hydrostatic pressure. By diffusion, the antibody concentration forms a gradient from the first well to the second well. After 2 hours at room temperature, the two wells are washed off by adding 50 μl of buffer to the second well and removing 50 μl from the first well. By physisorption, the solution gradient is transferred onto a surface thereby forming a surface gradient. A solution of IL-8 (recombinant human IL-8 with a HISx6 fusion tag, R+D systems, catalog No. 968-IL) at concentration of 25 μg/ml is added to the channel regions. The solution is allowed to incubate for 30 minutes at room temperature. Excess IL-8 chemokine is washed off and the surface is decorated with bound IL-8. Neutrophils(freshly isolated from a healthy donor) are added to the second well. Typically 20,000-100,000 cells are added in volume ranging from 10-550 μl. Neutrophils are allowed to adhere to the support member and allowed to migrate towards the higher concentration of IL-8. Inhibition of migration is achieved by adding polyclonal antibody against IL-8.

### Example 21

### Selective Activation of Endothelial Cells by Delivery of TNF-∀ in a Gradient by Laminar Flow

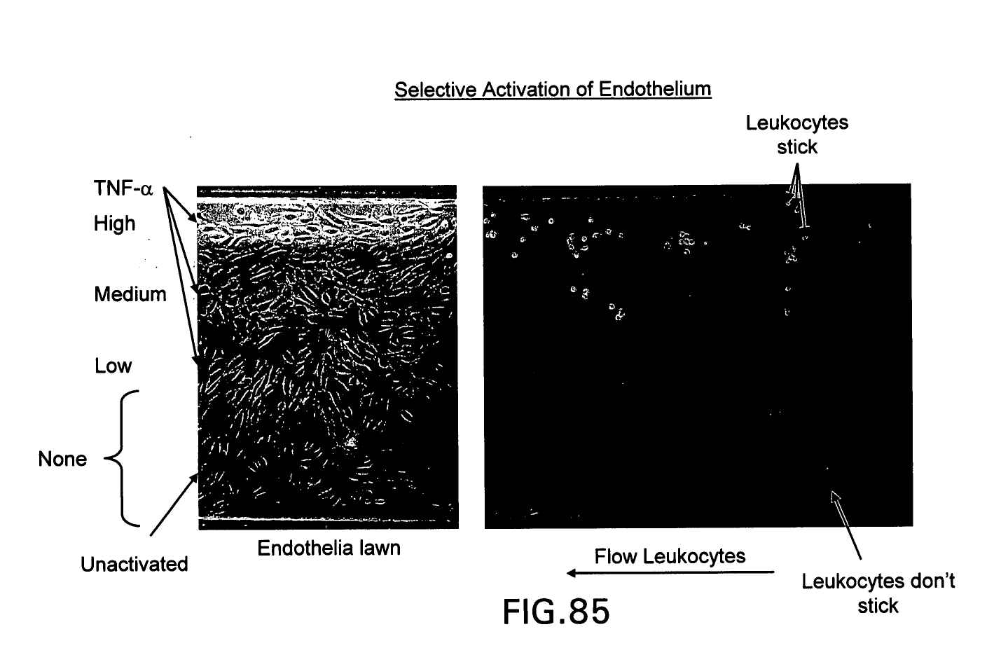

The surface of a device of the present invention was coated with endothelial cells and allowed to grow to confluence (to create a “lawn” of cells). TNF-∀ was delivered to the lawn of endothelial cells via laminar flow to “activate” the endothelial cells. Each stream of solutions containing TNF-∀ were at different concentrations, thus creating a gradient perpendicular to the channel. This gradient effectively delivered TNF-∀ to the lawn of endothelial cells at different concentrations at different positions on the lawn of cells. Leukocytes were then flowed over the lawn of activated endothelial cells. Only those endothelial cells that were activated by TNF-∀ provide suitable “attachment” sites for the leukocytes. The leukocytes did not attach equally to the entire lawn, but attached to the areas of the endothelial cell lawn that had been exposed to high concentrations of TNF-∀ and did not attach to those areas of the lawn that had been exposed to low concentrations of TNF-∀, or those areas not exposed to TNF-∀ at all. These results indicate that there was indeed a creation of a concentration gradient of TNF-∀ by the laminar flow. See FIG. 85.

While several embodiments have been described above it should be understood that these are only illustrative and that others also within the spirit and scope of the present invention are also plausible.

We claim:

1. A method for creating a primary cell profile, the method comprising in vitro monitoring of primary cells from a test patient wherein said monitoring comprises studying primary cell phenotypes and dynamics selected from the group consisting of cell morphology, molecular marker expression pattern, selective activation, rolling and adhesion properties, transmigration ability, and chemotactic properties.

2. The method of claim 1 further comprising creating a database of primary cell profiles wherein said data base comprises a primary cell profile for at least one healthy patient and for at least one diseased patient.

3. A method of predicting a therapeutic outcome for a test patient having a disease, said method comprising
a) generating a primary cell profile for the test patient by the method of claim 1;
b) comparing the primary cell profile of the test patient with the primary cell profile of a profiled patient having the same disease and having received a therapy
c) determining the similarities of the primary cell profiles regarding cell phenotypes and dynamics selected from the group consisting of cell morphology, molecular marker expression pattern, selective activation, rolling and adhesion properties, transmigration ability, and chemotactic properties
d) determining the therapeutic outcome of the profiled patient; and
e) correlating the therapeutic outcome of the profiled patient to predict the therapeutic outcome of the test patient based on the similarities of the primary cell profiles.

4. The method of claim 1 wherein the cell profile is determined using primary leukocytes.

5. The method of claim 1 wherein the cell profile is determined using monocytes.
